(19) United States
(12) Patent Application Publication
(10) Pub. No.: US 2022/0207516 A1
(43) Pub. Date: Jun. 30, 2022

(54) PROGRAM, INFORMATION PROCESSING METHOD, AND TERMINAL

(71) Applicant: LINE CORPORATION, Tokyo (JP)

(72) Inventors: Taedong KIM, Tokyo (JP); Seyoung Chun, Tokyo (JP)

(73) Assignee: LINE CORPORATION, Tokyo (JP)

(21) Appl. No.: 17/698,674

(22) Filed: Mar. 18, 2022

Related U.S. Application Data
(63) Continuation of application No. PCT/JP2019/051639, filed on Dec. 30, 2019.

(30) Foreign Application Priority Data
Dec. 30, 2019 (JP) 2019-240073

(51) Int. Cl. G06Q 20/32; G06Q 20/22; G06Q 20/06

(52) U.S. Cl. CPC G06Q 20/3278; G06Q 20/065; G06Q 20/227

(57) ABSTRACT

A non-transitory computer-readable medium stores instructions which, when executed by at least one processor of a terminal that executes processing relating to payment, cause the at least one processor to perform processing related to a first settlement based on a first account with which a user of the terminal is able to carry out settlement; control a display region of the terminal to display first information related to an insufficiency of a balance of the first account, the first information being based on an amount of the first settlement and the balance of the first account; and based on a first input being received at the display region while the first information is displayed, perform the processing related to the first settlement based on at least a second account different from the first account.

### CROSS-REFERENCE TO RELATED APPLICATION(S)

This application is a bypass continuation of International Application No. PCT/JP2019/51639, filed on Dec. 30, 2019, which is based on and claims priority to Japanese Patent Application No. JP2019-240073, filed on Dec. 30, 2019, in the Japan Patent Office, the disclosures of which are incorporated by reference herein in their entireties.

### BACKGROUND

### 1. Field

The present disclosure relates to a program, an information processing method, and a terminal.

### 2. Description of Related Art

Services that realize electronic settlement carried out by a terminal or a user of the terminal using applications that can be executed on terminals such as smartphones are becoming increasingly widespread.

For example, technology for settling the purchase amounts of goods may use such a terminal.

### SUMMARY

In accordance with an aspect of the disclosure, a non-transitory computer-readable medium stores instructions which, when executed by at least one processor of a terminal that executes processing relating to payment, cause the at least one processor to perform processing related to a first settlement based on a first account with which a user of the terminal is able to carry out settlement; control a display region of the terminal to display first information related to an insufficiency of a balance of the first account, the first information being based on an amount of the first settlement and the balance of the first account; and based on a first input being received at the display region while the first information is displayed, perform the processing related to the first settlement based on at least a second account different from the first account.

The first account may be a shared account, and at least the user of the terminal and a first user different from the user of the terminal may be able to carry out settlement with the shared account.

The processing related to the first settlement may be performed based on at least the shared account and the second account, based on the first input received at the display region.

In the first settlement, payment may be carried out preferentially from a balance of the shared account from among the shared account and the second account.

According to the first settlement, money may be transferred from the second account to the shared account, and the first settlement is carried out based on a balance of the shared account.

According to the processing related to the first settlement, the money may be transferred from the second account to the shared account based on the first input, and the first input may be received from the user of the terminal.

The instructions may further cause the at least one processor to: control the display region to display first code information associated with the second account, or code reader information which indicates reading of code information, based on the first input being received at the display region while the first information is displayed, the first input being received from the user of the terminal; and perform the processing related to the first settlement based on the first code information being read, or based on the code information being read by the terminal while the code reader information is displayed in the display region.

The second account may be an account of the user of the terminal.

The instructions may further cause the at least one processor to control the display region to display second information related to an insufficiency of a balance of the shared account, based on the amount of the first settlement, the balance of the shared account, and a balance of the second account; and perform processing related to sending money to the second account, based on a second input being received at the display region while the second information is displayed, the second input received from the user of the terminal.

The second account may be an account of the first user.

The instructions may further cause the at least one processor to transmit a request for permission to use the second account for settlement to another terminal different from the terminal using a communication interface of the terminal, and the processing related to the first settlement may be performed based on the permission being received from the first user.

The instructions may further cause the at least one processor to receive, using a communication interface of the terminal, charge information related to a charge for an amount corresponding to payment using the second account; and control the display region to display a first indication based on the charge information.

The processing related to the first settlement may be performed based on the shared account and accounts of users, the users may be able to carry out settlement using the shared account, and the accounts may include the second account.

Payment that is based on the first settlement may be executed while a shortfall in the balance of the shared account is equally assigned to the accounts.

The second account may be an account of a business operator, and the processing related to the first settlement may be performed by lending, from the second account, an amount corresponding to a shortfall in the balance of the first account.

The processing related to the first settlement may be performed based on code information displayed at the display region being read, or based on the terminal reading code information.

The first information may be received using a communication interface of the terminal from a server that processes the first settlement, based on the balance of the shared account being determined to be insufficient based on the amount of the first settlement and the balance of the shared account.

The processing related to the first settlement may be performed using wireless communication with a terminal corresponding to a store which sells goods or provides a service to be purchased according to the first settlement, and the wireless communication may be performed using a communication interface of the terminal.

The wireless communication may include short-range communication.

The second account may be an account of a first user different from the user of the terminal.

The second account may be selected based on input to the terminal, the input being received from the user of the terminal.

The second account may be selected based on a selection of a chat-room including the user of the terminal and the first user, the selection being received from the user of the terminal.

The instructions may further cause the at least one processor to transmit information related to a request for permission to use the second account for settlement, using a communication interface of the terminal, and the processing related to the first settlement may be executed based on the permission being received from the first user.

In accordance with an aspect of the disclosure, an information processing method of a terminal for performing processing related to settlement includes performing, using a controller of the terminal, processing related to first settlement based on a first account with which a user of the terminal is able to carry out settlement; displaying, in a display region of the terminal, first information related to an insufficiency of a balance of the first account, based on an amount of the first settlement and the balance of the first account; and based on a first input being received at the display region while the first information is displayed, performing, using the controller, the processing related to the first settlement based on at least a second account different from the first account.

In accordance with an aspect of the disclosure, a terminal for performing processing relating to settlement includes a controller configured to perform processing relating to a first settlement, based on a first account with which a user of the terminal is able to carry out settlement; and a display configured to display first information relating to an insufficiency of a balance of the first account, based on an amount of the first settlement and the balance of the first account, based on an input being received from the user of the terminal at the display while the first information is displayed, the controller is further configured to perform the processing related to the first settlement based on at least a second account different from the first account.

In accordance with an aspect of the disclosure, a terminal for performing processing relating to settlement includes a processor configured to read program code stored in a memory and execute processing based on the program code, wherein the program code is configured to cause the processor to: perform processing related to a first settlement based on a first account with which a user of the terminal is able to carry out settlement, control a display region of the terminal to display first information related to an insufficiency of a balance of the first account, based on an amount of the first settlement and the balance of the first account, and based on a first input being received at the display region while the first information is displayed, perform the processing related to the first settlement based on at least a second account different from the first account.

In accordance with an aspect of the disclosure, a non-transitory computer-readable medium may be configured to store instructions which, when executed by at least one processor of a server that communicates with a terminal for performing processing relating to settlement, cause the at least one processor to: perform processing related to first settlement based on a first account with which a user of the terminal is able to carry out settlement; control a communication interface of the server to transmit, to the terminal, first information relating to insufficiency of a balance of the first account based on an amount of the first settlement and the balance of the first account; and based on a first input being received from the user of the terminal at a display region of the terminal while the first information is displayed on the display region, perform the processing related to the first settlement based at least on a second account different from the first account.

### BRIEF DESCRIPTION OF DRAWINGS

FIG. 1-1 is a diagram showing an example of a system configuration of a communication system in an aspect of an embodiment.

FIG. 1-2 is a diagram showing an example of a system configuration of a store POS system according to an aspect of an embodiment.

FIG. 1-3 is a diagram showing an example of a function implemented by a controller of a server according to a first embodiment.

FIG. 1-4 is a diagram showing an example of information stored in a storage of the server according to the first embodiment.

FIG. 1-5 is a diagram showing an example of payment-application user registration data according to the first embodiment.

FIG. 1-6 is a diagram showing an example of a data configuration of a user management database according to the first embodiment.

FIG. 1-7 is a diagram showing an example data configuration of a first shared wallet management database, which is an example of a shared wallet management database according to the first embodiment.

FIG. 1-8 is a flowchart showing an example flow of processing executed by devices according to the first embodiment.

FIG. 1-9 is a flowchart showing an example flow of processing executed by devices according to the first embodiment.

FIG. 1-10 is a flowchart showing an example flow of processing executed by devices according to the first embodiment.

FIG. 1-11 is a flowchart showing an example flow of processing executed by devices according to the first embodiment.

FIG. 2-1 is a diagram showing an example of a screen displayed in a display of a terminal according to a second embodiment.

FIG. 2-2 is a diagram showing an example of a screen displayed in the display of the terminal according to the second embodiment.

FIG. 2-3 is a diagram showing an example of a screen displayed in the display of the terminal according to the second embodiment.

FIG. 2-4 is a diagram showing an example of a screen displayed in the display of the terminal according to the second embodiment.

FIG. 2-5 is a diagram showing an example of a screen displayed in the display of the terminal according to the second embodiment.

FIG. 2-6 is a diagram showing an example of a screen displayed in the display of the terminal according to the second embodiment.

FIG. 2-7 is a diagram showing an example of a screen displayed in the display of the terminal according to the second embodiment.

FIG. 2-8 is a flowchart showing an example flow of processing executed by devices according to the second embodiment.

FIG. 2-9 is a flowchart showing an example flow of processing executed by devices according to the second embodiment.

FIG. 2-10 is a diagram showing an example of a screen displayed in a display of a terminal according to a variation of the second embodiment.

FIG. 2-11 is a diagram showing an example of a screen displayed in the display of the terminal according to the variation of the second embodiment.

FIG. 2-12 is a diagram showing an example of a screen displayed in the display of the terminal according to the variation of the second embodiment.

FIG. 2-13 is a flowchart showing an example flow of processing executed by devices according to second variation of the second embodiment.

FIG. 2-14 is a flowchart showing an example flow of processing executed by devices according to second variation of the second embodiment.

FIG. 3-1 is a diagram showing an example of an application screen displayed in a display of a terminal according to a third embodiment.

FIG. 3-2 is a diagram showing an example of a shared wallet selection screen displayed in the display of the terminal according to the third embodiment.

FIG. 3-3 is a diagram showing an example of a camping fund payment screen displayed in the display of the terminal according to the third embodiment.

FIG. 3-4 is a diagram showing an example of a code payment screen displayed in the display of the terminal according to the third embodiment.

FIG. 3-5 is a diagram showing an example of a remittance screen displayed in the display of the terminal according to the third embodiment.

FIG. 3-6 is a diagram showing an example of a code payment screen displayed in the display of the terminal according to the third embodiment.

FIG. 3-7 is a diagram showing an example of a code payment completion screen displayed in the display of the terminal according to the third embodiment.

FIG. 3-8 is a flowchart showing an example flow of processing executed by devices according to the third embodiment.

FIG. 3-9 is a diagram showing an example of a code reader screen displayed in the display of the terminal according to the third embodiment.

FIG. 3-10 is a diagram showing an example of a reading completion screen displayed in a display of a terminal according to a variation of the third embodiment.

FIG. 3-11 is a diagram showing an example of a payment amount input screen displayed in the display of the terminal according to the variation of the third embodiment.

FIG. 3-12 is a flowchart showing an example flow of processing executed by devices according to the variation of the third embodiment.

FIG. 3-13 is a diagram showing an example of a code payment screen displayed in the display of the terminal according to the variation of the third embodiment.

FIG. 3-14 is a diagram showing an example of a top-up screen displayed in the display of the terminal according to the variation of the third embodiment.

FIG. 3-15 is a diagram showing an example of a code payment screen displayed in the display of the terminal according to the variation of the third embodiment.

FIG. 3-16 is a flowchart showing an example flow of processing executed by devices according to the variation of the third embodiment.

FIG. 3-17 is a flowchart showing an example flow of processing executed by devices according to the variation of the third embodiment.

FIG. 3-18 is a diagram showing an example of a code payment screen displayed in the display of the terminal according to the variation of the third embodiment.

FIG. 3-19 is a diagram showing an example of a member selection screen displayed in the display of the terminal according to the variation of the third embodiment.

FIG. 3-20 is a diagram showing an example configuration of a server according to the variation of the third embodiment.

FIG. 3-21 is a diagram showing an example of a member selection screen (talk-room selection screen) displayed in the display of the terminal according to the variation of the third embodiment.

FIG. 4-1 is a diagram showing an example of an insufficient shared wallet balance screen displayed in a display of a terminal according to a fourth embodiment.

FIG. 4-2 is a diagram showing an example of a code payment screen displayed in the display of the terminal according to the fourth embodiment.

FIG. 4-3 is a diagram showing an example of a code payment completion screen displayed in the display of the terminal according to the fourth embodiment.

FIG. 4-4 is a flowchart showing an example flow of processing executed by devices according to the fourth embodiment.

FIG. 4-5 is a flowchart showing an example flow of processing executed by devices according to the fourth embodiment.

FIG. 4-6 is a diagram showing an example of an insufficient shared wallet balance screen displayed in a display of a terminal according to a variation of the fourth embodiment.

FIG. 4-7 is a flowchart showing an example flow of processing executed by devices according to the variation of the fourth embodiment.

FIG. 4-8 is a flowchart showing an example flow of processing executed by devices according to the fourth embodiment.

FIG. 4-9 is a flowchart showing an example flow of processing executed by devices according to the variation of the fourth embodiment.

FIG. 4-10 is a diagram showing an example of a code payment screen displayed in the display of the terminal according to the variation of the fourth embodiment.

FIG. 4-11 is a diagram showing an example of an insufficient shared wallet balance screen displayed in the display of the terminal according to the variation of the fourth embodiment.

FIG. 4-12 is a diagram showing an example of an insufficient user's wallet balance screen displayed in the display of the terminal according to the variation of the fourth embodiment.

FIG. 4-13 is a diagram showing an example of a code payment completion screen displayed in the display of the terminal according to the variation of the fourth embodiment.

FIG. 4-14 is a diagram showing an example of a notification screen displayed in the display of the terminal according to the variation of the fourth embodiment.

FIG. 4-15 is a diagram showing an example of a payment history screen displayed in the display of the terminal according to the variation of the fourth embodiment.

FIG. 4-16 is a diagram showing an example of a talk-room screen displayed in the display of the terminal according to the variation of the fourth embodiment.

FIG. 4-17 is a diagram showing an example of a talk-room screen displayed in the display of the terminal according to the variation of the fourth embodiment.

FIG. 4-18 is a flowchart showing an example flow of processing executed by devices according to the variation of the fourth embodiment.

FIG. 4-19 is a flowchart showing an example flow of processing executed by devices according to the variation of the fourth embodiment.

FIG. 4-20 is a flowchart showing an example flow of processing executed by devices according to the variation of the fourth embodiment.

FIG. 4-21 is a flowchart showing an example flow of processing executed by devices according to the variation of the fourth embodiment.

FIG. 4-22 is a diagram showing an example of a configuration of a store code reader device according to the variation of the fourth embodiment.

FIG. 5-1 is a diagram showing an example of information stored in a storage of a server according to a fifth embodiment.

FIG. 5-2 is a diagram showing an example of a data configuration of an integrated account management database according to the fifth embodiment.

FIG. 5-3 is a diagram showing an example of the code payment screen displayed in a display of a terminal according to the fifth embodiment.

FIG. 5-4 is a diagram showing an example of a code information updating screen displayed in the display of the terminal according to the fifth embodiment.

FIG. 5-5 is a diagram showing an example of a code payment screen displayed in the display of the terminal according to the fifth embodiment.

FIG. 5-6 is a flowchart showing an example flow of processing executed by devices according to the fifth embodiment.

FIG. 5-7 is a flowchart showing an example flow of processing executed by devices according to the fifth embodiment.

FIG. 5-8 is a diagram showing an example of a code reader screen displayed in a display of a terminal according to a variation of the fifth embodiment.

FIG. 5-9 is a diagram showing an example of a payment code information updating screen displayed in the display of the terminal according to the variation of the fifth embodiment.

FIG. 5-10 is a diagram showing an example of a code reader screen displayed in the display of the terminal according to the variation of the fifth embodiment.

FIG. 5-11 is a flowchart showing an example flow of processing executed by devices according to the variation of the fifth embodiment.

FIG. 5-12 is a flowchart showing an example flow of processing executed by devices according to the variation of the fifth embodiment.

FIG. 5-13 is a diagram showing another example of the code payment screen displayed in the display of the terminal according to the variation of the fifth embodiment.

FIG. 5-14 is a flowchart showing an example flow of processing executed by devices according to the variation of the fifth embodiment.

FIG. 5-15 is a flowchart showing an example flow of processing executed by devices according to the variation of the fifth embodiment.

FIG. 5-16 is a flowchart showing an example flow of processing executed by devices according to the variation of the fifth embodiment.

FIG. 5-17 is a diagram showing an example of a code payment screen displayed in the display of the terminal according to the variation of the fifth embodiment.

FIG. 5-18 is a diagram showing an example of a code payment screen displayed in the display of the terminal according to the variation of the fifth embodiment.

FIG. 5-19 is a diagram showing an example of a code payment screen displayed in the display of the terminal according to the variation of the fifth embodiment.

FIG. 5-20 is a flowchart showing an example flow of processing executed by devices according to the variation of the fifth embodiment.

FIG. 5-21 is a diagram showing an example of a code payment screen displayed in the display of the terminal according to the variation of the fifth embodiment.

FIG. 5-22 is a diagram showing an example of a code payment screen displayed in the display of the terminal according to the variation of the fifth embodiment.

FIG. 5-23 is a diagram showing an example of a notification screen displayed in the display of the terminal according to the variation of the fifth embodiment.

FIG. 5-24 is a diagram showing an example of a code information update screen displayed in the display of the terminal according to the variation of the fifth embodiment.

FIG. 5-25 is a diagram showing an example of a code payment screen displayed in the display of the terminal according to the variation of the fifth embodiment.

FIG. 5-26 is a diagram showing an example of a code payment screen displayed in the display of the terminal according to the variation of the fifth embodiment.

FIG. 5-27 is a diagram showing another example of the code payment screen displayed in the display of the terminal according to the variation of the fifth embodiment.

FIG. 5-28 is a flowchart showing an example flow of processing executed by devices according to the variation of the fifth embodiment.

FIG. 5-29 is a flowchart showing an example flow of processing executed by devices according to the variation of the fifth embodiment.

FIG. 5-30 is a diagram showing an example of a code payment screen displayed in the display of the terminal according to the variation of the fifth embodiment.

FIG. 5-31 is a diagram showing an example of a code payment screen displayed in the display of the terminal according to the variation of the fifth embodiment.

FIG. 5-32 is a diagram showing an example of a code information update screen displayed in the display of the terminal according to the variation of the fifth embodiment.

FIG. 5-33 is a diagram showing an example of a code payment screen displayed in the display of the terminal according to the variation of the fifth embodiment.

FIG. 6-1 is a flowchart showing an example flow of processing executed by devices according to a sixth embodiment.

FIG. 6-2 is a flowchart showing an example flow of processing executed by devices according to the sixth embodiment.

FIG. 6-3 is a flowchart showing an example flow of processing executed by devices according to a variation of the sixth embodiment.

FIG. 6-4 is a flowchart showing an example flow of processing executed by devices according to the sixth variation.

FIG. 6-5 is a flowchart showing an example flow of processing executed by devices according to the variation of the sixth embodiment.

FIG. 6-6 is a flowchart showing an example flow of processing executed by devices according to the variation of the sixth embodiment.

FIG. 6-7 is a flowchart showing an example flow of processing executed by devices according to the variation of the sixth embodiment.

FIG. 6-8 is a flowchart showing an example flow of processing executed by devices according to the variation of the sixth embodiment.

FIG. 6-9 is a flowchart showing an example flow of processing executed by devices according to the variation of the sixth embodiment.

FIG. 7-1 is a flowchart showing an example flow of processing executed by devices according to a seventh embodiment.

FIG. 7-2 is a flowchart showing an example flow of processing executed by devices according to a variation of the seventh embodiment.

FIG. 7-3 is a flowchart showing an example flow of processing executed by devices according to the variation of the seventh embodiment.

FIG. 7-4 is a flowchart showing an example flow of processing executed by devices according to the variation of the seventh embodiment.

FIG. 7-5 is a flowchart showing an example flow of processing executed by devices according to the variation of the seventh embodiment.

FIG. 7-6 is a flowchart showing an example flow of processing executed by devices according to the variation of the seventh embodiment.

FIG. 7-7 is a flowchart showing an example flow of processing executed by devices according to the variation of the seventh embodiment.

FIG. 7-8 is a flowchart showing an example flow of processing executed by devices according to the variation of the seventh embodiment.

FIG. 8-1 is a diagram showing an example data configuration of a second shared wallet management database, which is an example of a shared wallet management database according to an eighth embodiment.

FIG. 8-2 is a diagram showing an example data configuration of a third shared wallet management database, which is an example of a shared wallet management database according to a variation of the eighth embodiment.

FIG. 8-3 is a diagram showing an example of a summary display screen displayed in the display of the terminal according to the variation of the eighth embodiment.

FIG. 8-4 is a diagram showing an example of a summary display screen displayed in the display of the terminal according to the variation of the eighth embodiment.

FIG. 8-5 is a diagram showing an example of a summary display screen displayed in the display of the terminal according to the variation of the eighth embodiment.

FIG. 9-1 is a diagram showing an example of a code payment screen displayed in a display of a terminal according to a ninth embodiment.

FIG. 9-2 is a diagram showing an example of a talk-room selection screen displayed in the display of the terminal according to the ninth embodiment.

FIG. 9-3 is a diagram showing an example of a code payment screen displayed in the display of the terminal according to the ninth embodiment.

FIG. 9-4 is a diagram showing an example of a code payment completion screen displayed in the display of the terminal according to the ninth embodiment.

FIG. 9-5 is a diagram showing an example of a talk-room screen displayed in the display of the terminal according to the ninth embodiment.

FIG. 9-6 is a diagram showing an example of a talk-room screen displayed in the display of the terminal according to the ninth embodiment.

FIG. 9-7 is a diagram showing an example of a talk-room screen displayed in the display of the terminal according to the ninth embodiment.

FIG. 10 is a diagram showing an example of a table for illustrating combinations of a first account and a second account according to a tenth embodiment.

### DESCRIPTION OF EMBODIMENTS

Embodiments for implementing programs information processing methods, display methods, terminals, servers, and the like according to the present disclosure will be described with reference to the drawings.

In recent years, applications (application software) relating to network services, such as applications for making payments and settlements using electronic money (payment applications, settlement applications) and applications for sending and receiving money using electronic money (remittance applications), as well as applications that integrate some or all of the functions of such applications have become widespread. A user of a terminal 20 can receive various services relating to electronic money using these applications.

“Electronic money” may refer to electronic money that is distinguished from physical money and is possessed by the terminal 20 managed by the aforementioned various applications or the user of the terminal 20.

Note that electronic money may be referred to as “digital currency (digital money)”. Also, legal tender or a virtual currency may also be used as “electronic money” or “digital currency (digital money)”. Also, cryptocurrency (crypto-assets) may also be included in “electronic money” or “digital currency (digital money)”. Also, physical money such as coupons may also be included in a virtual currency.

In the present specification, the expression “using a communication I/F” is used as appropriate. This expression means that a device transmits and receives various types of information and data via the communication interface (I/F) based on control performed by a controller (a processor, etc.), for example, although there is no limitation thereto.

In the present specification, “settlement” means electronic settlement. An example thereof is electronic settlement using electronic money.

In the present specification, “processing relating to settlement” is processing relating to settlement executed by the terminal 20, for example, without limitation thereto, and includes processing that somehow relates to carrying out settlement, or more specifically, any processing executed on the terminal 20 as processing relating to carrying out settlement, such as processing for acquiring code information for making payment from a server or the like (including processing for requesting the server or the like to generate code information and processing for receiving the generated code information from the server or the like), processing for displaying the acquired code information, and processing for acquiring settlement results (including settlement notifications) from the server or the like.

In the present specification, “code information” includes a code image, information (stored information) that is stored in a code image through encoding, and information to be stored. The stored information and the information to be stored include tokens, which will be described later in detail, for example, without limitation thereto.

The present specification will describe non-limiting examples of two types of code settlement, which are payment methods/settlement methods using a code (code information), namely:

(1) user-presenting mode; and
(2) store-presenting mode,
for example, without limitation thereto.

The user-presenting mode may refer to a method in which the user (the user of the terminal 20) presents a payment code displayed in a display 24 of the terminal 20 to a clerk or the like of a store (non-limiting examples of which include a member store), and carries out settlement by having the payment code read by a code reader 58 of a store code reader device 50, for example, without limitation thereto.

The store-presenting mode may refer to a method in which the user carries out settlement by reading a payment store code presented or posted at a store (non-limiting examples of which include a member store), using a camera 27 or a code reader (including a code reader of a payment application) of the terminal 20, for example, without limitation thereto.

Although the code displayed in the display 24 of the terminal 20 in the user-presenting mode will be to as a “payment code” below, it may alternatively be referred to as a “user-presented code” or the like.

Further, although the code read by the terminal 20 in the store-presenting mode will be referred to as a “payment store code” below, it may alternatively be referred to as a “store-presented code” or the like.

The present specification will describe non-limiting examples of two types of settlement that is based on an account, namely:

(A) shared account settlement; and
(B) linked-account settlement.
for example, without limitation thereto.

“Account” may refer to an account of an application for carrying out payment and settlement (payment application, settlement application) using electronic money, for example, without limitation thereto.

The shared account settlement is a method of carrying out settlement based on an account that can be used in common by a plurality of users (hereinafter referred to as a “shared account”). This settlement will be referred to as “shared account settlement”. The shared account settlement is implemented by using a shared wallet. The “shared wallet” is a form of an electronic money account that is set by a plurality of users, and may include one virtual wallet.

The shared account settlement can also be understood as settlement carried out by a user using an account shared by a plurality of users (a single shared account)

Note that the shared account settlement may also be referred to as shared wallet settlement.

The linked-account settlement may refer to a method of carrying out settlement with a plurality of accounts that are linked. Linking accounts may refer to associating a plurality of accounts so that they are used for settlement. Linking accounts will be referred to as “account linkage”, and settlement using account linkage will be referred to as “linked-account settlement”.

In this case, a plurality of accounts of one user may be linked, or accounts of a plurality of users may be linked. That is, accounts of different people are not essential for account linkage, and a plurality of accounts of one person can also be linked, for example, without limitation thereto.

To implement the linked-account settlement, after a plurality of accounts are associated with each other, for example, without limitation thereto, processing (account linkage processing) is executed to configure a setting so that settlement is carried out while the settlement amount is equally split by the number of linked accounts, for example, without limitation thereto.

The linked-account settlement can also be understood as settlement carried out by a user using not only the user's own account but also another account (another account of the user or another person's account).

Note that the account linkage may also be referred to as wallet linkage. Also, the linked-account settlement may also be referred to as linked-wallet settlement.

In the following, embodiments will be described while envisioning example cases where a plurality of users, such as friends or associates, carry out settlement of payment for a purchase.

Although the shared account settlement basically may refer to carrying out settlement from one account that is assumed to be shared by a plurality of users, the following embodiments will also describe methods in which settlement is carried out based on a shared account and a different account from the shared account.

Accounts can be linked either (B-1) before making payment or (B-2) when making payment, for example, without limitation thereto.

(B-1) Account linkage before making payment can be applied when reimbursement after the payment (non-limiting examples of which include reimbursement for splitting the paid amount) is bothersome, for example, without limitation thereto.

(B-2) Account linkage when making payment can be applied when the balance is insufficient in an account (non-limiting examples of which include a user's own account) that is set up as an account for carrying out settlement at the time of payment, for example, without limitation thereto. In this case, settlement can be carried out while linking the user's own account with other user's account, for example, without limitation thereto.

The shared account settlement uses an account shared by a plurality of users. For this reason, although the details will be described later, there are cases where processing for reimbursement after the payment (reckoning) is needed if settlement is carried out while one user pays in advance for the other user's payment amount. That is, there are case where processing for adjusting the amount of money for each user, such as processing for remittance/receipt of money, is needed at a certain timing after the settlement is completed.

In contrast, in the linked-account settlement, processing for reimbursement after the payment is basically not necessary since permission is obtained, in advance or on the spot, from users of the linked accounts so that the amount of money is set to be consumed from the linked accounts.

Based on the above, embodiments of the “shared account settlement” and the “linked-account settlement” will be described.

Note that “linkage” includes a meaning of doing things together for one purpose. Therefore, it can be said that the shared account settlement and the linked-account settlement have the same purpose in the sense that a plurality of users carry out settlement together.

### System Configuration

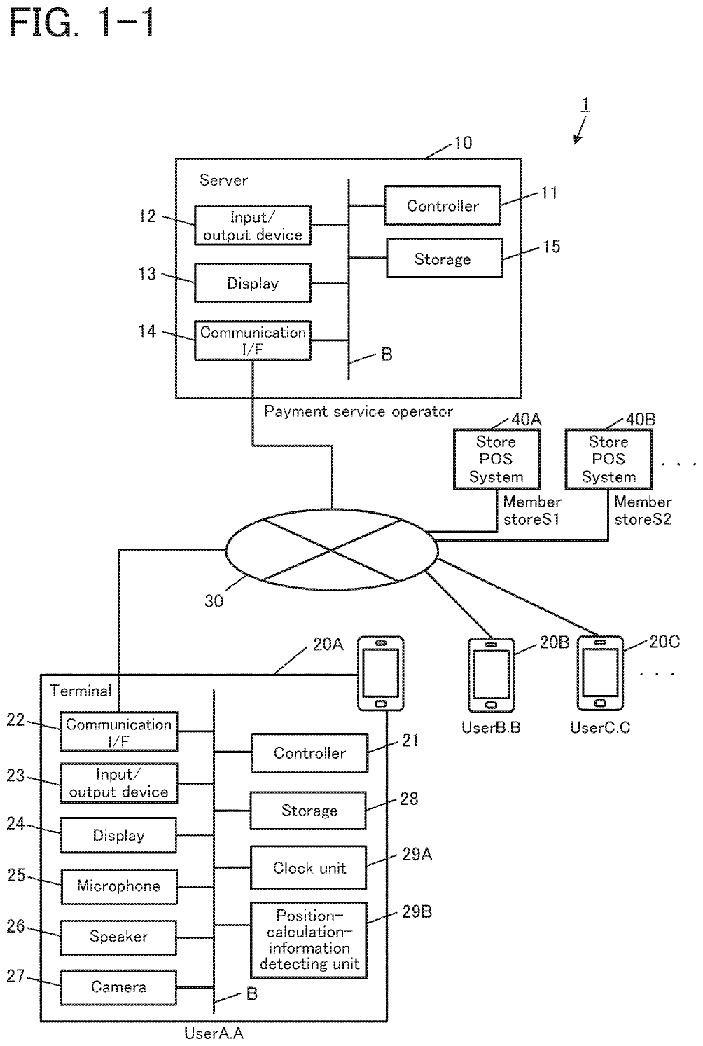

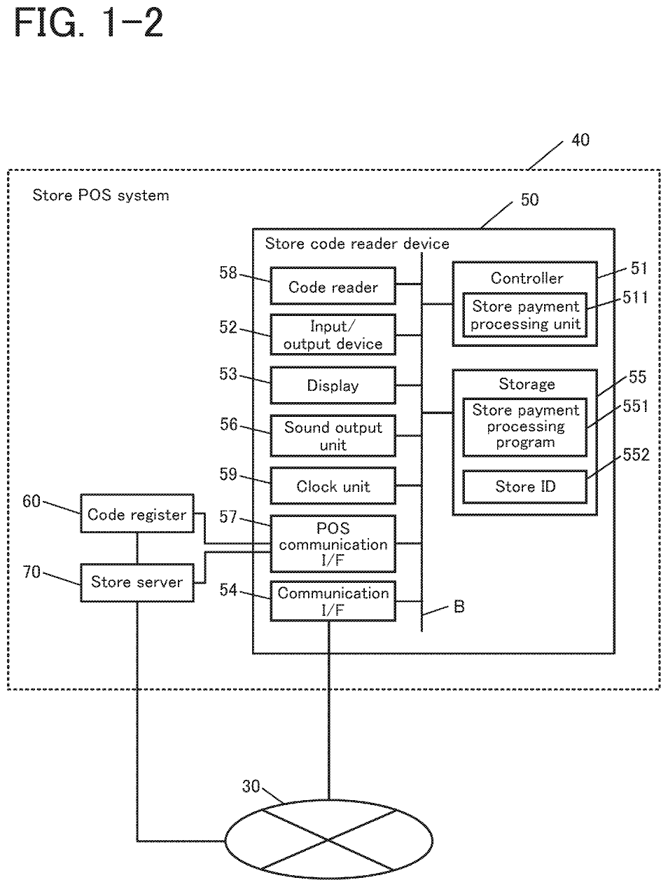

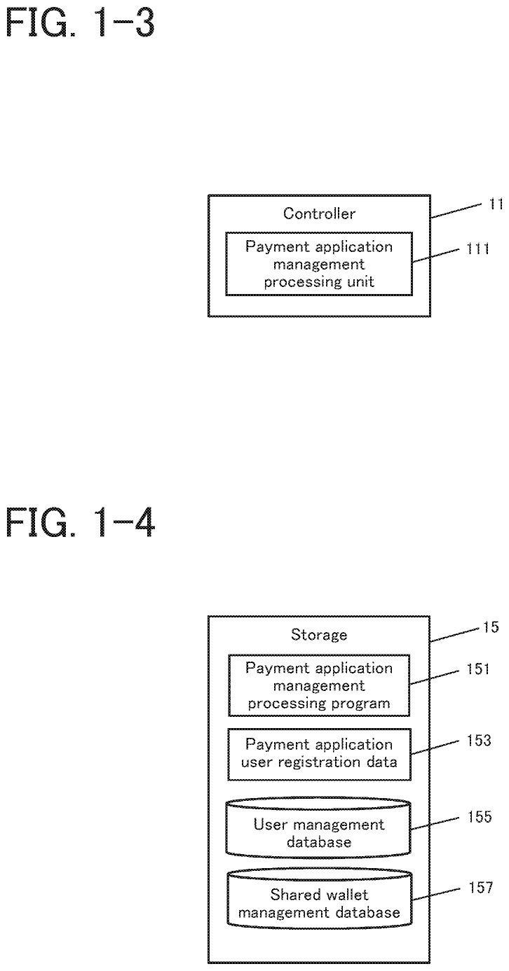

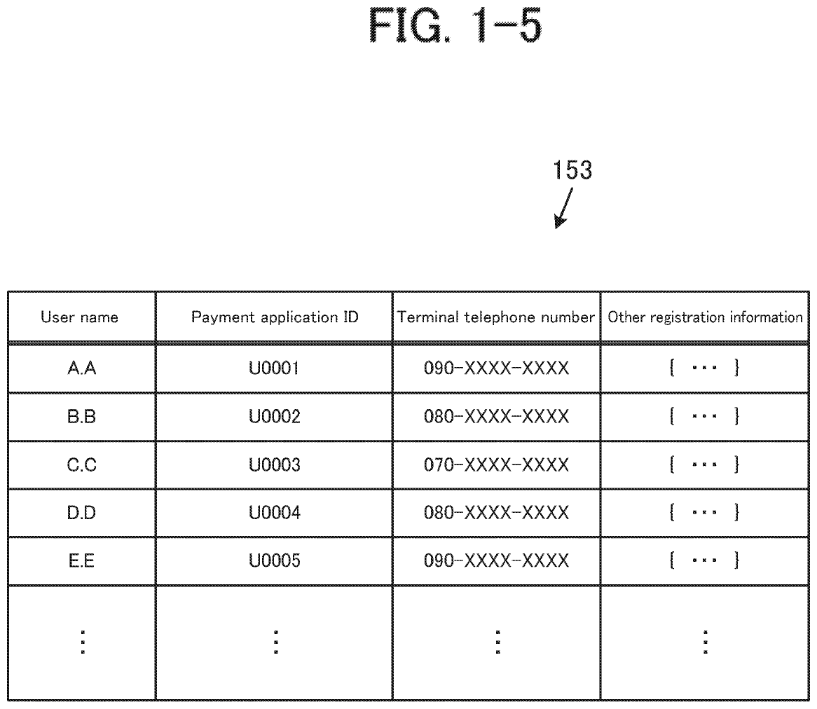

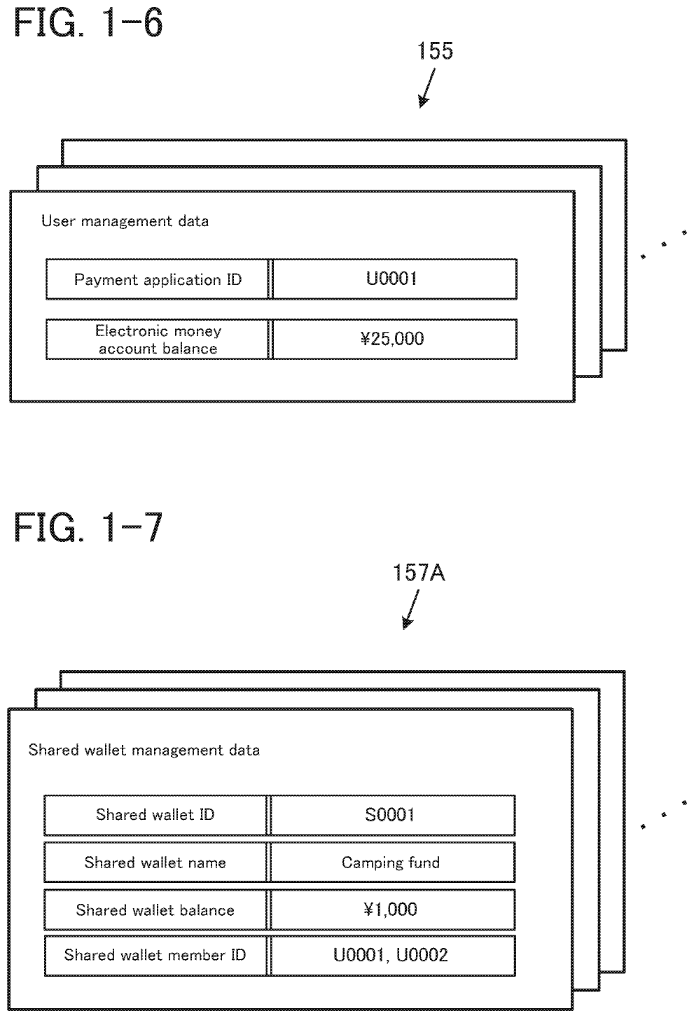

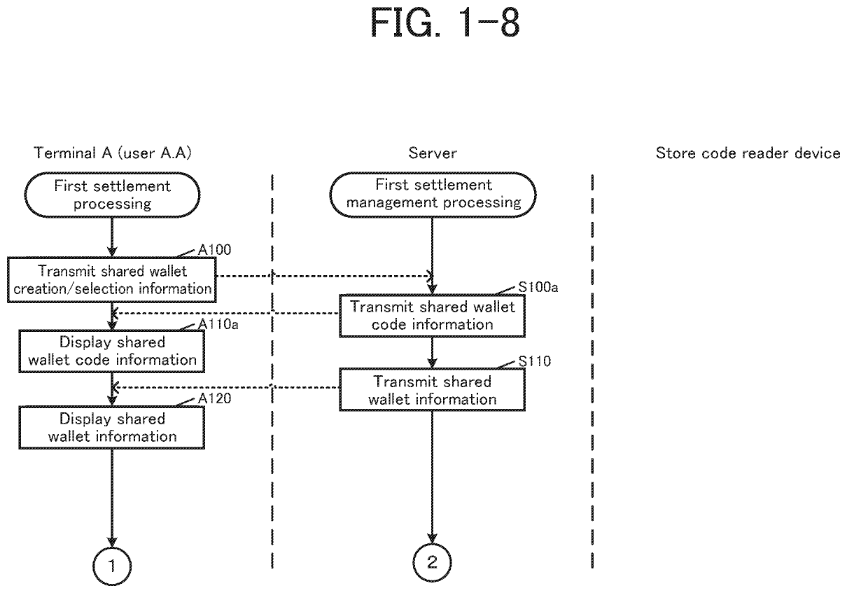

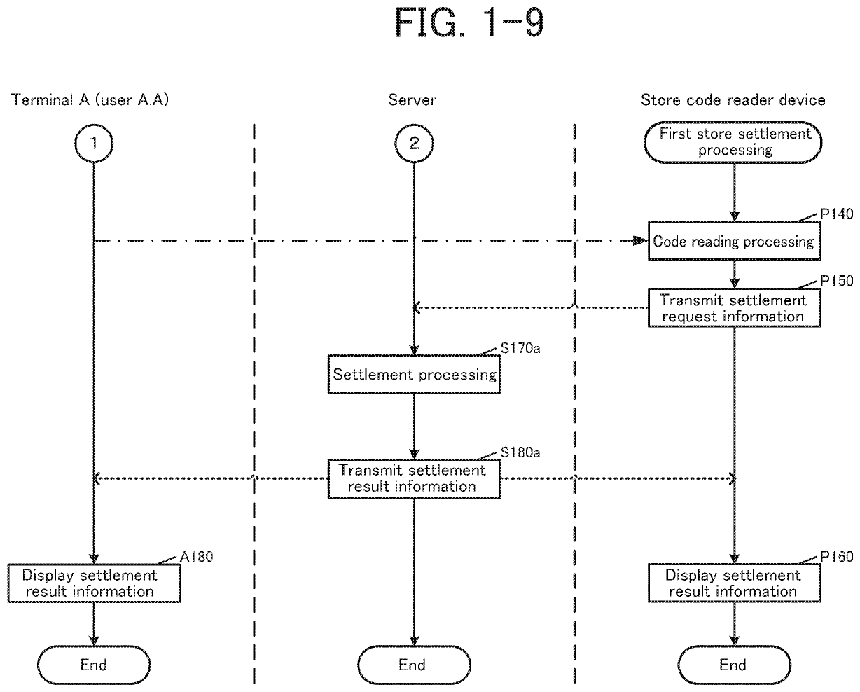

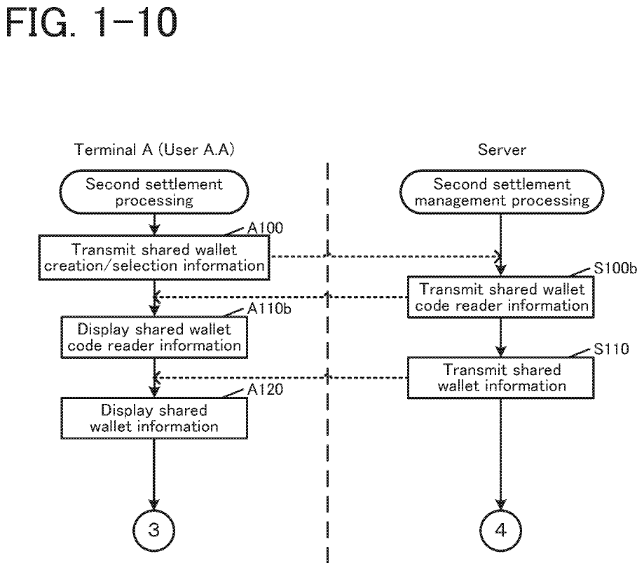

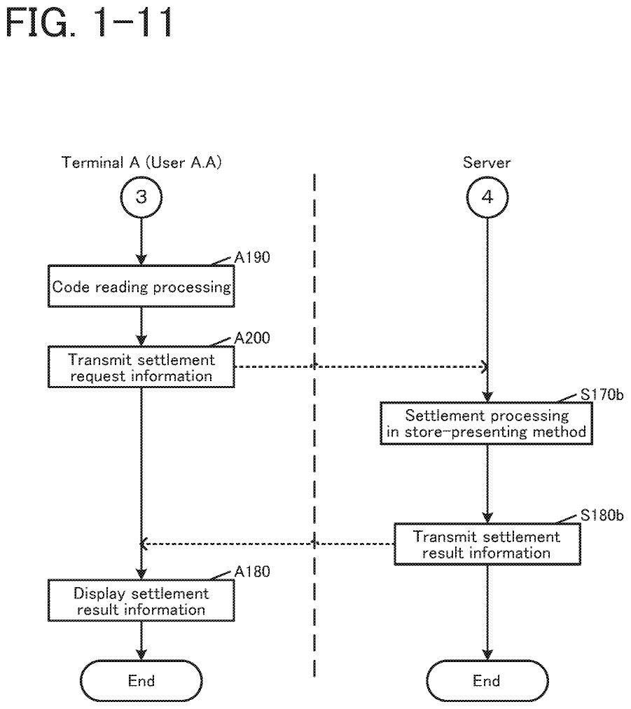

FIG. 1-1 is a diagram showing an example of a system configuration of a communication system 1 according to the present embodiment.

In the communication system 1, a server 10, a plurality of terminals 20 (terminals 20A, 20B, 20C, . . . ), and a plurality of store POS systems 40 (store POS systems 40A, 40B, 40C, . . . ) are connected to each other via a network 30, for example, without limitation thereto.

The server 10 functions to provide a payment service to a terminal 20 owned by a user, via the network 30. The server 10 can also be referred to as a payment service server, a payment management server, a settlement service server, a settlement management server, or the like.

Note that the numbers of servers 10 and terminals 20 to be connected to the network 30 are not limited.

The network 30 serves to connect one or more terminals 20, one or more servers 10, and one or more store POS systems 40 to each other. That is, the network 30 serves as a communication network that provides a connection path to enable the various types of devices mentioned above to transmit and receive data after the devices are connected to each other.

One or more portions of the network 30 may be a wired network or a wireless network. Non-limiting examples of the network 30 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the public switched telephone network (PSTN), a mobile phone network, integrated service digital networks (ISDNs), a wireless LAN, long term evolution (LTE), code division multiple access (CDMA), BLUETOOTH, satellite communication, and a combination of two or more of these networks. The network 30 may include a single network 30 or a plurality of networks 30.

The server 10 (a non-limiting example of a server, an information processing device, or an information management device) functions to provide a predetermined service (payment service in the present embodiment) to the terminal 20. The server 10 may be any information processing device that is capable of implementing functions described in the embodiments. Non-limiting examples of the server 10 include a server device, a computer (non-limiting examples of which include a desktop, a laptop, and a tablet), a media computer platform (non-limiting examples of which include cable and satellite set-top boxes and a digital video recorder), a handheld computer device (non-limiting examples of which include a PDA and an electronic mail client), and other types of computers and communication platforms. The server 10 may also be referred to as an “information processing device”. If there is no need to distinguish the server 10 and the terminal 20, each of the server 10 and the terminal 20 may be referred to as an “information processing device”.

### Hardware (HW) Configurations of Devices

HW configurations of the devices included in the communication system 1 will be described.

### (1) HW Configuration of Terminal

FIG. 1-1 shows an example of the HW configuration of the terminal 20.

The terminal 20 includes a controller 21 (central processing unit: CPU), a storage 28, a communication I/F (interface) 22, an input/output device 23, a display 24, a microphone 25, a speaker 26, a camera 27, a clock unit 29A, and a position-calculation-information detecting unit 29B. The HW elements of the terminal 20 are connected to each other via a bus B, for example, without limitation thereto. Note that the HW configuration of the terminal 20 does not necessarily have to include all of the elements. The terminal 20 may be configured such that one or more elements such as the microphone 25 and the camera 27 are removable.

The communication I/F 22 transmits and receives various types of data via the network 30. The communication may be carried out in a wired or wireless manner, and may be based on any communication protocol that enables mutual communication to be carried out. The communication I/F 22 functions to communicate with various types of devices such as the server 10 via the network 30. The communication I/F 22 transmits various types of data to the various types of devices such as the server 10 in accordance with instructions from the controller 21. Also, the communication I/F 22 receives various types of data transmitted from the various types of devices such as the server 10 and conveys the data to the controller 21. The communication I/F 22 may also be simply referred to as a “communication interface”. The communication I/F 22 may also be referred to as a “communication circuit” in cases where the communication I/F may include a physically structured circuit.

The input/output device 23 includes a device that inputs various operations made to the terminal 20 and a device that outputs the results of processing executed by the terminal 20. The input/output device 23 may include an input device and an output device that are configured as a single device or are separate from each other.

The input device is implemented by any one of or a combination of two or more of all types of devices capable of accepting input from a user and conveying information regarding the input to the controller 21. Non-limiting examples of the input device include a touch panel, a touch display, hardware keys of a keyboard or the like, a pointing device such as a mouse, a camera (input of operations via moving images), and a microphone (input of operations using voice).

The output device is implemented by any one of or a combination of two or more of all types of devices capable of outputting the results of processing performed by the controller 21. Non-limiting examples of the output device include a touch panel, a touch display, a speaker (audio output), a lens (non-limiting examples of which include 3D (three-dimensional) output and hologram output), and a printer.

The display 24 is implemented by any one of or a combination of two or more of all types of devices capable of providing display in accordance with display data written in a frame buffer. Non-limiting examples of the display 24 include a touch panel, a touch display, a monitor (non-limiting examples of which include a liquid crystal display and an organic electroluminescence display (OELD)), a head mounted display (HDM), and devices capable of displaying images, text information, and the like using projection mapping or holograms, or in the air (may be a vacuum). Note that the display 24 may be capable of displaying display data in 3D.

If the input/output device 23 is a touch panel, the input/output device 23 and the display 24 may also have substantially the same size and shape and be arranged opposing each other.

The clock unit 29A is a built-in clock of the terminal 20 and outputs time information (time measurement information). The clock unit 29A is configured to include a clock that employs a crystal oscillator, for example, without limitation thereto. The clock unit 29A may also be referred to as a “time measurement unit” or a “time information detecting unit”, for example, without limitation thereto.

Note that the clock unit 29A may include a clock to which NITZ (Network Identity and Time Zone) standards or the like are applied.

The position-calculation-information detecting unit 29B is a functional unit that detects (measures) information (hereinafter referred to as “position calculation information”) that is necessary for the controller 21 to calculate (measure) the position of the terminal 20. The position-calculation-information detecting unit 29B may also be referred to as a “position calculation sensor unit”, for example, without limitation thereto.

Non-limiting examples of the position-calculation-information detecting unit 29B include a satellite positioning sensor (a satellite positioning unit) that is a sensor or a unit for calculating the position of the terminal 20 using a satellite positioning system such as GPS (Global Positioning System) and an inertial measurement sensor (IMU (Inertial Measurement Unit)) that is a sensor or a unit for calculating the position of the terminal 20 using an inertial navigation system.

The satellite positioning unit includes an RF (Radio Frequency) receiving circuit that converts RF signals, which include a positioning satellite signal emitted from a positioning satellite and received by an antenna (not illustrated), into digital signals and a baseband processing circuit that captures the positioning satellite signal by performing correlation operation processing or the like on a digital signal output from the RF receiving circuit and outputs information such as satellite orbit data and time data that are taken from the positioning satellite signal, as position calculation information, for example, without limitation thereto.

The inertial measurement unit includes an inertial sensor that detects information necessary to calculate the position of the terminal 20 through an inertial navigation operation. The inertial sensor includes a three-axis acceleration sensor and a three-axis gyroscope sensor, for example, without limitation thereto, and outputs acceleration detected by the acceleration sensor and angular velocity detected by the gyroscope sensor, as position calculation information.

The controller 21 calculates the position of the terminal 20 at regular or specific timings based on the position calculation information detected by the position-calculation-information detecting unit 29B, for example, without limitation thereto. The position of the terminal will be referred to as a “terminal position”, and the calculated terminal position will be referred to as a “calculated terminal position”. The controller 21 then stores, in the storage 28, the calculated terminal position in association with the date and time at which this calculated terminal position is calculated, as calculated terminal position history data.

The controller 21 includes a physically structured circuit for executing functions that are implemented in accordance with codes or commands included in a program, and is implemented by a data processing device embedded in hardware, for example, without limitation thereto. Accordingly, the controller 21 may be referred to as a “control circuit”.

Non-limiting examples of the controller 21 include a central processing unit (CPU), a microprocessor, a processor core, a multiprocessor, an ASIC (Application-Specific Integrated Circuit), and a FPGA (Field Programmable Gate Array).

The storage 28 functions to store various programs and various types of data that are necessary for the terminal 20 to operate. Non-limiting examples of the storage 28 include various storage media such as an HDD (Hard Disk Drive), an SSD (Solid State Drive), a flash memory, a RAM (Random Access Memory), and a ROM (Read Only Memory). The storage 28 may be referred to as a “memory”.

The terminal 20 stores a program P in the storage 28, and the controller 21 executes the program P to execute processing while serving as units that are included in the controller 21. That is, the program P stored in the storage 28 causes the terminal 20 to implement functions executed by the controller 21. The program P may be referred to as a “program module”.

The microphone 25 is used to input audio data. The speaker 26 is used to output audio data. The camera 27 is used to acquire moving image data.

### (2) HW Configuration of Server

FIG. 1-1 shows an example of the HW configuration of the server 10.

The server 10 includes a controller (CPU) 11, a storage 15, a communication I/F (interface) 14, an input/output device 12, a display 13, and a clock unit 19. The HW elements of the server 10 are connected to each other via a bus B, for example, without limitation thereto. Note that the HW configuration of the server 10 does not necessarily have to include all of the elements above. HW of the server 10 may be configured such that the display 13 is removable.

The controller 11 includes a physically structured circuit for executing functions that are implemented in accordance with codes or commands included in a program, and is implemented by a data processing device embedded in hardware, for example, without limitation thereto.

The controller 11 is typically a central processing unit (CPU), and may be a microprocessor, a processor core, a multiprocessor, an ASIC, or an FPGA. In the present disclosure, the controller 11 is not limited to these examples.

The storage 15 functions to store various programs and various types of data that are necessary for the server 10 to operate. The storage 15 is implemented by various storage media such as an HDD, an SSD, and a flash memory. However, in the present disclosure, the storage 15 is not limited to these examples. The storage 15 may be referred to as a “memory”.

The communication I/F 14 transmits and receives various types of data via the network 30. The communication may be carried out in a wired or wireless manner, and may be based on any communication protocol that enables mutual communication to be carried out. The communication I/F 14 functions to communicate with various types of devices such as the terminal 20 via the network 30. The communication I/F 14 transmits various types of data to the various types of devices such as the terminal 20 in accordance with instructions from the controller 11. Also, the communication I/F 14 receives various types of data transmitted from the various types of devices such as the terminal 20 and conveys the data to the controller 11. The communication I/F 14 may also be simply referred to as a “communication interface”. The communication I/F 14 may also be referred to as a “communication circuit” in cases where the communication I/F is included in a physically structured circuit.

The input/output device 12 is implemented by a device that inputs various operations that are made to the server 10. The input/output device 12 is implemented by any one of or a combination of two or more of all types of devices capable of accepting input from a user and conveying information regarding the input to the controller 11. The input/output device 12 is implemented by hardware keys, a typical example of which is a keyboard, and a pointing device such as a mouse. Note that the input/output device 12 may include a touch panel, a camera (input of operations via moving images), or a microphone (input of operations using voice). However, in the present disclosure, the input/output device 12 is not limited to these examples.

The display 13 is typically implemented by a monitor (non-limiting examples of which include a liquid crystal display and an organic electroluminescence display (OELD)). Note that the display 13 may be a head mounted display (HDM) or the like. Note that the display 13 may be capable of displaying display data in 3D. In the present disclosure, the display 13 is not limited to these examples.

The clock unit 19 is a built-in clock of the server 10 and outputs time information (time measurement information). The clock unit 19 is configured to include an RTC (Real Time Clock) as a hardware clock, a system clock, and the like, for example, without limitation thereto. The clock unit 19 may also be referred to as a “time measurement unit” or a “time information detecting unit”, for example, without limitation thereto.

### (3) Configuration of Store POS System

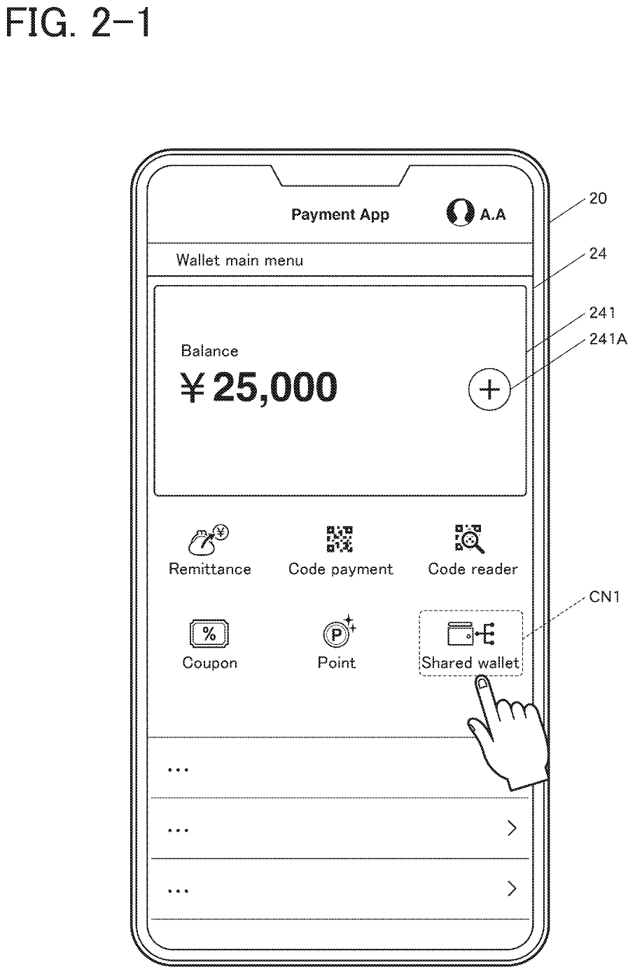

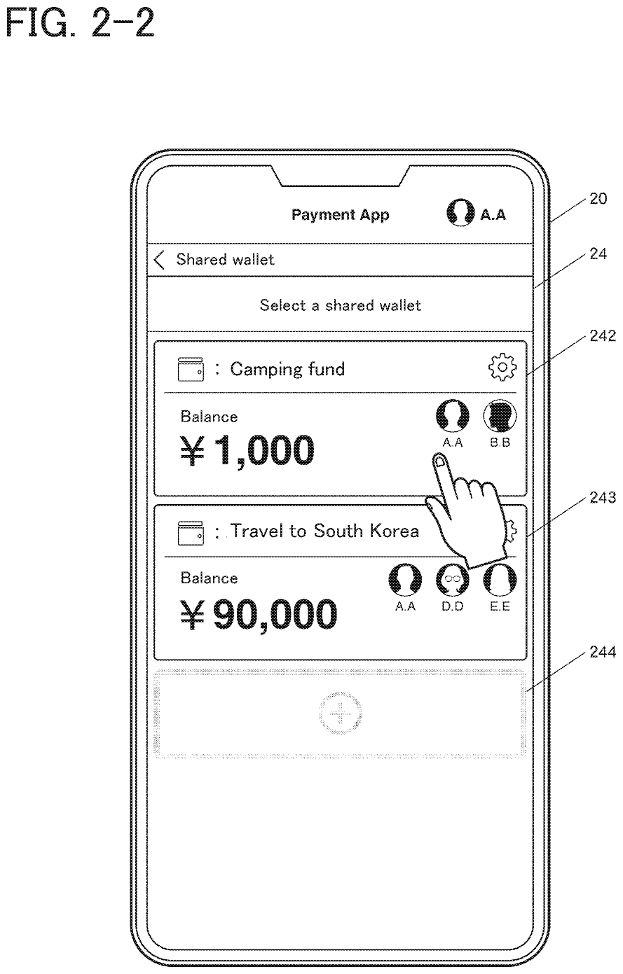

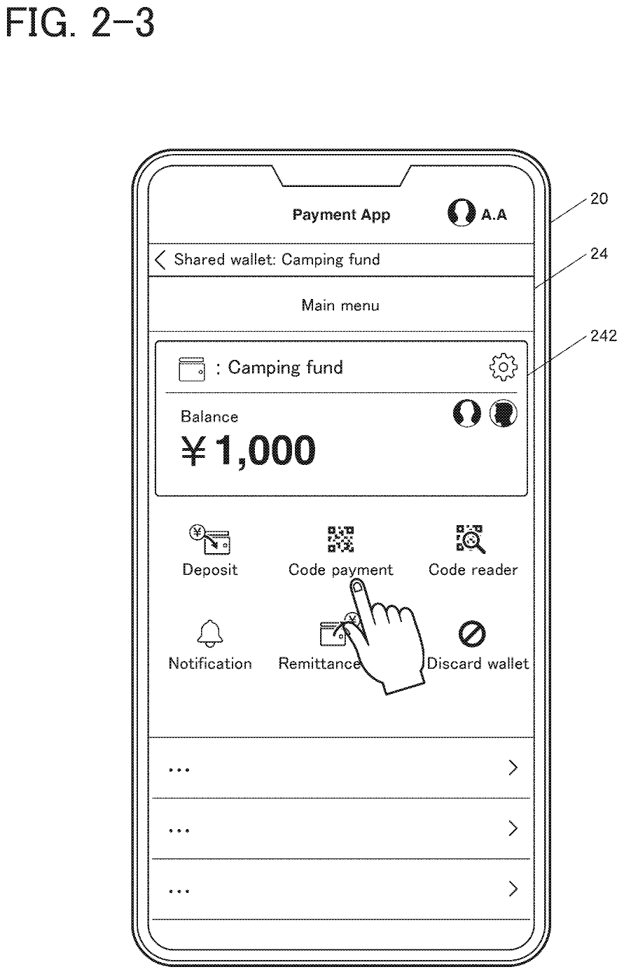

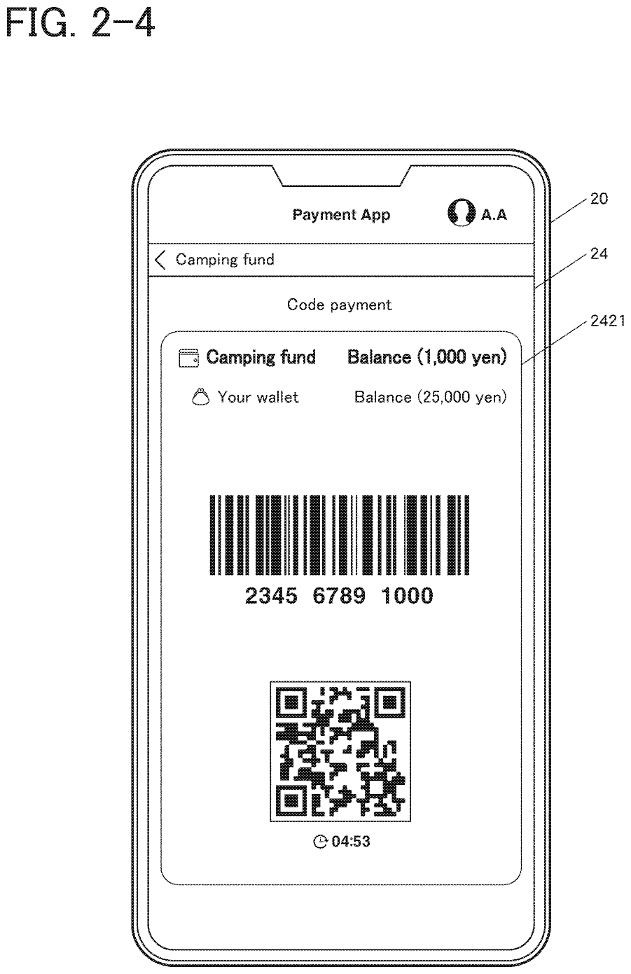

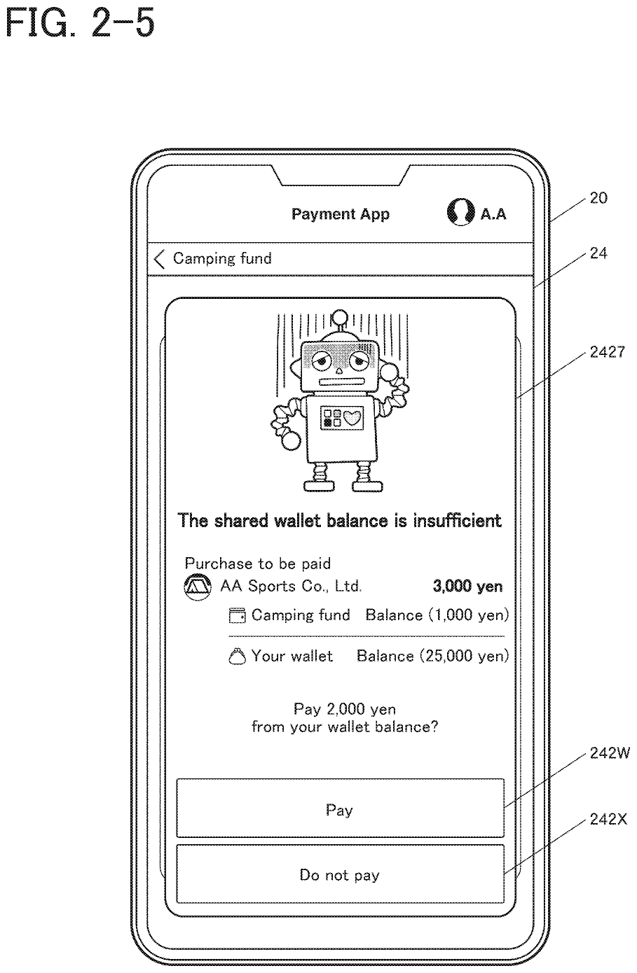

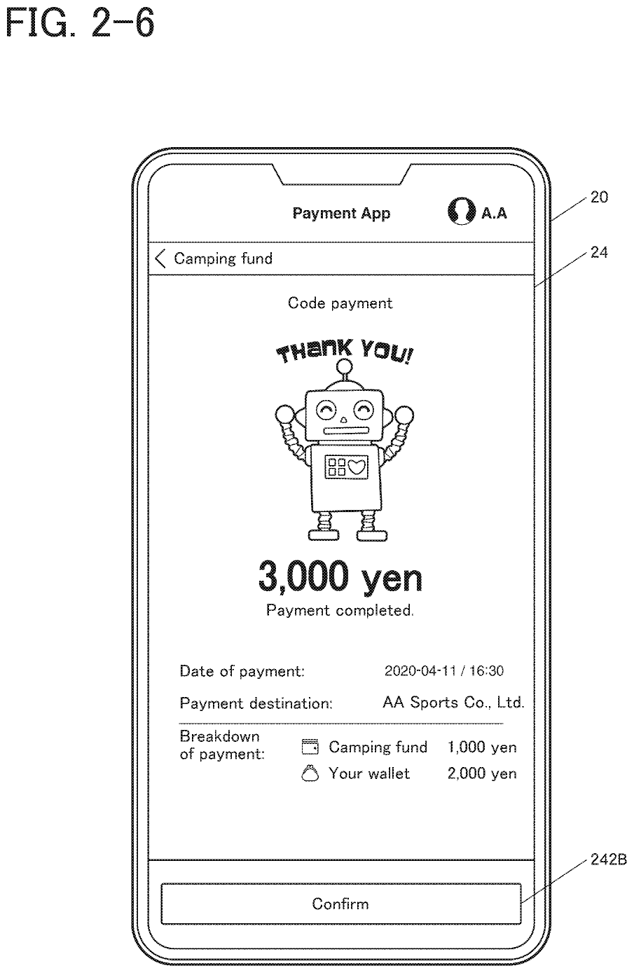

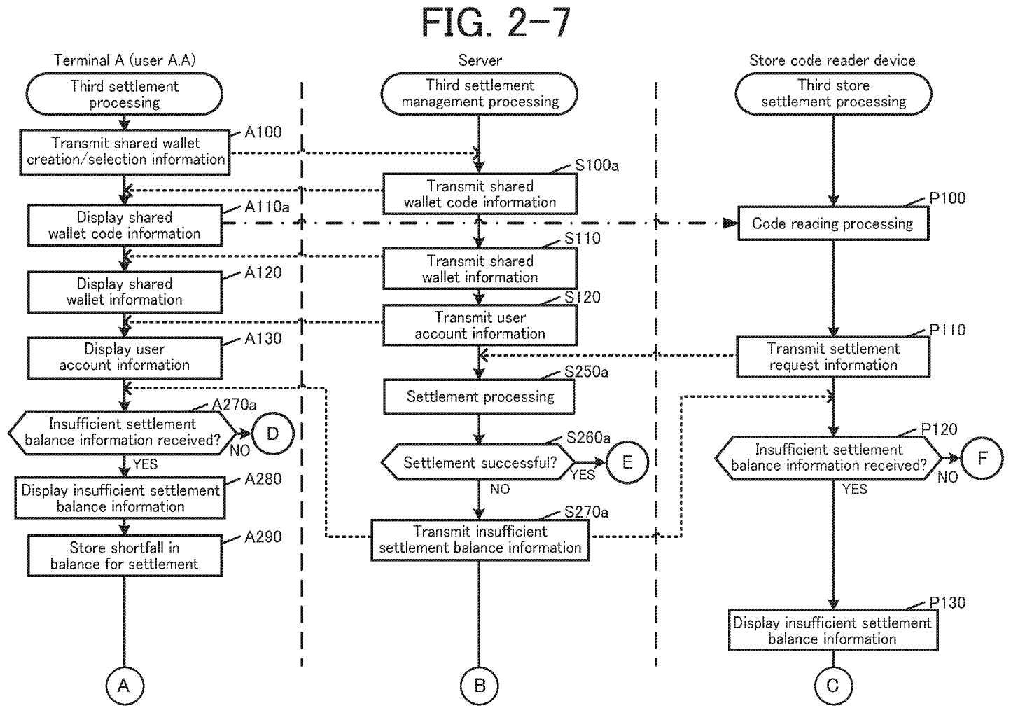

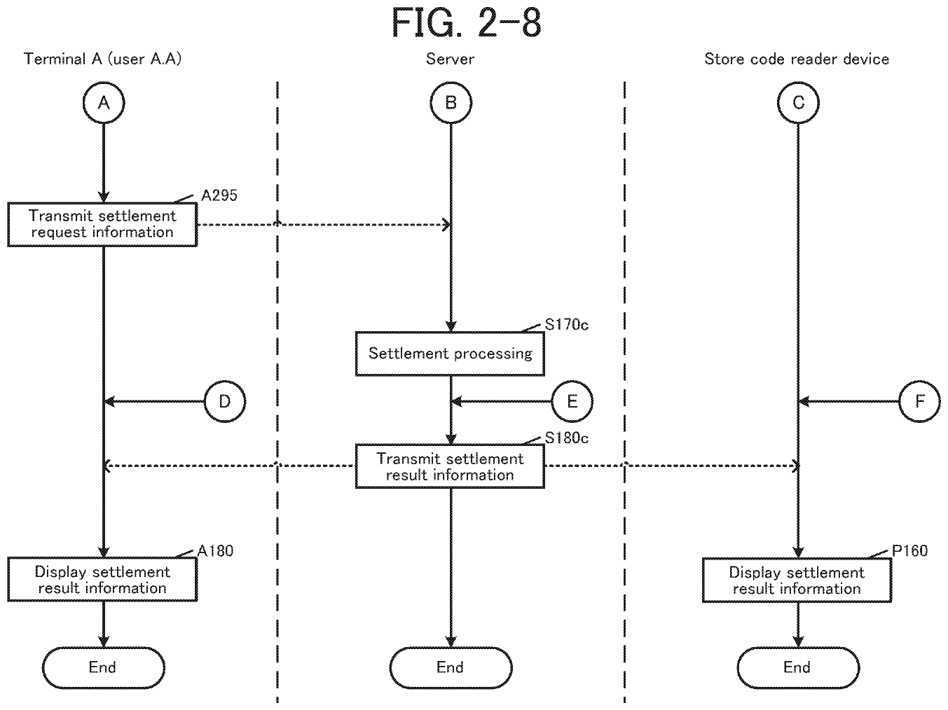

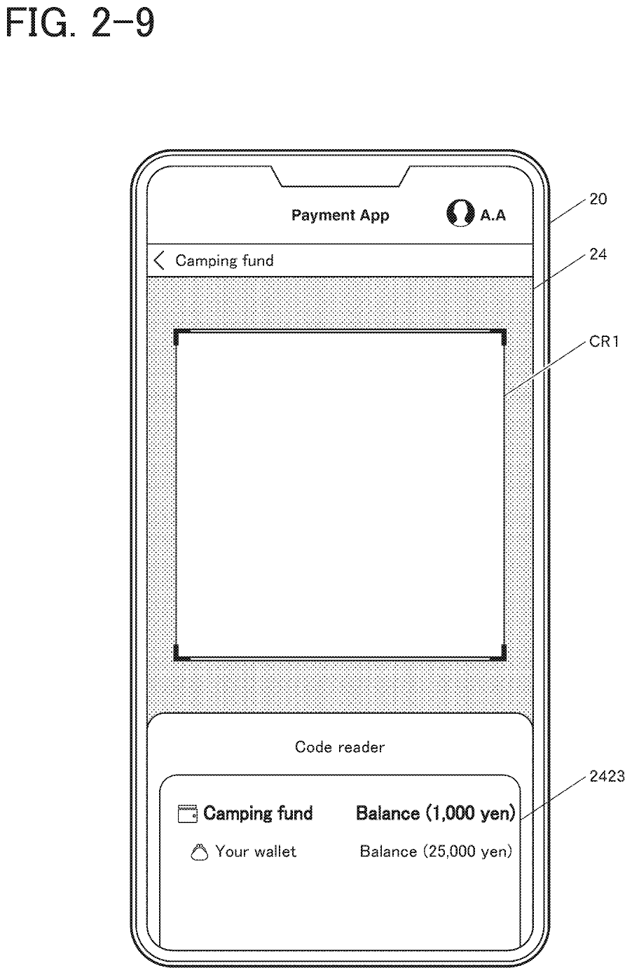

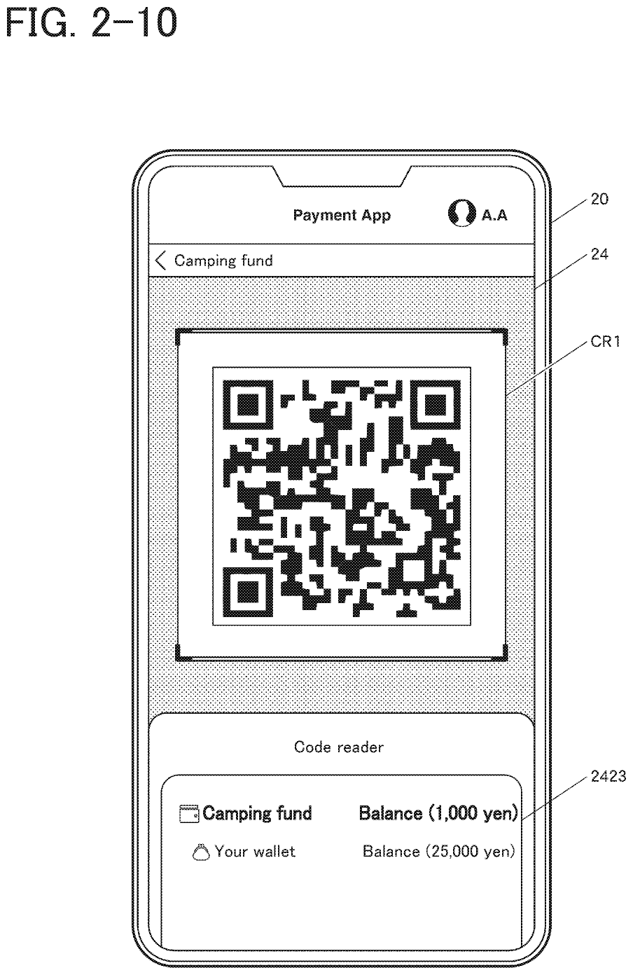

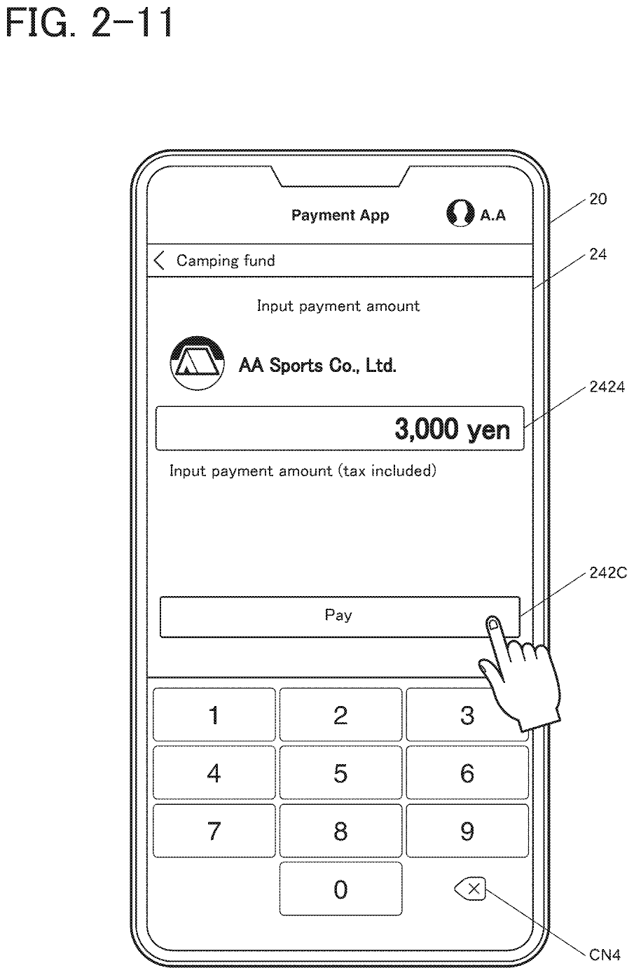

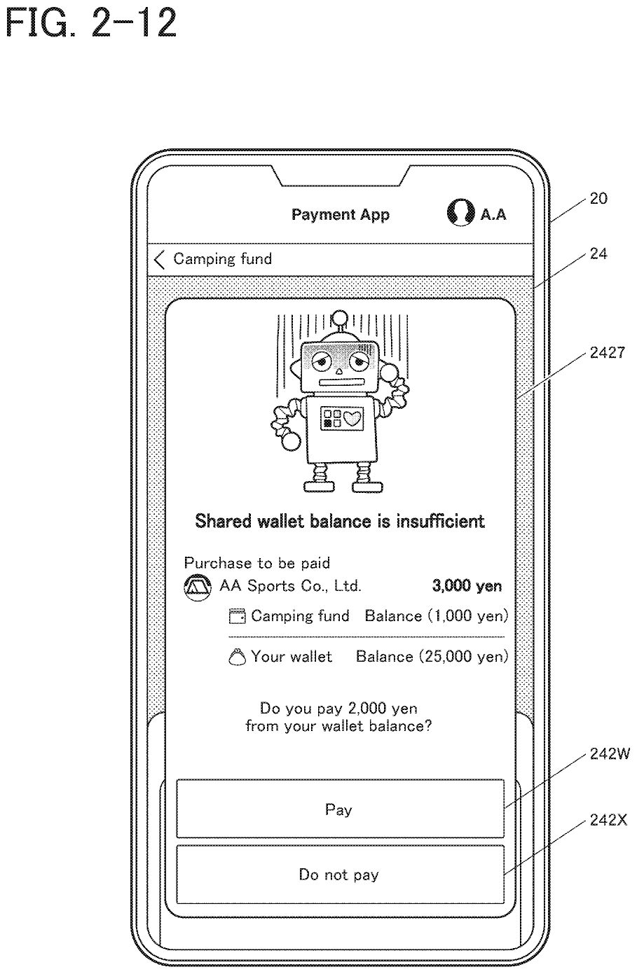

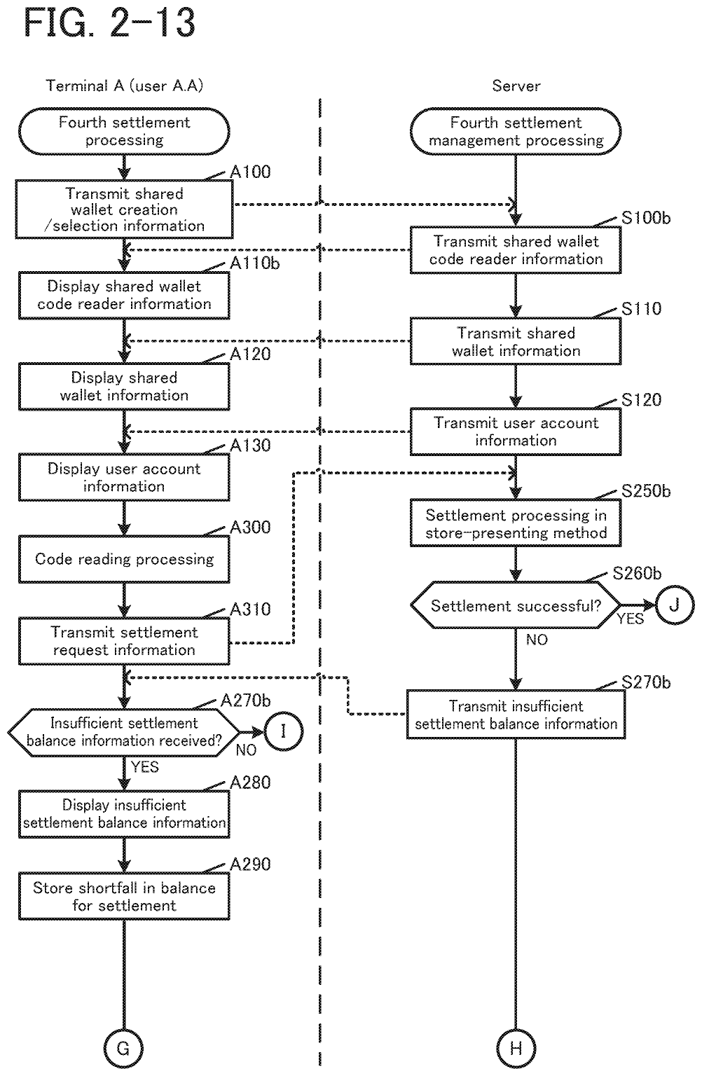

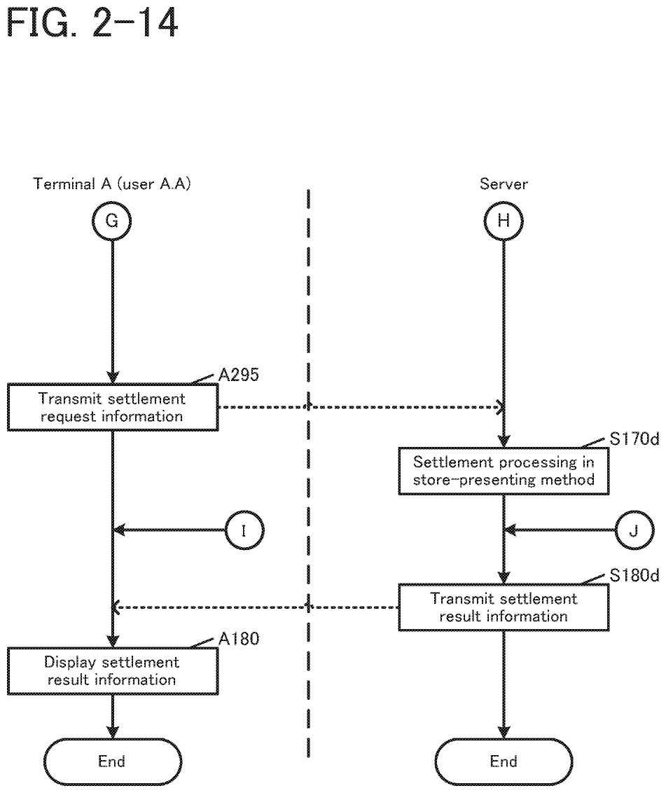

FIG. 2-1 shows an example of a system configuration of a store POS system 40.

The store POS system 40 is a POS system that is installed and used in a store that is tied up with the business operator operating the server 10, and includes the store code reader device 50, the code register 60, and the store server 70, for example, although there is no limitation thereto.

The store code reader device 50 is communicably connected to the code register 60 and the store server 70 using a POS communication I/F 57 (non-limiting examples of which include a wired communication I/F and a wireless communication I/F in the store), and reads code information that is displayed in the display 24 of the terminal 20 when payment is to be made using the code register 60. Based on the read code information, the store code reader device 50 transmits payment request information using a communication I/F 54 to the server 10, and receives information regarding a payment result from the server 10 using the communication I/F 54 after payment is carried out by the server 10.

The store code reader device 50 includes a controller 51, an input/output device 52, a display 53, the communication I/F 54, a storage 55, a sound output unit 56, the POS communication I/F 57, a code reader 58, and a clock unit 59, for example, without limitation thereto.

The code reader 58 is a code reader for reading a one-dimensional code (one-dimensional code image), a two-dimensional code (two-dimensional code image), and a later-described payment code (payment code image), for example, without limitation thereto.

The code register 60 is communicably connected to the store code reader device 50 and the store server 70 using the POS communication I/F 57, for example, without limitation thereto, and issues a receipt on which information such as the total amount of sold goods and the balance of electronic money of the user of the terminal 20 is printed based on a payment completion notification, or the like, received by the store code reader device 50 from the server 10.

It is also possible to provide a display that is provided together with the code register 60 as a single unit or is separate from the code register 60, and includes a display surface facing a customer.

The code register 60 is a register that is configured to support the payment application, and can also be referred to as a stationary terminal that supports the payment application.

The store server 70 manages various types of information such as store information regarding the store, information regarding goods sold at the store, information regarding services provided at the store, and information regarding sales of goods sold at the store and services provided at the store, for example, without limitation thereto. The store server 70 is configured to communicate with the store code reader device 50 and the code register 60 using the POS communication I/F 57 and communicate with external devices such as the server 10 via the network 30.

Note that the store server 70 does not necessarily have to be configured to directly communicate with the store code reader device 50, and may also be configured to communicate with the store code reader device 50 via the code register 60. A configuration is also possible in which the payment completion notification or the like received by the store code reader device 50 from the server 10 is transmitted to the code register 60, and thereafter transmitted from the code register 60 to the store server 70, for example, without limitation thereto.

### (4) Others

The server 10 stores the program P in the storage 15, and the controller 11 executes the program P to execute processing while serving as units that are included in the controller 11. That is, the program P stored in the storage 15 causes the server 10 to implement functions executed by the controller 11. The program P may be referred to as a “program module”. This also applies to other devices.

Embodiments of the present disclosure will be described assuming that the embodiments are implemented as a result of CPU(s) of the terminal 20 and/or the server 10 executing the program P. This also applies to other devices.

Note that the controller 21 of the terminal 20 and/or the controller 11 of the server 10 may implement processing by using not only the CPU(s) including a control circuit, but also a logic circuit (hardware) or a dedicated circuit that is formed on an IC (integrated circuit) chip, an LSI (Large Scale Integration), or the like. Also, these circuits may be implemented by one or more integrated circuits, and a plurality of types of processing described in the embodiments may be implemented by a single integrated circuit. LSI may be referred to as VLSI, super LSI, ultra LSI, or the like depending on the degree of integration. Accordingly, the controller 21 may be referred to as a “control circuit”. This also applies to other devices.

The program P (non-limiting examples of which include a software program, a computer program, and a program module) in the embodiments of the present disclosure may be provided in a state where the program is stored in a computer-readable storage medium. The program P can be stored in a “non-transitory tangible medium”. Also, the program P may be a program for implementing some of the functions described in the embodiments of the present disclosure. Furthermore, the program P may be a differential file (differential program) that enables the functions described in the embodiments of the present disclosure to be implemented in combination with a program P that is already recorded in a storage medium.

The storage medium may include one or more semiconductor-based or other integrated circuits (ICs; non-limiting examples of which include field programmable gate arrays (FPGAs) and application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM drives, secure digital cards, drives, any other appropriate storage media, and a suitable combination of two or more of these storage media. Where appropriate, the storage medium may consist only of a volatile storage medium or a non-volatile storage medium, or a combination of volatile and non-volatile storage media. Note that the storage medium is not limited to these examples, and may be any device or medium that is capable of storing the program P. Also, the storage medium may be referred to as a “memory”.

The server 10 and/or the terminal 20 can implement functions of a plurality of functional units described in the embodiments by reading the program P stored in the storage medium and executing the read program P. This also applies to other devices.

The program P according to the present disclosure may be provided to the server 10 and/or the terminal 20 via any transmission medium (a communication network, broadcast waves, etc.) that is capable of transmitting the program. The server 10 and/or the terminal 20 implement(s) the functions of the functional units described in the embodiments by executing the program P downloaded via the Internet or the like, for example, without limitation thereto. This also applies to other devices.

The embodiments of the present disclosure can also be implemented in the form of a data signal in which the program P is embodied through electronic transmission.

At least a portion of processing in the server 10 and/or the terminal 20 may be implemented through cloud computing corresponding to one or more computers.

At least a portion of processing in the terminal 20 may be carried out by the server 10. In this case, the server 10 may carry out at least a portion of processing carried out by functional units of the controller 21 of the terminal 20.

At least a portion of processing in the server 10 may be carried out by the terminal 20. In this case, the terminal 20 may carry out at least a portion of processing carried out by functional units of the controller 11 of the server 10.

In the embodiments of the present disclosure, configurations for determination are not essential unless explicitly mentioned otherwise, and predetermined processing may be activated in case a determination condition is satisfied, or predetermined processing may be activated in case a determination condition is not satisfied, without limitation thereto.

The program according to the present disclosure is implemented using a script language such as ActionScript or JAVASCRIPT, a compiler language such as Objective-C or JAVA, or a markup language such as HTML5, for example, although there is no limitation thereto.

### First Embodiment

Initially, an embodiment of the aforementioned “(A) shared account settlement” will be described.

As a first embodiment of the shared account settlement, an embodiment will be described in which the terminal 20 uses a payment application to carry out payment from the balance of a shared wallet (the balance of electronic money in the shared wallet, which will be hereinafter referred to as a “shared wallet balance”) at a store where payment can be made using the payment application via the server 10.

In the following description, a business operator that provides a payment service using the payment application will be referred to as a “payment service operator”.

Note that the payment service operator may be referred to as an “operator providing the payment application” or an “operator of the server 10”.

Also, the payment service operator may be referred to as a “settlement service operator” with the meaning of an operator providing a settlement service.

In the following description, a store that is tied up with the payment service operator to make the payment service using the payment application available for payment for goods or services provided at the store will be referred to as a “member store”.

Also, in the following description, it is assumed that the server 10 is operated and managed by the payment service operator. Also, in the following description, the payment application is appropriately referred to as “Payment App” and shown as such in the drawings.

The payment application may be provided by the server 10 as an independent application that does not include functions of a messaging service (MS) or a multi-function application that includes the functions of an MS. Also, the messaging service may include an instant messaging service (IMS) that enables transmission and reception of content such as simple messages between terminals 20.

The content may include not only messages that contain simple text, emojis, or the like, but also various types of information that can be transmitted and received between terminals 20, such as image information (including still images, moving images, etc.), operation information (including operations to buttons, icons, etc.), communication information/link information (including URIs, URLs, etc.), for example, without limitation thereto.

Also, the payment application may be provided by the server 10 as an independent application that does not include functions of a social networking service (SNS) or a multi-function application that includes the functions of an SNS.

Note that the messaging service (MS, including IMS) can also be considered as being a form of a social networking service (SNS).

For this reason, an MS may be distinguished from an SNS.

Functional Configuration

FIG. 1-3 is a diagram showing an example of a function implemented by the controller 11 of the server 10 in the present embodiment.

The controller 11 includes, as a function unit, a payment application management processing unit 111 for executing payment application management processing in accordance with a payment application management processing program 151 that is stored in the storage 15, for example, without limitation thereto.

FIG. 1-4 is a diagram showing an example of information stored in the storage 15 of the server 10 in the present embodiment.

The payment application management processing program 151, which is executed as payment application management processing, a payment application user registration data 153, a user management database 155, and a shared wallet management database 157 are stored in the storage 15, for example, without limitation thereto.

The payment application user registration data 153 is registration data relating to the terminal 20 that uses the payment application or the user of the terminal 20. FIG. 1-5 shows an example of the data configuration of the payment application user registration data 153.

A user name, a payment application ID, a terminal telephone number, and other registration information are stored in association with each other in the payment application user registration data 153, for example, without limitation thereto.

The “user name” may refer to the name of the user of the terminal 20 that uses the payment application, and the name registered by the user of the terminal 20 when using the payment application is stored, for example, without limitation thereto.

The payment application ID may refer to an account (account information) of the payment application, and is an ID that identifies the terminal 20 or the user of the terminal 20. As this payment application ID, a unique ID is set and stored by the server 10, for example, without limitation thereto.

The terminal telephone number may refer to a telephone number of the terminal 20 of the user with this user name, and a telephone number of the terminal 20 that is registered by the user of the terminal 20 when using the payment application is stored, for example, without limitation thereto.

Other registration information can include an e-mail address of the terminal 20 of the user with the user name (terminal e-mail address), authentication information such as an authentication password to be used for various types of authentications in the payment application, image data on an icon used by the user (icon image), a profile of the user (user profile), and so on, for example, without limitation thereto.

However, in embodiments the above information may be not used.

The user management database 155 is a database for user management that is based on the account (account information) stored in the payment application user registration data 153. FIG. 1-6 shows an example of a data configuration of the user management database 155.

In the user management database 155, user management data is stored as management data for each payment application ID stored as the payment application user registration data 153.

A payment application ID and an electronic money account balance are stored as each piece of user management data, for example, without limitation thereto.

Here, the shared wallet will be described in detail with reference to the shared wallet management database 157.

The shared wallet is a form of an electronic money account that is set in advance before payment is made, by a plurality of users who use the payment application.

With the shared wallet, payment can be made by a plurality of set users using the balance of the shared wallet. In the following description, users able to use the shared wallet will be referred to as “shared wallet members”.

To use the shared wallet, first, a user performs an operation to generate a shared wallet. To generate a shared wallet, information (non-limiting examples of which include the payment application ID) that specifies electronic money accounts of the shared wallet members is required, for example, without limitation thereto.

The shared wallet management database 157 may refer to a database with which the server 10 manages the shared wallet. FIG. 1-7 shows an example data configuration of a first shared wallet management database 157A, which is an example of the shared wallet management database 157A.

In the first shared wallet management database 157A, shared wallet management data is stored as management data for each shared wallet ID for uniquely identifying a shared wallet.

A shared wallet ID, a shared wallet name, a shared wallet balance, and a shared wallet member ID are associated with each other as each piece of the shared wallet management data, for example, without limitation thereto.

The shared wallet ID may refer to an account of a shared wallet (hereinafter referred to as a “shared account” as appropriate) in the payment application.

The shared wallet name may refer to the name of a shared wallet identified by the shared wallet ID.

The shared wallet balance may refer to the balance of electronic money used when payment is made using the shared wallet identified by the shared wallet ID.

The shared wallet member ID may refer to a payment application ID of each shared wallet member that is designated when a shared wallet is generated.

Note that after a shared wallet is generated, a new shared wallet member can also be added thereto by adding a payment application ID to the shared wallet member ID. Also, a plurality of payment application IDs possessed by the same user may be stored as the shared wallet member IDs.

When a shared wallet is generated, the shared wallet balance thereof is “0”. Before payment is made, the shared wallet members send electronic money from the respective electronic money accounts to the shared wallet to increase the shared wallet balance.

Note that each shared wallet member can also top up the shared wallet from an account of an external financial institution (non-limiting examples thereof include a bank account) registered for the payment service (i.e., change the money in the account in the external financial institution to electronic money and send it to the shared wallet).

When the shared wallet is no longer necessary, a shared wallet discard operation is performed to delete the existing shared wallet. If the shared wallet discard operation is executed, the amount obtained by dividing (equally dividing) the shared wallet balance by the number of shared wallet members is sent to the respective electronic money accounts of the shared wallet members. After the shared wallet balance becomes “0”, the record of this shared wallet management data is deleted from the first shared wallet management database 157A.

### Processing

### (1) Code Payment Using User-Presenting Mode

FIGS. 1-8 and 1-9 are flowcharts showing an example flow of processing executed by the devices in the present embodiment. These flowcharts show examples of settlement processing executed by the controller 21 of a terminal A (non-limiting examples of which include the terminal 20 of a user A.A), settlement management processing executed by the controller 11 of the server 10, and store settlement processing executed by the controller 51 of the store code reader device 50, which is an element of a store POS system (non-limiting examples of which include the store POS system 40 at a member store S1), in order from the left. These types of processing are examples of processing relating to code settlement in the user-presenting mode.

As an example, an electronic money account that can be used by the terminal 20 of the user A.A (terminal A) and the terminal 20 of a user B.B (terminal B) will be described as a shared wallet. In practice, the number of terminals that can make payment using a shared wallet is not limited to two, but the same processing as that of the terminal B is applied, and therefore other terminals are not shown in the figures.

Note that these are merely examples of processing for implementing the method of the present disclosure, and there is no limitation to these types of processing. Another step may be added to the above processing, and some of steps may be omitted (deleted).

The same applies to the flowcharts (processing) described below.

Serial numbers of the processing executed by the devices are shown in the figures, but are omitted in the specification. The same applies to the subsequent embodiments.

First, the controller 21 of the terminal A transmits shared wallet creation/selection information to the server 10 using the communication I/F 22 (A100).

Specifically, information for selecting a shared wallet (non-limiting example of which include a shared wallet ID) that can be used from the terminal A is transmitted to the server 10 using the communication I/F 22. In this step, the selectable shared wallet ID may be received from the server 10 using the communication I/F 22, or the selectable shared wallet ID that is stored in advance in the storage 28 may be called.

If there is no shared wallet that can be used from the terminal A, information for newly creating a shared wallet is transmitted to the server 10 using the communication I/F 22. Here, non-limiting examples of the information for newly creating a shared wallet include account information (non-limiting examples of which include payment application IDs of the users A.A and B.B) regarding members included in the shared wallet, the name of the shared wallet, and the initial amount to be sent to the shared wallet.

Upon receiving the information for selecting a shared wallet or the information for newly creating a shared wallet from the terminal A using the communication I/F 14, the controller 11 of the server 10 generates a payment token for authorizing payment from the wallet, based on the shared wallet ID for which the request has been received, or the shared wallet ID that is newly created and is assigned uniquely (without duplication) by the controller 11.

In the following, the payment token for authorizing payment from the shared wallet balance associated with the shared wallet ID will be referred to as a “shared wallet payment token”. Here, the shared wallet payment token is identified by an integer value of predetermined digits (non-limiting examples of which include 12 digits), for example, without limitation thereto. The shared wallet payment token may be a token with an expiration time for authorizing payment only within a predetermined time (non-limiting examples of which include “five minutes”) from when the token is generated.

After the shared wallet payment token has been generated, the controller 11 of the server 10 generates shared wallet code information, which is code information including the shared wallet payment token. Non-limiting examples of the shared wallet code information include a payment code (image information) obtained by encoding an identifier of the shared wallet payment token into a one-dimensional code (barcode etc.) and/or a two-dimensional code (QR code etc.).

Note that if the shared wallet payment token has an expiration time, the shared wallet code information may also include the expiration time. Further, the shared wallet code information may also include the name of the shared wallet for which the shared wallet payment token has been generated.

Thereafter, the controller 11 of the server 10 transmits the shared wallet code information to the terminal A using the communication I/F 14 (S100a).

Upon receiving the shared wallet code information from the server 10 using the communication I/F 22, the controller 21 of the terminal A causes the display 24 to display the received shared wallet code information (A110a). Specifically, the controller 21 causes the display 24 to display a payment code as the shared wallet code information, for example, without limitation thereto.

Note that if the shared wallet code information includes the identifier and the expiration time of the shared wallet payment token, the controller 21 of the terminal A may cause the identifier and the expiration time to be displayed.

If the shared wallet payment token is expired while the payment code is displayed, the controller 21 of the terminal A may transmit information for making a claim for regenerating the shared wallet payment token to the server 10 using the communication I/F 22.

In this case, the controller 21 of the server 10 regenerates the shared wallet payment token and the shared wallet code information and transmits the shared wallet code information to the terminal A using the communication I/F 14. Upon receiving the regenerated shared wallet code information from the server 10 using the communication I/F 22, the controller 21 of the terminal A can cause the display 24 to display the payment code and the expiration time again.

Next, the controller 11 of the server 10 transmits shared wallet information, which is information relating to the shared wallet for which the shared wallet payment token has been generated, to the terminal A using the communication I/F 14 (S110). Non-limiting examples of the shared wallet information include the shared wallet balance.

Upon receiving the shared wallet information from the server 10 using the communication I/F 22, the controller 21 of the terminal A causes the display 24 to display the received shared wallet information (A120). Specifically, the controller 21 causes the display 24 to additionally display the shared wallet balance, for example, without limitation thereto, as the shared wallet information.

The controller 51 of the store code reader device 50 executes store settlement processing, and a predetermined amount to be settled (non-limiting examples of which include “3000 yen”) is input to the controller 51 based on an operation to the input/output device 52 of the store code reader device 50. The controller 51 of the store code reader device 50 then reads the payment code displayed in the display 24 of the terminal A, using the code reader 58 (P140). In this case, since the payment code displayed in the display 24 is associated with the shared wallet payment token, the reading result obtained by the code reader 58 includes the shared wallet payment token as a payment token.

The controller 51 of the store code reader device 50 transmits settlement request information including a store ID, the amount to be settled, and the payment token (in this case, the shared wallet payment token), for example, without limitation thereto, to the server 10 using the communication I/F 54 (P150).

Upon receiving the settlement request information from the store code reader device 50 using the communication I/F 14, the controller 11 of the server 10 retrieves the shared wallet ID using the shared wallet payment token with which the request has been made, and executes, for the shared wallet, settlement processing to pay the amount to be settled for the member store defined by the store ID (S170a).

The controller 11 of the server 10 transmits settlement result information including the settlement processing result and the shared wallet balance after the settlement processing, for example, without limitation thereto, to the terminal A and the store code reader device 50 using the communication I/F 14 (S180a), and ends the processing.

Upon receiving the settlement result information from the server 10 using the communication I/F 22, the controller 21 of the terminal A causes the display 24 to display the settlement result information (A180), and ends the processing.

Also, upon receiving the settlement result information from the server 10 using the communication I/F 54, the controller 51 of the store code reader device 50 causes the display 53 to display the settlement result information (P160), and ends the processing.

### (2) Code Settlement in Store-Presenting Mode

In the following, the “payment store code” will be described as a code (one-dimensional and/or two-dimensional code) that includes member store identification information (non-limiting examples of which include a store ID that is uniquely assigned to each member store) for identifying the member store, for example, without limitation thereto.

Note that the payment store code may include information indicating a specific amount to be settled (non-limiting examples of which include “500 yen”).

FIGS. 1-10 and 1-11 are flowcharts showing an example flow of processing executed by the devices in this case. These flowcharts show examples of settlement processing executed by the controller 21 of the terminal A (non-limiting examples of which include the terminal 20 of the user A.A) and settlement management processing executed by the controller 11 of the server 10, in order from the left.

Note that the same steps as those in the above-described flowcharts (processing) are assigned the same reference numerals, and a redundant description thereof is omitted.

The same applies to the flowcharts (processing) described below.

Similar to the above-described processing, upon a shared wallet payment token being generated by the controller 11 of the server 10, the controller 11 of the server 10 generates shared wallet code reader information, which is information for reading the code that includes the shared wallet payment token. The controller 11 of the server 10 then transmits the shared wallet code reader information to the terminal A using the communication I/F 14 (S100b).

After A100, upon receiving the shared wallet code reader information from the server 10 using the communication I/F 22, the controller 21 of the terminal A causes the display 24 to display a code reader screen for reading a payment store code, based on the received shared wallet code reader information. The controller 21 of the terminal A also activates the camera 27 to read the code (A110b). The controller 21 of the terminal A then advances the processing to A120.

After A120, the controller 21 of the terminal A executes code reading processing to read the payment store code using the camera 27 or the like (A190). Thus, a store ID is acquired from the read payment store code.

Thereafter, the controller 21 of the terminal A causes the display 24 to display a display screen for inputting the amount to be settled, for example, without limitation thereto. Upon the amount to be settled being input based on a user operation to the input/output device 23 of the terminal A, the controller 21 transmits settlement request information including the shared wallet payment token included in the shared wallet code reader information, the store ID, and the amount to be settled, for example, without limitation thereto, to the server 10 using the communication I/F 22 (A200). The controller 21 of the terminal A then advances the processing to A180.

Note that if the amount to be settled is included in the payment store code, the input of the amount to be settled to the terminal A can be omitted.

After S110, upon the settlement request information being received from the terminal A using the communication I/F 14, the controller 11 of the server 10 retrieves the shared wallet ID from the shared wallet payment token with which the request has been received, and executes, for the shared wallet, settlement processing in the store-presenting mode to make payment of the amount to be settled to the member store defined by the store ID (S170b).

Thereafter, the controller 11 of the server 10 transmits settlement result information including the settlement processing result and the shared wallet balance after the settlement processing, for example, without limitation thereto, to the terminal A using the communication I/F 14 (S180b). Then, the controller 11 ends the processing.

### Second Embodiment

In the second embodiment, when the terminal 20 uses the payment application to carry out payment at a member store from the shared wallet balance but the shared wallet balance is insufficient at the time of the payment, information relating to insufficiency of the shared wallet balance is displayed.

Further, in the second embodiment, when the shared wallet balance is insufficient, settlement is carried out from a user's own wallet (user's user account) instead of the shared wallet (shared account).

The content described in the second embodiment is applicable to any other embodiments and variations.

Corresponding elements that are the same as those already described are assigned the same reference numerals as those used for corresponding elements, and a redundant description thereof is omitted.

### Example Display Screen

An example where the terminal 20 is a smartphone equipped with the display 24, which is a vertical display, will be described.

The smartphone has a touch panel, which functions as an input device and is arranged facing the display, for example, without limitation thereto. If elements such as icons, buttons, items, or an input region are displayed in the display, and a region that is a part of the touch panel and faces the region where these elements are displayed is touched by the user, a program associated with this element or a subroutine of this program is executed. In the following, the region of the touch panel that face the region where the elements are displayed in the display will also referred to as a “facing region”. That is, the facing region functions as an accepting means.

FIG. 2-1 is a diagram showing an example of an application screen of the payment application executed by the terminal 20 that is displayed in the display 24. This application screen is an example of a screen that is displayed when an operation to start the payment application is performed by the user and the payment application then starts.

In this application screen, “Payment App”, which is the application name of the payment application, is displayed on an uppermost title bar, and an icon image of the user A.A and the text “A.A” indicating the user name is displayed next to the application name, for example, without limitation thereto. The current location in a hierarchical menu of the “Payment App” is displayed below the title bar. Specifically, “wallet main menu”, which is the top menu that is currently executed, is displayed, for example, without limitation thereto. Below that, an electronic money account balance display region (hereinafter referred to simply as a “balance display region”) 241 for displaying the electronic money account balance of the user (user A.A) is provided.

In this example, “25,000 yen” is displayed as an electronic money account balance of the user A.A that is managed by the “Payment App” in the balance display region 241, and a top-up button 241A for topping up an amount is displayed next to the balance display region 241. Below that, an icon display region is provided in which a plurality of icons corresponding to various functions of the payment application are displayed as a submenu that is selectable from the “wallet main menu”. In this example, six icons that correspond respectively to “send money, “code payment”, “code reader”, “coupon”, “point”, and “shared wallet” are displayed in the icon display region. In the following, the icon corresponding to the “shared wallet” will be described as a shared wallet icon CN1.

FIG. 2-2 is a diagram showing an example of a shared wallet selection screen that is displayed when the shared wallet icon CN1 is touched in the application screen in FIG. 2-1.

In this example, the “shared wallet”, which is the currently executed item in the submenu, is displayed as a current location in the hierarchical menu of the “Payment App” below the title bar.

The explanation “select a shared wallet” is displayed as an operation guide for the user below the “shared wallet”, and a display region for a plurality of shared wallets is provided below this explanation. In this example, a camping fund display region 242, which is a shared wallet display region for a camping fund, and a South Korea travel display region 243, which is a shared wallet display region for travel to South Korea, are displayed. Below that, a new registration operation region 244 for the user to newly add and register a shared wallet is provided.

In the camping fund display region 242, the name of this shared wallet (“camping fund” in this example) is displayed in an upper part, together with an image of a “wallet” indicating a shared wallet. An icon for various settings is displayed next to the name of the shared wallet.

The shared wallet balance (here, “1,000 yen”) of this camping fund is displayed in a lower part, and icon images and user names of users sharing this shared wallet are displayed next to the shared wallet balance. In this example, icon images and user names of the users A.A and B.B are displayed. That is, it can be said that this shared wallet for the camping fund is a shared wallet that is shared by two people, namely the users A.A and B.B.

Similarly, in the South Korea travel display region 243, the name of the shared wallet (“camping fund” in this example) is displayed in an upper part, together with an image of a wallet, which indicates a shared wallet. An icon for various settings is displayed next to the name of the shared wallet.

The balance (“90,000 yen” in this example) is displayed in a lower part, and icon images and user names of users sharing this shared wallet are displayed next to the balance. In this example, icons of the users A.A, D.D, and E.E are displayed. That is, it can be said that this shared wallet for travel to South Korea is a shared wallet that is shared by three users, namely the users A.A, D.D, and E.E.

In the new registration operation region 244, a “+” mark is displayed at the center so that the user can easily recognize that this region is for performing an operation to newly add and register a shared wallet. A shared wallet can be newly created and registered by touching any position, which is not limited to the “+” mark, in the new registration operation region 244.

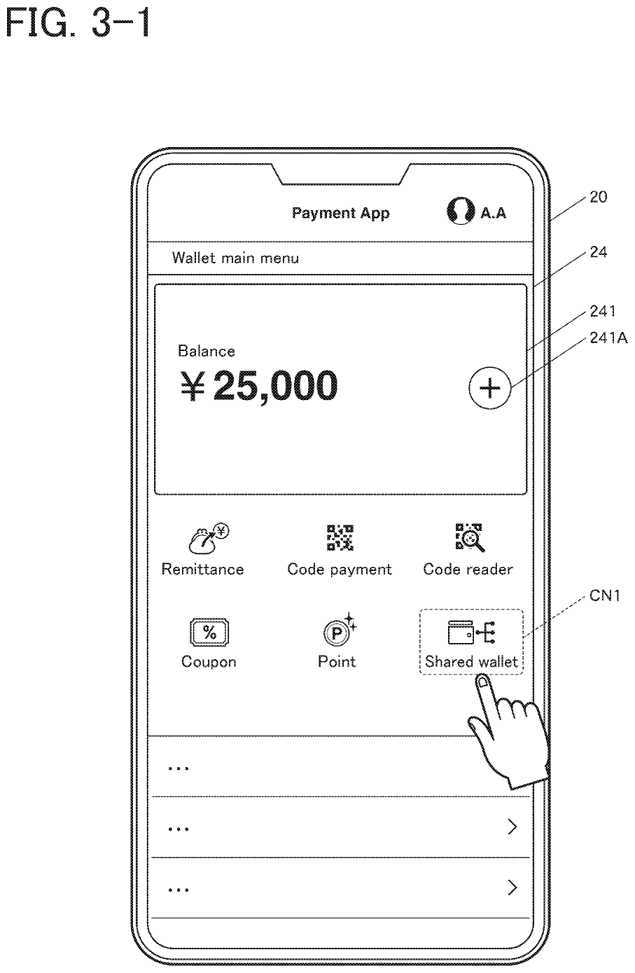

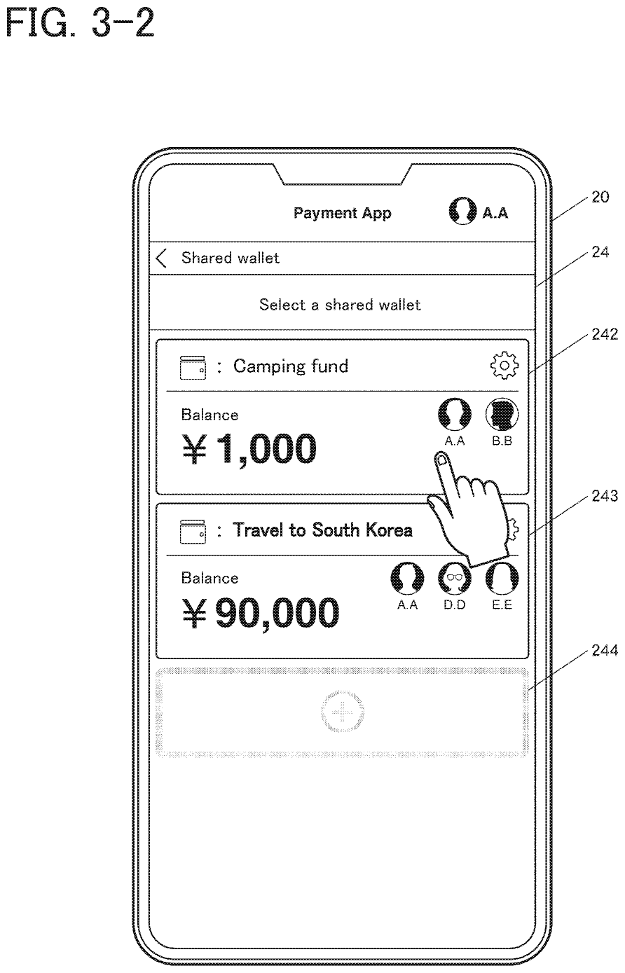

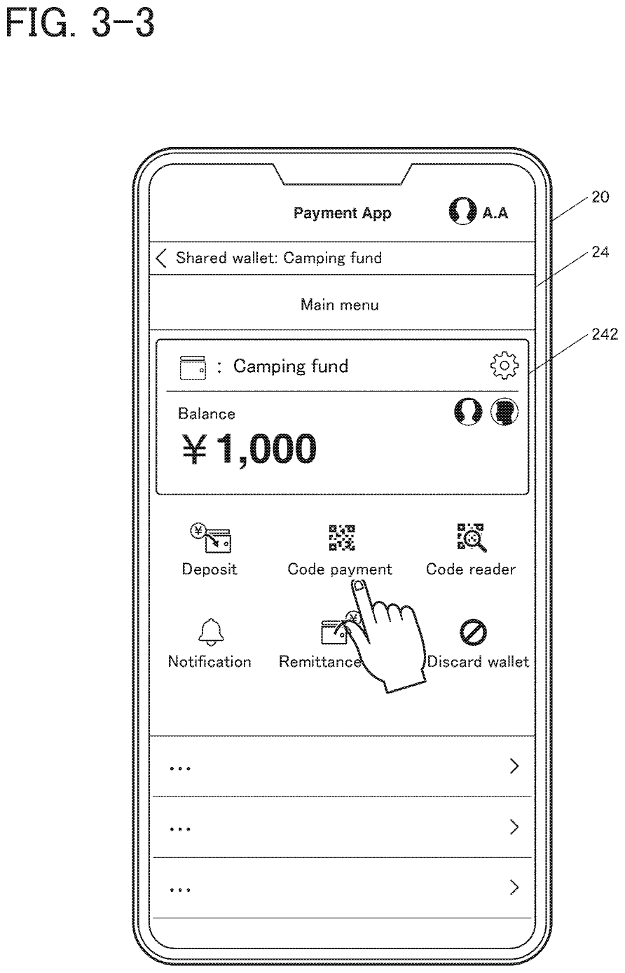

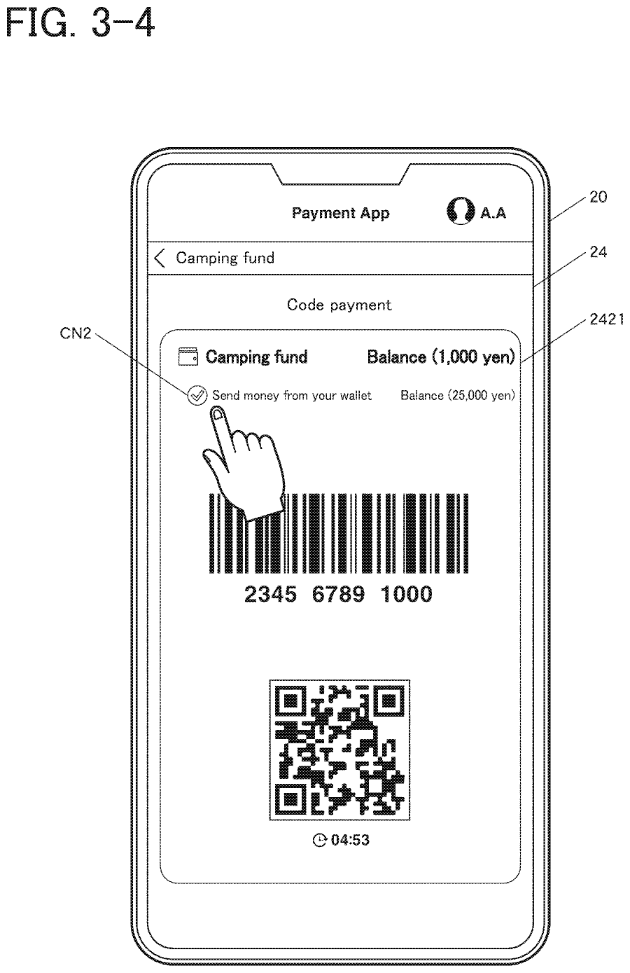

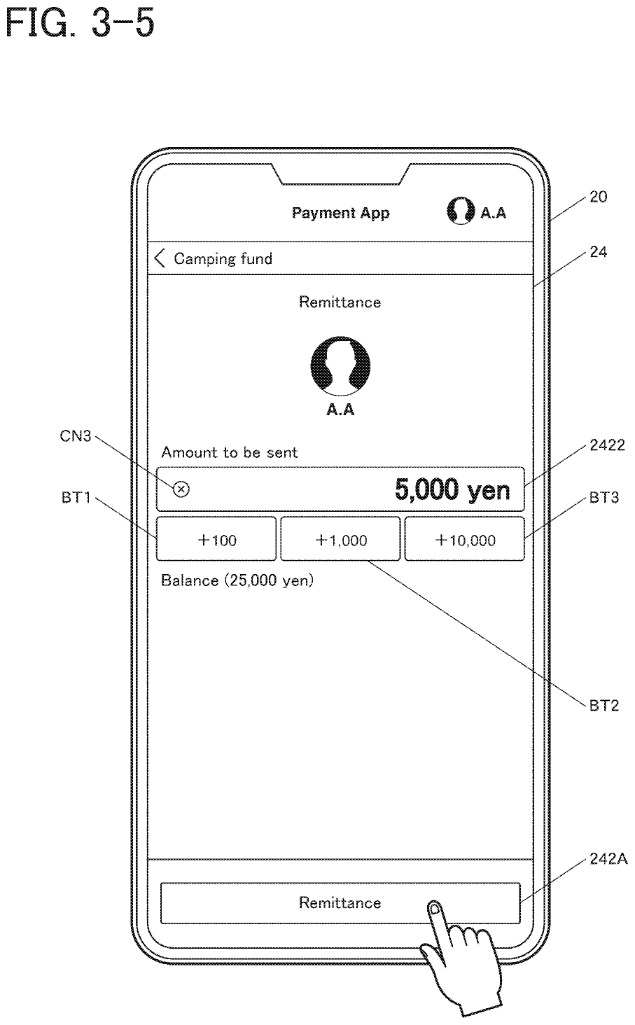

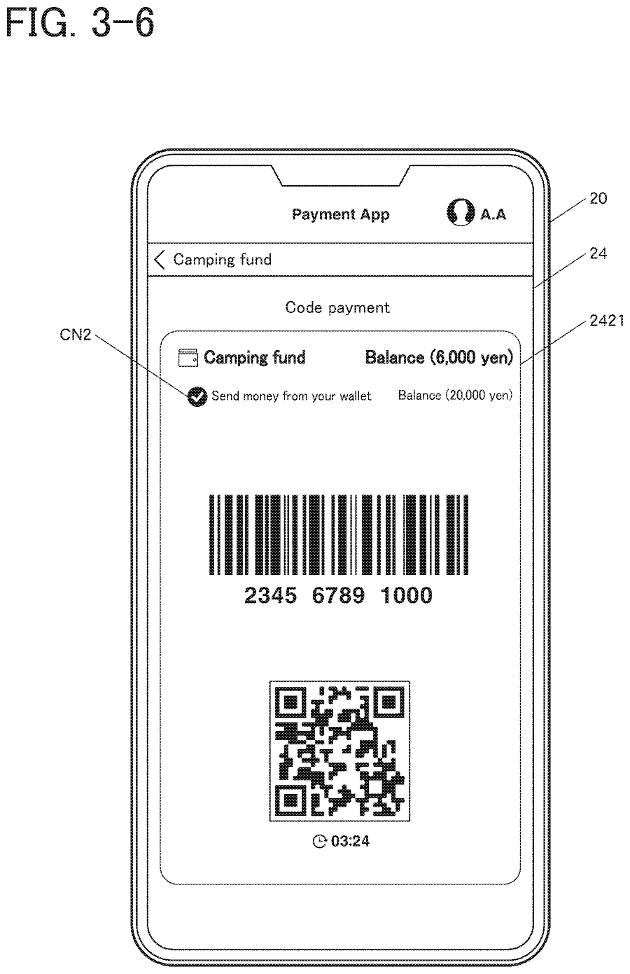

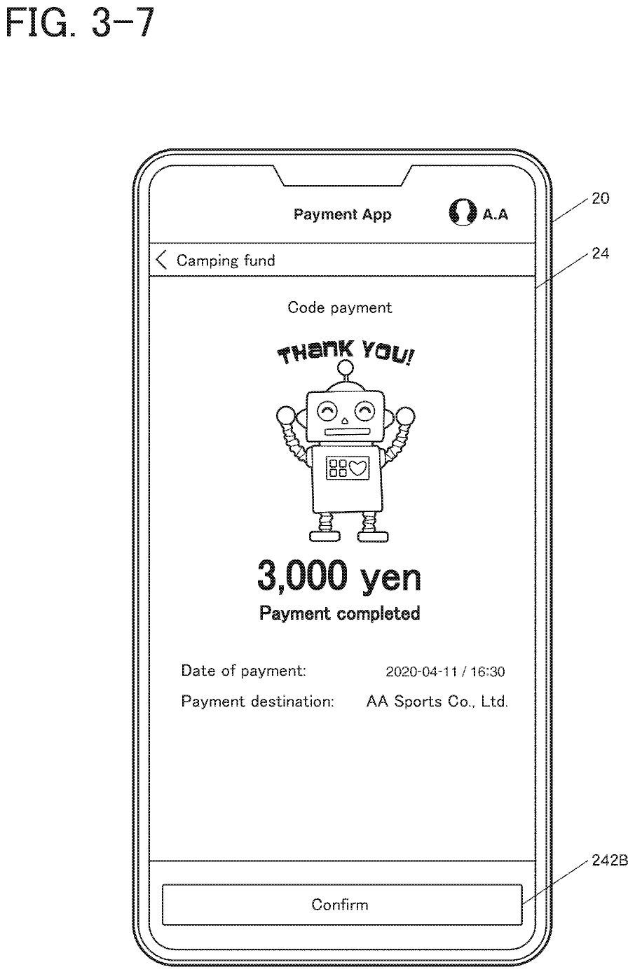

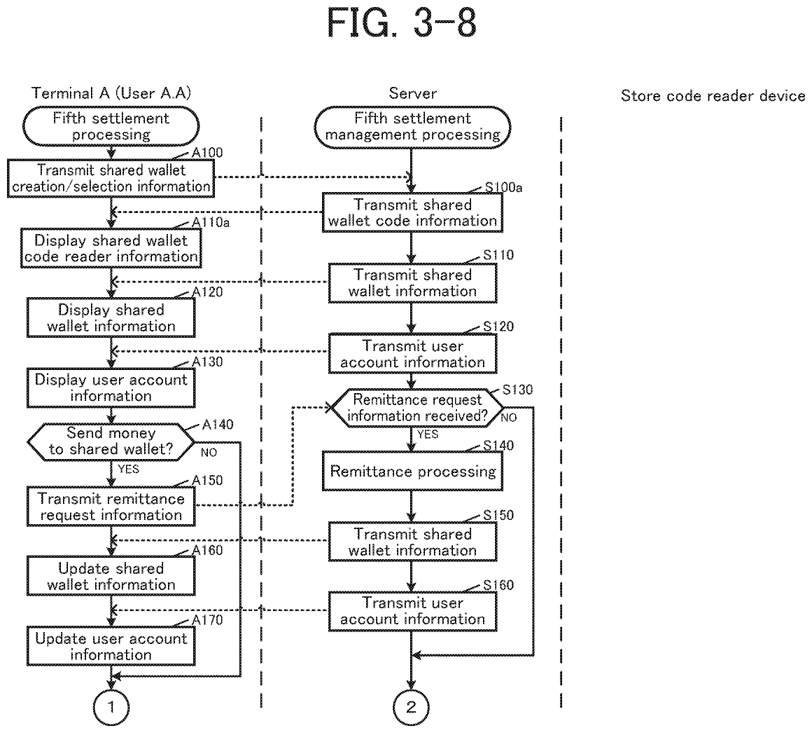

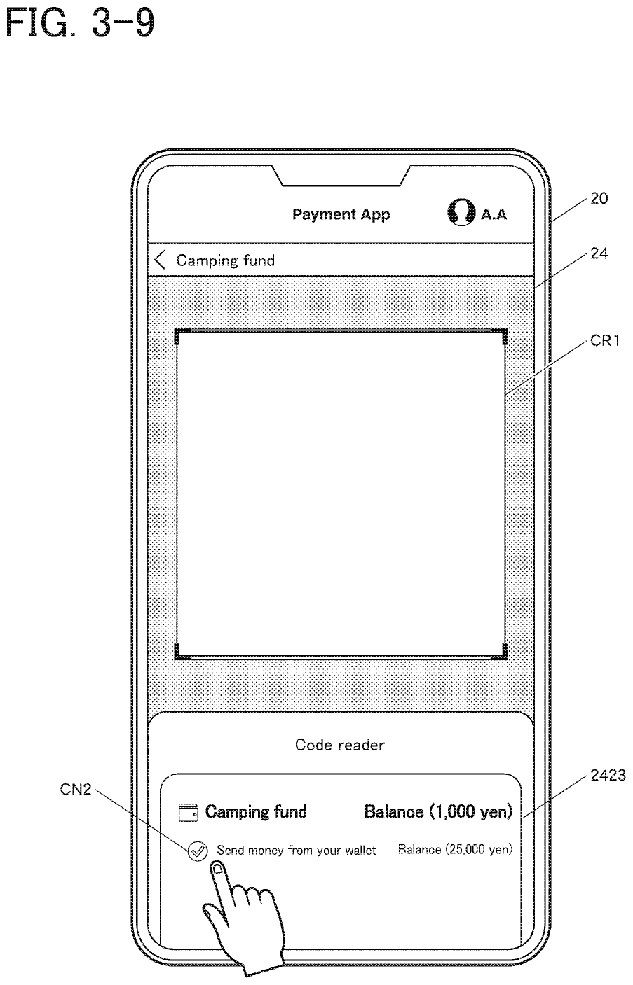

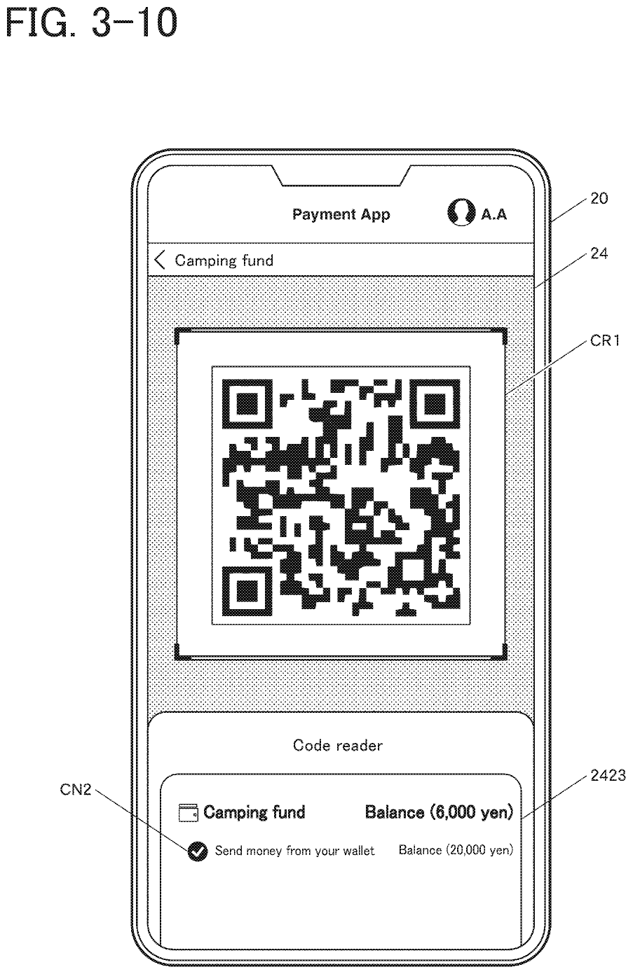

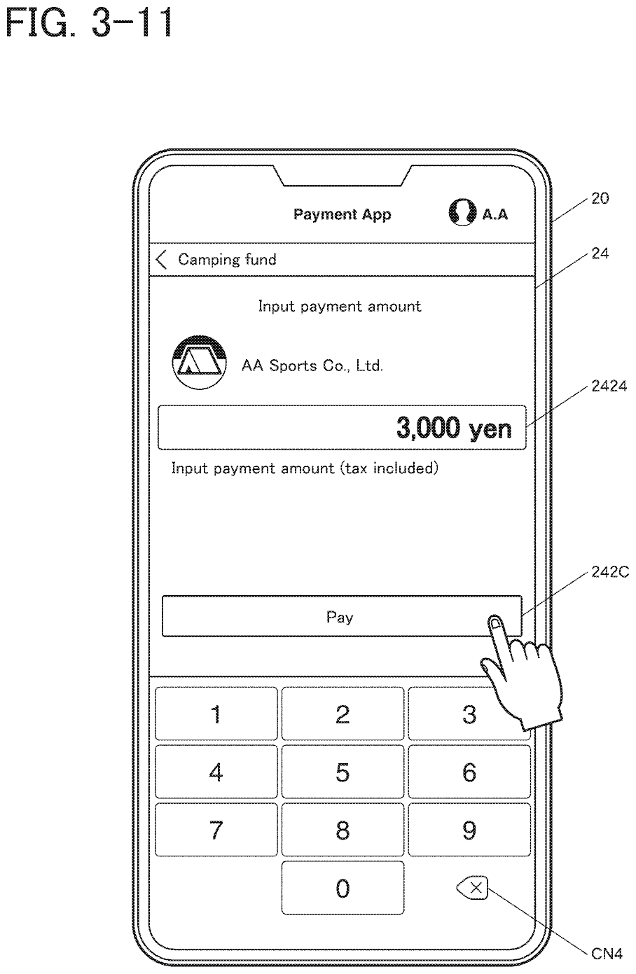

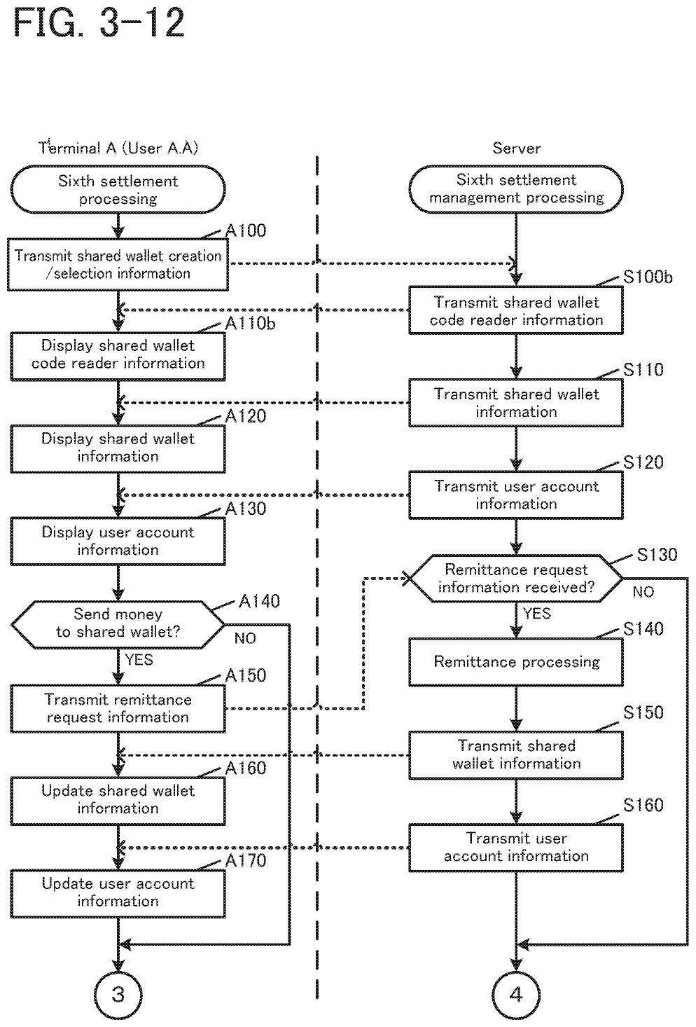

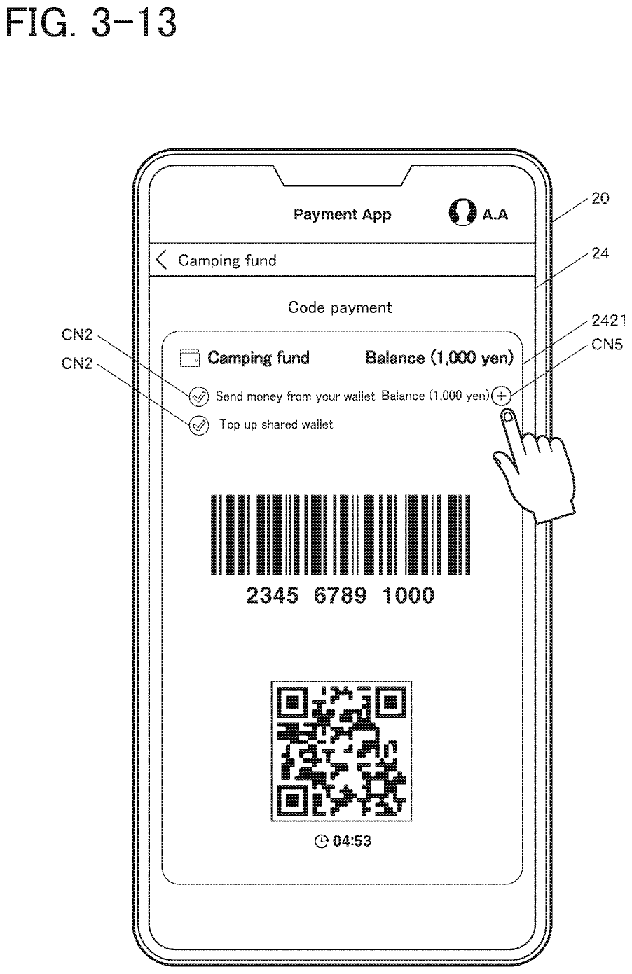

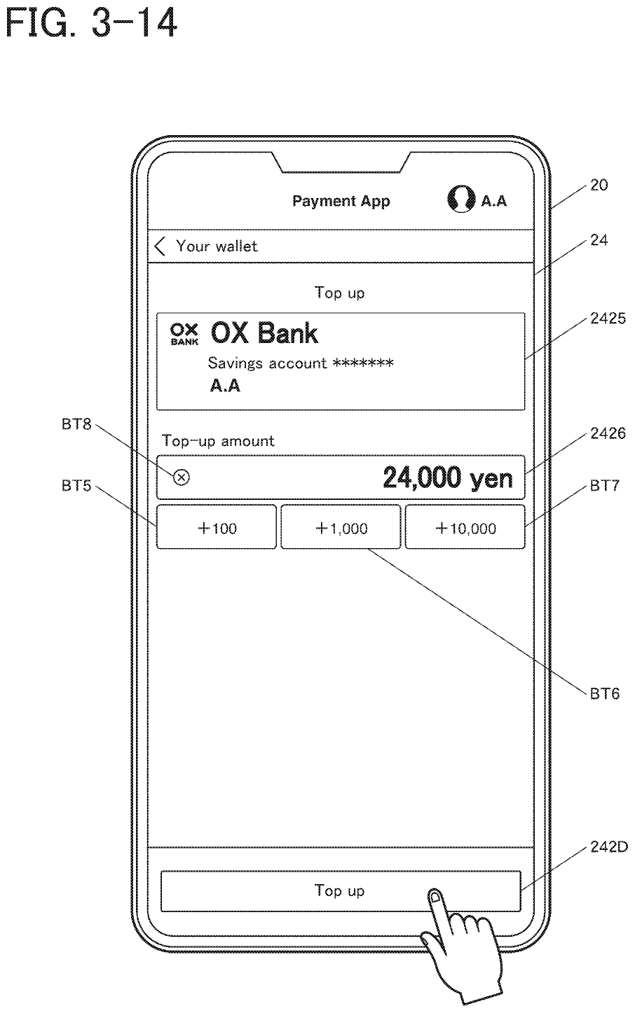

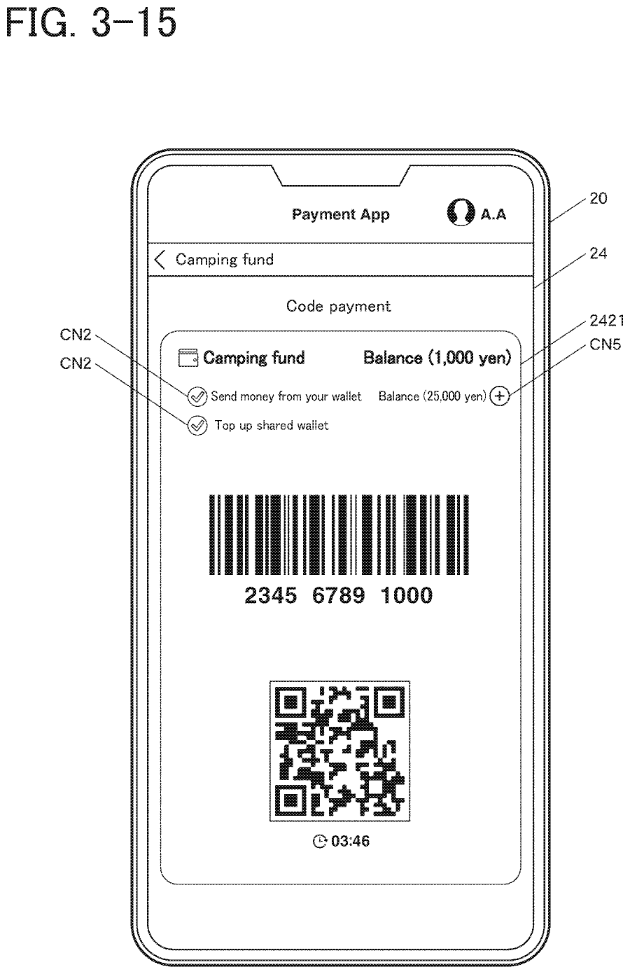

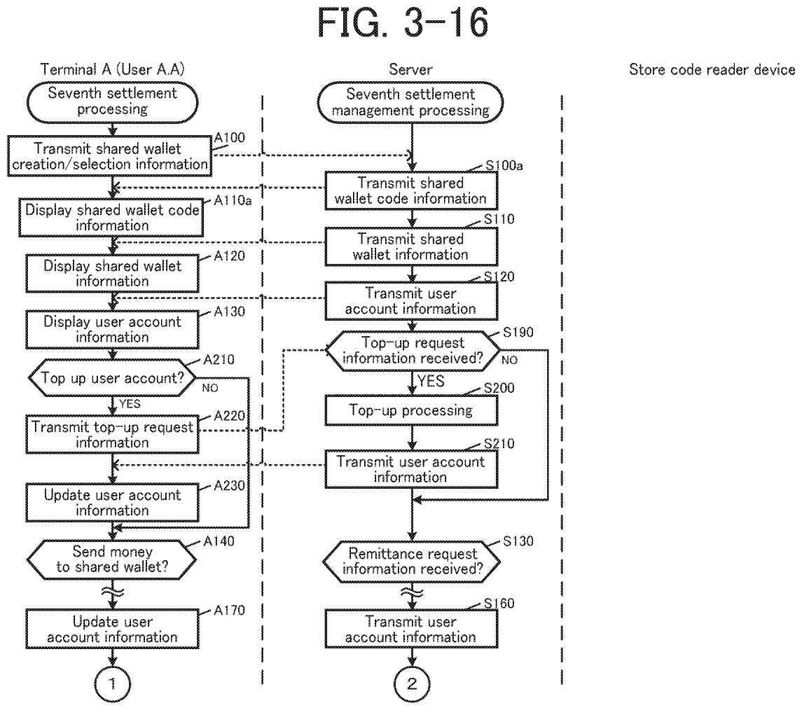

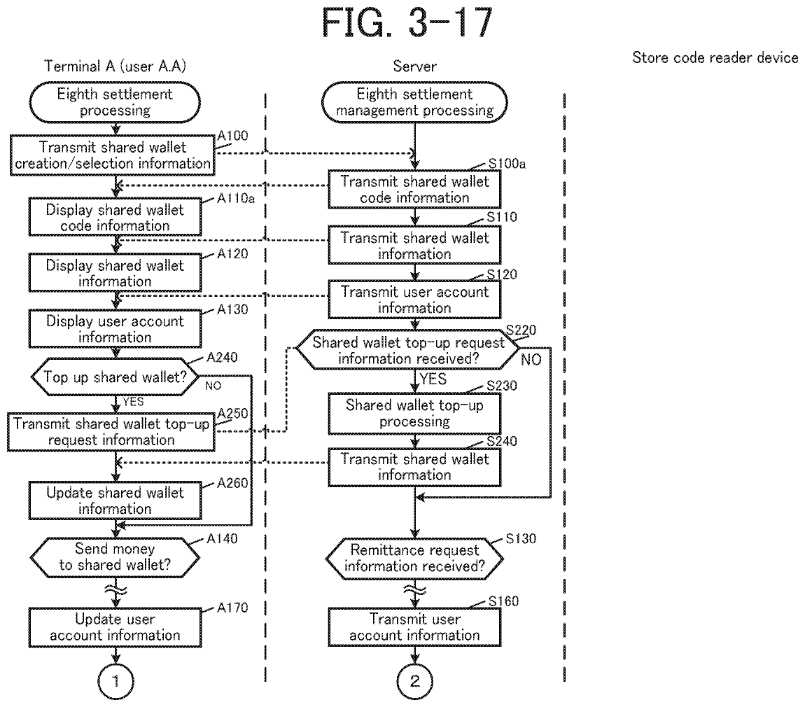

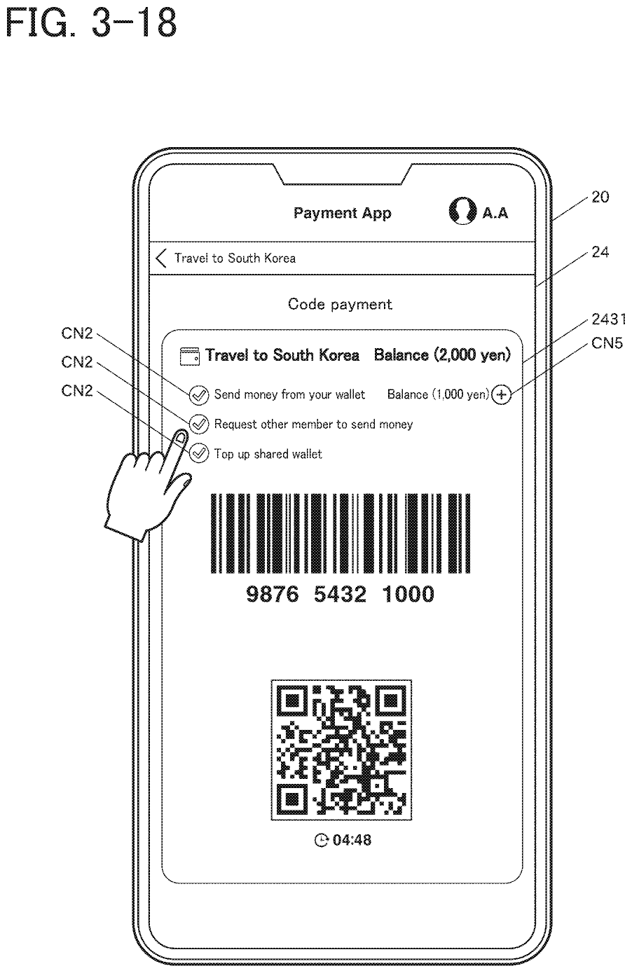

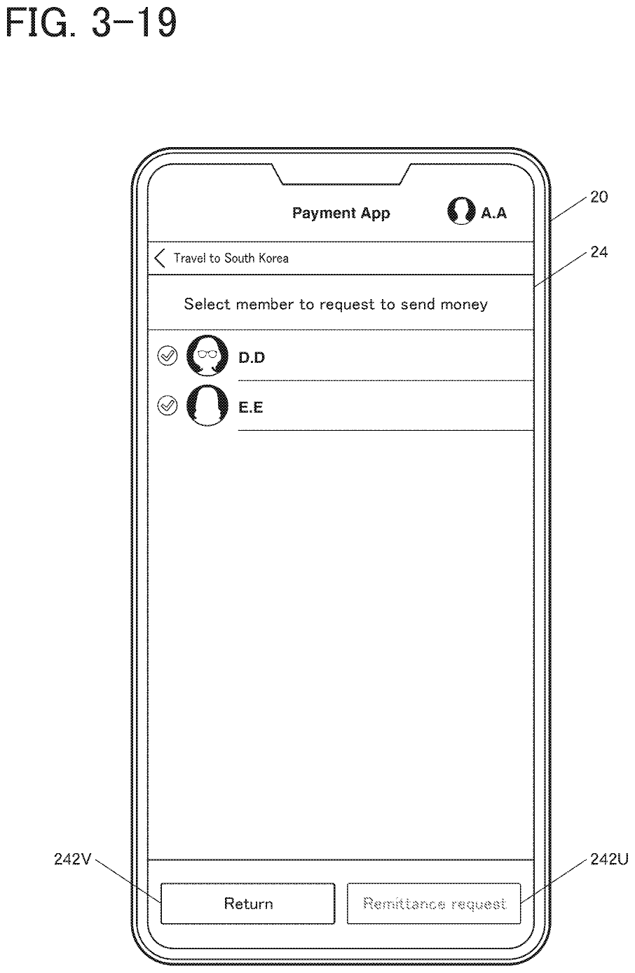

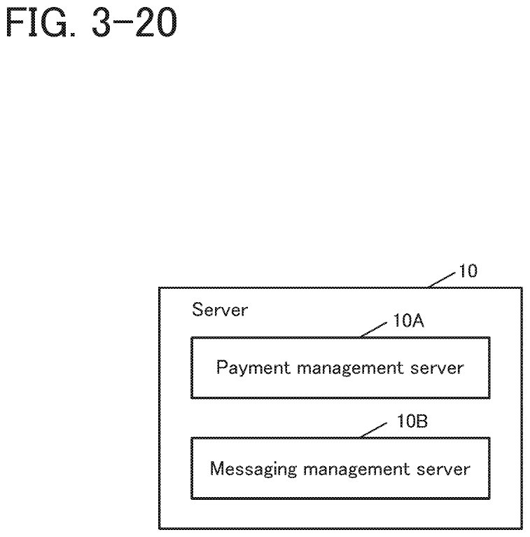

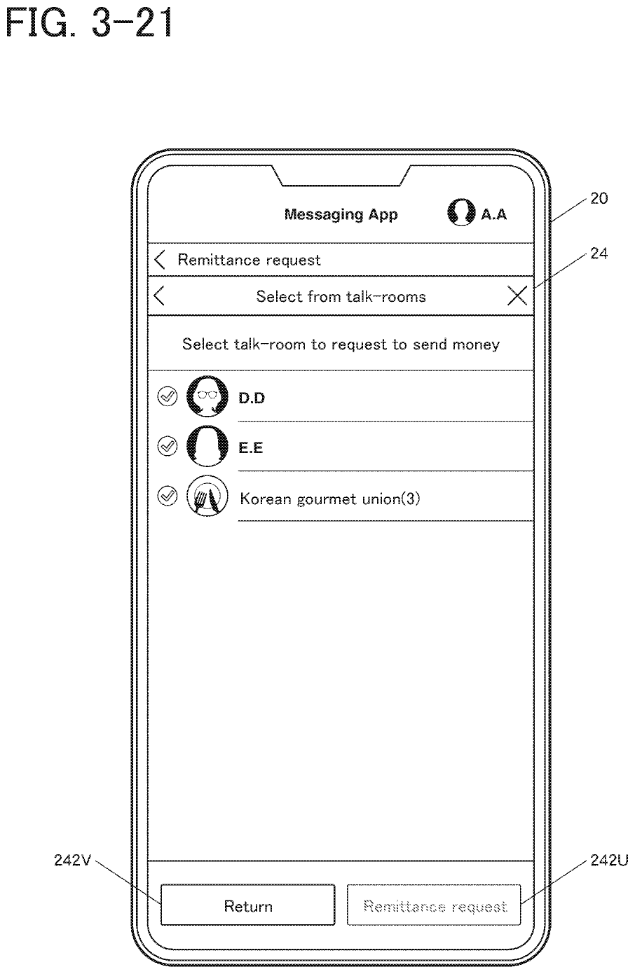

FIG. 2-3 is a diagram showing an example of a camping fund payment screen that is displayed when the camping fund display region 242 is touched in the shared wallet selection screen in FIG. 2-2.

In this example, “shared wallet: camping fund”, which is the currently executed item in the submenu, is displayed as a current location in the hierarchical menu below the title bar. Below that, “main menu” is displayed as an operation guide for the user, and the camping fund display region 242 is displayed below the “main menu”. Six icons that correspond respectively to “deposit”, “code payment”, “code reader”, “notification”, “send money”, and “discard wallet”, which are items in a submenu that can be selected from the “main menu”, are displayed below the camping fund display region 242.

Of these icons, the icon shown as “code payment” is a “code payment icon” for acquiring a payment code from the server 10 when code settlement using the “user-presenting mode” is carried out. The icon shown as “code reader” is a code reader icon for starting a code reader (hereinafter referred to as an “application code reader”) that is provided as a function of the code payment application to have the terminal 20 read a code to be read by a terminal when code settlement in the “store-presenting mode” is carried out.

FIG. 2-4 is a diagram showing an example of a code payment screen that is displayed when the icon shown as “code payment” in the camping fund payment screen in FIG. 2-3 is touched by the user A.A of the terminal 20.

In this example, “camping fund”, which is the currently executed item in the submenu, is displayed as a current location in the hierarchical menu of the “Payment App” below the title bar. The “code payment” is displayed as an operation guide for the user below the “camping fund”, and a camping fund code payment region 2421 is displayed below the “code payment”.

In the camping fund code payment region 2421, the shared wallet balance (“1,000 yen” in this example) of this camping fund is displayed together with an image of a wallet and the name (camping fund) of the shared wallet, similarly to the above.

Below that, the text “your wallet” is displayed together with an image of a purse with a clasp indicating a wallet (electronic money account) of the user of the terminal 20, and the balance (electronic money account balance; “25,000 yen” in this example) is displayed next to the text and the image.

Below that, a one-dimensional payment code shown as a bar code, for example, without limitation thereto, and a two-dimensional payment code shown as a QR CODE, for example, without limitation thereto, are displayed as payment codes that are codes (code images) that are transmitted from the server 10 and received by the terminal 20 and are to be used to carry out settlement using the shared wallet.

A period within which settlement can be carried out using these payment codes (hereinafter referred to as a “code expiration period”) is determined for these payment codes. In this example, the remaining time of the code expiration period is displayed in a countdown format in association with the payment codes. The code expiration period may be any period, and may be defined as a period of “five minutes”, for example, without limitation thereto.

Note that the code expiration period may be a period in which the payment codes are displayed on the terminal 20 (hereinafter referred to as a “code display period”), and the displayed payment codes may be hidden when the code display period ends.

The user of the terminal 20 presents the code payment screen to a clerk of the store at a code register, and carries out code payment by having the payment codes read by the store code reader device 50.

FIG. 2-5 is a diagram showing an example of an insufficient shared wallet balance screen that is displayed in the display 24 of the terminal 20 when the shared wallet balance is insufficient after the payment codes in the code payment screen in FIG. 2-4 are read by the store code reader device 50.

In this insufficient shared wallet balance screen, “camping fund” is displayed as a current location, and an insufficient shared wallet balance information display/operation region 2427 is displayed in a pop-up format below the “camping fund”. In this example, an image of a “robot with a troubled face” is displayed as an image indicating that the balance is insufficient, and “the shared wallet balance is insufficient” is displayed as an insufficient balance message below the image of the robot.

Below that, the text “purchase to be paid for” is displayed. In this example, the text “AA Sports Co., Ltd.”, which is the name of a company, is displayed together with a logo image of AA Sports Co., Ltd. The text “3,000 yen” is displayed as a payment amount next to the name and logo image of the company. Below that, the shared wallet balance (“1,000 yen” in this example) of the camping fund is displayed as a breakdown, together with an image of a wallet and the name (camping fund) of the shared wallet.

Below that, the user's electronic money account balance (“25,000 yen” in this example) is displayed together with an image of a purse with a clasp and “your wallet”. Further, below that, a guide sentence “Pay 2,000 yen from your wallet balance?” is displayed as information for asking the user's intention about whether or not to pay for the shortfall in the balance for settlement (=amount to be settled−shared wallet balance) from the user's wallet. In this example, the payment amount is “3,000 yen”, while the shared wallet balance is “1,000 yen”. Therefore, there is a shortage of “2,000 yen” and the shortfall is “2,000 yen”.

Further, in this example, a payment execution button 242W shown as “pay”, for example, without limitation thereto, for executing payment from the user's wallet balance, and a payment non-execution button 242X shown as “do not pay”, for example, without limitation thereto, for not executing payment from the user's wallet balance are displayed below the insufficient shared wallet balance information display/operation region 2427.

FIG. 2-6 is a diagram showing an example of a code payment completion screen that is displayed in the display 24 of the terminal 20 when the payment execution button 242W is touched in the insufficient shared wallet balance screen in FIG. 2-5 and then settlement processing is completed by the server 10.

In this code payment completion screen, “camping fund” is displayed as a current location, and information relating to the settlement result is displayed below the “camping fund”. Specifically, the text “THanK YOU!” serving as a payment completion message is displayed together with the text “code payment”, and an “image of a robot putting its hands up with a smiling face” expressing gratitude is displayed below the payment completion message. Below that, the text “Payment is completed.” is displayed together with the payment amount “3,000 yen”.

Below that, it is indicated, as payment details, that the payment is “Apr. 11, 2020” and the time of payment is “16:30”. Below that, it is indicated that the payment destination is “AA Sports Co., Ltd.”.

Below that, a breakdown of the payment is displayed with a horizontal line placed between the breakdown and the payment destination. In this example, information indicating that the amount paid from the shared wallet for the camping fund is “1,000 yen” and the amount paid from the user's wallet is “2,000 yen” is displayed.

Processing

FIGS. 2-7 and 2-8 are flowcharts showing an example flow of processing executed by the devices in the present embodiment. These flowcharts show examples of settlement processing executed by the controller 21 of a terminal A (non-limiting examples of which include the terminal 20 of a user A.A), settlement management processing executed by the controller 11 of the server 10, and store settlement processing executed by the controller 51 of the store code reader device 50, which is an element of a store POS system (non-limiting examples of which include the store POS system 40 at a member store S1), in order from the left. These types of processing are examples of processing relating to code settlement in the user-presenting mode.

After S110, the controller 11 of the server 10 transmits user account information (non-limiting examples of which include an electronic money account balance) associated with the payment application ID of the user A.A, who is the user of the terminal A, to the terminal A using the communication I/F 14 (S120).

After A120, upon receiving the user account information from the server 10 using the communication I/F 22, the controller 21 of the terminal A causes the display 24 to display the received user account information (A130). Specifically, the controller 21 causes the display 24 to additionally display the electronic money account balance of the user A.A of the terminal A, for example, without limitation thereto.

The controller 51 of the store code reader device 50 executes store settlement processing, and a predetermined amount to be settled (non-limiting examples of which include “3,000 yen”) is input to the controller 51 based on an operation to the input/output device 52 of the store code reader device 50. The controller 51 of the store code reader device 50 then reads the payment code displayed in the display 24 of the terminal A, using the code reader 58 (P100). In this case, since the payment code displayed in the display 24 is associated with the shared wallet payment token, the reading result obtained by the code reader 58 includes the shared wallet payment token.

The controller 51 of the store code reader device 50 transmits settlement request information including the store ID, the amount to be settled, and the shared wallet payment token, for example, without limitation thereto, to the server 10 using the communication I/F 54 (P110).

Upon receiving the settlement request information from the store code reader device 50 using the communication I/F 14, the controller 11 of the server 10 retrieves the shared wallet ID using the shared wallet payment token with which the request has been made, and executes, for the shared wallet, settlement processing to pay the amount to be settled for the member store defined by the store ID (S250a).

If the settlement is successful in the settlement processing (S260a: YES), the controller 11 of the server 10 advances the processing to S180c.

On the other hand, if the settlement fails in the settlement processing (S260a: NO), the controller 11 of the server 10 transmits insufficient settlement balance information including a message indicating that the settlement has failed and the shortfall in the balance for settlement in the shared wallet in this case, for example, without limitation thereto, to the terminal A and the store code reader device 50 using the communication I/F 14 (S270a).

After A130, upon receiving the insufficient settlement balance information from the server 10 using the communication I/F 22 (A270a: YES), the controller 21 of the terminal A causes the display 24 to additionally display the received insufficient settlement balance information (A280). Also, the controller 21 of the terminal A stores, in the storage 28, the shortfall in the balance for settlement that is included in the received insufficient settlement balance information (A290).

Thereafter, based on input (input to the input/output device 23) being made for the user account information displayed together with the insufficient settlement balance information in the display 24, the controller 21 of the terminal A transmits settlement request information for requesting the server 10 to pay the shortfall from the electronic money account balance of the user A.A and carry out settlement from the shared wallet balance and the user A.A's electronic money account balance, to the server 10 using the communication I/F 22, for example, without limitation thereto (A295).

Upon receiving the settlement request information from the terminal A using the communication I/F 14, the controller 11 of the server 10 executes settlement processing (S170c). Specifically, the shared wallet balance is reduced to “0” and the shortfall is deducted from the electronic money account balance of the user A.A, for example, without limitation thereto.

Thereafter, the controller 11 of the server 10 transmits settlement result information including various types of information included in the payment completion screen in FIG. 2-6 to the terminal A and the store code reader device 50 using the communication I/F 14, for example, without limitation thereto (S180c), and ends the processing.

On the other hand, if the insufficient settlement balance information is not received from the server 10 (A270a: NO), the controller 21 of the terminal A receives the settlement result information from the server 10 using the communication I/F 22, and advances the processing to A180.

After P110, upon receiving the insufficient settlement balance information from the server 10 using the communication I/F 54 (P120: YES), the controller 51 of the store code reader device 50 causes the display 53 to display the insufficient settlement balance information (P130). After receiving the settlement result information from the server 10, the controller 51 of the store code reader device 50 advances the processing to P160.

Display of Insufficient Settlement Balance Information

“The insufficient settlement balance information is displayed” means “after the insufficient settlement balance information is displayed” or “when the insufficient settlement balance information is displayed once”, and does not necessarily require that the insufficient settlement balance information be still displayed at present.

That is, “input to the display 24 in which the insufficient settlement balance information is displayed” may refer to concepts including:

(1) the case where, after the insufficient settlement balance information is displayed, input is made to the display 24 with the insufficient settlement balance information displayed; and
(2) the case where, after the insufficient settlement balance information is displayed, the insufficient settlement balance information is hidden, and thereafter input is made to the display 24.

This applies to the following embodiments.

### Input to Terminal

An example has been described where, in the above processing, whether or not to pay the shortfall from the user account (electronic money account) of the user of the terminal 20 is selected based on the input to the input/output device 23 of the terminal 20. However, this need not be the case. This selection may be implemented by, for example, inputting sound (including voice) to the microphone 25 of the terminal 20.

The same applies to various types of input to the terminal 20.

### Effects of Second Embodiment

In the second embodiment, the terminal 20 executes, with use of the controller 21, processing relating to settlement based on an account (a non-limiting example of a first account) with which the user of the terminal 20 can carry out settlement. Also, the terminal 20 causes the display 24 to display the insufficient settlement balance information (a non-limiting example of first information relating to insufficiency of the balance of the first account that is based on the amount of a first settlement and the balance of the first account, without limitation thereto). Then, based on the input to the display 24 in which the insufficient settlement balance information is displayed, the terminal 20 executes processing (a non-limiting example of the processing relating to the first settlement) for carrying out settlement by paying the shortfall from the user account of the user of the terminal 20 (a non-limiting example of a second account different from the first account).

As an example of the effect achieved by this configuration, it is possible to notify the user of the terminal that the balance of the first account with which the user of the terminal can carry out settlement is insufficient. In addition, settlement can be implemented based on the first account, and can also be implemented based at least on the second account different from the first account.

Also, the second embodiment describes a configuration in which the account with which the user of the terminal 20 can carry out settlement is a shared account (a non-limiting example of a shared account with which at least the user of the terminal and a first user different from the user of the terminal can carry out settlement).

As an example of the effect achieved by this configuration, settlement can be implemented based on the shared account with which at least the user of the terminal and the first user who is different from the user of the terminal can carry out settlement.

### Second Embodiment Variation (1)

The second embodiment has described code settlement in the user-presenting mode, but this need not be the case.

Specifically, code settlement in the store-presenting mode can also be applied, for example, without limitation thereto.

### Example Display Screen

FIG. 2-9 is a diagram showing an example of a code reader screen displayed in the display 24 of the terminal 20.

If the “code reader” icon, rather than the “code payment” icon, is touched in the camping fund payment screen in FIG. 2-3 by the user A.A of the terminal 20, the application code reader is started, and a code reader screen for reading a payment store code, such as that shown in FIG. 2-9, is displayed in the display 24, for example, without limitation thereto.

In this code reader screen, “camping fund”, which is the currently executed item in the submenu, is displayed as a current location in the hierarchical menu of “Payment app” below the title bar.

Below that, a code reading region CR1 is displayed, “code reader” is displayed as an operation guide for the user below the code reading region CR1, and a camping fund code payment region 2423 is displayed below the “code reader”.

In the camping fund code payment region 2423, the text “camping fund” is displayed together with an image of a wallet in an upper part, and the shared wallet balance of this camping fund (“1,000 yen” in this example) is displayed next to the text “camping fund”. Below that, the text “your wallet” is displayed together with an image of a purse with a clasp, and the electronic money account balance (“25,000 yen” in this example) of the user is displayed next to the text “your wallet”.

FIG. 2-10 is a diagram showing an example of a reading completion screen that is displayed when the payment store code in the code reader screen in FIG. 2-9 is read.

The read payment store code is displayed in the code reading region CR1. The same information as that in FIG. 2-9 is displayed in a camping fund code payment region 2423 in a lower part of the screen.

FIG. 2-11 is a diagram showing an example of a payment amount input screen that is displayed following FIG. 2-10. Upon information being acquired by decoding the read payment store code, a payment amount input screen for inputting the payment amount is displayed.

In this payment amount input screen, “input payment amount” is displayed as an operation guide for the user. Below that, the name “AA Sports Co., Ltd.” of the destination to which the payment amount is to be sent is displayed together with an icon image thereof. Below that, a payment amount display region 2424 for displaying the input payment amount is displayed. Below that, the text “input payment amount (tax included)” is displayed, and a payment button 242C is displayed below the text.

In a lower part of the screen, a keyboard for inputting the payment amount and an erase button CN4 for erasing the payment amount are displayed.

This example shows the state where “3,000 yen” is input as the payment amount and is displayed in a payment amount display region 2424.

FIG. 2-12 is a diagram showing an example of an insufficient shared wallet balance screen that is displayed based on the insufficiency of the shared wallet balance after the payment button 242C is touched in the payment amount input screen in FIG. 2-10.

The configuration of this insufficient shared wallet balance screen is the same as FIG. 2-5. A difference from FIG. 2-5 lies in that the background of the insufficient shared wallet balance information display/operation region 2427 is a code reader screen.

After the payment execution button 242W is touched in the insufficient shared wallet balance screen in FIG. 2-12 and the settlement processing is completed by the server 10, the same code payment completion screen as FIG. 2-6 is displayed.

### Processing

FIGS. 2-13 and 2-14 are flowcharts showing an example flow of processing executed by the devices in this variation. These flowcharts show examples of settlement processing executed by the controller 21 of the terminal A (non-limiting examples of which include the terminal 20 of the user A.A) and settlement management processing executed by the controller 11 of the server 10, in order from the left.

After A300, the controller 21 of the terminal A causes the display 24 to display a display screen for inputting the amount to be settled, for example, without limitation thereto. Upon the amount to be settled being input based on a user operation to the input/output device 23 of the terminal A, the controller 21 of the terminal A transmits settlement request information including the shared wallet payment token included in the shared wallet code reader information, the store ID, and the amount to be settled, for example, without limitation thereto, to the server 10 using the communication I/F 22 (A310).

Note that if the amount to be settled is included in the payment store code, the input of the amount to be settled to the terminal A can be omitted.

Upon receiving the settlement request information from the terminal A using the communication I/F 14, the controller 11 of the server 10 retrieves the shared wallet ID using the shared wallet payment token with which the request has been received, and executes, for the shared wallet, settlement processing in the store-presenting mode to make payment of the amount to be settled to the member store defined by the store ID (S250b).

If the settlement is successful in S250b (S260b: YES), the controller 11 of the server 10 advances the processing to S180d.

If the settlement fails in S250b (S260b: NO), the controller 11 of the server 10 transmits insufficient settlement balance information including a message indicating the settlement failure and the shortfall in the balance for settlement in the shared wallet in this case, to the terminal A using the communication I/F 14 (S270b).

Upon receiving the insufficient settlement balance information from the server 10 using the communication I/F 22 (A270b: YES), the controller 21 of the terminal A causes the display 24 to display the insufficient settlement balance information (A280), and stores the shortfall in the balance for settlement in the storage 28 (A290). The controller 21 of the terminal A then advances the processing to A295. Specifically, the controller 21 of the terminal A transmits settlement request information having the same content as that in A295 in FIG. 2-8 to the server 10 using the communication I/F 22. The controller 21 of the terminal A then receives the settlement result information from the server 10 using the communication I/F 22, and advances the processing to A180.

Upon receiving the settlement request information from the terminal A using the communication I/F 14, the controller 11 of the server 10 executes settlement processing in the store-presenting mode with the same content as that in S170c in FIG. 2-8 (S170d). The controller 11 of the server 10 then transmits the settlement result information to the terminal A using the communication I/F 14 (S180d), and ends the processing.

On the other hand, if the insufficient settlement balance information is not received from the server 10 (A270b: NO), the controller 21 of the terminal A receives the settlement result information from the server 10 using the communication I/F 22, and advances the processing to A180.

### Second Embodiment Variation (2)

In the second embodiment, when the shared wallet balance is insufficient, the shortfall is paid from the user account of the user of the terminal 20, but this need not be the case.

Specifically, when the shared wallet balance is insufficient, the full amount may be paid from the user account of the user of the terminal 20 without using the shared wallet balance. That is, the account to be used in the settlement may be changed (switched) from the shared account (shared wallet) to the user account of the user of the terminal 20 (user's electronic money account balance).

### Third Embodiment

In the third embodiment, remittance from a user's wallet to a shared wallet is implemented.

Enabling remittance from a user's wallet to a shared wallet makes it possible to top up the shared wallet balance in advance and top up the shared wallet balance when the shared wallet balance is insufficient at the time of payment, for example, without limitation thereto.

The content described in the third embodiment is applicable to any other embodiments and variations.

Corresponding elements that are the same as those already described are assigned the same reference numerals as those used for corresponding elements, and a redundant description thereof is omitted.

### Example Display Screen

An example display screen displayed on the display 24 of the terminal 20 will be described.

Display screens in FIGS. 3-1 to 3-3 are the same as the display screens in FIGS. 2-1 to 2-3, respectively.

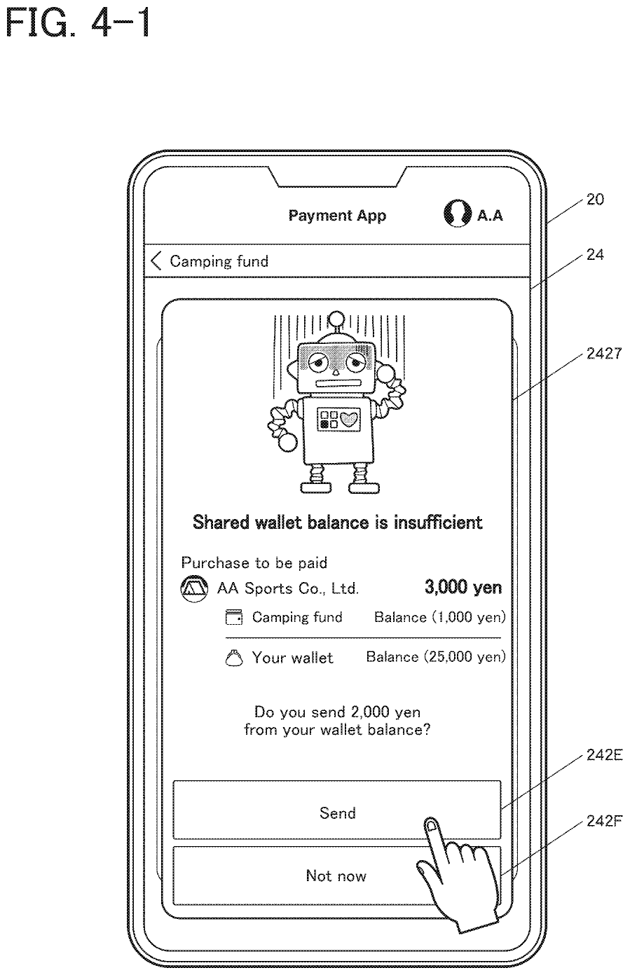

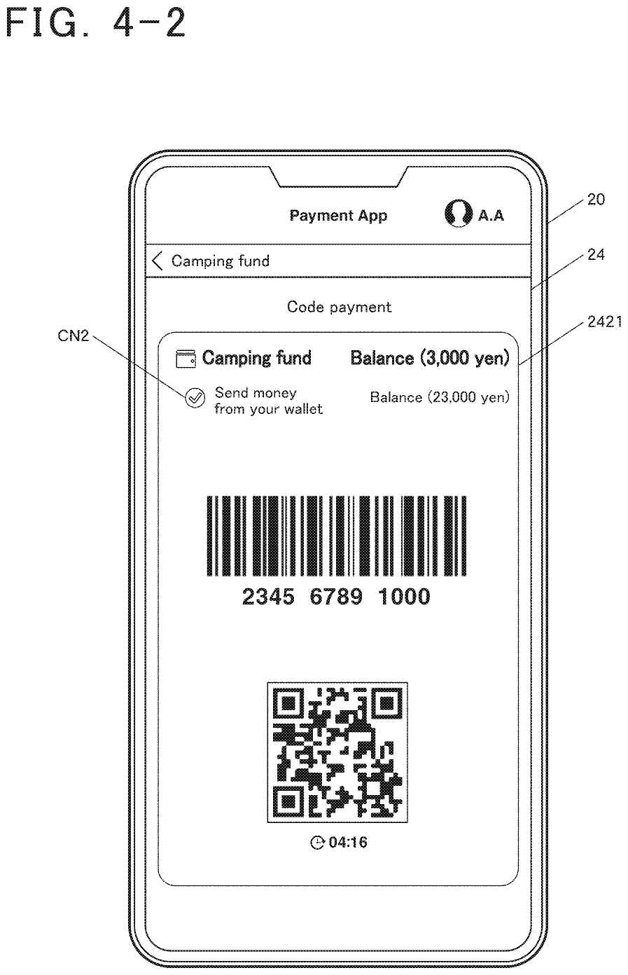

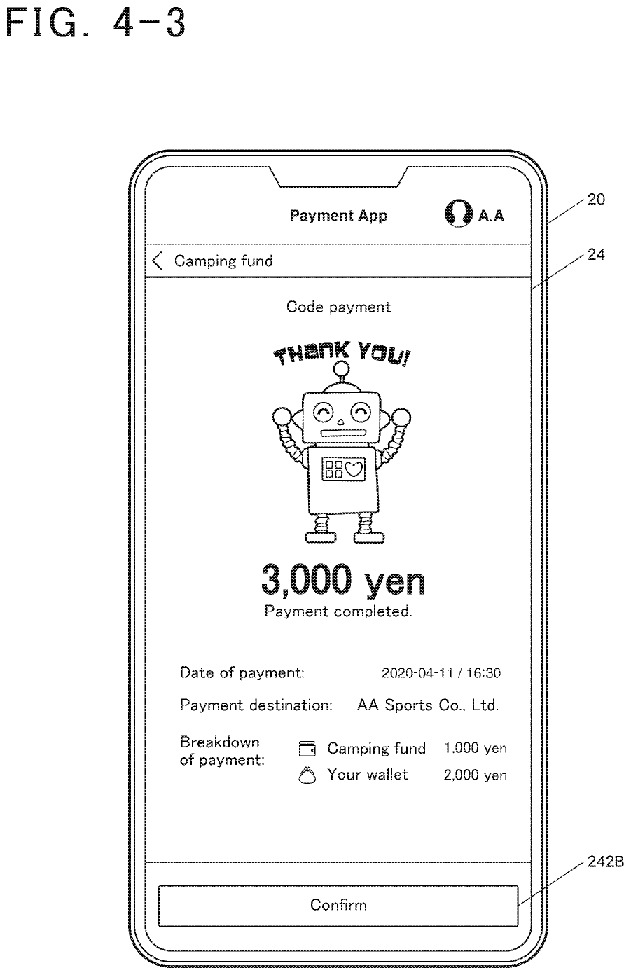

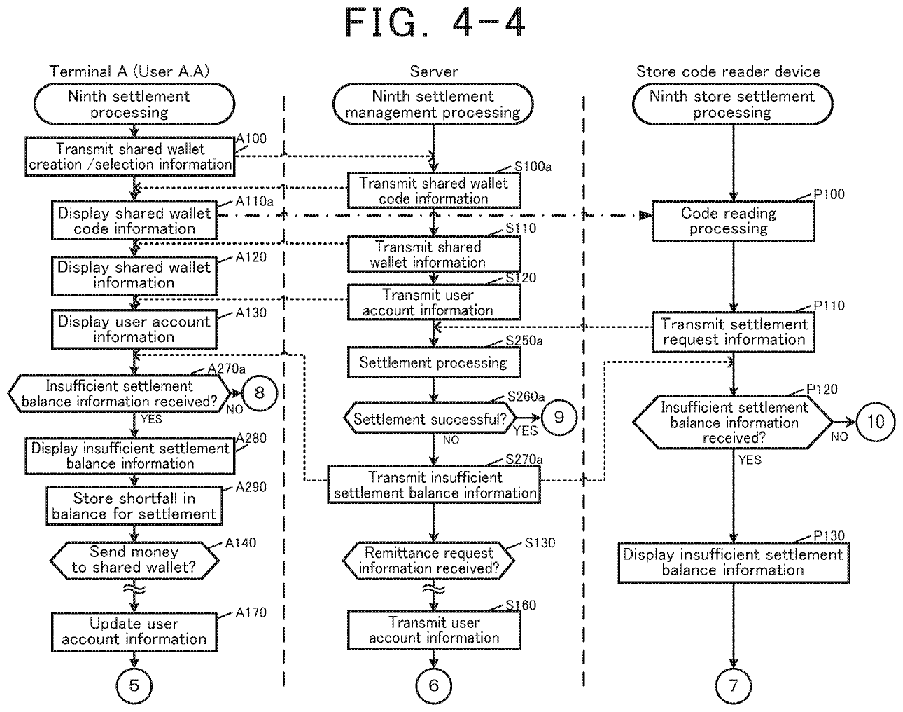

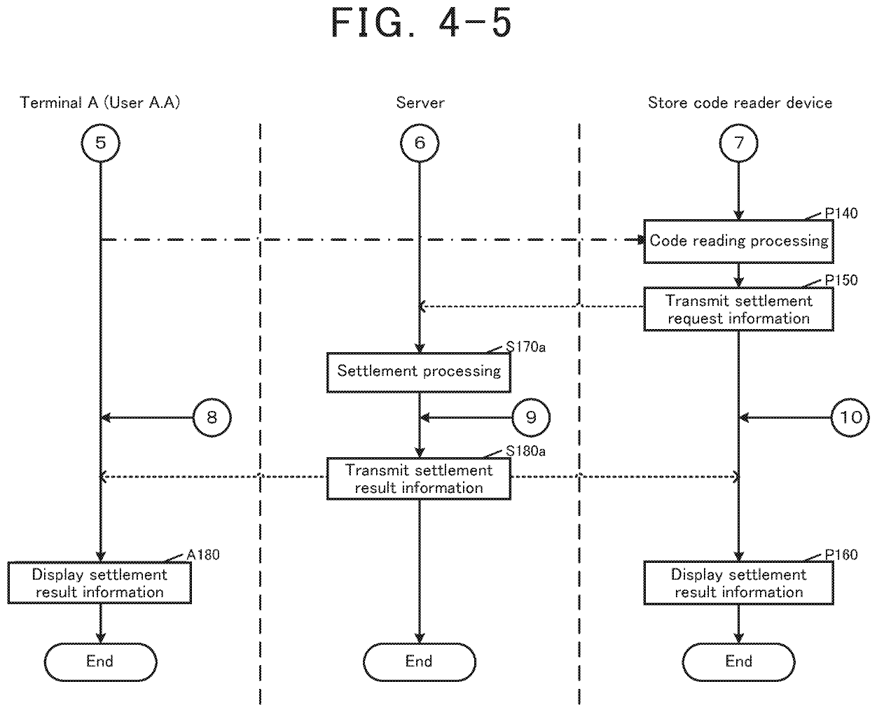

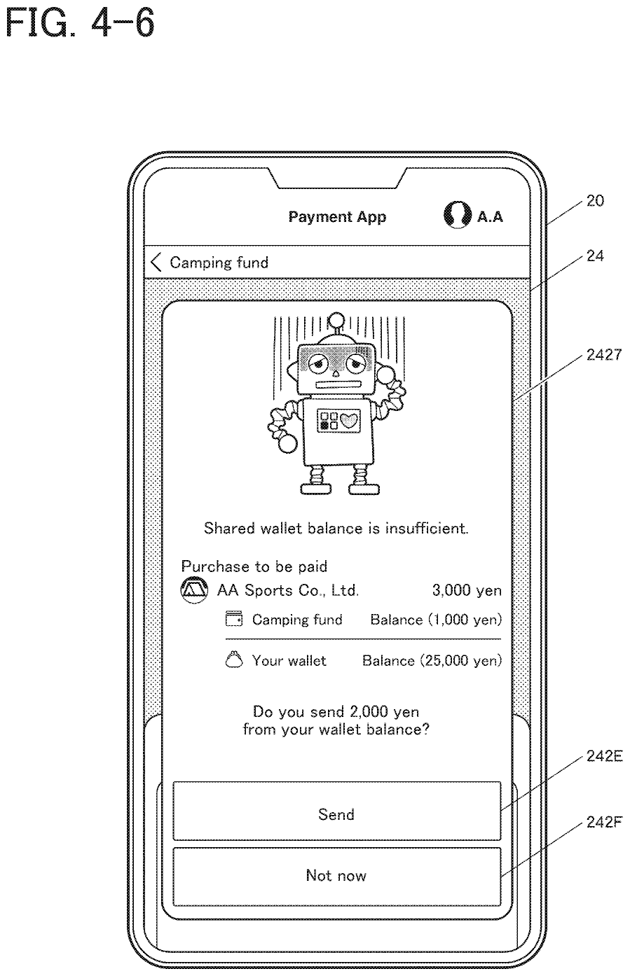

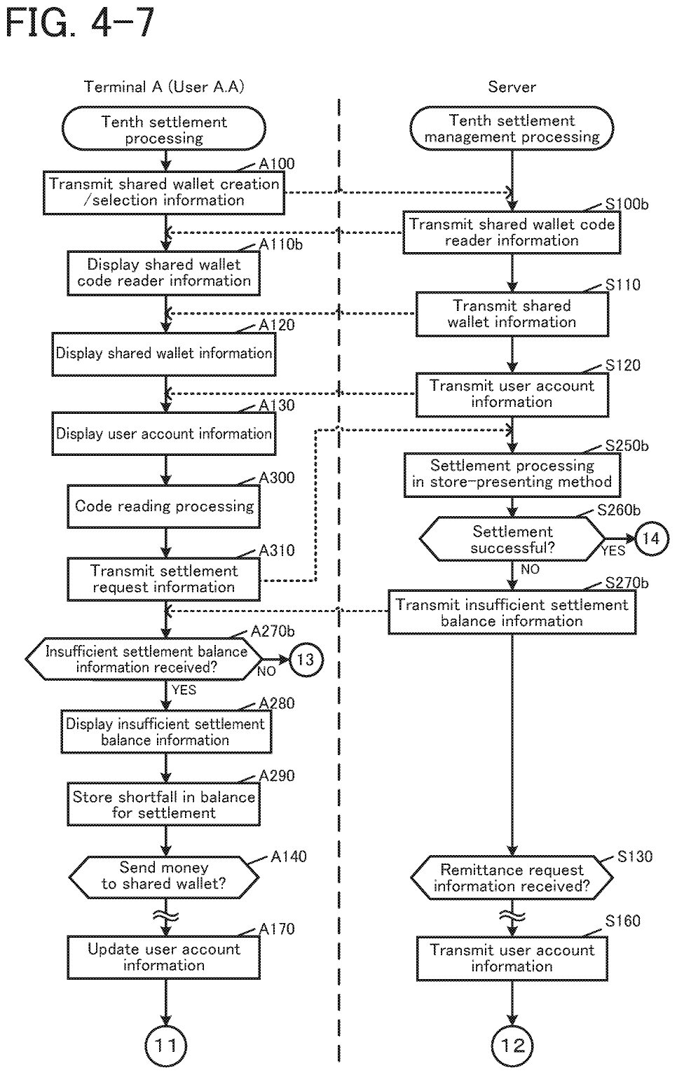

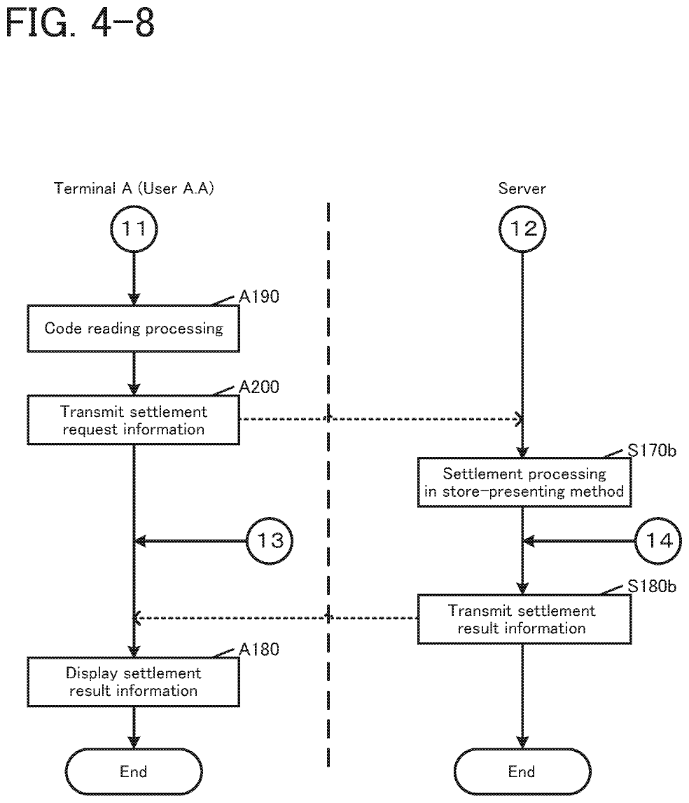

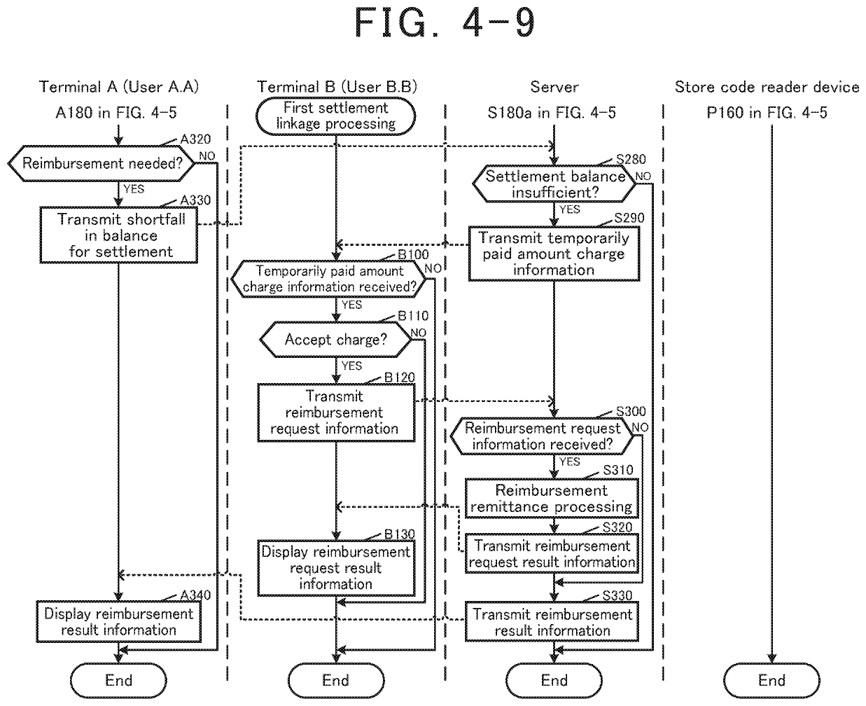

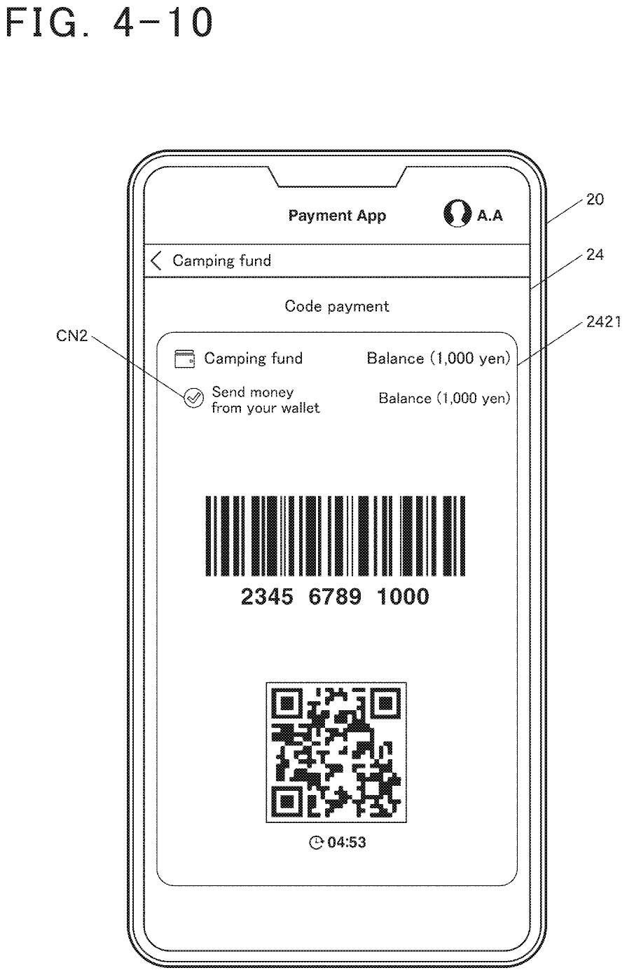

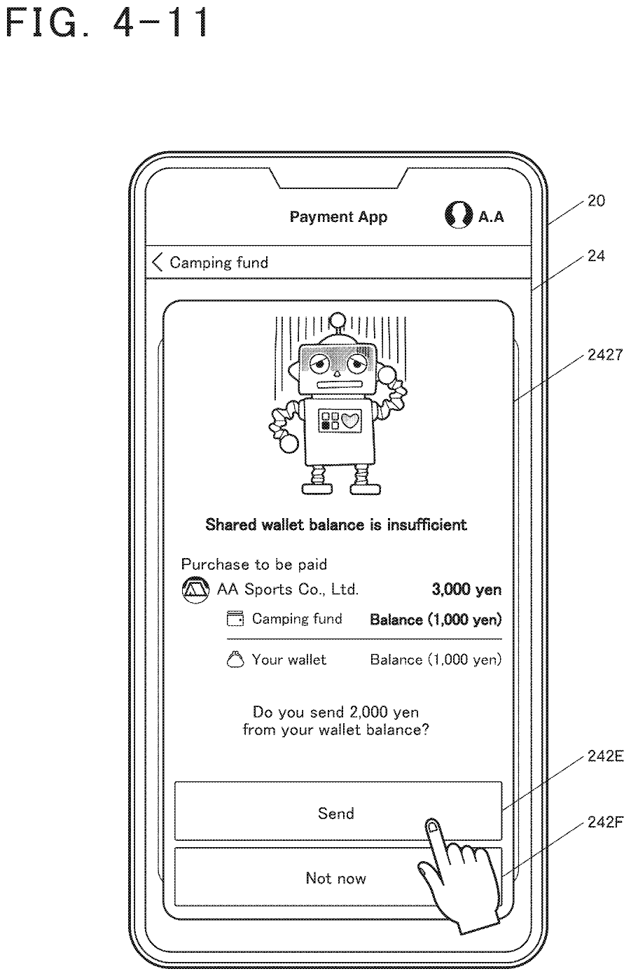

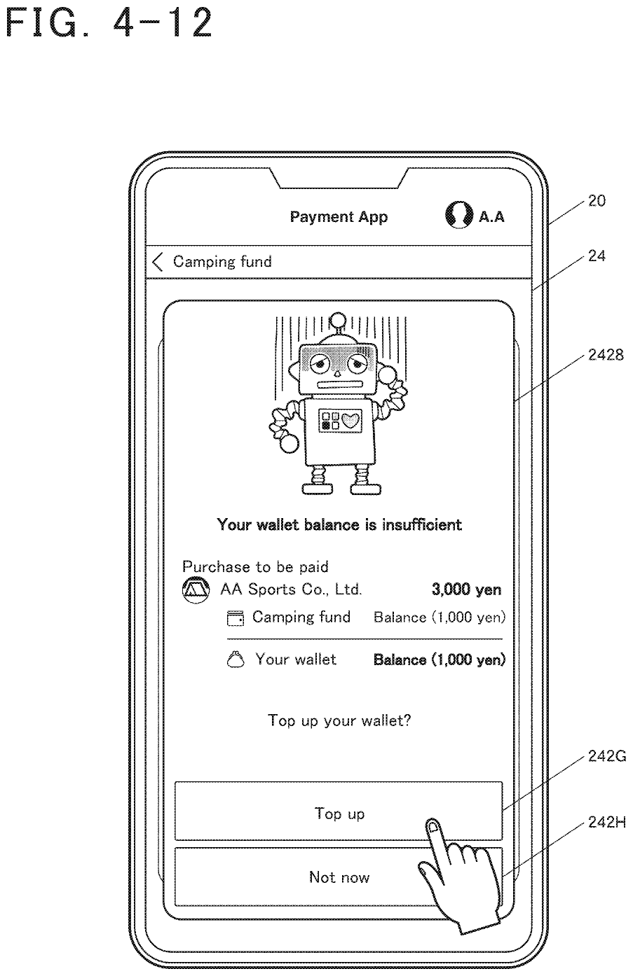

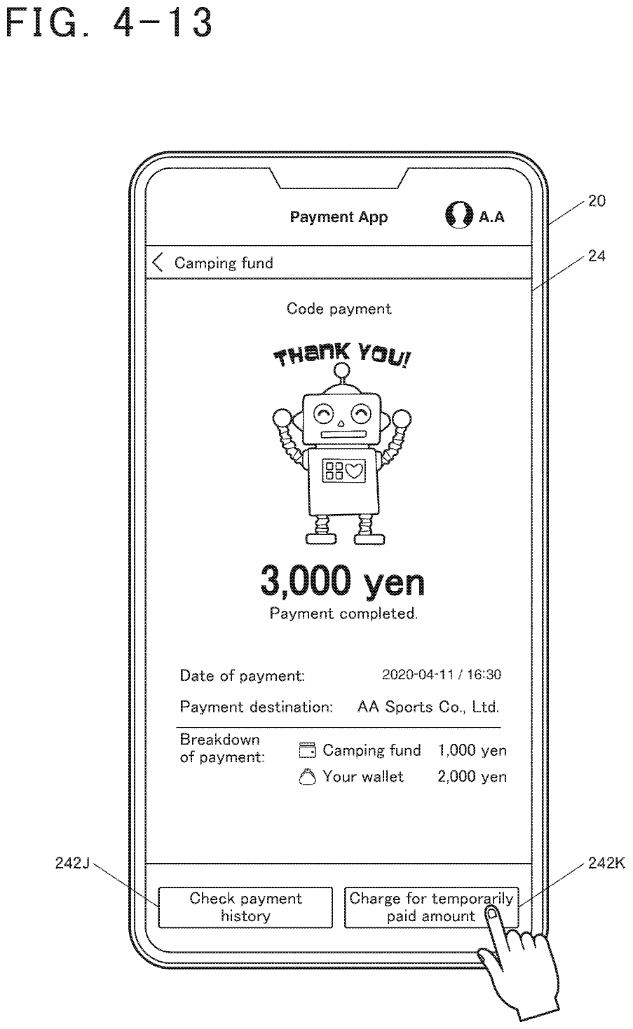

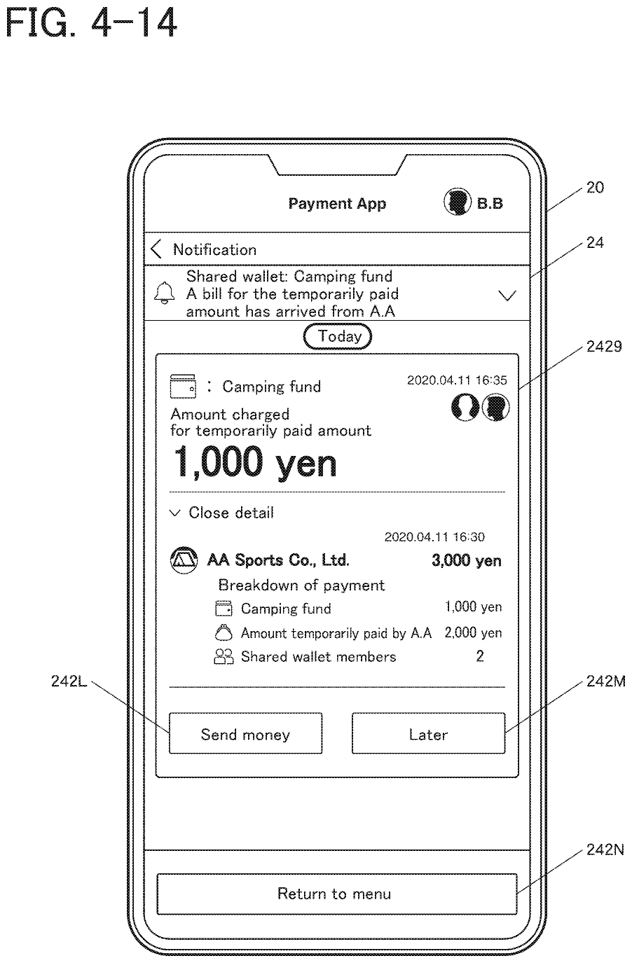

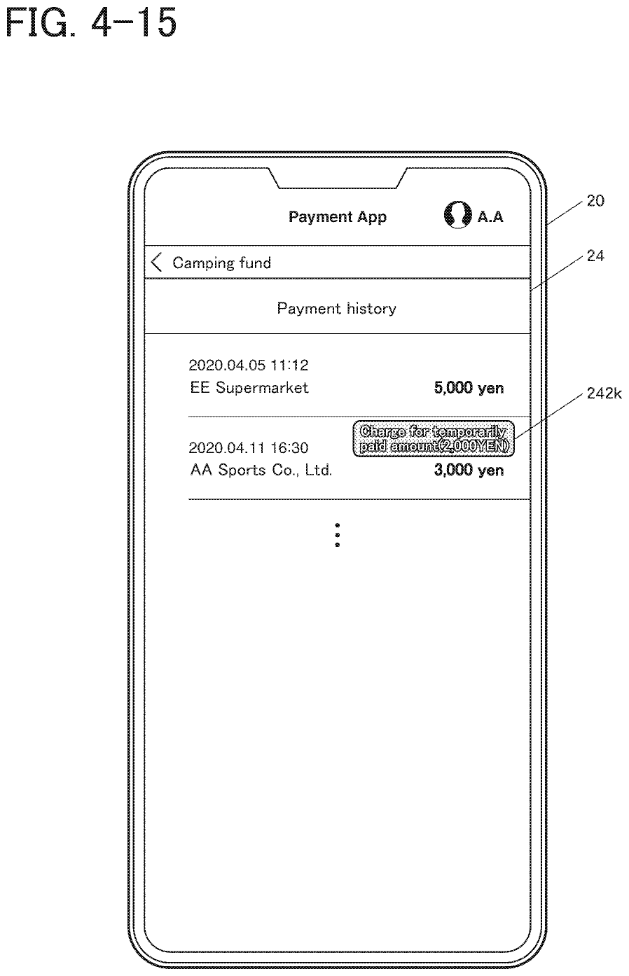

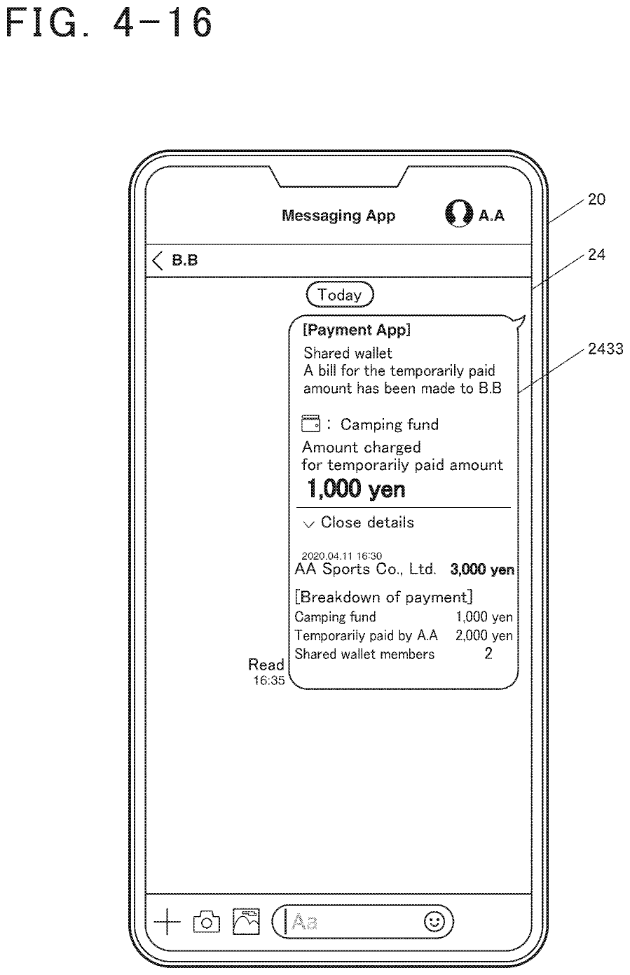

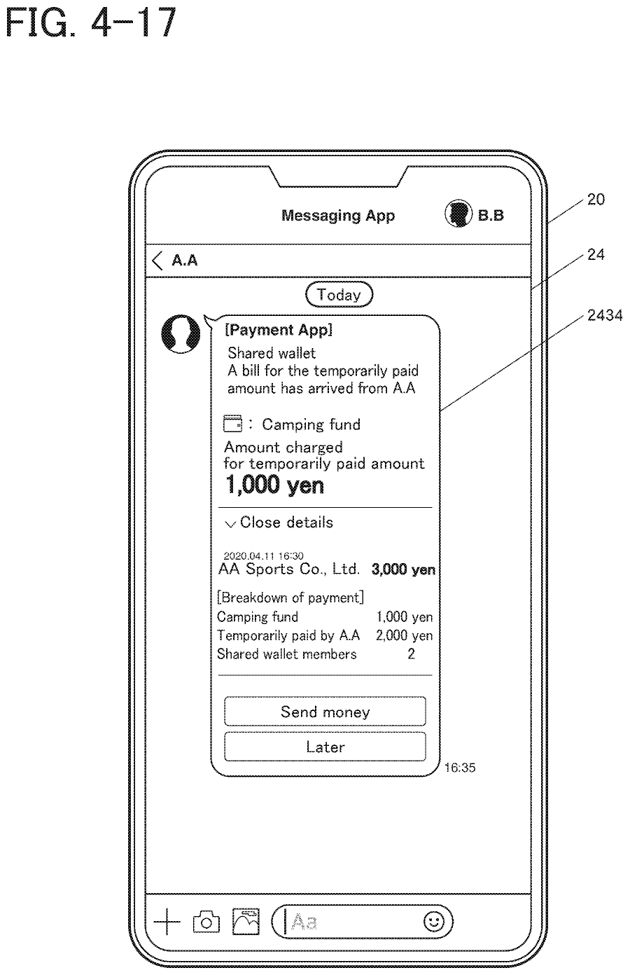

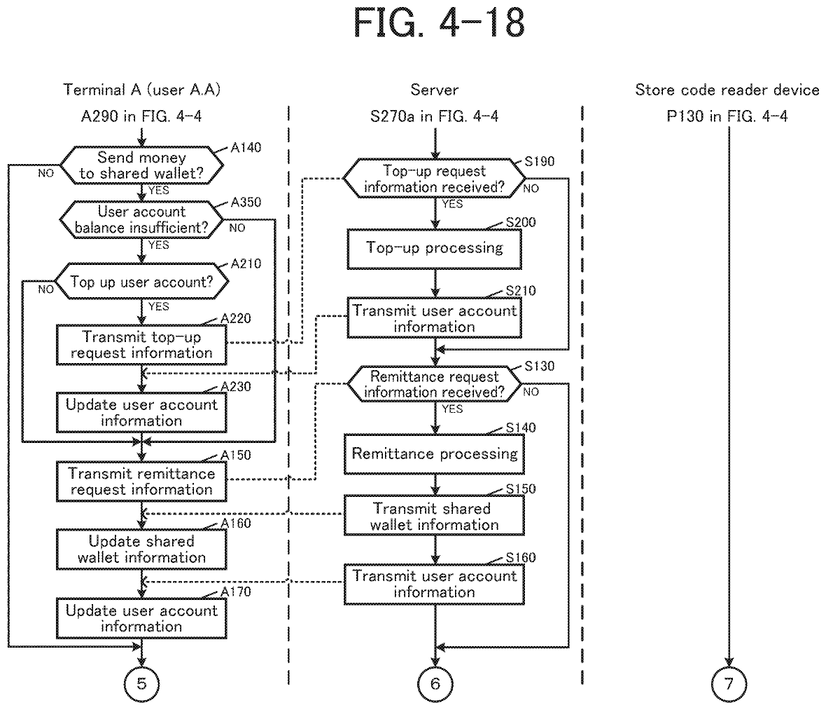

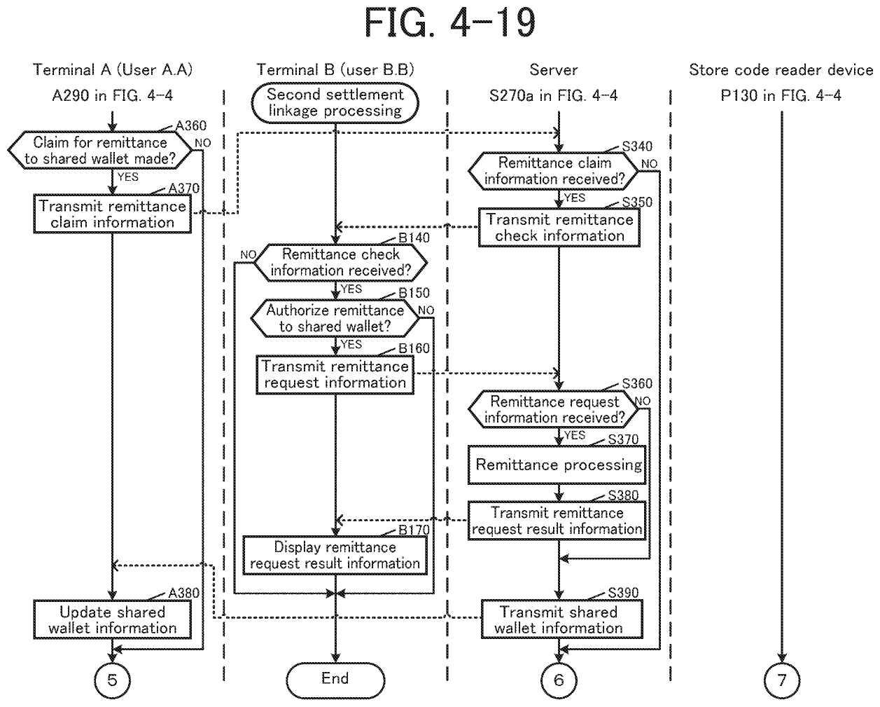

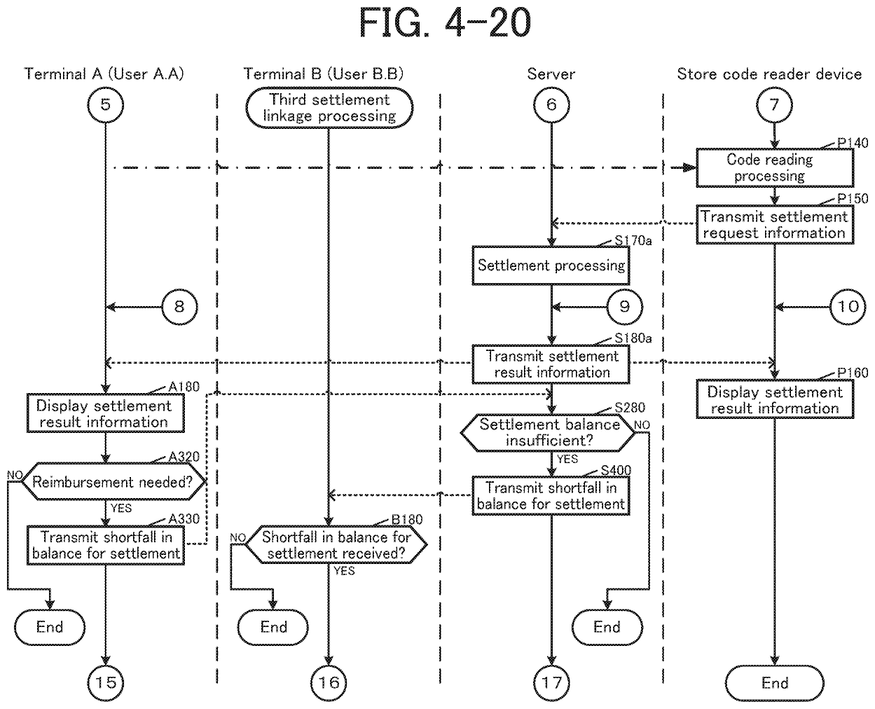

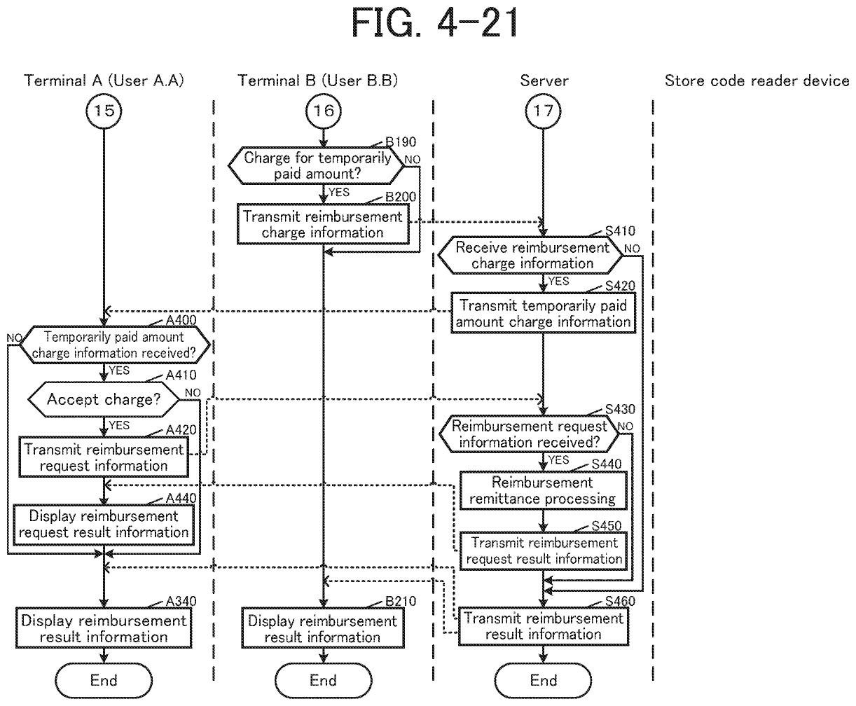

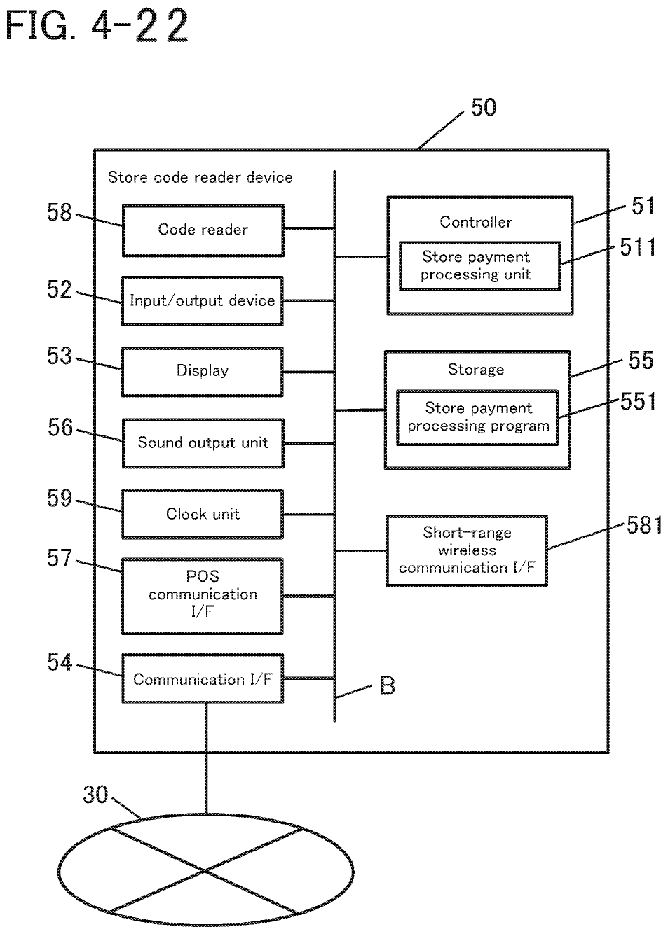

FIG. 3-4 is a diagram showing an example of a code payment screen (before remittance) that is displayed when the icon shown as “code payment” in the camping fund payment screen in FIG. 3-3 is touched by the user A.A of the terminal 20.

In this example, “camping fund”, which is the currently executed item in the submenu, is displayed as a current location in the hierarchical menu of the “Payment App” below the title bar. The “code payment” is displayed as an operation guide for the user below the “camping fund”, and a camping fund code payment region 2421 is displayed below the “code payment”.

In the camping fund code payment region 2421, the shared wallet balance (“1,000 yen” in this example) of this camping fund is displayed together with an image of a wallet and the name (camping fund) of the shared wallet, similarly to the above.

Below that, the text “send money from your wallet” is displayed together with a check mark button CN2 having a check mark in a circle, and the balance (25,000 yen in this example) is displayed next to such text and check mark button. Upon the check mark button CN2 being touched, a remittance screen for sending money from the user's wallet to the shared wallet is displayed.

Below that, a one-dimensional payment code shown as a bar code, for example, without limitation thereto, and a two-dimensional payment code shown as a QR CODE, for example, without limitation thereto, are displayed as payment codes that are codes (code images) transmitted from the server 10 and received by the terminal 20 and that are to be used to carry out settlement in the “user-presenting mode”.

A period within which settlement can be carried out using these payment codes (hereinafter referred to as a “code expiration period”) is determined for these payment codes. In this example, the remaining time of the code expiration period is displayed in a countdown format in association with the payment codes. The code expiration period may be any period, and may be defined as a period of “five minutes”, for example, without limitation thereto.

Note that the code expiration period may be a period in which the payment codes are displayed on the terminal 20 (hereinafter referred to as a “code display period”), and the displayed payment codes may be hidden when the code display period ends.

FIG. 3-5 is a diagram showing an example of a remittance screen that is displayed when the check mark button CN2 in the code payment screen in FIG. 3-4 is touched by the user A.A of the terminal 20.

In this example, “camping fund”, which is the currently executed item in the submenu, is displayed as a current location in the hierarchical menu of the “Payment App” below the title bar. Below the “camping fund”, “send money” is displayed as an operation guide for the user, and the icon image of the user A.A, who is to send money, and the user name “A.A” are displayed below the “send money.

Below that, an amount-to-be-sent input region 2422 for displaying the input amount to be sent is displayed together with the display of “amount to be sent”. Here, a state where “5,000 yen” is input as the amount to be sent is shown. Below that, add buttons for inputting the amount to be added to the amount-to-be-sent input region 2422, which are, here, a first add button BT1 for adding “100 yen”, a second add button BT2 for adding “1,000 yen”, and a third add button BT3 for adding “10,000 yen”, are displayed side by side.

As an example without limitation thereto, if the first add button BT1 is touched once with “5,000 yen” input as the amount to be sent, then “5,100 yen” is displayed in the amount-to-be-sent input region 2422. If the second add button BT2 is subsequently touched once, then “6,100 yen” is displayed. If the third add button BT3 is subsequently touched once, then “16,100 yen” is displayed.

In this example, an erase button CN3 is displayed in a left part of the amount-to-be-sent input region 2422. If the erase button CN3 is touched, the amount in the amount-to-be-sent input region 2422 is erased, and “0 yen” is displayed in the amount-to-be-sent input region 2422.

In this example, the balance (here, “25,000 yen”) in the wallet of the user A.A is displayed below the first add button BT1.

In this example, a remittance button 242A for sending the amount input to the amount-to-be-sent input region 2422 is displayed in a lower part of the remittance screen.

Note that, if the amount-to-be-sent input region 2422 is touched, a numeric-key region for inputting the amount to be sent is displayed in a lower part of the display 24, and the amount to be sent can also be specifically input based on the input to the numeric-key region.

FIG. 3-6 is a diagram showing an example of a code payment screen (after remittance) that is displayed when the remittance button 242A is touched in the remittance screen in FIG. 3-5.

Although the camping fund code payment region 2421 is the same as that in FIG. 3-4, the amount of each balance is difference since the remittance has been carried out. That is, “6,000 yen” is displayed as a shared wallet balance for the camping fund to which the amount sent has been added, and “20,000 yen” is displayed as a user's electronic money account balance from which the amount sent has been subtracted. Further, the check mark button CN2 is highlighted to indicate that remittance has been carried out.

Note that in this example, both payment codes are the same as those in FIG. 3-4.

The user A.A of the terminal 20 presents the aforementioned code payment screen to a clerk of the store at a code register, and make code payment by having the payment codes read by the store code reader device.

FIG. 3-7 is a diagram showing an example of a code payment completion screen that is displayed on the terminal 20 when the code payment is completed by the server 10.

In this code payment completion screen, “camping fund” is displayed as a current location, and “code payment” is displayed at the center below the “camping fund”.

In this example, below that, the text “THanK YOU!” is displayed as a payment completion message, and “an image of a robot putting its hands up with a smiling face” expressing gratitude is displayed below the payment completion message. Further, the text “3,000 yen” is displayed in a large manner as a payment amount below the image of the robot, and the text “Payment completed.” are displayed as a completion notification below “3,000 yen”.

Below that, it is displayed, as payment completion information, that the payment date is “Apr. 11, 2020” and the time of payment is “16:30”. Below that, it is displayed that the payment destination is “AA Sports Co., Ltd.”.

A confirmation button 242B is displayed in a lower part of the code payment completion screen.

### Processing

FIG. 3-8 is a flowchart showing an example flow of processing executed by the devices in the present embodiment. These flowcharts show examples of settlement processing executed by the controller 21 of a terminal A (non-limiting examples of which include the terminal 20 of a user A.A), settlement management processing executed by the controller 11 of the server 10, and store settlement processing executed by the controller 51 of the store code reader device 50, which is an element of a store POS system (non-limiting examples of which include the store POS system 40 at a member store S1), in order from the left. These types of processing are examples of processing relating to code settlement in the user-presenting mode.

Note that the latter half of the processing may be the same as FIG. 1-9, for example, without limitation thereto, and a description thereof is therefore omitted here.

After A130, the controller 21 of the terminal A causes the display 24 to additionally display information (non-limiting examples of which include a button with a selection function) for selecting whether or not to send money from the electronic money account of the user A.A to the shared wallet. The controller 21 of the terminal A then determines whether or not sending money from the electronic money account of the user A.A to the shared wallet is selected, based on a user operation to the input/output device 23 (A140).

If sending money to the shared wallet is selected (A140: YES), the controller 21 of the terminal A causes the display 24 to display a screen (remittance screen) that prompts input of the amount to be sent, for example, without limitation thereto. Upon the amount to be sent being input based on a user operation to the input/output device 23 of the terminal A, the controller 21 of the terminal A transmits remittance request information including the amount to be sent, to the server 10 using the communication I/F 22 (A150).

After S120, upon receiving the remittance request information from the terminal A using the communication I/F 14 (S130: YES), the controller 11 of the server 10 executes remittance processing to send the amount to be sent from the electronic money account of the user A.A to the shared wallet (S140).

The controller 11 of the server 10 then transmits shared wallet information including the shared wallet balance after the remittance to the terminal A using the communication I/F 14 (S150).

Upon receiving the shared wallet information from the server 10 using the communication I/F 22, the controller 21 of the terminal A causes the display 24 to update and display the shared wallet balance, for example, without limitation thereto, based on the received shared wallet information (A160).

The controller 11 of the server 10 also transmits user account information including the electronic money account balance of the user A.A after the remittance, to the terminal A using the communication I/F 14 (S160). Then, the controller 11 of the server 10 advances the processing to S170a in FIG. 1-9.

Upon receiving the user account information from the server 10 using the communication I/F 22, the controller 21 of the terminal A causes the display 24 to update and display the electronic money account balance of the user A.A, for example, without limitation thereto, based on the received user account information (A170). Then, the controller 21 of the terminal A advances the processing to A180 in FIG. 1-9.

Note that if sending money from the electronic money account of the user A.A to the shared wallet is not selected (A140: NO), steps A150 to A170 are not executed. Accordingly, the controller 11 of the server 10 does not receive remittance request information (S130: NO), and steps S140 to S160 are not executed either.

Note that the input to the terminal 20 is not limited to input of operations, as mentioned above.

An example has been described where, in the above processing, whether or not to send money from the user account (electronic money account) of the user of the terminal 20 to the shared wallet is selected based on the input to the input/output device 23 of the terminal 20. However, this need not be the case. This selection may be implemented by, for example, inputting sound (including voice) to the microphone 25 of the terminal 20.

Effects of Third Embodiment

In the third embodiment, the terminal 20 causes the display 24 to display shared wallet code information (a non-limiting example of first code information) associated with an account (a non-limiting example of a first account) with which the user of the terminal 20 can carry out settlement, and user account information (a non-limiting example of second account information) relating to the user account of the user of the terminal 20 (a non-limiting example of a second account). The terminal 20 executes, with use of the controller 21, processing (a non-limiting example of processing relating to first settlement that is based on the first account and the second account) that is executed by the terminal 20 as processing relating to settlement, such as processing for causing the display 24 to display the remittance screen based on the input (input of operations, input using sound etc.) (a non-limiting example of input to the second account information) made by the user of the terminal 20 to select sending money from the electronic money account of the user account of this user to a shared wallet, processing for transmitting remittance request information to the server 10, processing for receiving an updated shared wallet balance from the server 10, processing for causing the display 24 to update and display the received shared wallet balance, processing for receiving the electronic money account balance of the user account from the server 10, processing for causing the display 24 to update and display the received electronic money account balance of the user account, processing for causing the display 24 to display payment codes, processing for receiving settlement result information from the server 10, and processing for causing the display 24 to display the received settlement result information.

As an example of the effect achieved by this configuration, it is possible to display the first code information associated with the first account with which the user of the terminal can carry out settlement in the display region of the terminal and have the displayed first code information used for settlement, and it is also possible to make the user of the terminal recognize the second account information relating to the second account different from the first account. Further, settlement that is based on the first and second accounts can be implemented based on input to the second account information.

The third embodiment has described a configuration in which the aforementioned account with which the user of the terminal 20 can carry out settlement is a shared account with which at least the user of the terminal 20 (an example of which is the user A.A) (a non-limiting example of a user of a terminal) and a user of another terminal 20 (an example of which is the user B.B) (a non-limiting example of a first user different from the user of the terminal) can carry out settlement.

As an example of the effect achieved by this configuration, it is possible to display the first code information in the display region of the terminal and have the displayed first code information used for settlement, and it is also possible to make the user of the terminal recognize the second account information relating to the second account different from the shared account. Further, settlement that is based on the shared account and the second account can be implemented based on input to the second account information.

In the third embodiment, the terminal 20 causes the display 24 to display information regarding the shared wallet balance (a non-limiting example of an amount of first electronic money associated with a shared account) and a remittance screen (a non-limiting example of a first indication for sending money from a second account to the shared account). The terminal 20 has a configuration in which remittance from the user account of the user of the terminal 20 to the shared account is implemented based on input (input of operations, input using sound etc.) to the remittance screen that is made by the user of the terminal 20, and information regarding the shared wallet balance after the remittance (a non-limiting example of an amount of second electronic money associated with the shared account) is displayed in the display 24 based on the remittance to the shared account.

As an example of the effect achieved by this configuration, the user of the terminal can be notified of the amount of the first electronic money associated with the shared account. It is also possible to easily implement remittance from the second account to the shared account based on input to the first indication, and notify the user of the terminal of the amount of the second electronic money associated with the shared account based on the remittance to the shared account.

The third embodiment has described a configuration in which processing relating to the first settlement is executed based on the shared account to which money has been sent from the user account of the user of the terminal 20 (a non-limiting example of the second account).

As an example of the effect achieved by this configuration, settlement can be implemented based on the shared account to which money has been sent from the second account.

The third embodiment describes a configuration in which the input to the remittance screen (a non-limiting example of input to the first indication) includes input of the amount to be sent from the user account of the user of the terminal 20 (a non-limiting example of the second account) to the shared account.

As an example of the effect achieved by this configuration, remittance from the second account to the shared account can be implemented based on the input of the amount to be sent from the second account to the shared account.

The third embodiment describes a configuration in which the second account is the user account of the user of the terminal 20 (a non-limiting example of an account of the user of the terminal).

As an example of the effect achieved by this configuration, settlement can be implemented using the account of the user of the terminal as the second account.

### Third Embodiment Variation (1)

The third embodiment has described code settlement in the user-presenting mode, but this need not be the case.

Specifically, code settlement in the store-presenting mode can also be applied, for example, without limitation thereto.

Example Display Screen

FIG. 3-9 is a diagram showing an example of a code reader screen displayed in the display 24 of the terminal 20.

If the “code reader” icon, rather than the “code payment” icon, is touched in the camping fund payment screen in FIG. 3-3 by the user A.A of the terminal 20, the application code reader is started, and a code reader screen for reading a payment store code, such as that shown in FIG. 3-9, is displayed in the display 24, for example, without limitation thereto.

In this code reader screen, “camping fund”, which is the currently executed item in the submenu, is displayed as a current location in the hierarchical menu of “Payment app” below the title bar.

Below the “camping fund”, a code reading region CR1 is displayed, and “code reader” is displayed as an operation guide for the user below the code reading region CR1, and a camping fund code payment region 2423 is displayed below the “code reader”.

In the camping fund code payment region 2423, the text “camping fund” is displayed in an upper part together with an image of a wallet, which indicates a shared wallet, and the shared wallet balance (“1,000 yen” in this example) of this camping fund is displayed next to such text and the image. Below that, the user's electronic money account balance (“25,000 yen” in this example) is displayed together with a check mark button CN2 and the text “send money from your wallet”.

Here, if the check mark button CN2 in the code reader screen in FIG. 3-9 is touched by the user A.A of the terminal 20, the same remittance screen as that in FIG. 3-5 is displayed. In this example, the user A.A sends “5,000 yen” from his wallet to the shared wallet in the remittance screen.

FIG. 3-10 is a diagram showing an example of a reading completion screen that is displayed when the remittance button 242A is touched in the remittance screen in FIG. 3-5, remittance from the user's wallet to the camping fund is completed, and then reading of the payment store code is completed.

The read payment store code is displayed in this code reading region CR1. In the camping fund code payment region 2423, “6,000 yen” is displayed as a shared wallet balance of the camping fund, and “20,000 yen” is displayed as a user's electronic money account balance, based on the user A.A having sent “5,000 yen” from his wallet to the shared wallet as mentioned above. Further, the check mark button CN2 is highlighted to indicate that remittance has been carried out.

FIG. 3-11 is a diagram showing an example of a payment amount input screen that is displayed when information is acquired by decoding the payment store code read in the reading completion screen in FIG. 3-10.

In this payment amount input screen, “input payment amount” is displayed as an operation guide for the user. Below that, the name “AA Sports Co., Ltd.” of the destination to which the payment amount is to be sent is displayed together with an icon image thereof. Below that, a payment amount display region 2424 for displaying the input payment amount is displayed, and here, “3,000 yen” is input and displayed as a payment amount. Below that, the text “input payment amount (tax included)” is displayed, and a payment button 242C is displayed below the text.

On the lower side of the screen, a keyboard for inputting the payment amount is displayed, and an erase button CN4 for erasing the payment amount is also displayed.

If the payment button 242C for executing payment is touched in the payment amount input screen shown in FIG. 3-11 and code payment is completed, the code payment completion screen is displayed, similarly to FIG. 3-7.

### Processing

FIG. 3-12 is a flowchart showing an example flow of processing executed by the devices in this variation. These flowcharts show examples of settlement processing executed by the controller 21 of the terminal A (non-limiting examples of which include the terminal 20 of the user A.A) and settlement management processing executed by the controller 11 of the server 10, in order from the left.

Note that the latter half of the processing may be the same as FIG. 1-11, for example, without limitation thereto, and a description thereof is therefore omitted here.

The shared wallet payment token is generated similarly to S100a in FIG. 3-8, and the controller 11 of the server 10 generates shared wallet code reader information, which is code reading information including the shared wallet payment token. The controller 11 of the server 10 then transmits the shared wallet code reader information to the terminal A using the communication I/F 14 (S100b). Then, the controller 11 of the server 10 advances the processing to S110.

After A100, upon receiving the shared wallet code reader information from the server 10 using the communication I/F 22, the controller 21 of the terminal A causes the display 24 to display a code reader screen for reading a payment store code, based on the received shared wallet code reader information. The controller 21 of the terminal A also activates the camera 27 to read the code (A110b). The controller 21 of the terminal A then advances the processing to A120.

After A170, upon reading the payment store code presented at the member store using the camera 27 or the like, the controller 21 of the terminal A acquires a store ID from the read payment store code (A190).

Thereafter, the controller 21 of the terminal A causes the display 24 to display a display screen for inputting the amount to be settled. Upon the amount to be settled being input based on a user operation to the input/output device 23 of the terminal A, the controller 21 transmits settlement request information including the shared wallet payment token included in the shared wallet code reader information, the store ID, and the amount to be settled, for example, without limitation thereto, to the server 10 using the communication I/F 22 (A200). The controller 21 of the terminal A then advances the processing to A180.

Note that if the amount to be settled is included in the payment store code, the input of the amount to be settled to the terminal A can be omitted.

After S160, upon receiving the settlement request information from the terminal A using the communication I/F 14, the controller 11 of the server 10 retrieves the shared wallet ID using the shared wallet payment token with which the request has been received, and executes, for the shared wallet, settlement processing to make payment of the amount to be settled to the member store defined by the store ID (S170b).

Thereafter, the controller 11 of the server 10 transmits settlement result information including the settlement processing result and the shared wallet balance after the settlement processing, for example, without limitation thereto, to the terminal A using the communication I/F 14 (S180b). Then, the controller 11 ends the processing.

In this variation, the terminal 20 causes the display 24 to display a code reader screen (a non-limiting example of first code reader information) for reading the payment store code (a non-limiting example of code information) that is based on the shared wallet code reader information, and user account information (a non-limiting example of second account information) relating to the user account of the user of the terminal 20 (a non-limiting example of second account). The terminal 20 executes, with use of the controller 21, processing that is executed by the terminal 20 as processing relating to settlement (a non-limiting example of processing relating to first settlement that is based on the first account and the second account), such as processing for causing the display 24 to display the remittance screen based on the input (input of operations, input using sound etc.) (a non-limiting example of input to the second account information) made by the user of the terminal 20 to select sending money from the electronic money account of the user account of this user to a shared wallet, processing for transmitting remittance request information to the server 10, processing for receiving a shared wallet balance from the server 10, processing for causing the display 24 to update and display the received shared wallet balance, processing for receiving the electronic money account balance of the user account from the server 10, processing for causing the display 24 to update and display the received electronic money account balance of the user account, processing for reading the payment store code, processing for transmitting settlement request information to the server 10, processing for receiving settlement result information from the server 10, and processing for causing the display 24 to display the received settlement result information.

As an example of the effect achieved by this configuration, it is possible to display the first code reader information, which is an indication relating to reading of the code information, in the display region of the terminal and have the displayed first code reader information used for settlement, and it is also possible to make the user of the terminal recognize the second account information relating to the second account different from the first account. Further, settlement that is based on the first and second accounts can be implemented based on input to the second account information.

### Third Embodiment Variation (2)

The third embodiment has described an example of sending money from the electronic money account balance of the user A.A to a shared wallet at the beginning of payment, but this need not be the case.

The electronic money account of the user A.A may be topped up (i.e., money may be sent thereto) from an account of an external financial institution that is registered in advance by the user A.A, before sending money to the shared wallet, for example, without limitation thereto.

### Example Display Screen

FIG. 3-13 is a diagram showing an example of a code payment screen (before remittance) that is displayed when the “code payment” icon in the camping fund payment screen in FIG. 3-3 is touched by the user A.A of the terminal 20.

The indication in the camping fund code payment region 2421 is almost the same as that in FIG. 3-4, but is partially different. Specifically, a top-up button CN5 for topping up the user's electronic money account is displayed next to the amount of the user's electronic money account balance associated with “send money from your wallet”, for example, without limitation thereto. In this example, “1,000 yen” is displayed as a user's electronic money account balance.

Below that, the text “top up shared wallet” is displayed together with the check mark button CN2 as an indication for topping up the shared wallet.

FIG. 3-14 is a diagram showing an example of a top-up screen that is displayed when the top-up button CN5 is touched in the code payment screen (before top-up) in FIG. 3-13.

Below the title bar, “your wallet”, which is the currently executed item in the submenu, is displayed as a current location in the hierarchical menu of the “Payment App”. Below the “your wallet”, “top-up” is displayed as an operation guide for the user, and a bank account display region 2425 is provided below the “top-up”.

In this example, a bank name “OX Bank” is displayed together with a logo of the “OX Bank” (OX BANK) in the bank account display region 2425. Below that, “savings account *******” is displayed as a deposit type and account number, and “A.A”, which is the account holder, is displayed below the deposit type and account number.

Below the bank account display region 2425, a top-up amount input region 2426 for displaying the input amount to be topped up is provided together with an indication of “top-up amount”. Here, “24,000 yen” is input and displayed as an amount to be topped up.

Below that, top-up buttons for inputting the amount to be topped up to the top-up amount input region 2426, namely a first top-up button BT5 for topping up “100 yen”, a second top-up button BT6 for topping up “1,000 yen”, and a third top-up button BT7 for topping up “10,000 yen” are displayed side by side in this example.

In this example, if the first top-up button BT5 is touched, “24,100 yen” is displayed in the top-up amount input region 2426. If the second top-up button BT6 is subsequently touched, then “25,100 yen” is displayed. If the third top-up button BT7 is subsequently touched, then “35,100 yen” is displayed.

Note that an erase button BT8 is displayed in a left part of the top-up amount input region 2426. If the erase button BT8 is touched, the amount in the top-up amount input region 2426 is erased, and “0 yen” is displayed in the top-up amount input region 2426.

A top-up button 242D for topping up the amount input to the top-up amount input region 2426 is displayed in a lower part of the top-up screen. If the top-up button 242D is touched, “24,000 yen” is topped up to the user's wallet.

Note that if the top-up amount input region 2426 is touched, a numeric-key region for inputting the amount to be sent is displayed in a lower part of the display 24, and the amount to be sent can also be specifically input based on the input to the numeric-key region.

FIG. 3-15 is a diagram showing an example of a code payment screen that is displayed when the top-up button 242D is touched in the top-up screen in FIG. 3-14.

The camping fund code payment region 2421 is the same as that in FIG. 3-13, but the amount (“25,000 yen” in this example) of the balance displayed next to the text “send money from your wallet” is different since the topping up has been carried out.

Note that in this example, both payment codes are the same as those in FIG. 3-13.

As mentioned above, after the check mark button CN2 corresponding to “send money from your wallet” is touched, and remittance to the camping fund is carried out, the user A.A of the terminal 20 presents the aforementioned code payment screen to a clerk of the store at a code register, and makes code payment by having the payment codes read by the store code reader device. Upon the settlement processing being completed by the server 10, the same code payment completion screen as that in FIG. 3-7 is displayed.

### Processing

FIG. 3-16 is a flowchart showing an example flow of processing executed by the devices in this variation. These flowcharts show examples of settlement processing executed by the controller 21 of the terminal A (non-limiting examples of which include the terminal 20 of the user A.A) and settlement management processing executed by the controller 11 of the server 10, in order from the left.

After A130, the controller 21 of the terminal A causes the display 24 to display a screen for selecting whether or not to top up the electronic money account of the user A.A, for example, without limitation thereto. The controller 21 of the terminal A then determines whether or not topping up the electronic money account of the user A.A is selected, based on a user operation to the input/output device 23 of the terminal A (A210).

If topping up the electronic money account of the user A.A is selected (A210: YES), the controller 21 of the terminal A causes the display 24 to display a screen that prompts input of the top-up amount. Upon the top-up amount being input based on a user operation to the input/output device 23 of the terminal A, the controller 21 of the terminal A transmits top-up request information including the top-up amount, to the server 10 using the communication I/F 22 (A220).

After S120, upon receiving the top-up request information from the terminal A using the communication I/F 14 (S190: YES), the controller 11 of the server 10 executes top-up processing to reduce the account balance of the external financial institution of the user A.A by the top-up amount and increase the electronic money account balance of the user A.A by the top-up amount (S200).

Thereafter, the controller 11 of the server 10 transmits user account information including the electronic money account balance of the user A.A after the top-up processing to the terminal A using the communication I/F 14 (S210).

Note that if, in the processing in S200, the topping up is not successfully performed due to, for example, the account balance of the external financial institution of the user A.A falling below the top-up amount, user account information including a message indicating the topping up failure may be transmitted.

Upon receiving the user account information from the server 10 using the communication I/F 22, the controller 21 of the terminal A causes the display 24 to update and display the electronic money account balance of the user A.A of the terminal A, for example, without limitation thereto, based on the received user account information (A230).

On the other hand, if topping up the electronic money of the user A.A is not selected (A210: NO), steps A220 to A230 are not executed. Accordingly, the controller 11 of the server 10 does not receive the top-up request information (S190: NO), and steps S200 to S210 are not executed either.

Note that, after the processing for remittance to the shared wallet (A170 and S160 in FIG. 3-16), electronic money may be topped up to the electronic money account of the user A.A by executing steps A210 to A230 and steps S190 to S210.

Third Embodiment Variation (3)

The third embodiment has described an example of sending money from the electronic money account balance of the user A.A at the point of settlement processing to the shared wallet, but this need not be the case.

Money may be topped up (sent) as electronic money from an account of an external financial institution that is registered in advance by the user A.A to the shared wallet before the remittance to the shared wallet, for example, without limitation thereto.

FIG. 3-17 is a flowchart showing an example flow of processing executed by the devices in this variation. These flowcharts show examples of settlement processing executed by the controller 21 of the terminal A (non-limiting examples of which include the terminal 20 of the user A.A) and settlement management processing executed by the controller 11 of the server 10, in order from the left.

After A130, the controller 21 of the terminal A causes the display 24 to display a screen for selecting whether or not to top up the shared wallet, for example, without limitation thereto. The controller 21 of the terminal A then determines whether or not topping up the shared wallet is selected, based on a user operation to the input/output device 23 of the terminal A (A240).

If topping up the shared wallet is selected (A240: YES), the controller 21 of the terminal A causes the display 24 to display a screen that prompts input of the amount to be topped up to the shared wallet. Upon the amount to be topped up to the shared wallet being input based on a user operation to the input/output device 23 of the terminal A, the controller 21 of the terminal A transmits shared wallet top-up request information including the amount to be topped up to the shared wallet, to the server 10 using the communication I/F 22 (A250).

After S120, upon receiving the shared wallet top-up request information from the terminal A using the communication I/F 14 (S220: YES), the controller 11 of the server 10 executes shared wallet top-up processing to reduce the account balance of the external financial institution of the user A.A by the top-up amount to the shared wallet, and increase the shared wallet balance by the top-up amount to the shared wallet (S230).

Thereafter, the controller 11 of the server 10 transmits the shared wallet information including the shared wallet balance after the shared wallet top-up processing to the terminal A using the communication I/F 14 (S240).

Note that if, in the processing in S230, the topping up is not successfully performed due to, for example, the account balance of the external financial institution of the user A.A falling below the amount to be topped up to the shared wallet, shared wallet information including a message indicating the topping up failure may be transmitted.

Upon receiving the shared wallet information from the server 10 using the communication I/F 22, the controller 21 of the terminal A causes the display 24 to update and display the shared wallet balance, for example, without limitation thereto, based on the received shared wallet information (A260).

On the other hand, if topping up electronic money to the shared wallet is not selected (A240: NO), steps A250 to A260 are not executed. Accordingly, the controller 11 of the server 10 does not receive the shared wallet top-up request information (S220: NO), and steps S230 to S240 are not executed either.

Note that, after the processing for remittance to the shared wallet (A170 and S160 in FIG. 3-17), electronic money may be topped up to the shared wallet by executing steps A240 to A260 and steps S220 to S240.

Third Embodiment Variation (4)

In the third embodiment, the terminal 20 may have money sent to a shared wallet by, for example, transmitting information for making a request for remittance to the shared wallet to a terminal 20 of a shared wallet member other than the user of the own terminal 20.

FIG. 3-18 is a diagram showing an example of a code payment screen displayed in the display 24 of the terminal 20 in this variation, and shows an example of a screen displayed in the display 24 of the terminal 20 (terminal A) of the user A.A.

This code payment screen is a code payment screen corresponding to a shared wallet for travel to South Korea. An item: “remittance request to other members” for requesting other shared wallet members to send money to the shared wallet is provided in addition to the aforementioned item: “send money from your wallet” for sending money from the user's wallet to the shared wallet and the item: “top up shared wallet” for topping up the shared wallet, in the South Korea travel display region 2431, which is a display region for the shared wallet for travel to South Korea. Check mark buttons CN2 for executing processing corresponding to the respective items are also provided in association with these items.

FIG. 3-19 is an example of a member selection screen that is displayed in the display 24 when the check mark button CN2 associated with the item of the remittance request to other members is touched in the code payment screen in FIG. 3-18.

This member selection screen is a screen for selecting a shared wallet member (remittance request destination) to request remittance, and candidates of the shared wallet members are listed at the screen center. In this example, two users, namely users D.D and E.E are displayed as shared wallet members of the shared wallet for travel to South Korea other than the user (user A.A) of the terminal 20, together with icon images and user names.

Check mark buttons CN2 are displayed in association with the respective shared wallet members, and a shared wallet member can be selected as a remittance request destination by turning ON the corresponding check mark button CN2.

In this case, it is possible to select not only one but also two or more (including all) shared wallet members as remittance request destinations.

In a lower part of the screen, a remittance request button 242U shown as “remittance request” for executing a remittance request and a return button 242V shown as “return” for returning to the previous screen are displayed.

The remittance request button 242U is grayed out, for example, without limitation thereto, when all the check mark buttons CN2 are OFF, and is unable to accept an operation. When at least one of the check mark buttons CN2 turns ON, the gray-out is canceled, and the remittance request button 242U can then accept an operation.

Note that, unlike this example, a user to be a remittance request destination can alternatively be selected based on a selection of a chat-room including at least the user of the terminal 20 and other shared wallet members.

The following description will take an example of a talk-room in a messaging application. A talk using a messaging application is an example of a “chat”, and a talk-room is an example of a “chat-room”.

The “chat” is a means for communication between users of terminals 20 using a data communication line on a computer network, and the “chat-room” is a virtual room for carrying out this chat. The “chat” includes chats using messaging services (MS: including an instant messaging service (IMS)) or a social networking service (SNS). Also, the “chat” may also include chats using a short message service, for example, without limitation thereto.

In the present specification, the “chat” includes a talk using a messaging service, and the “chat-room” includes a talk-room for talking. The “talk-room” includes talk-rooms for users to talk one-on-one, and group talk-rooms for a group of users that is formed in the messaging service to talk.

FIG. 3-20 is a diagram showing an example of a configuration of the server 10 in this variation.

The server 10 includes a payment management server 10A and a messaging management server 10B, for example, without limitation thereto.

The payment management server 10A is a server that provides a payment service (an application server of a payment application).

The messaging management server 10B is a server that provides a messaging service (MS) (an application server of a messaging application).

Note that the payment application may be provided by the server 10 as an independent application that does not have a messaging service function, as in the above embodiment, or may alternatively be provided by the server 10 as a multi-function application having a messaging service function, as in this variation.

Also, the messaging service may include an instant messaging service (IMS) that enables transmission and reception of content such as simple messages between terminals 20.

In the description of this variation, the messaging management server 10B provides an IMS as a messaging service, for example, without limitation thereto.

Also, in the following description, a multi-function application including a messaging application and a payment application is used, and information regarding a user of the messaging application and information of a user of the payment application is managed as shared information by the server 10.

Also, the messaging application is appropriately referred to as “Messaging App” in the following description and is shown as such in the drawings.

FIG. 3-21 is a diagram showing an example of a member selection screen (talk-room selection screen) in the messaging application executed on the terminal A of the user A.A in this case.

Upon a check mark button CN2 associated with an item of a remittance request to be made to another member being touched in the code payment screen in FIG. 3-18, the payment application screen transitions to a messaging application screen, and this member selection screen is displayed, for example, without limitation thereto.

In this member selection screen, the text “Messaging App” is displayed in an upper part of the screen, and an icon image and a user name of the user (user A.A in this example) of the terminal 20 are displayed next to the text “Messaging App”.

Also, the text “select a talk-room you would like to make a remittance request to” is displayed together with the text “select from talk-rooms”, and candidates of the talk-room to be selected as a remittance request destination are displayed below such text.

Specifically, a talk-room of a user D.D, who is a shared wallet member, and a talk-room of a user E.E, who is also a shared wallet member, are displayed as talk-rooms for the user A.A to talk with users who are registered as friends of the user A.A in the messaging application and are associated with the shared wallet for travel to South Korea, for example, without limitation thereto.

In addition, in this example, a group talk-room of “Korean gourmet union (3)”, which includes three people including the users A.A, D.D, and E.E, for example, without limitation thereto, is displayed as a group talk-room for the user A.A to talk in a group with users who are registered as friends of the user A.A in the messaging application and are associated with the shared wallet for travel to South Korea, for example, without limitation thereto.

Check mark buttons CN2 are displayed in association with the respective talk-rooms, and a talk-room (the user of this talk-room) corresponding to any of the check mark buttons CN2 can be selected as a remittance request destination by turning ON the check mark button CN2.

In this case, not only one but also two or more (including all) of the users can be selected as remittance request destination(s), for example, without limitation thereto.

Note that a configuration is possible in which group talk-rooms are not displayed as candidate remittance request destinations in the aforementioned member selection screen in the messaging application. Also, talk-rooms of all users who are registered as friends of the user A.A in the messaging application, users who are the shared wallet member with the user A.A in the payment application, and users who are selected and set in advance by the user A.A, for example, may be displayed as candidate remittance request destinations.

In this variation, a second account is a user account (a non-limiting example of a first user's account) of a shared wallet member (a non-limiting example of an account of a first user) other than the user of the own terminal 20.

As an example of the effect achieved by this configuration, it is possible to implement settlement that is based on the shared account and the second account, which is the account of the first user.

Further, in this variation, a user account of another shared wallet member is selected based on input to the user's terminal 20 performed by the user of this terminal 20.

As an example of the effect achieved by this configuration, the second account can be easily selected based on the input to the terminal performed by the user of the terminal.

Further, in this variation, a user account of another shared wallet member is selected based on selection of a talk-room (a non-limiting example of a chat-room) that includes the user of the terminal 20 and other shared wallet members.

As an example of the effect achieved by this configuration, the second account can be easily selected based on a selection of a chat-room including the user of the terminal and the first user that is performed by the user of the terminal.

### Fourth Embodiment

In the fourth embodiment, when the terminal 20 uses the payment application to carry out payment at a member store from the shared wallet balance but the shared wallet balance is insufficient at the time of the payment, information relating to insufficiency of the shared wallet balance is displayed.

Further, in the fourth embodiment, when the shared wallet balance is insufficient, money is sent from the electronic money account of the user of the terminal 20 to the shared wallet based on the method described in the third embodiment to compensate for the insufficient shared wallet balance, rather than using the shared wallet.

The content described in the fourth embodiment is applicable to any other embodiments and variations.

Corresponding elements that are the same as those already described are assigned the same reference numerals as those used for corresponding elements, and a redundant description thereof is omitted.

### Example Display Screen

FIG. 4-1 is a diagram showing an example of an insufficient shared wallet balance screen that is displayed when code payment is carried out using a payment code without touching the check mark button CN2 in the code payment screen in FIG. 3-4 and the shared wallet balance is insufficient.

In this insufficient shared wallet balance screen, “camping fund” is displayed as a current location, and an insufficient shared wallet balance information display/operation region 2427 is displayed in a pop-up format below the “camping fund”. In this example, an image of a “robot with a troubled face” is displayed as an image indicating that the balance is insufficient, and “the shared wallet balance is insufficient” is displayed as an insufficient balance message below the image of the robot.

Below that, the text “purchase to be paid for” is displayed, and the text “AA Sports Co., Ltd.”, which is the name of a company, is displayed below that, together with a logo image of AA Sports Co., Ltd. The text “3,000 yen” is displayed as a payment amount next to the name and logo image of the company. Below that, the shared wallet balance (“1,000 yen” in this example) of the camping fund is displayed as a breakdown, together with an image of a wallet and the name (camping fund) of the shared wallet.

Below that, the user's electronic money account balance (“25,000 yen” in this example”) is displayed together with an image of a purse with a clasp, which indicates a wallet (electronic money account) of the user of the terminal 20, and “my wallet”. Further, below that, a guide sentence: “Pay 2,000 yen from your wallet balance?” is displayed to send money for the shortfall in the shared wallet balance from the user's wallet.

In this example, a remittance button 242E, which is for sending the shortfall amount to compensate for the shortfall in the balance and is shown as “send money”, for example, without limitation thereto, is displayed in a lower part of the insufficient shared wallet balance information display/operation region 2427. Below that, a cancel button 242F, which is for not sending money for the shortfall amount and shown as “not now”, for example, without limitation thereto, is displayed.

FIG. 4-2 is a diagram showing an example of a code payment screen (after remittance) when the remittance button 242E is touched in the insufficient shared wallet balance screen in FIG. 4-1.

Although the camping fund code payment region 2421 is the same as that in FIG. 3-4, the balances are different since money has been set from the user's wallet. That is, “3,000 yen” is displayed as a shared wallet balance for the camping fund to which the amount sent has been added, and “23,000 yen” is displayed as a user's electronic money account balance from which the amount sent has been subtracted.

FIG. 4-3 is a diagram showing an example of a code payment completion screen that is displayed on the terminal 20 when code payment is completed by the server 10, similarly to FIG. 3-7.

The code payment completion screen shown in FIG. 4-3 is different from the code payment completion screen shown in FIG. 3-7 in that the breakdown of the payment is added below a line under the payment destination. Specifically, as the breakdown of the payment, the shared wallet balance (“1,000 yen” in this example) of the camping fund is displayed together with an image of a wallet and the text “camping fund”. Below that, the user's electronic money account balance (“2,000 yen” in this example) is displayed together with an image of a purse with a clasp and the text “my wallet”.

### Processing

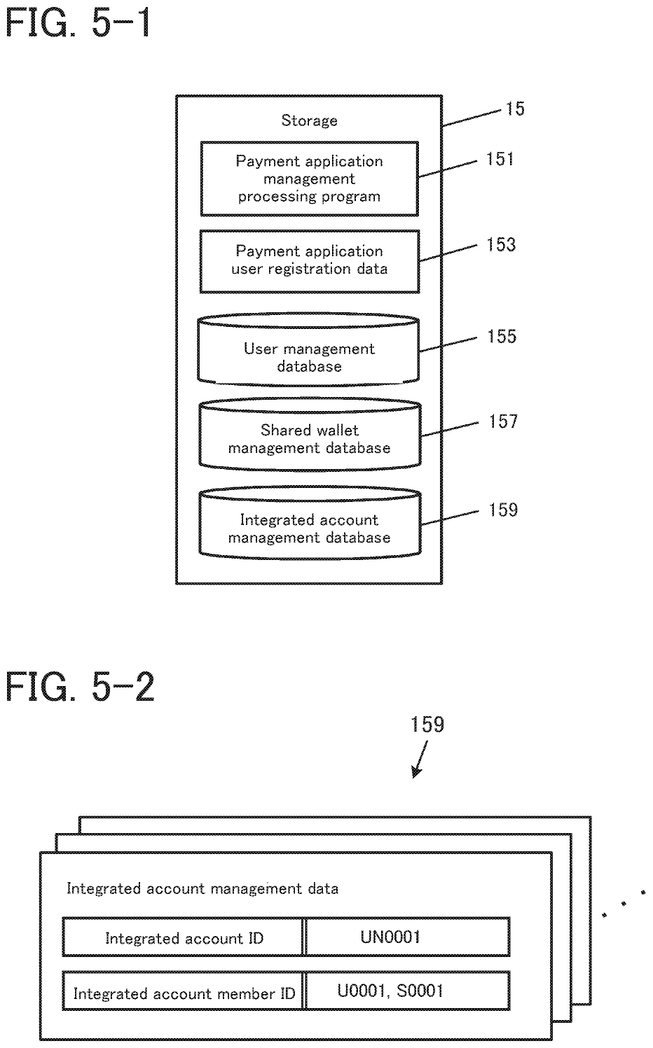

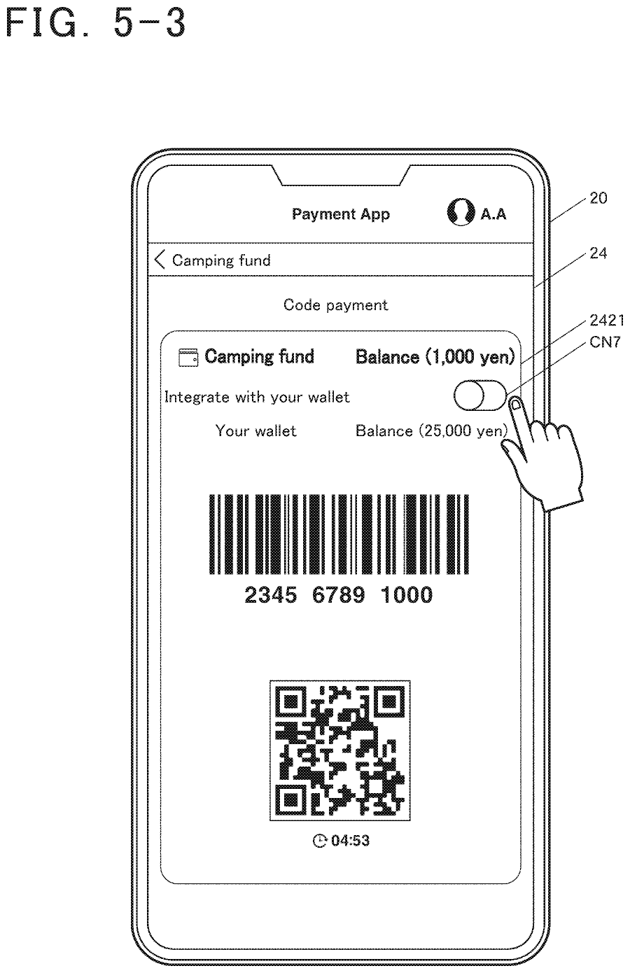

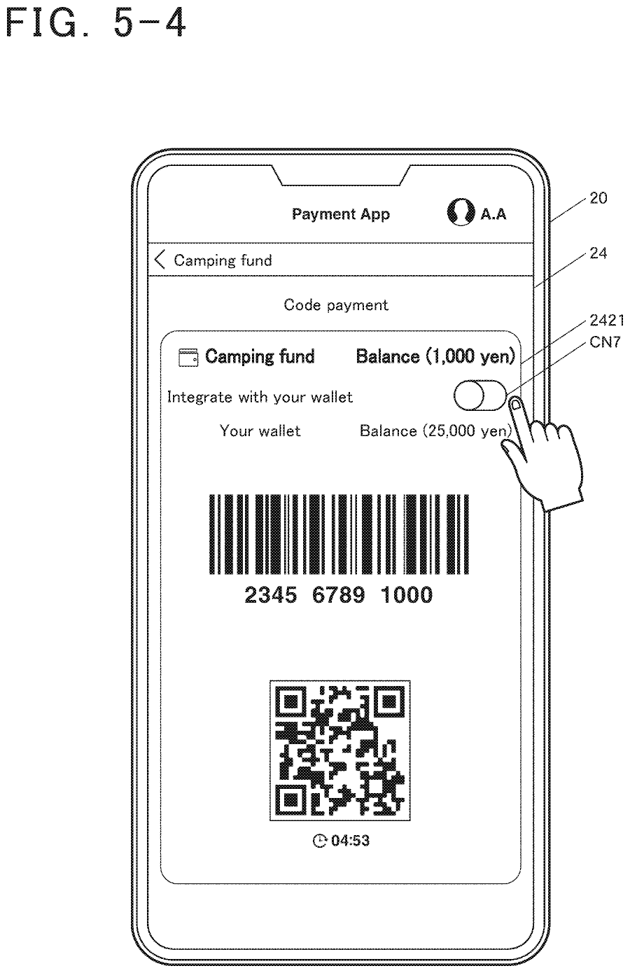

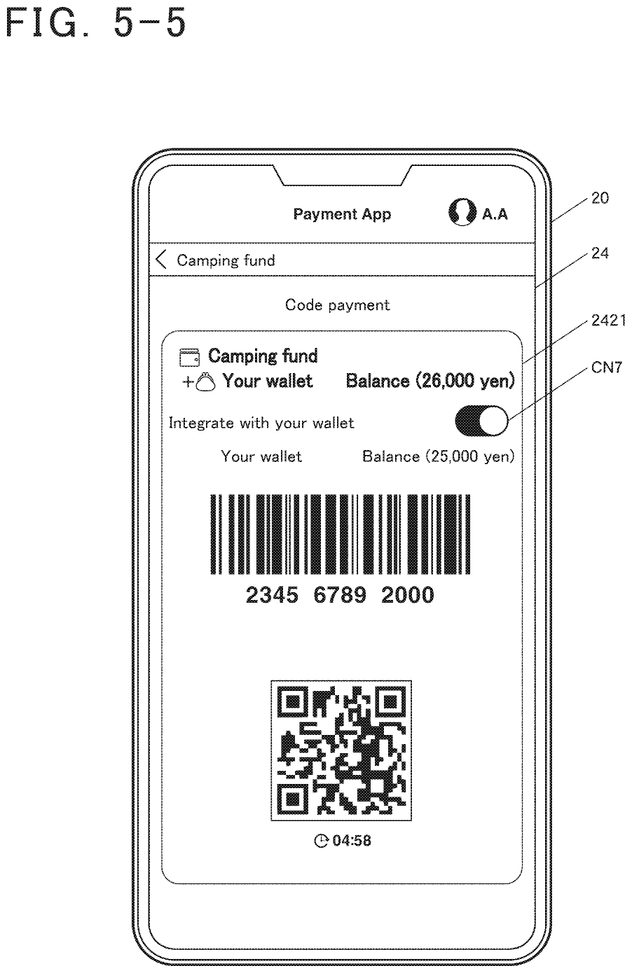

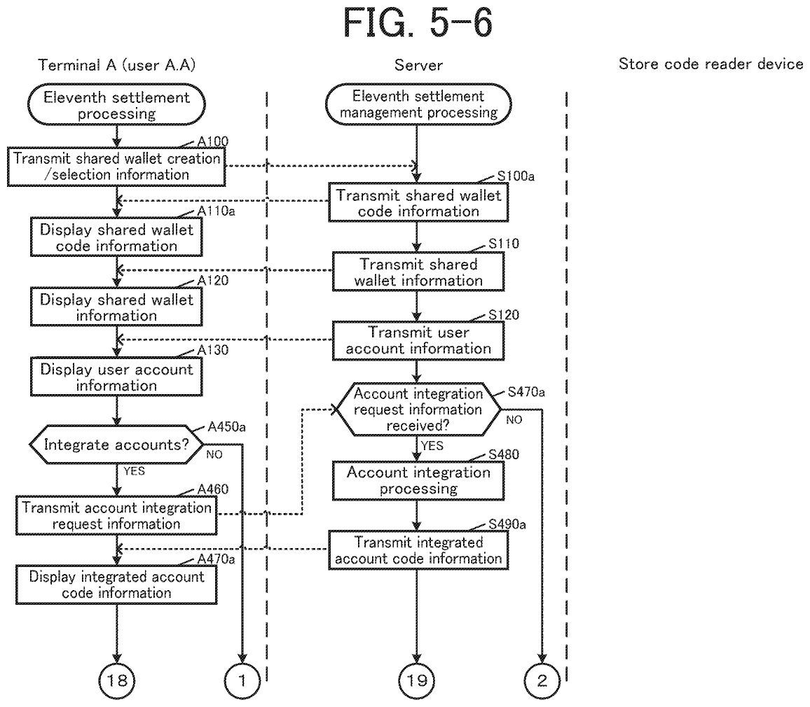

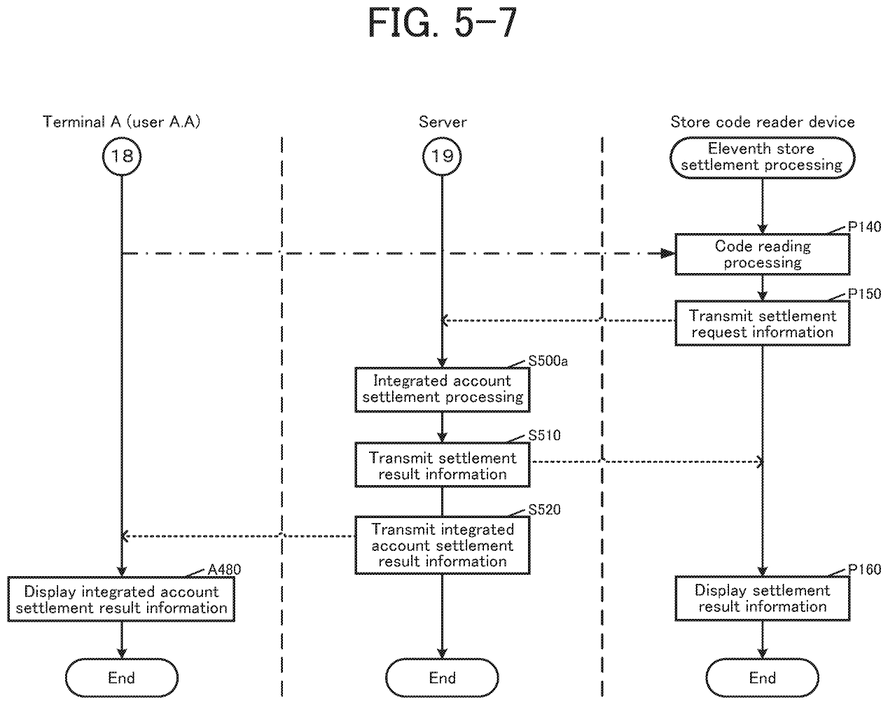

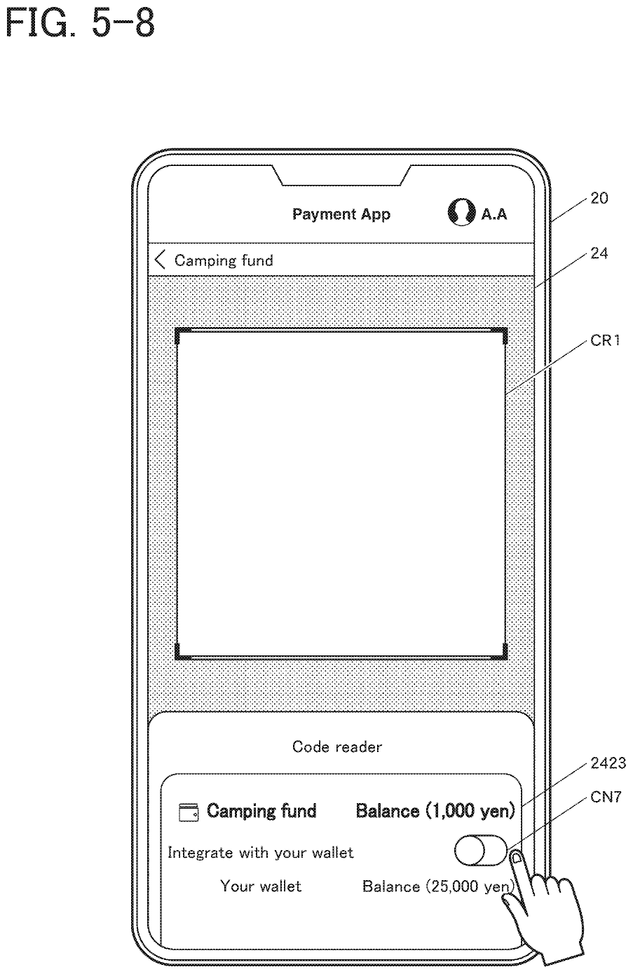

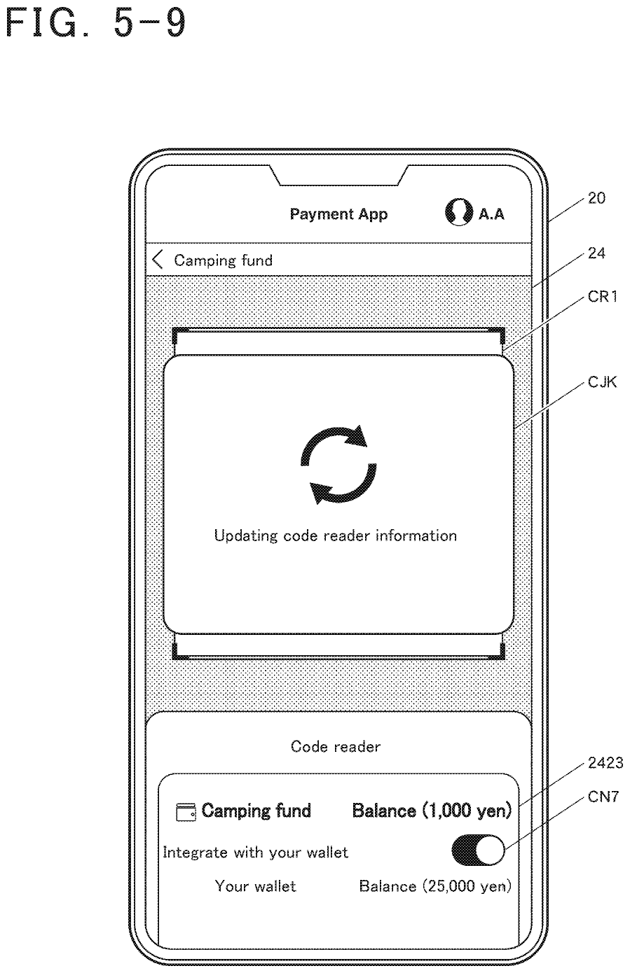

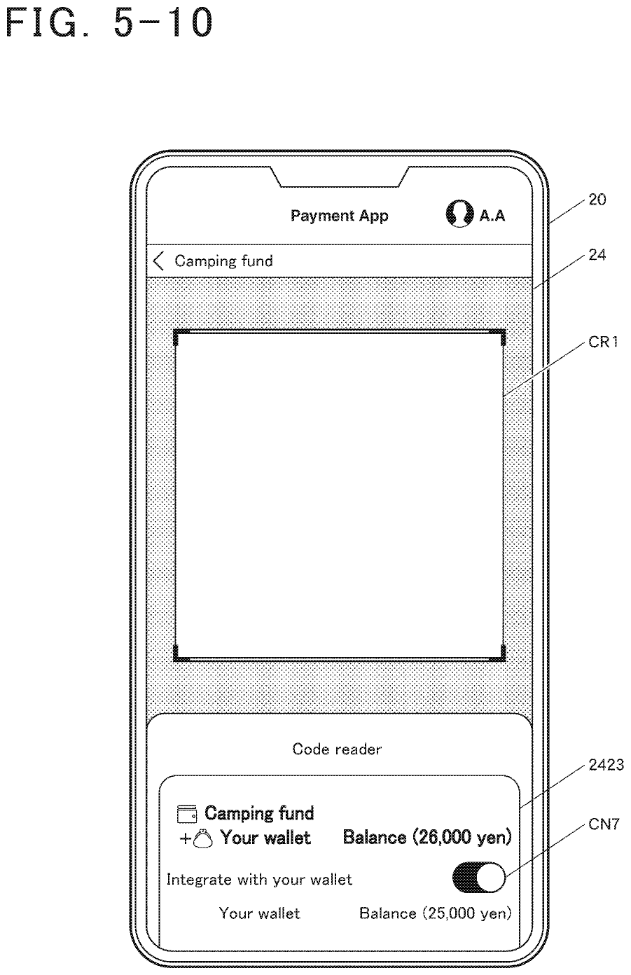

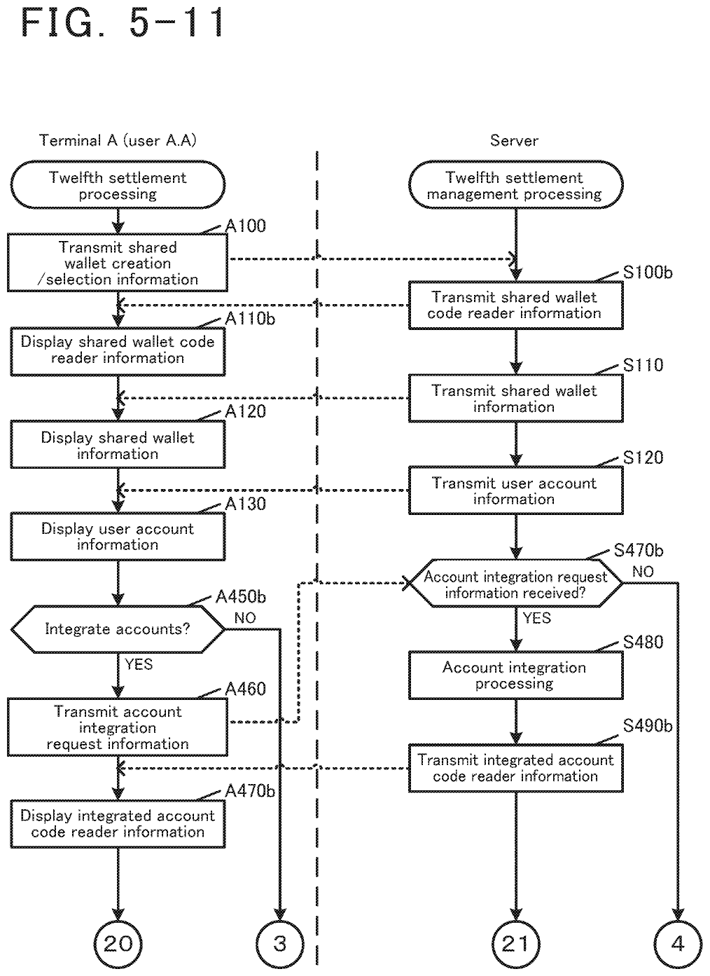

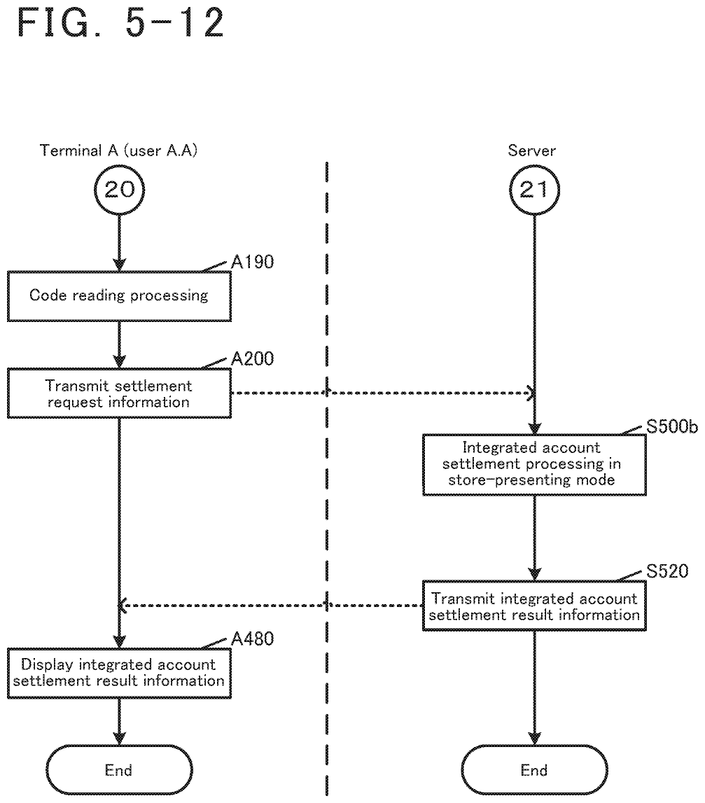

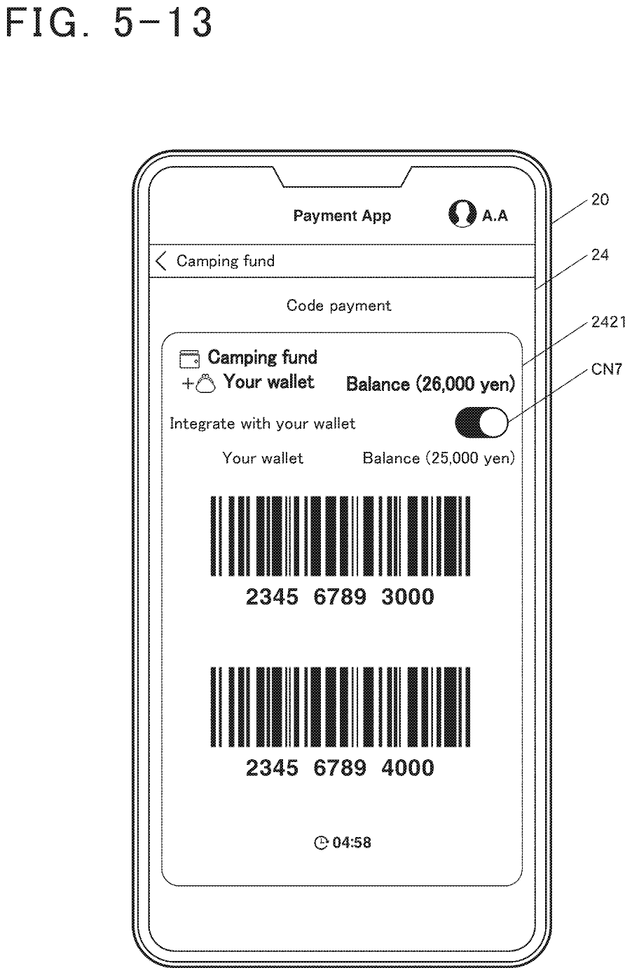

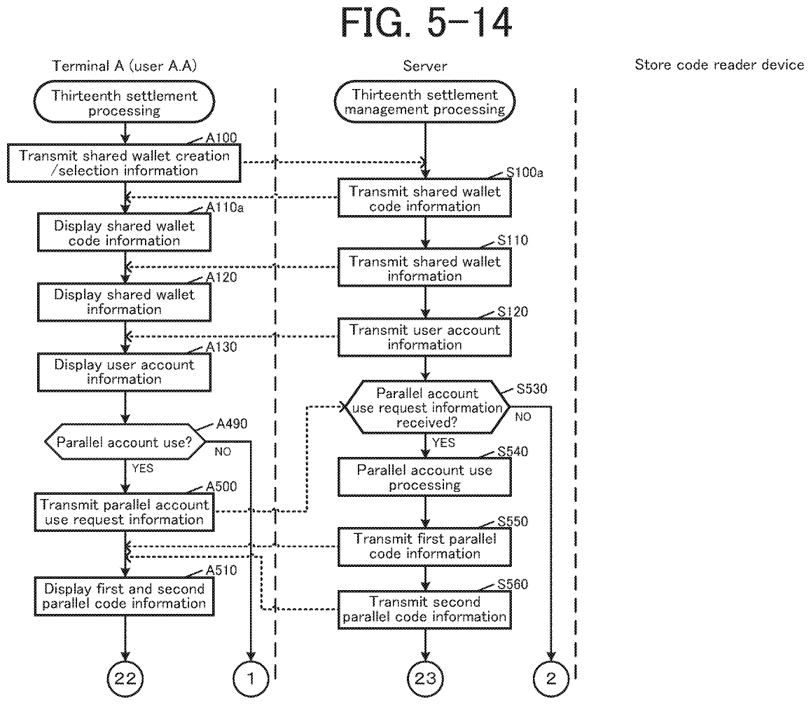

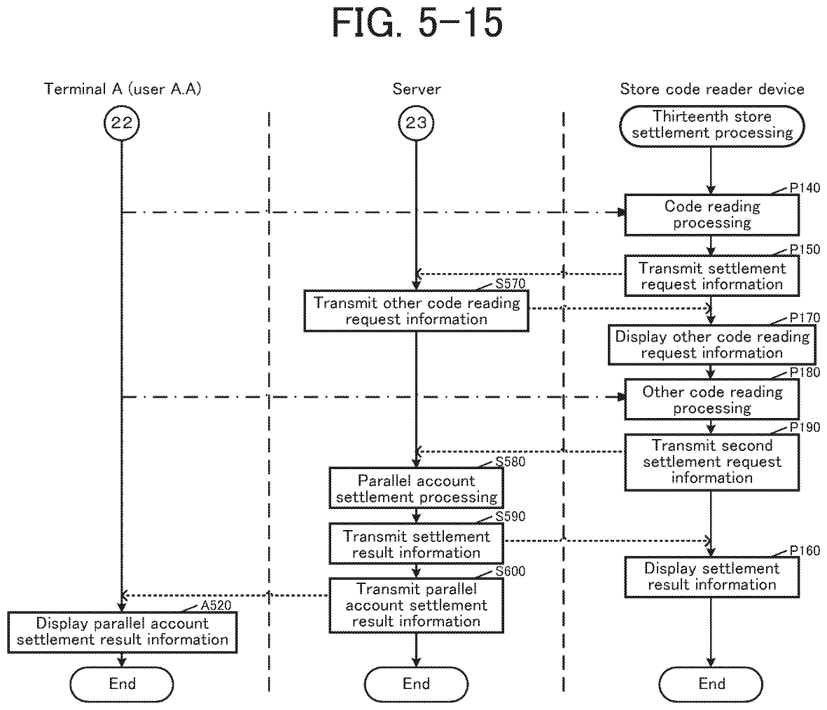

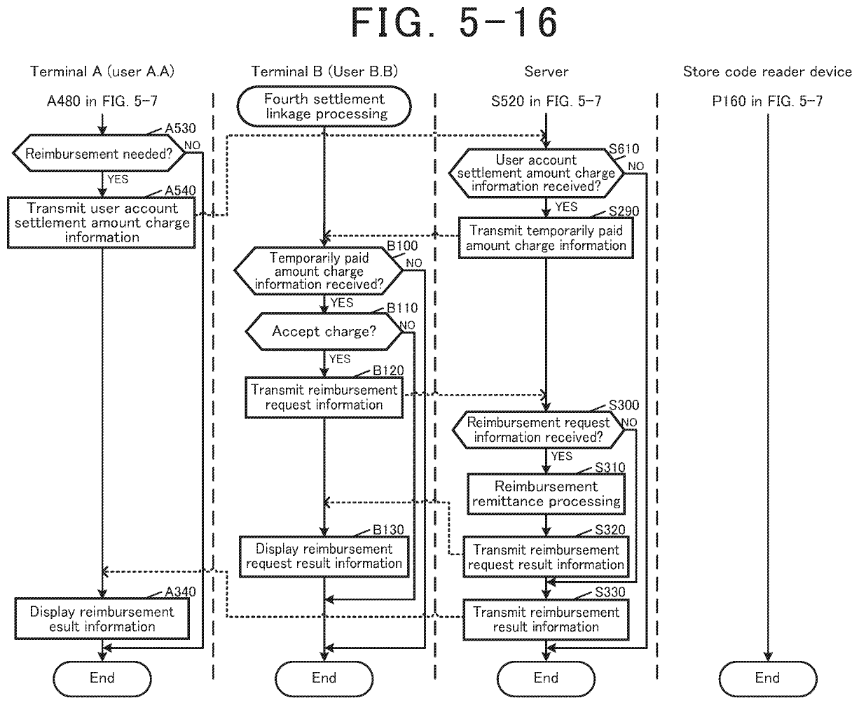

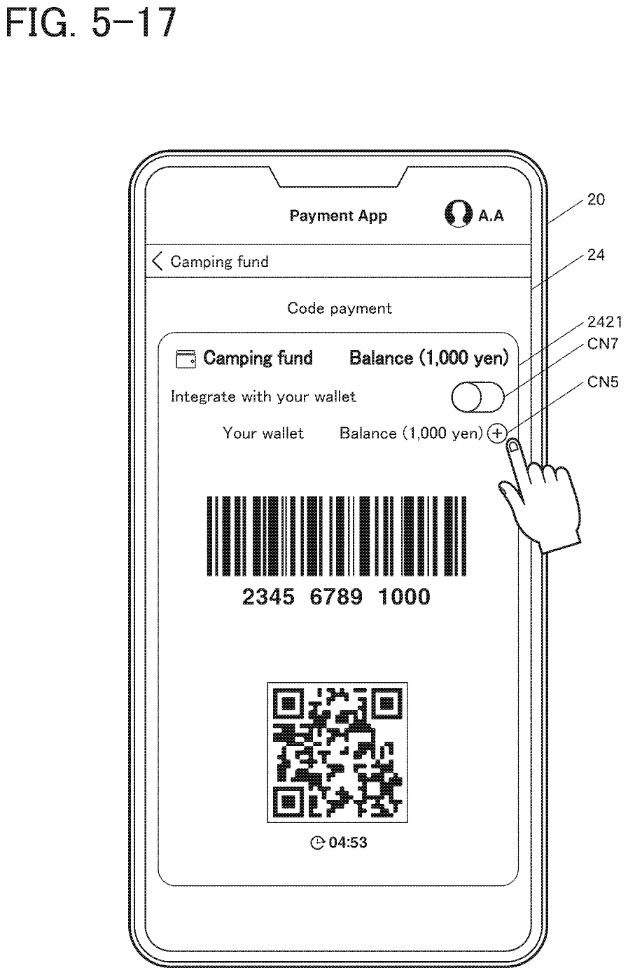

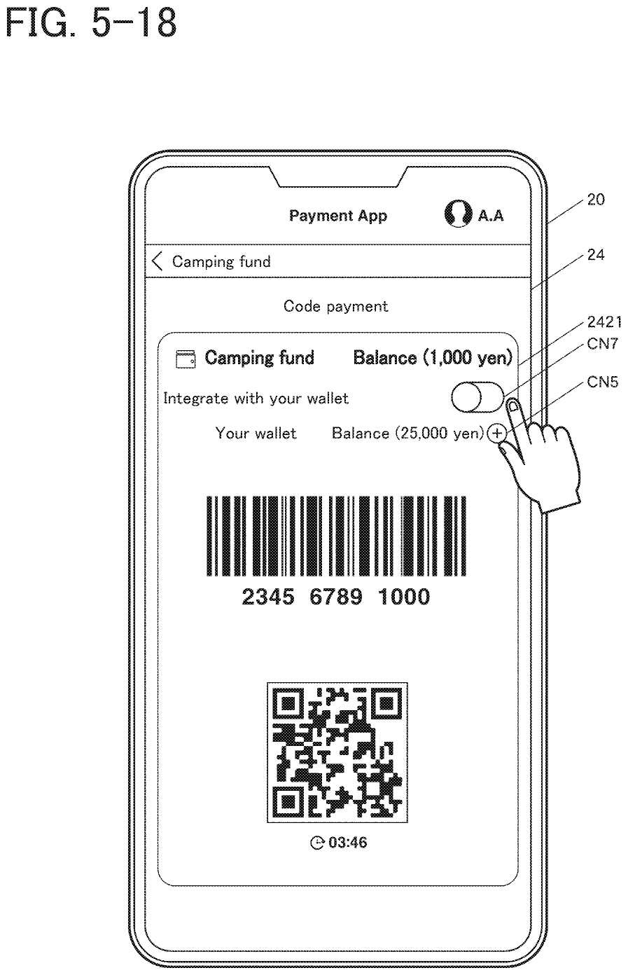

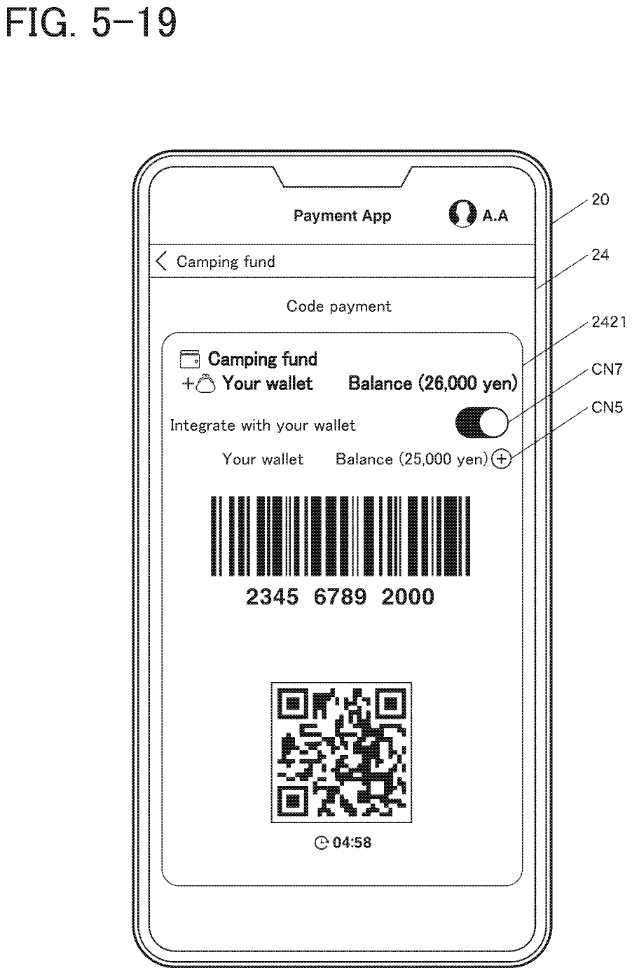

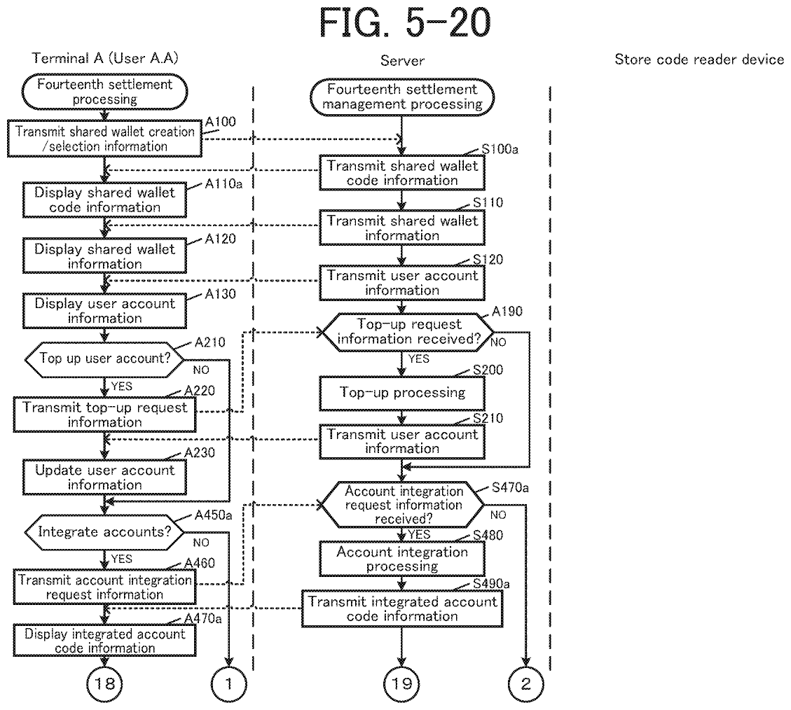

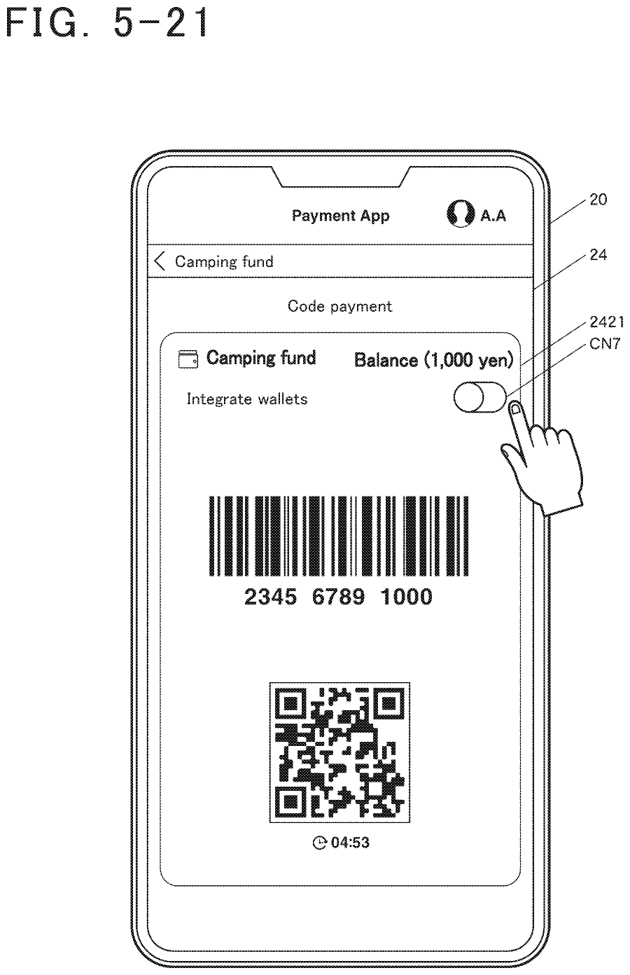

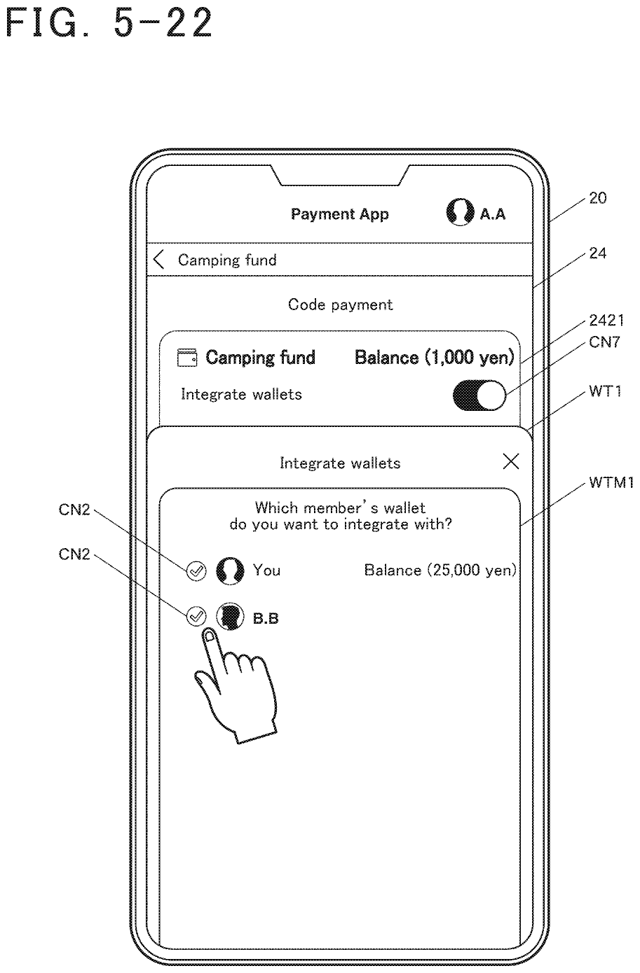

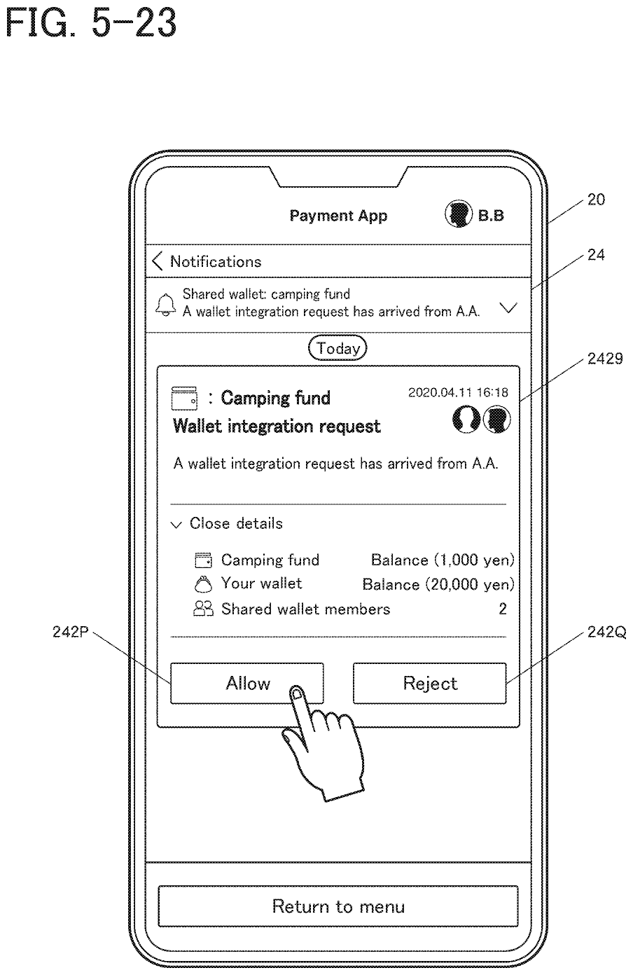

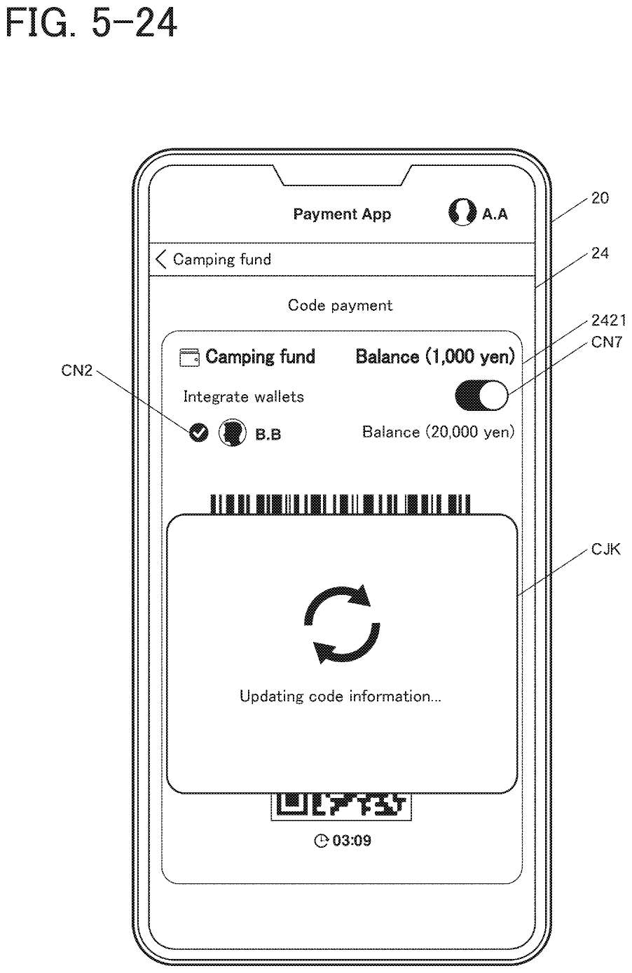

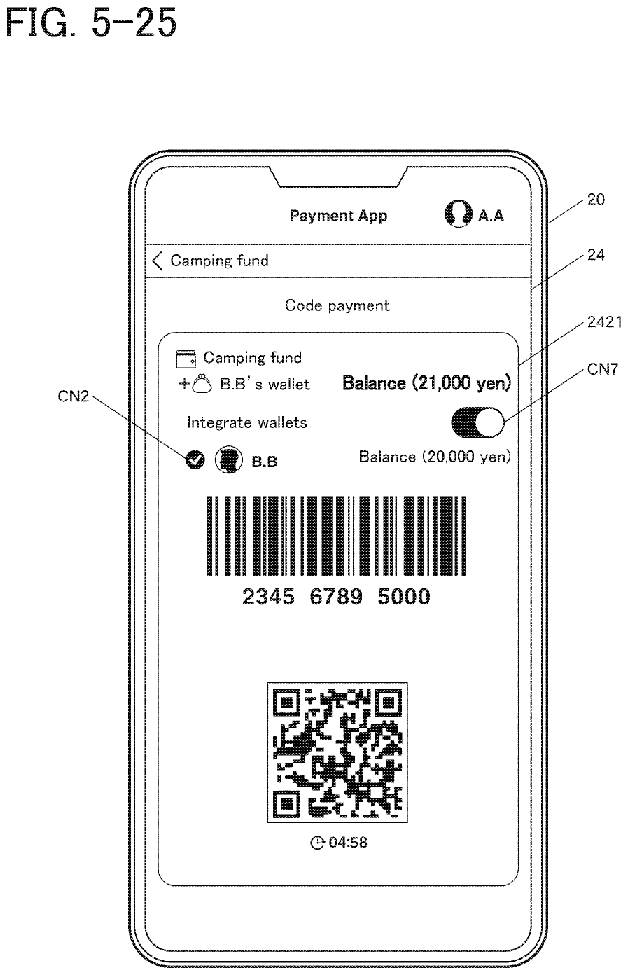

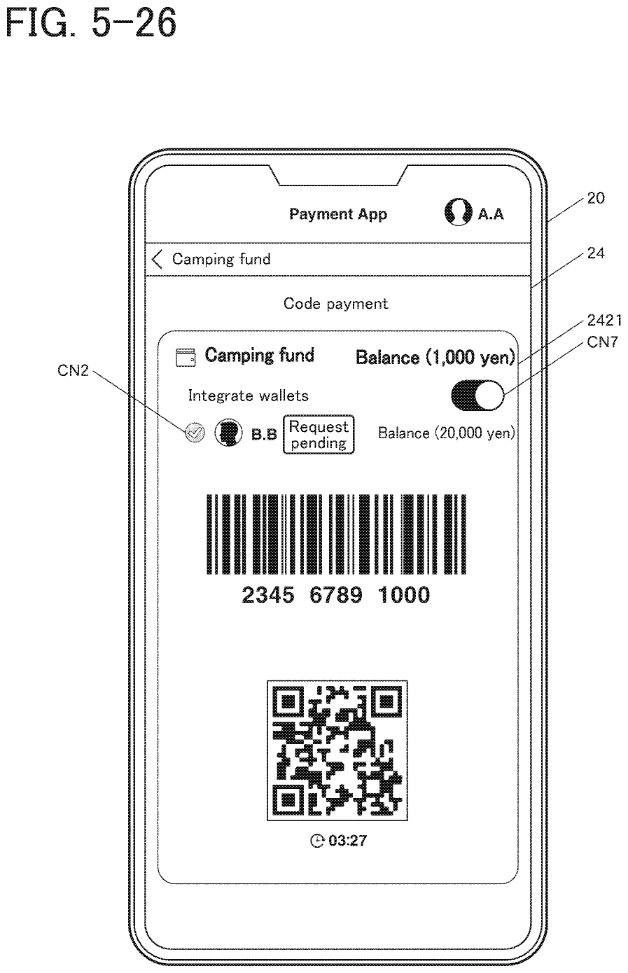

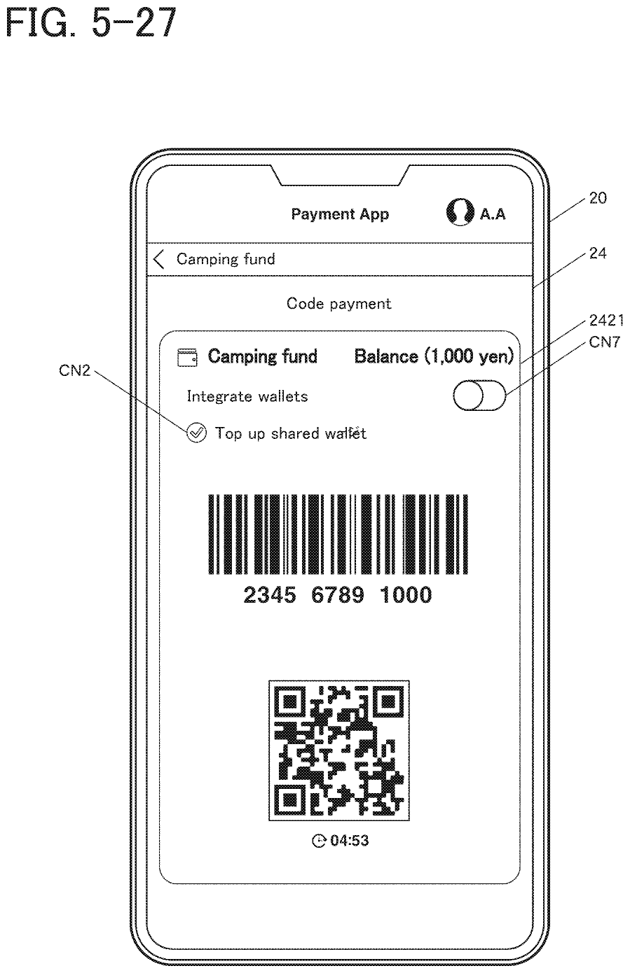

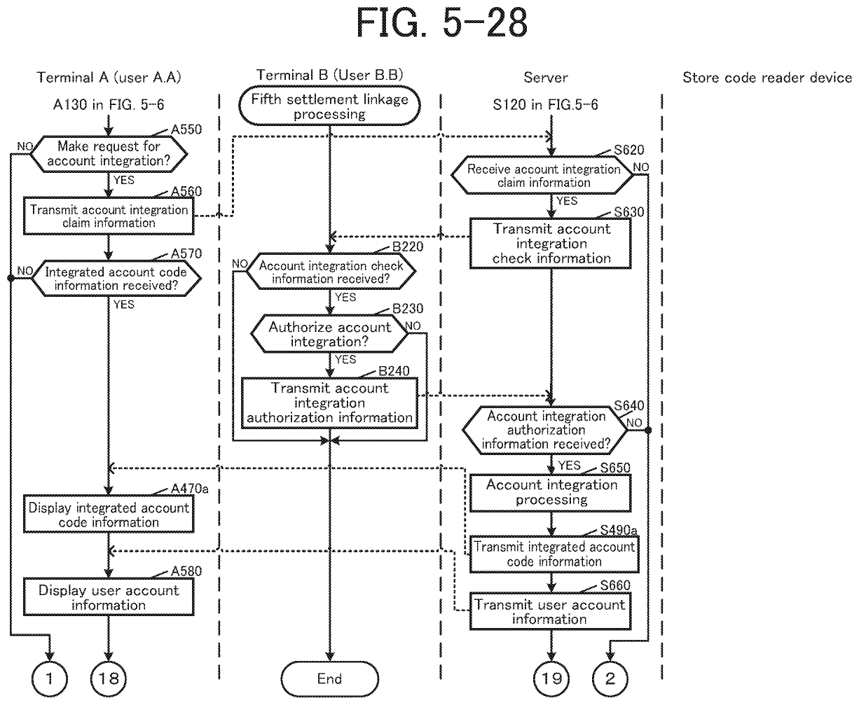

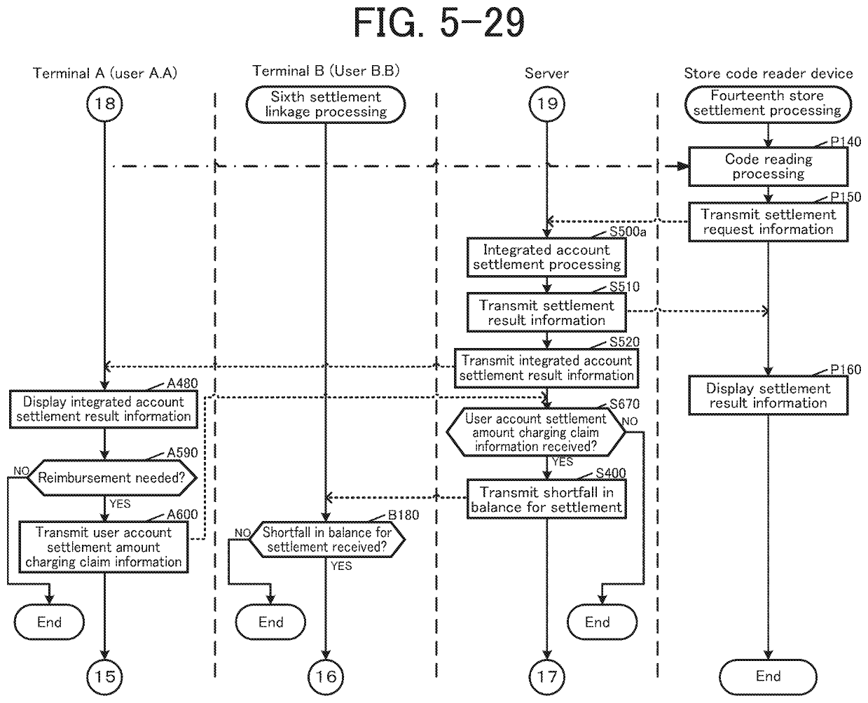

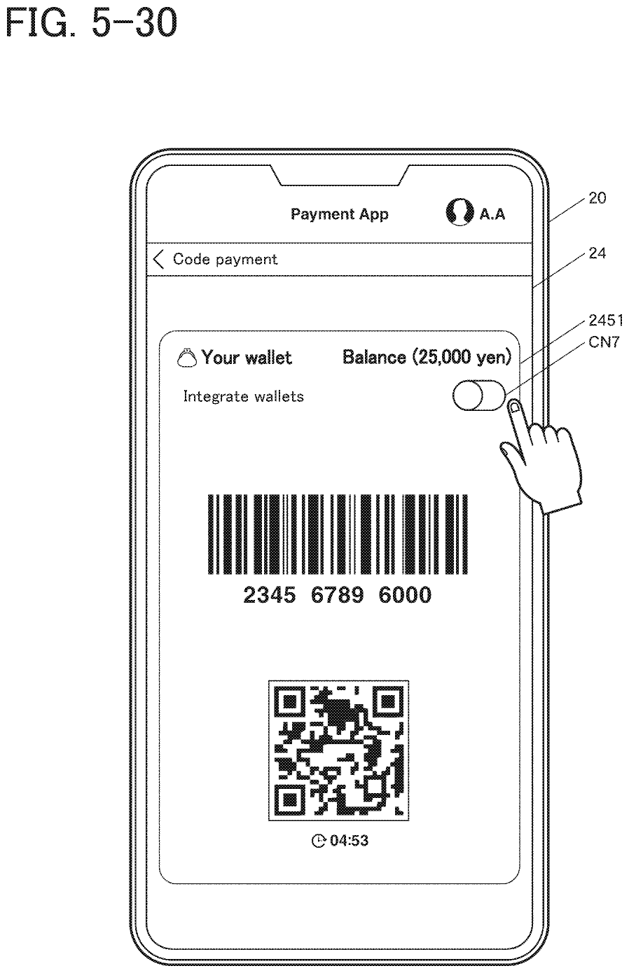

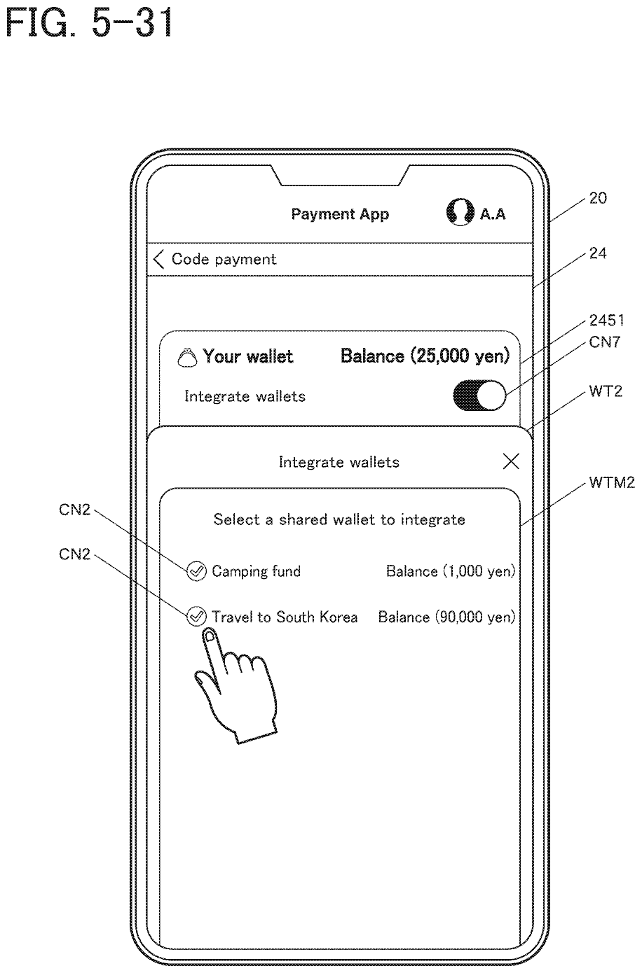

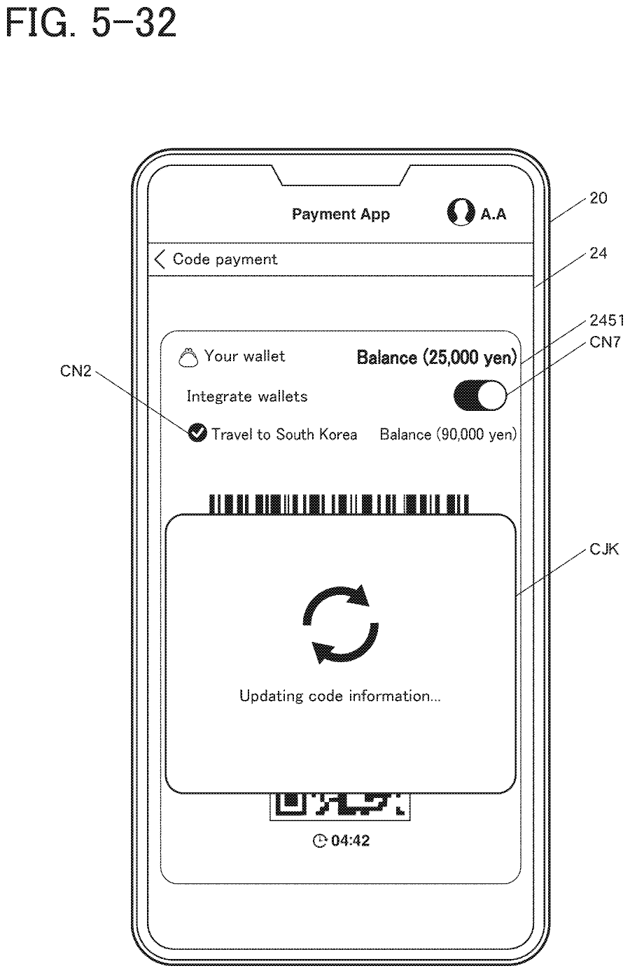

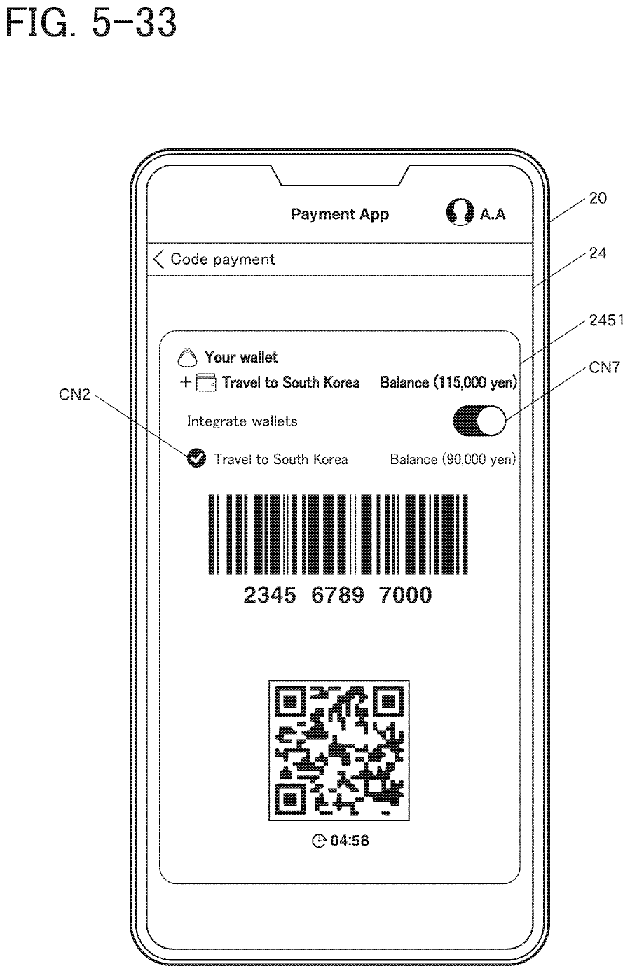

FIGS. 4-4 and 4-5 are flowcharts showing an example flow of processing executed by the devices in the present embodiment. These flowcharts show examples of settlement processing executed by the controller 21 of a terminal A (non-limiting examples of which include the terminal 20 of a user A.A), settlement management processing executed by the controller 11 of the server 10, and store settlement processing executed by the controller 51 of the store code reader device 50, which is an element of a store POS system (non-limiting examples of which include the store POS system 40 at a member store S1), in order from the left. These types of processing are examples of processing relating to code settlement in the user-presenting mode.

The controller 51 of the store code reader device 50 executes store settlement processing, and a predetermined amount to be settled (non-limiting examples of which include “3000 yen”) is input to the controller 51 based on an operation to the input/output device 52 of the store code reader device 50. The controller 51 of the store code reader device 50 then reads the payment code displayed in the display 24 of the terminal A, using the code reader 58 (P100). In this case, since the payment code displayed in the display 24 is associated with the shared wallet payment token, the reading result obtained by the code reader 58 includes the shared wallet payment token.

The controller 51 of the store code reader device 50 transmits settlement request information including the store ID, the amount to be settled, and the shared wallet payment token, for example, without limitation thereto, to the server 10 using the communication I/F 54 (P110).

After S120, upon receiving the settlement request information from the store code reader device 50 using the communication I/F 14, the controller 11 of the server 10 retrieves the shared wallet ID using the shared wallet payment token with which the request has been made, and executes, for the shared wallet, settlement processing to pay the amount to be settled to the member store defined by the store ID (S250a).

If the settlement is successful in the settlement processing (S260a: YES), the controller 11 of the server 10 advances the processing to S180a.

On the other hand, if the settlement fails in the settlement processing (S260a: NO), the controller 11 of the server 10 transmits insufficient settlement balance information including a message indicating that the settlement failure and the shortfall in the balance for settlement in the shared wallet in this case, to the terminal A and the store code reader device 50 using the communication I/F 14 (S270a). Then, the controller 11 of the server 10 advances the processing to S130. Steps S130 to S160 are the same as those in FIG. 3-8. The controller 11 of the server 10 then advances the processing to S170a.

After A130, upon receiving the insufficient settlement balance information from the server 10 using the communication I/F 22 (A270a: YES), the controller 21 of the terminal A causes the display 24 to display the received insufficient settlement balance information (A280).

Also, the controller 21 of the terminal A stores, in the storage 28, the shortfall in the balance for settlement included in the received insufficient settlement balance information (A290). The controller 21 of the terminal A then advances the processing to A140. Steps A140 to A170 are the same as those in FIG. 3-8. The controller 21 of the terminal A then receives the settlement result information from the server 10 using the communication I/F 22, and advances the processing to A180.

On the other hand, if the insufficient settlement balance information is not received from the server 10 (A270a: NO), the controller 21 of the terminal A receives the settlement result information from the server 10 using the communication I/F 22 and advances the processing to A180.

After P110, upon receiving the insufficient settlement balance information from the server 10 using the communication I/F 54 (P120: YES), the controller 51 of the store code reader device 50 causes the display 53 to display the insufficient settlement balance information (P130). The controller 51 of the store code reader device 50 then executes code reading processing again (P140). The controller 51 of the store code reader device 50 then advances the processing to P150.

On the other hand, if the insufficient settlement balance information is not received from the server 10 (P120: NO), the controller 51 of the store code reader device 50 receives the settlement result information from the server 10 using the communication I/F 54, and advances the processing to P160.

Note that “insufficient settlement balance information being displayed in the present embodiment has the same meaning as that in the second embodiment.

### Effects of Fourth Embodiment

In the fourth embodiment, the terminal 20 executes, with use of the controller 21, processing relating to settlement based on an account (a non-limiting example of a first account) with which the user of the terminal 20 can carry out settlement. Also, the terminal 20 causes the display 24 to the display insufficient settlement balance information (a non-limiting example of first information relating to insufficiency of the balance of the first account that is based on the amount of a first settlement and the balance of the first account). Then, based on the input to the display 24 in which the insufficient settlement balance information is displayed, the terminal 20 executes processing (a non-limiting example of processing relating to first settlement) for sending money from a user account of the user of the terminal 20 (a non-limiting example of a second account different from the first account) to a shared account.

As an example of the effect achieved by this configuration, it is possible to notify the user of the terminal that the balance of the first account with which the user of the terminal can carry out settlement is insufficient. In addition, settlement can be implemented based on the first account, and can also be implemented based at least on the second account different from the first account.

Also, the fourth embodiment describes a configuration in which the account with which the user of the terminal 20 can carry out settlement is a shared account (a non-limiting example of a shared account with which at least the user of the terminal and a first user different from the user of the terminal can carry out settlement).

As an example of the effect achieved by this configuration, settlement can be implemented based on the shared account with which at least the user of the terminal and the first user who is different from the user of the terminal can carry out settlement.

The fourth embodiment describes a configuration in which processing relating to settlement is executed based on the shared account and the user account of the user of the terminal 20, based on input to the display 24 in which insufficient settlement balance information is displayed.

As an example of the effect achieved by this configuration, settlement can be implemented based on at least the shared account and the second account.

The fourth embodiment describes a configuration in which, in settlement (a non-limiting example of first settlement), payment is carried out preferentially from a shared wallet balance (a non-limiting example of a balance of a shared account), out of the shared wallet balance and the electronic money account balance of the user account of the user of the terminal 20.

As an example of the effect achieved by this configuration, payment is carried out preferentially from the balance of the shared account, and thus, the second account can be used as a secondary account.

The fourth embodiment describes a configuration in which money is sent from the user account of the user of the terminal 20 to a shared account, and settlement is carried out based on the balance of the shared account.

As an example of the effect achieved by this configuration, money can be sent from the second account to the shared account to top up the shared account, and settlement can be carried out based on the balance of the shared account.

The fourth embodiment describes a configuration in which, in processing relating to settlement, money is sent from the user account of the user of the terminal 20 to a shared account based on input to the terminal 20 performed by the user of the terminal 20.

As an example of the effect achieved by this configuration, the user of the terminal can perform input to the terminal to have money sent from the second account to the shared account.

In the fourth embodiment, based on input to the display 24 with insufficient settlement balance information displayed therein that is performed by the user of the terminal 20, the terminal 20 causes the display 24 to display a payment code (a non-limiting example of first code information associated with the second information) associated with the user account of the user of the terminal 20, or a code reader screen (a non-limiting example of first code reader information) for reading a payment store code (a non-limiting example of code information) that is based on shared wallet code reader information. The terminal 20 then executes processing relating to settlement based on the payment code being read or the payment store code being read by the terminal 20 with the code reader screen displayed in the display 24 thereof.

As an example of the effect achieved by this configuration, the first code information associated with the second account or the code reader information that is an indication relating to reading of the code information can be displayed in the display region of the terminal and used in settlement, based on input to the display region with the first information displayed therein that is performed by the user of the terminal. Further, settlement can be easily implemented based on the first code information being read, or based on the code information being read by the terminal with the code reader information displayed in the display region thereof.

The fourth embodiment describes a configuration in which the second account is the user account of the user of the terminal 20 (a non-limiting example of an account of the user of the terminal).

As an example of the effect achieved by this configuration, settlement can be implemented based on at least an account of a user of a terminal that is different from the first account.

The fourth embodiment describes a configuration in which processing relating to settlement is executed based on a payment code displayed in the display 24 being read by the store code reader device 50.

As an example of the effect achieved by this configuration, settlement can be easily implemented based on the code information displayed in the display region being read.

The fourth embodiment describes a configuration in which insufficient settlement balance information (a non-limiting example of first information) is received from the server 10 (a non-limiting example of a server that executes processing for first settlement) using the communication I/F 22 of the terminal 20 when the shared wallet balance is insufficient, based on the amount to be settled (a non-limiting example of an amount of the first settlement) and the shared wallet balance (a non-limiting example of a balance of a shared account).

As an example of the effect achieved by this configuration, the first information can be easily acquired from the server that executes the processing for the first settlement when the balance of the shared account is insufficient.

In the fourth embodiment, the server 10 executes, with use of the controller 11, settlement processing (a non-limiting example of processing relating to the first settlement) based on an account with which the user of one terminal 20 can carry out settlement (a non-limiting example of a first account with which the user of the terminal can carry out settlement). Also, the server 10 uses the communication I/F 14 to transmit, to the one terminal 20, insufficient settlement balance information (a non-limiting example of first information relating to insufficiency of the balance of the first account that is based on the amount of the first settlement and the balance of the first account). The server 10 executes, with use of the controller 11, the settlement processing based on at least the user account of the user of the one terminal 20 (a non-limiting example of a second account different from the first account), based on input to the insufficient settlement balance information displayed in the display 24 of this terminal 20 that is performed by the user of the terminal 20.

As an example of the effect achieved by this configuration, it is possible to notify the terminal that the balance of the first account with which the user of the terminal can carry out settlement is insufficient. In addition, settlement can be carried out based on the first account, and further, settlement can be carried out based on at least the second account different from the first account.

Note that the account with which the user of one terminal 20 can carry out settlement may be a shared account (a non-limiting example of a shared account with which at least the user of the terminal and a first user different from the user of the terminal can carry out settlement), for example, without limitation thereto, similarly to the above.

### Fourth Embodiment Variation (1)

In the fourth embodiment, if sending money from the electronic money account of the user A.A to a shared wallet is selected (A140 in FIG. 4-4: YES), the controller 21 of the terminal A causes the display 24 to display a screen that prompts input of the amount to be sent. However, this need not be the case.

The controller 21 of the terminal A may set the shortfall in the balance for settlement stored in A290 in FIG. 4-4 as the amount to be sent, and transmit remittance request information to the server 10, for example, without limitation thereto.

### Fourth Embodiment Variation (2)

In the fourth embodiment, after causing the display 53 to display settlement result information (P130 in FIG. 4-4), the controller 51 of the store code reader device 50 executes code reading processing again and transmits settlement request information to the server 10. However, this need not be the case.

In the case of receiving remittance request information in S130 in FIG. 4-4 (S130: YES), the controller 11 of the server 10, after transmitting user account information to the terminal 20 (S160 in FIG. 4-4), may execute settlement processing in S170a in FIG. 4-5 based on the settlement request information used in the settlement processing in S250a in FIG. 4-4, without receiving the settlement request information from the store code reader device 50, for example, without limitation thereto.

In this case, the controller 51 of the store code reader device 50 receives the settlement result information from the server 10 using the communication I/F 54 after step P130 in FIG. 4-4, and executes step P160 in FIG. 4-5.

### Fourth Embodiment Variation (3)

The fourth embodiment has described the code settlement in the user-presenting mode, but this need not be the case. Specifically, the code settlement in the store-presenting mode may alternatively be adopted.

### Example Display Screen

FIG. 4-6 is a diagram showing an example of an insufficient shared wallet balance screen that is displayed when code payment is carried out from the code reader screen in FIG. 3-9 and the shared wallet balance is insufficient.

FIG. 4-6 is different from FIG. 4-1 in that the background of the insufficient shared wallet balance information display/operation region 2427 is a code reader screen.

In FIG. 4-6, if the remittance button 242E is touched to send “2,000 yen” from the user's wallet balance, a payment amount input screen is displayed, similarly to FIG. 3-11. Here, if “3,000 yen” is input and the payment button 242C is touched similarly to FIG. 3-11, a code payment completion screen is displayed similarly to FIG. 4-3.

### Processing

FIGS. 4-7 and 4-8 are flowcharts showing an example flow of processing executed by the devices in this variation. These flowcharts show examples of settlement processing executed by the controller 21 of the terminal A (non-limiting examples of which include the terminal 20 of the user A.A) and settlement management processing executed by the controller 11 of the server 10, in order from the left.

After A130, the controller 21 of the terminal A uses the camera 27 to read a payment store code presented by a member store, and acquires a store ID from the payment store code (A300).

Thereafter, the controller 21 of the terminal A causes the display 24 to display a display screen for inputting the amount to be settled. Upon the amount to be settled being input based on a user operation to the input/output device 23 of the terminal A, the controller 21 transmits settlement request information including the shared wallet payment token included in the shared wallet code reader information, the store ID, and the amount to be settled, for example, without limitation thereto, to the server 10 using the communication I/F 22 (A310).

Note that if the amount to be settled is included in the payment store code, the input of the amount to be settled to the terminal A can be omitted.

Upon the settlement request information being received from the terminal A using the communication I/F 14, the controller 11 of the server 10 retrieves the shared wallet ID using the shared wallet payment token with which the request has been received, and executes, for the shared wallet, settlement processing to make payment of the amount to be settled to the member store defined by the store ID (S250b).

If the settlement is successful in S250b (S260b: YES), the controller 11 of the server 10 advances the processing to S180b.

If the settlement fails in S250b (S260b: NO), the controller 11 of the server 10 transmits insufficient settlement balance information including a message indicating the settlement failure and the shortfall in the balance for settlement in the shared wallet in this case, to the terminal A using the communication I/F 14 (S270b). Then, the controller 11 of the server 10 advances the processing to S130. After S160, the controller 11 of the server 10 receives the settlement request information from the terminal A, and advances the processing to S170b.

Upon receiving the insufficient settlement balance information from the server 10 using the communication I/F 22 (A270b: YES), the controller 21 of the terminal A causes the display 24 to display the insufficient settlement balance information (A280), and stores the shortfall in the balance for settlement in the storage 28 (A290). The controller 21 of the terminal A then advances the processing to A140. After A170, the controller 21 of the terminal A advances the processing to A190.

Note that if, similarly to the fourth embodiment variation (1), sending money from the electronic money account of the user A.A to the shared wallet is selected (A140 in FIG. 4-7: YES), the controller 21 of the terminal A may set the shortfall in the balance for settlement stored in A290 in FIG. 4-7 as the amount to be sent and transmit the remittance request information to the server 10.

This variation describes a configuration in which processing relating to settlement is executed based on the payment store code being read by the terminal 20.

As an example of the effect achieved by this configuration, settlement can be easily implemented based on the code information being read by the terminal.

### Fourth Embodiment Variation (4)

In the fourth embodiment variation (3), after causing the display 53 to display the insufficient settlement balance information (A280 in FIG. 4-7), the controller 21 of the terminal A executes the code reading processing again (A190 in FIG. 4-8) and transmits the settlement request information to the server 10. However, this need not be the case.

After updating the user account information (A170 in FIG. 4-7), the controller 21 of the terminal A may also transmit the settlement request information in A200 in FIG. 4-8 to the server 10 based on the settlement request information transmitted in A310 in FIG. 4-7, for example, without limitation thereto.

### Fourth Embodiment Variation (5)

In the fourth embodiment, even if the user A.A of the terminal A temporarily pays the shortfall in the shared wallet balance by sending money from the electronic money account of the user A.A at the time of payment at a member store, another user (a non-limiting example of which include a user B.B) of the shared wallet is not charged for the temporarily paid amount. However, the other user may be charged for the temporarily paid amount.

FIG. 4-9 is a flowchart showing an example flow of processing executed by the devices in this variation. These flowcharts show examples of settlement processing executed by the controller 21 of the terminal A (non-limiting examples of which include the terminal 20 of the user A.A), settlement linkage processing executed by the controller 21 of the terminal B (non-limiting examples of which include the terminal 20 of the user B.B), settlement management processing executed by the controller 11 of the server 10, and store settlement processing executed by the controller 51 of the store code reader device 50, which is an element of a store POS system (non-limiting examples of which include the store POS system 40 at a member store S1), in order from the left.

Note that the former half of the processing can be implemented with the same processing as that in FIGS. 4-4 and 4-5, for example, without limitation thereto, and a description thereof is therefore omitted here.

Upon displaying the settlement result information (A180), the controller 21 of the terminal A causes the display 24 to display a screen for selecting whether or not to make reimbursement (reckoning) for the temporarily paid amount (A320).

Note that if the shortfall in the balance for settlement stored in the storage 28 of the terminal A is “0”, or if the settlement has failed, the reimbursement need not be made (A320: NO). Therefore, the processing may be ended without causing the display 24 to display the selection screen.

If the shortfall in the balance for settlement stored in the storage 28 of the terminal A is greater than “0” and the settlement has been successful, reimbursement may be automatically carried out (A320: YES) without causing the display 24 to display the selection screen.

If making the reimbursement based on a user operation to the input/output device 23 of the terminal A has been selected (A320: YES), the controller 21 of the terminal A transmits the shortfall in the balance for settlement stored in the storage 28 of the terminal A to the server 10 using the communication I/F 22 (A330).

On the other hand, if making the reimbursement has not been selected (A320: NO), the controller 21 of the terminal A ends the processing.

The controller 11 of the server 10 transmits settlement result information (S180a). If the shortfall in the balance for settlement is received from the terminal A using the communication I/F 14, the controller 11 determines whether or not the shortfall in the balance for settlement is greater than “0” (S280).

If the received shortfall in the balance for settlement is “0”, or if the shortfall in the balance for settlement is not received (S280: NO), it is determined that the settlement balance is not insufficient, or that reimbursement is not necessary, and the controller 11 of the server 10 ends the processing.

If the received shortfall in the balance for settlement is greater than “0” (YES: S280), the controller 11 of the server 10 calculates “M+N” as the amount to be paid for the temporarily paid amount assigned to each member of the shared wallet, where M denotes the shortfall in the balance for settlement and N denotes the number of users of the shared wallet member (the number of users of the shared wallet member), for example, without limitation thereto. The controller 11 of the server 10 then transmits the temporarily paid amount charge information including the temporarily paid amount, to the terminal (here, the terminal B) of each user excluding the temporary payer of the shared wallet, using the communication I/F 14 (S290).

Upon the temporarily paid amount charge information being received from the server 10 using the communication I/F 22 (B100: YES), the controller 21 of the terminal B causes the display 24 to display the received temporarily paid amount and a screen for selecting whether or not to accept the charge of the temporarily paid amount (B110). Note that if the temporarily paid amount charge information is not received (B100: NO), the controller 21 of the terminal B ends the processing.

If accepting the charge for the temporarily paid amount has been selected (B110: YES) based on a user operation to the input/output device 23 of the terminal B, the controller 21 of the terminal B transmits reimbursement request information for making a request for reimbursement of the temporarily paid amount to the server 10 using the communication I/F 22 (B120).

If accepting the charge for the temporarily paid amount has not been selected (B110: NO) based on a user operation to the input/output device 23 of the terminal B, the controller 21 of the terminal B ends the processing.

If the reimbursement request information is received from the terminal B using the communication I/F 14 (S300: YES), the controller 11 of the server 10 executes reimbursement remittance processing (S310).

On the other hand, if reimbursement request information is not received (S300: NO), the controller 11 of the server 10 advances the processing to S330.

In the reimbursement remittance processing, first, the temporarily paid amount is sent from the electronic money account of the user B.B of the terminal B to the shared wallet. Upon remittance being completed by each user excluding the temporary payer, the amount to be borne by the payer, which is calculated by “(N−1)×temporarily paid amount”, is sent from the shared wallet to the electronic money account of the user A.A of the terminal A. The controller 11 of the server 10 then transmits reimbursement request result information including the remittance result to the terminal (here, the terminal B) of each user of the shared wallet using the communication I/F 14 (S320).

Note that if the temporarily paid amount charge information is transmitted to two or more terminals in S290, the controller 11 of the server 10 need not necessarily execute the reimbursement remittance processing unless the reimbursement request information is received from all the terminals to which the temporarily paid amount is transmitted.

In the reimbursement remittance processing, remittance may be carried out between users' electronic money accounts not via the shared wallet.

Lastly, the controller 11 of the server 10 transmits reimbursement result information including the remittance result to the terminal A of the user A.A, who is the temporary payer, using the communication I/F 14 (S330), and ends the processing.

Upon receiving the reimbursement request result information from the server 10 using the communication I/F 22, the controller 21 of the terminal B causes the display 24 to display the reimbursement request result information (B130), and ends the processing.

Also, upon receiving the reimbursement result information from the server 10 using the communication I/F 22, the controller 21 of the terminal A causes the display 24 to display the reimbursement result information (A340), and ends the processing.

In this variation, processing for sending money to the shared wallet that is based on the temporarily paid amount charge information is executed based on input performed by the user B.B of the terminal 20. If the shared wallet contains an amount greater than or equal to the amount paid from the user account of the terminal 20 of the user A.A through settlement (a non-limiting example of first settlement) carried out by the user A.A, the amount paid from the user account of the user A.A (a non-limiting example of the first account) through the settlement carried out by the user A.A is sent from the shared wallet.

As an example of the effect achieved by this configuration, if the shared account contains an amount greater than or equal to the amount paid from the first account through the first settlement, the amount paid from the first account through the first settlement can be sent from the shared account.

### Fourth Embodiment Variation (6)

In the fourth embodiment, if sending money from the electronic money account of the user A.A to the shared wallet is selected, the controller 21 of the terminal A transmits the remittance request information to the server 10 based on the electronic money account of the user A.A at the point of the selection. However, this need not be the case.

### Example Display Screen

FIG. 4-10 is a diagram showing an example of a code payment screen (before remittance) that is displayed when the icon shown as “code payment” in the camping fund payment screen in FIG. 3-3 is touched by the user A.A of the terminal 20.

FIG. 4-10 is different from FIG. 3-4 in the amount of the user's electronic money account balance (“1,000 yen” in this example) displayed next to the text “send money from your wallet” in the camping fund code payment region 2421.

FIG. 4-11 is a diagram showing an example of an insufficient shared wallet balance screen that is displayed when code payment is carried out using the payment codes in the code payment screen shown in FIG. 4-10 and the shared wallet balance is insufficient.

FIG. 4-11 is different from FIG. 4-1 in the amount of the user's electronic money account balance (“1,000 yen” in this example) displayed next to the text “send money from your wallet” in the insufficient shared wallet balance information display/operation region 2427. In this example, the amount to be settled is “3,000 yen”, while the shared wallet balance of the camping fund is “1,000 yen”, which is “2,000 yen” short. Therefore, it is selected whether or not to send “2,000 yen”, which is the shortfall, from the user's wallet balance.

FIG. 4-12 is a diagram showing an example of an insufficient user's wallet balance screen that is displayed when the remittance button 242E is touched in the insufficient shared wallet balance screen shown in FIG. 4-11.

FIG. 4-12 is the same as the insufficient shared wallet balance information display/operation region 2427 shown in FIG. 4-11, but is different in that the text “your wallet balance is insufficient” are displayed below the robot, and that a guide sentence “Top up your wallet?” is displayed. There is also a difference in that a top-up button 242G for topping up the shortfall amount to compensate for the insufficient balance is displayed in a lower part of the insufficient shared wallet balance information display/operation region 2427. Below that, a cancel button 242H that is for not execute the topping up and shown as “not now”, for example, without limitation thereto, is displayed.

In FIG. 4-12, if the top-up button 242G is touched to top up the user's wallet, the same top-up screen as FIG. 3-14 is displayed, for example, without limitation thereto. Then, a desired amount can be topped up in this top-up screen.

In this example, the user's wallet balance becomes “2,000 yen” as a result of topping up “1,000 yen” to the user's wallet, and the aforementioned shortfall can be compensated for.

Note that, in this case, another user (non-limiting examples of which include the user B.B) can be charged for the amount that was temporarily paid by the user A.A for payment, as described in the fourth embodiment variation (5).

FIG. 4-13 is a diagram showing an example of a code payment completion screen that is displayed on the terminal 20 when code payment is completed by the server 10, similarly to FIG. 4-2.

FIG. 4-13 is different from FIG. 3-7 in that a payment history check button 242J and a temporarily paid amount charging button 242K are displayed in a lower part of the code payment completion screen.

FIG. 4-14 is a diagram showing an example of a notification screen that is displayed for charging, for the temporarily paid amount, the user B.B, who is a member of the shared wallet for the camping fund and a charge destination for the temporarily paid amount, when the temporarily paid amount charging button 242K is touched in the code payment completion screen in FIG. 4-13.

In FIG. 4-14, in this application screen, “Payment App”, which is the application name of the payment application, is displayed in an uppermost title bar, and an icon image of the user B.B and the text “B.B” indicating the user name are displayed next to “PaymentApp”, for example, without limitation thereto. Below the title bar, the text “notifications” is displayed as a current location in the hierarchical menu of “Payment App”.

An icon image of a bell, which means a notification, is displayed below the text “notifications”, the text “shared wallet: camping fund” is displayed as a title in an upper line, of the upper and lower lines next to the icon image, and the text “a bill for the temporarily paid amount has arrived from A. A” is displayed as content of the notification in a lower line. Below that, the text “today”, which indicates the notification date, is displayed, and a camping fund notification display region 2429 is displayed below “today”.

In the camping fund notification display region 2429, the name of this shared wallet (“camping fund” in this example) is displayed in an upper part, together with an image of a wallet, which indicates a shared wallet. Next to “camping fund”, “Apr. 11, 2020 16:35” is displayed as the date and time of notification, and the icon images of the users A.A and B.B who share this shared wallet are displayed below the date and time.

Below the “camping fund”, the text “amount charged for temporarily paid amount” is displayed as an amount that is charged for the temporarily paid amount (hereinafter referred to as an “amount charged for temporarily paid amount”), and the shared wallet balance (“1,000 yen” in this example) of this camping fund is displayed below such text. The text “close details” is displayed below that. Also, the text “AA Sports Co., Ltd.”, which is the name of the company to which the payment amount is sent, is displayed together with a logo image of the company as details of the amount charged for the temporarily paid amount, below the “close details”. “Apr. 11, 2020 16:30” is displayed as the date and time of remittance on one side, and “3,000 yen” is displayed as a payment amount below the date and time of remittance.

The text “breakdown of payment” is displayed below the payment amount. Below that, the shared wallet balance (“1,000 yen” in this example) of the camping fund is displayed together with an image of a wallet and the name (camping fund) of the shared wallet. Below that, an image of a purse with a clasp and the text “temporarily paid by A.A” are displayed, and the temporarily paid amount (“2,000 yen” in this example) is displayed. Below that, the text “shared wallet members” is displayed together with icon images of the shared wallet members, and the number of members (“2” in this example) is displayed.

In this example, a remittance button 242L for sending the amount for compensating for the insufficient balance and a later button 242M for sending money later are displayed side by side in a lower part of the camping fund notification display region 2429. Below that, a menu button 242N for returning to the menu is displayed.

FIG. 4-15 is a diagram showing an example of a payment history screen that is displayed when the payment history check button 242J is touched in the code payment completion screen FIG. 4-13.

In FIG. 4-15, the payment history is displayed chronologically in rows in ascending order.

In the first row of payment history, “Apr. 5, 2020 11:12” is displayed as the date and time of payment, the text “EE Supermarket” is displayed as a payment destination below the date and time. Also, in this example, “5,000 yen” is displayed as a payment amount.

In the second row of payment history, “Apr. 11, 2020 16:30” is displayed as the date and time of payment, and a temporarily paid amount charging icon 242k with highlighted the text “charged for temporarily paid amount (2,000 yen)” is displayed indicating the temporarily paid amount. The temporarily paid amount charging icon 242k has the same function as the temporarily paid amount charging button 242K, and the screen transitions to FIG. 4-14 when the temporarily paid amount charging icon 242k is touched. Below that, “AA Sports Co., Ltd.” is displayed as a payment destination, and “3,000 yen” is displayed as a payment amount.

Note that in the above example, it is possible to cause the display 24 of the terminal 20 of the user who charges the temporarily paid amount to display information indicating that the temporarily paid amount has been charged, and to cause the display 24 of the terminal 20 of the user to be charged to display information indicating that the user has been charged for the temporarily paid amount.

In this case, this information may be displayed in an application screen of the payment application, but may alternatively be displayed in a talk-room screen of the aforementioned messaging application.

FIG. 4-16 is a diagram showing an example of the talk-room screen of the messaging application displayed in the display 24 of the terminal 20 (terminal A) of the user A.A based on the temporarily paid amount charging button 242K being operated in the code payment completion screen in FIG. 4-13.

As a result of the user (user A.A) of the terminal A charging the user (user B.B) of the terminal B for the temporarily paid amount, a message indicating the charging is transmitted from the messaging management server 10B to the terminal A and is displayed in a talk-room for the user A.A to talk with the user B.B (a talk-room with the user B.B as a talk partner). In this example, a first temporarily paid amount charging message 2433 containing text indicating that the user B.B is charged for the temporarily paid amount and the details thereof are displayed in a balloon form as a message originating from the user A. A, on the right side of the screen.

FIG. 4-17 is a diagram showing an example of a talk-room screen of the messaging application that is displayed in the display 24 of the terminal 20 (terminal B) of the user B.B based on the temporarily paid amount charging button 242K being operated in the code payment completion screen in FIG. 4-13.

As a result of the user (user A.A) of the terminal A charging the user (user B.B) of the terminal B for the temporarily paid amount, a message indicating the charging is transmitted from the messaging management server 10B to the terminal B and is displayed in a talk-room for talking with the user A.A. In this example, a second temporarily paid amount charging message 2434 containing text indicating that the user A.A has charged the user B.B for the temporarily paid amount and the details thereof are displayed in a balloon form as a message originating from the user A.A, on the left side of the screen.

### Processing

FIG. 4-18 is a flowchart showing an example flow of processing executed by the devices in this variation. These flowcharts show examples of settlement processing executed by the controller 21 of a terminal A (non-limiting examples of which include the terminal 20 of a user A.A), settlement management processing executed by the controller 11 of the server 10, and store settlement processing executed by the controller 51 of the store code reader device 50, which is an element of a store POS system (non-limiting examples of which include the store POS system 40 at a member store S1), in order from the left.

If sending money from the electronic money account of the user A.A to the shared wallet is selected (A140: YES), the controller 21 of the terminal A determines whether or not the electronic money account balance of the user A.A is smaller than the shortfall in the balance for settlement based on the shortfall in the balance for settlement stored in A290 and the user account information displayed in A130 (A350).

If the electronic money account balance of the user A.A is greater than or equal to the shortfall in the balance for settlement (A350: NO), the controller 21 of the terminal A advances the processing to A150.

If the electronic money account balance is insufficient (A350: YES), the controller 21 of the terminal A executes steps A210 to A230. Accordingly, in this case, the controller 11 of the server 10 executes steps S190 to S210 after executing step in S270a.

Note that if topping up the account is not selected in step A210 (A210: NO), the controller 21 of the terminal A may return to A140 and execute the processing.

In this variation, the terminal 20 causes the display 24 to display insufficient settlement balance information (a non-limiting example of second information relating to insufficiency of a balance of a shared account that is based on an amount of first settlement, the balance of the shared account, and a second account), based on the amount to be settled (a non-limiting example of the amount of the first settlement), the shared wallet balance (a non-limiting example of the balance of the shared account), and the user account of the user of the terminal 20 (a non-limiting example of the second account). The terminal 20 then executes, with use of the controller 21, processing (a non-limiting example of processing for sending money to the second account) for topping up the electronic money account of the user account of the user of the terminal 20 based on input to the display 24 displaying the insufficient settlement balance information that is made by the user of the terminal 20.

As an example of the effect achieved by this configuration, the user of the terminal can be notified that the balance of the shared account is insufficient. In addition, money can be sent to the second account based on the input made by the user of the terminal.

Further, in this variation, the terminal 20 causes the display 24 to display insufficient settlement balance information (a non-limiting example of first information relating to insufficiency of a shared account and a second account based on a balance of the shared account and a balance of the second account), based on the amount to be settled (a non-limiting example of an amount of first settlement), the shared wallet balance (a non-limiting example of the balance of the shared account), and the user account of the user of the terminal 20 (a non-limiting example of the second account). The terminal 20 then executes, with use of the controller 21, processing (a non-limiting example of processing for sending money to the second account) for topping up the electronic money account of the user account of the user of the terminal 20 based on input to the display 24 displaying the insufficient settlement balance information that is made by the user of the terminal 20.

As an example of the effect achieved by this configuration, the user of the terminal can be notified that the balances of the shared account and the second account are insufficient. In addition, money can be sent to the second account based on input to the first information that is made by the user of the terminal.

### Fourth Embodiment Variation (7)

In the fourth embodiment, whether or not to send money to the shared wallet from the electronic money account of the user (non-limiting examples of which include the user A.A) of the terminal (non-limiting examples of which include the terminal A) that executes settlement processing is selected. However, the electronic money account from which money is sent is not limited thereto.

Money may alternatively be able to be sent from an electronic money account of another member of the shared wallet (non-limiting examples of which include the user B.B) included in the shared wallet, for example, without limitation thereto.

FIG. 4-19 is a flowchart showing an example flow of processing executed by the devices in this variation. These flowcharts show examples of settlement processing executed by the controller 21 of the terminal A (non-limiting examples of which include the terminal 20 of the user A.A), settlement linkage processing executed by the controller 21 of the terminal B (non-limiting examples of which include the terminal 20 of the user B.B), settlement management processing executed by the controller 11 of the server 10, and store settlement processing executed by the controller 51 of the store code reader device 50, which is an element of a store POS system (non-limiting examples of which include the store POS system 40 at a member store S1), in order from the left.

Note that the latter half of the processing may be the same as FIG. 4-5, for example, without limitation thereto, and a description thereof is therefore omitted here.

After A290, the controller 21 of the terminal A causes the display 24 to additionally display a button functioning to select whether or not to make a request for remittance to the shared wallet from an electronic money account of another user (non-limiting examples of which include the user B.B) who is a shared wallet member, for example, without limitation thereto. The controller 21 of the terminal A then determines whether or not making a request for remittance to the shared wallet from an electronic money account of another user (non-limiting examples of which include the user B.B) is selected, based on a user operation to the input/output device 23 of the terminal A (A360).

If making a request for remittance from the electronic money account of the user B.B to the shared wallet is selected (A360: YES), the controller 21 of the terminal A transmits remittance claim information including the request for remittance and a claimed remittance amount that is an amount equal to the shortfall in the balance for settlement, for example, without limitation thereto, to the server 10 using the communication I/F 22 (A370).

If making a request for remittance from the electronic money account of the user B.B to the shared wallet is not selected (A360: NO), the controller 21 of the terminal A receives the settlement result information from the server 10 using the communication I/F 22, and executes step A180 in FIG. 4-5.

If the remittance claim information is received from the terminal A using the communication I/F 14 (S340: YES), the controller 11 of the server 10 transmits remittance verification information including the claimed remittance amount to the terminal B using the communication I/F 14 (S350).

If the remittance claim information is not received (S340: NO), the controller 11 of the server 10 receives the settlement request information from the store code reader device 50 using the communication I/F 14, and executes step S170a in FIG. 4-5.

If remittance verification information is received from the server 10 using the communication I/F 22 (B140: YES), the controller 21 of the terminal B causes the display 24 to display a screen for selecting whether or not to authorize the remittance from the electronic money account of the user B.B to the shared wallet, based on the remittance verification information (B150).

On the other hand, if the remittance verification information is not received (B140: NO), the controller 21 of the terminal B ends the processing.

If authorizing the remittance to the shared wallet is selected based on a user operation to the input/output device 23 of the terminal B (B150: YES), the controller 21 of the terminal B transmits the remittance request information to the server 10 using the communication I/F 22 (B160).

On the other hand, if not authorizing the remittance to the shared wallet is selected (B150: NO), the controller 21 of the terminal B ends the processing.

If the remittance request information is received from the terminal B using the communication I/F 14 (S360: YES), the controller 11 of the server 10 executes remittance processing to send the claimed remittance amount from the electronic money account of the user B.B to the shared wallet (S370). The controller 11 of the server 10 then transmits remittance request result information including the result of the remittance processing and the electronic money account balance of the user B.B after the remittance, for example, without limitation thereto, to the terminal B using the communication I/F 14 (S380).

Next, the controller 21 of the server 10 transmits shared wallet information including the shared wallet information after the remittance to the terminal A using the communication I/F 14 (S390).

If the remittance request information is not received from the terminal B (S360: NO), the controller 11 of the server 10 transmits shared wallet information including the shared wallet balance to the terminal A using the communication I/F 14 (S390).

Note that, in this case, information indicating that the remittance claim has been declined by the terminal B may be incorporated into the shared wallet information and transmitted.

Next, the controller 11 of the server 10 receives the settlement request information from the store code reader device 50 using the communication I/F 14, and executes step S170a.

Upon receiving the remittance request result information from the server 10 using the communication I/F 22, the controller 21 of the terminal B causes the display 24 to display the remittance request result information (B170), and ends the processing.

Upon receiving the shared wallet information from the server 10 using the communication I/F 22, the controller 21 of the terminal A causes the display 24 to update and display the shared wallet balance, for example, without limitation thereto, based on the received shared wallet information (A380).

Note that if information indicating that the remittance claim has been declined by the terminal B is included in the shared wallet information, the display 24 may be caused to display this information may in a pop-up format or the like, for example, without limitation thereto.

Next, the controller 21 of the terminal A then receives the settlement result information from the server 10 using the communication I/F 22, and executes step A180.

Note that in the above processing, the controller 21 of the terminal 20 may select making a request for remittance from an electronic money account of another user (non-limiting examples of which include the user B.B) to the shared wallet based on a selection of a talk-room (a non-limiting example of a chat-room) that at least includes the user of the own terminal 20 (non-limiting examples of which include the user A.A) and the other user (non-limiting examples of which include the user B.B), the selection being performed by the user of the own terminal 20, for example, without limitation thereto.

In this case, it is possible to cause the display 24 of the terminal 20 to display the same screen as the member selection screen (talk-room selection screen) in the messaging application described with reference to FIG. 3-21 and have the user select a talk-room to make a request for remittance to, for example, without limitation thereto.

This variation describes a configuration in which the second account is a user account of a user (a non-limiting example of a first user) different from the user of the own terminal 20.

As an example of the effect achieved by this configuration, settlement can be implemented based at least on the account of the first user different from the user of the terminal.

Further, this variation describes a configuration in which a user account (a non-limiting example of a second account) of a user different from the user of the own terminal 20 is selected based on input to the own terminal 20 that is made by the user of the own terminal 20.

As an example of the effect achieved by this configuration, the second account can be easily selected based on the input to the terminal performed by the user of the terminal.

Further, this variation describes a configuration in which a user account (a non-limiting example of a second account) of a user different from the user of the own terminal 20 is selected based on a selection of a chat-room including the user of the own terminal 20 and another user (a non-limiting example of a first user) that is performed by the user of the own terminal 20.

As an example of the effect achieved by this configuration, the second account can be easily selected based on a selection of a chat-room including the user of the terminal and the first user.

Further, in this variation, the terminal 20 transmits the remittance claim information (a non-limiting example of information relating to a request for permission for settlement that is based on a second account) to a terminal 20 different from the own terminal 20 using the communication I/F 22. Processing relating to settlement is executed based on the permission for settlement using an account (a non-limiting example of a second account) of a user (a non-limiting example of a first user) different from the user of the own terminal 20, the permission being made by the different user.

As an example of the effect achieved by this configuration, settlement can be enabled based on settlement using the second account being permitted by the first user. Conversely, settlement can be disabled if settlement using the second account is not permitted by the first user.

### Fourth Embodiment Variation (8)

In the fourth embodiment variation (7), even if the shortfall in the shared wallet balance is temporarily paid by making a request for sending money from an electronic money account of another user (non-limiting examples of which include the user B.B) of the shared wallet at the time of payment at a member store, the user of the own terminal himself is not charged for the temporarily paid amount. However, the user may be charged for the temporarily paid amount.

FIGS. 4-20 and 4-21 are flowcharts showing an example flow of processing executed by the devices in this variation. These flowcharts show examples of settlement processing executed by the controller 21 of the terminal A (non-limiting examples of which include the terminal 20 of the user A.A), settlement linkage processing executed by the controller 21 of the terminal B (non-limiting examples of which include the terminal 20 of the user B.B), settlement management processing executed by the controller 11 of the server 10, and store settlement processing executed by the controller 51 of the store code reader device 50, which is an element of a store POS system (non-limiting examples of which include the store POS system 40 at a member store S1), in order from the left.

Note that the former half of the processing may be the same as FIG. 4-19 for example, without limitation thereto, and a description thereof is therefore omitted here.

Upon causing the settlement result information to be displayed (A180), the controller 21 of the terminal A causes the display 24 to display a screen for selecting whether or not to make reimbursement for the temporarily paid amount (A320).

If making reimbursement has been selected (A320: YES), the controller 21 of the terminal A transmits the shortfall in the balance for settlement stored in the storage 28 of the terminal A to the server 10 using the communication I/F 22 (A330), and then advances the processing to A400.

On the other hand, if not making the reimbursement is selected (A320: NO), the controller 21 of the terminal A ends the processing.

If the shortfall in the balance for settlement received from the terminal A using the communication I/F 14 is greater than “0” (S280: YES), the controller 11 of the server 10 transmits the shortfall in the balance for settlement to the terminal 20 (here, terminal B) of the temporary payer (S400).

If the shortfall in the balance for settlement is received from the server 10 using the communication I/F 22 (B180: YES), the controller 21 of the terminal B causes the display 24 to display a screen for selecting whether or not to charge another member of the shared wallet for electronic money for the shortfall in the balance for settlement that has been temporarily paid by the user B.B of the terminal B (B190).

On the other hand, if the shortfall in the balance for settlement is not received (B180: NO), the controller 21 of the terminal B ends the processing.

If charging the other member of the shared wallet for the temporarily paid amount is selected based on a user operation to the input/output device 23 of the terminal B (B190: YES), the controller 21 of the terminal B transmits reimbursement charge information to the server 10 using the communication I/F 22 (B200).

On the other hand, if not charging the other member for the temporarily paid amount has been selected (B190: NO), the controller 21 of the terminal B skips B200 and advances the processing forward.

If the reimbursement charge information is received from the terminal B using the communication I/F 14 (S410: YES), the controller 11 of the server 10 executes steps from S420 to S450.

Note that these steps can be executed similarly to S290 to S320 in FIG. 4-9 with the terminal A serving as a transmission destination and a receiver, and the details are therefore not described.

If the reimbursement charge information is not received (S410: NO), the controller 11 of the server 10 advances the processing to step S460.

Upon receiving the temporarily paid amount charge information from the server 10 using the communication I/F 22 (A400: YES), the controller 21 of the terminal A executes steps A410 to A440.

Note that these steps can be executed similarly to steps B110 to B130 in FIG. 4-9, and the details are therefore not described.

If the temporarily paid amount charge information is not received (A400: NO), the controller 21 of the terminal A receives reimbursement result information from the server 10 using the communication I/F 22, and executes step A340.

Lastly, the controller 11 of the server 10 transmits reimbursement result information including the remittance result to the terminal B of the user B.B who is the temporary payer and the terminal A of the user A.A who has proposed the reimbursement, using the communication I/F 14 (S460), and ends the processing.

Also, upon receiving the reimbursement result information from the server 10 using the communication I/F 22, the controller 21 of the terminal B causes the display 24 to display the reimbursement result information (B210), and ends the processing.

The same applies to the terminal A (A340).

Note that in the above processing, the terminal B temporarily pays electronic money for the shortfall in the balance for settlement from the user account of the user (user B.B) of the own terminal 20. However, this need not be the case.

The terminal B may alternatively carry out settlement by using (consuming) electronic money for the shortfall in the balance for settlement from a user account of a user (non-limiting examples of which include a user C.C of a terminal C) who is a shared wallet member other than the users A.A and B.B, for example, without limitation thereto. In this case, the user B.B may obtain permission from the user C.C in advance.

If the reimbursement charge information is transmitted (B200), the controller 21 of the terminal B can cause the display 24 of the terminal B to display information indicating that the temporarily paid amount has been charged, for example, without limitation thereto.

If the temporarily paid amount charge information is received (A400: YES), the controller 21 of the terminal A can cause the display 24 of the terminal A to display the information indicating that the temporarily paid amount has been charged.

In this case, this information may be displayed in an application screen of the payment application, but it may alternatively be displayed on a talk-room screen of the aforementioned messaging application. This configuration may be adopted similarly to the screens shown in FIGS. 4-16 and 4-17, for example, without limitation thereto.

In this variation, a second terminal 20 (a terminal 20 to be charged) receives temporarily paid amount charge information (a non-limiting example of charge information relating to a charge for an amount that is based on payment using a second account) from a first terminal 20 (a terminal 20 that charges the temporarily paid amount) via the server 10 using the communication I/F 22. The second terminal 20 then causes the display 24 to display an indication (a non-limiting example of a first indication and a third indication that are based on the charge information) that is based on the received temporarily paid amount charge information.

As an example of the effect achieved by this configuration, the user of the terminal can be notified that the user has been charged for an amount that is based on payment using the second account and the content of the charge.

Further, in this variation, the first terminal 20 transmits temporarily paid amount charge information (a non-limiting example of charge information relating to a charge for an amount that is based on payment using a second account) to the second terminal 20 via the server 10 using the communication I/F 22. The first terminal 20 then causes the display 24 to display an indication (a non-limiting example of a second indication that is based on charge information) that is based on the transmitted temporarily paid amount charge information.

As an example of the effect achieved by this configuration, the user of the terminal can make a charge for an amount that is based on payment using the second account and then notify the user of the terminal of information relating to this charge.

Further, in this variation, processing relating to settlement (a non-limiting example of processing relating to first settlement) is executed by a first terminal 20 (a non-limiting example of a first terminal) based on a shared account with which at least a user of a second terminal 20 and a user (a non-limiting example of a first user) of the first terminal 20 can carry out settlement, and a user account (a non-limiting example of a first account) of the user of the first terminal 20, and the second terminal 20 receives the temporarily paid amount charge information (a non-limiting example of charge information relating to a charge for an amount that is based on the first settlement) based on settlement (a non-limiting example of the first settlement) carried out by the user of the first terminal 20, from the first terminal 20 via the server 10 using the communication I/F 22. The second terminal 20 then causes the display 24 to display an indication (a non-limiting example of a first indication that is based on the charge information) that is based on the received temporarily paid amount charge information.

As an example of the effect achieved by this configuration, it is possible to receive the charge for the amount that is based on the first settlement and notify the user of the terminal of the information relating to the charge, based on the processing relating to the first settlement being executed by the first terminal of the first user, based on the shared account with which at least the user of the terminal and the first user different the user of the terminal can carry out settlement, and the first account different from the shared account.

Further, in this variation, the first account is a user account of a user (a non-limiting example of a first user) of the first terminal 20.

As an example of the effect achieved by this configuration, the processing relating to the first settlement can be executed by the first terminal of the first user based on the shared account with which at least the user of the terminal and the first user different from the user of the terminal can carry out settlement, and the account of the first user.

Further, in this variation, the temporarily paid amount charge information is determined based on an amount (a non-limiting example of an amount paid by the first account) temporarily paid by the user account of the user of the first terminal 20. The second terminal 20 executes, with use of the controller 21, processing (a non-limiting example of processing relating to sending an amount that is based on charge information) for sending money from the user account of the user of the terminal 20 to the user account of the user of the first terminal 20.

As an example of the effect achieved by this configuration, an amount that is based on the charge information determined based on an amount paid using the first account can be sent from the account of the user of the terminal to the first account.

Further, in this variation, regarding the temporarily paid amount charge information, the amount is determined based on a shared wallet member (a non-limiting example of a user able to carry out settlement using a shared account).

As an example of the effect achieved by this configuration, it is possible to receive a charge for an amount that is based on the charge information determined based on the user able to carry out settlement using the shared account, and notify the user of the terminal of information relating to this charge.

Further, in this variation, the terminal 20 displays temporarily paid amount charge information in a talk-room (a non-limiting example of a chat-room) in which messages or the like (a non-limiting example of content) can be transmitted to and received from a shared wallet member.

As an example of the effect achieved by this configuration, the user of the terminal can be notified of information relating to a charge in an easy-to-understand form, i.e., a form of an indication in a chat-room in which content can be transmitted to and received from a user able to carry out settlement using the shared account.

Further, this variation describes a configuration in which remittance processing that is based on temporarily paid amount charge information is executed based on an operation (a non-limiting example of input to remittance information that is made by a user) to a remittance button or the like (a non-limiting example of remittance information).

As an example of the effect achieved by this configuration, remittance can be easily implemented based on input by the user to remittance information for sending money that is based on the charge information.

Further, in this variation, the indication that is based on the temporarily paid amount charge information includes information regarding the user of the first terminal 20.

As an example of the effect achieved by this configuration, the user of the terminal can be notified of the information regarding the user of the first account.

Further, in this variation, processing (a non-limiting example of processing relating to second settlement) relating to settlement is executed based on the shared account and the user account (a non-limiting example of a second account) of the user of the second terminal 20. The second terminal 20 then receives temporarily paid amount charge information that is based on settlement (a non-limiting example of first settlement) carried out by the user of the first terminal 20 and settlement (a non-limiting example of second settlement) carried out by the user of the second terminal 20, from the first terminal 20 via the server 10 using the communication I/F 22. The second terminal 20 executes, with use of the controller 21, processing (a non-limiting example of processing relating to sending an amount that is based on charge information) for sending money from the user account of the user of the terminal 20 to the user account of the user of the first terminal 20.

As an example of the effect achieved by this configuration, the processing relating to the second settlement is executed based on the shared account and the second account different from the shared account, and it is possible to receive a charge that is based on the first and second settlement and send money from the account of the user of the terminal to the first account.

Further, this variation describes a configuration in which the temporarily paid amount charge information (a non-limiting example of charge information relating to a charge for an amount that is based on first settlement) is transmitted from the server 10 (a non-limiting example of a server that executes processing relating to the first settlement).

As an example of the effect achieved by this configuration, charge information can be easily acquired from the server that executes the processing relating to the first settlement.

Further, this variation describes a configuration in which the first account is a user account of a user account (a non-limiting example of a user different from a first user) of a user different from the user (a non-limiting example of the first user) of the second terminal 20 able to carry out settlement using the shared account.

As an example of the effect achieved by this configuration, it is possible to receive a charge for an amount that is based on the first settlement and notify the user of the terminal of information relating to the charge, based on the processing relating to the first settlement being executed by the first terminal of the first user, based on the shared account with which at least the user of the terminal and the first user different from the user of the terminal can carry out settlement, and an account of a user able to carry out settlement using the shared account and different from the first user.

Further, in this variation, the server 10 executes, with use of the controller 11, settlement processing (a non-limiting example of processing relating to first settlement) based on the shared account with which at least the user (a non-limiting example of a user of a terminal) of the second terminal 20 and a user (a non-limiting example of a first user) of the first terminal 20 can carry out settlement, and a user account (a non-limiting example of a first account) of the user of the first terminal 20. The server 10 then transmits temporarily paid amount charge information (a non-limiting example of charge information relating to a charge for an amount that is based on first settlement) based on this settlement (a non-limiting example of the first settlement) to the second terminal 20 using the communication I/F 14.

As an example of the effect achieved by this configuration, the processing relating to the first settlement can be executed to implement settlement based on the shared account with which at least the user of the terminal and the first user different from the user of the terminal can carry out settlement, and the first account different from the shared account. In addition, the user of the terminal can be charged for the amount that is based on the first settlement.

### Fourth Embodiment Variation (9)

In the above embodiment, settlement is implemented based on the payment code displayed in the display 24 of the terminal 20 being read by the store code reader device 50, or based on the payment store code being read by the terminal 20. That is, the above embodiment has described a method of carrying out code settlement. However, this need not be the case. Settlement can also be carried out using wireless communication (including short-range wireless communication) instead of code settlement.

FIG. 4-22 is a diagram showing an example configuration of the store code reader device 50 in this variation.

The store code reader device 50 includes a short-range wireless communication I/F 581, for example, without limitation thereto, in addition to the configuration in FIG. 1-2.

The short-range wireless communication I/F 581 is an interface for performing short-range wireless communication with the terminal 20.

Here, short-range wireless communication includes contactless short-range communication (hereinafter referred to as “contactless communication”) and Bluetooth-based short-range communication (hereinafter referred to as “Bluetooth communication”), for example, without limitation thereto.

In the case of applying contactless communication, the short-range wireless communication I/F 581 can include a card reader for reading information stored in a contactless IC card such as an NFC chip provided in the terminal 20 and a card reader/writer for reading/writing information, for example, without limitation thereto. In this case, the user of the terminal 20 can carry out settlement similarly to the above embodiment by holding the terminal 20 over the card reader or the card reader/writer at the store, instead of code settlement (in the user-presenting mode or store-presenting mode) in the above embodiment.

In this case, if, as a result of reading information using the card reader, the shared wallet balance (a balance of a first account) is insufficient, the controller 11 of the server 10 transmits information (insufficient settlement balance information) indicating the insufficiency of the shared wallet balance to the terminal 20 using the communication I/F 14, for example, without limitation thereto. Upon receiving the insufficient settlement balance information from the server 10 using the communication I/F 22, the controller 21 of the terminal 20 causes the display 24 to display the insufficient settlement balance information. Based on input to the displayed insufficient settlement balance information that is made by the user of the terminal 20, the account to be used for settlement is changed and set to the user account (second account) of the user of the terminal 20 from the shared account, for example, without limitation thereto. Settlement can then be carried out by the user of the terminal 20 holding the terminal 20 again over the card reader at the store.

Note that if, as a result of reading information using the card reader, the shared wallet balance (a balance of a first account) is insufficient, information indicating the insufficiency of the shared wallet balance may be written to a contactless IC card of the terminal 20 using the card reader/writer, for example, without limitation thereto. In response to this, the controller 21 of the terminal 20 may cause the display 24 to display the insufficient settlement balance information, and change and set the account to be used for settlement to the user account (second account) of the user of the terminal 20 from the shared account, for example, without limitation thereto, based on input to the displayed insufficient settlement balance information that is made by the user of the terminal 20. Then, the user of the terminal 20 may be able to carry out settlement by holding the terminal 20 again over the card reader at the store.

In the case of applying Bluetooth communication, the short-range wireless communication I/F 581 includes a Bluetooth communication module or the like for performing Bluetooth communication with the terminal 20. In this case as well, settlement can be carried out in the same manner as described above by adopting Bluetooth communication, instead of contactless communication, as the communication method.

This variation describes a configuration in which processing relating to settlement is executed through wireless communication with the store code reader device 50 (a non-limiting example of a terminal at a store that sells goods or provides a service to be purchased through first settlement) using the communication I/F 22 (a non-limiting example of a communication interface).

As an example of the effect achieved by this configuration, settlement can be easily implemented by the communication interface of the terminal wirelessly communicating with the terminal at the store that sells goods or provides a service to be purchased through the first settlement.

Further, this variation describes a configuration in which the aforementioned wireless communication includes contactless communication and Bluetooth communication (a non-limiting example of short-range communication).

As an example of the effect achieved by this configuration, wireless communication with the terminal at the store that provides goods or provides a service to be purchased through the first settlement can be implemented through short-range communication.

### Fifth Embodiment

The fifth embodiment is an embodiment in which the terminal 20 (non-limiting examples of which include the terminal A) uses the payment application to execute payment at a member store from the shared wallet balance, or from an electronic money balance of a temporary payment account (hereinafter referred to as an “integrated account”) that is obtained by combining the shared wallet balance with the electronic money account balance of the user (non-limiting examples of which include the user A.A) of the terminal 20.

The content described in the fifth embodiment is applicable to any other embodiments and variations.

Corresponding elements that are the same as those already described are assigned the same reference numerals as those used for corresponding elements, and a redundant description thereof is omitted.

### Data Configuration

FIG. 5-1 is a diagram showing an example of information stored in the storage 15 of the server 10 in the present embodiment.

An integrated account management database 159, for example, without limitation thereto, is stored in the storage 15, in addition to the payment application management processing program 151, the payment application user registration data 153, the user management database 155, and the shared wallet management database 157.

The integrated account management database 159 is a database with which the server 10 manages the integrated account, and FIG. 5-2 shows an example of a data configuration thereof.

Integrated account management data is stored as management data for each integrated account in the integrated account management database 159.

In each piece of the integrated account management data, an integrated account ID, which is an example of identification information for identifying a corresponding integrated account, and an integrated account member ID, which indicates an account of a user included in this integrated account, are stored, for example, without limitation thereto. As the integrated account member ID, an account (including a payment application ID, a shared wallet ID etc. of the user) of the payment application integrated into the integrated account is stored.

FIG. 5-2 shows that an integrated account identified as “UN0001” is created by “U0001” (i.e., the user A.A) and “S0001” (i.e., the shared wallet “camping fund”), for example, without limitation thereto.

### Example Display Screen

FIG. 5-3 is a diagram showing an example of a code payment screen (before integration) that is displayed when the icon shown as “code payment” in the camping fund payment screen in FIG. 3-3 is touched by the user A.A of the terminal 20.

The screen in FIG. 5-3 is almost the same as the screen in FIG. 3-4, but is different in some indications in the camping fund code payment region 2421.

In the camping fund code payment region 2421 in FIG. 3-4, the text “send money from your wallet” is displayed together with the check mark button CN2, and the balance (“25,000 yen” in this example) is displayed next to such text. Meanwhile, in the camping fund code payment region 2421 in FIG. 5-3, a slide button CN7 for selecting (switching) whether or not to execute integration is arranged together with the text “integrate with your wallet” as information for integrating the shared wallet for the camping fund with the user's wallet. Below that, the text “your wallet” is newly displayed, and the user's electronic money account balance (“25,000 yen” in this example) is displayed next to such text.

The slide button CN7 is an image of an elongated circle having a circle therein. When the slide button CN7 is in a default state (“OFF” in this example), the circle is located at the left end of the elongated circle. The slide button CN7 is changed to a state with the circle located at the right end of the elongated circle (“ON” in this example) by touching or sliding the circle, and the color in the elongated circle is then highlighted, for example, without limitation thereto.

FIG. 5-4 is a diagram showing an example of a code information updating screen that is displayed when the slide button CN7 is operated in the code payment screen (before integration) in FIG. 5-3.

FIG. 5-4 is different from FIG. 5-3 in that the slide button CN7 in the camping fund code payment region 2421 is in the “ON” state, and updating information CJK indicating that the code information is being updated is superimposed on the camping fund code payment region 2421. In the updating information CJK, two rotating arrows indicating that the code information is being updated are displayed at the center, and the text “updating code information . . . ” is displayed below the arrows.

FIG. 5-5 is a diagram showing an example of a code payment screen (after integration) that is displayed after the payment code information updating screen in FIG. 5-4 is updated.

That is, in an upper part of the camping fund code payment region 2421, an image of a wallet, the shared wallet name (camping fund), a sign “+” indicating addition, an image of a purse, and the text “your wallet” is displayed. In addition, the integrated balance (“26,000 yen” in this example) after the shared wallet (camping fund) and the user's wallet are added and integrated is displayed.

Payment codes displayed in the camping fund code payment region 2421 in FIG. 5-5 are different from the payment codes in FIG. 5-3 due to the accounts having been integrated.

The user A.A of the terminal 20 presents the aforementioned code payment screen to a clerk of the store at a code register and carries out code payment by having the payment codes read by the store code reader device, as mentioned above. Upon the settlement processing being completed by the server 10, the same code payment completion screen as FIG. 3-7 is displayed.

### Processing

FIGS. 5-6 and 5-7 are flowcharts showing an example flow of processing executed by the devices in the embodiment. These flowcharts show examples of settlement processing executed by the controller 21 of a terminal A (non-limiting examples of which include the terminal 20 of a user A.A), settlement management processing executed by the controller 11 of the server 10, and store settlement processing executed by the controller 51 of the store code reader device 50, which is an element of a store POS system (non-limiting examples of which include the store POS system 40 at a member store S1), in order from the left. These types of processing are examples of processing relating to code settlement in the user-presenting mode.

After causing the display 24 to additionally display the electronic money account balance of the user A.A of the terminal A (A130), for example, without limitation thereto, the controller 21 of the terminal A causes the display 24 to additionally display a button functioning to select whether or not to execute payment using an integrated account that is obtained by combining the electronic money account balance of the user A.A with the shared wallet balance (A450a).

If executing payment using the integrated account is selected based on a user operation to the input/output device 23 of the terminal A (A450a: YES), the controller 21 of the terminal A transmits account integration request information to the server 10 using the communication I/F 22 (A460).

If executing payment using the integrated account is not selected (A450a: NO), the controller 21 of the terminal A receives the settlement result information from the server 10 using the communication I/F 22, and executes step A180 in FIG. 1-9.

If the account integration request information is received from the terminal A using the communication I/F 14 (S470a: YES), the controller 11 of the server 10 executes account integration processing (S480).

If the account integration request information is not received (S470a: NO), the controller 11 of the server 10 receives the settlement request information from the store code reader device 50, and executes step S170a in FIG. 1-9.

In the account integration processing, the controller 11 of the server 10 adds a record of integrated account management data having a unique integrated account member ID to the integrated account management database 159, and stores the payment application ID of the user A.A and the shared wallet ID of the shared wallet as integrated account member IDs of this record.

The controller 11 of the server 10 then generates a payment token for authorizing payment from the balance of the integrated account associated with the integrated account ID. In the following, this token will be referred to as an “integrated account payment token”.

Here, the balance of the integrated account is the combined total amount of the balances of electronic money associated with the payment application ID and the shared wallet ID that are stored as the integrated account member IDs.

The integrated account payment token is identified by an integer value of a predetermined number of digits (non-limiting examples of which include 12 digits), for example, without limitation thereto, similarly to the shared wallet payment token. The integrated account payment token may be a token with an expiration time.

Upon the integrated account payment token being generated through the account integration processing, the controller 11 of the server 10 generates integrated account code information, which is code information including the integrated account payment token. The integrated account code information includes a payment code (image information) obtained by encoding an identifier of the integrated account payment token to a one-dimensional code (bar code) and/or a two-dimensional code (QR code), for example, without limitation thereto.

Note that if the integrated account payment token has an expiration time, the integrated account code information may also include the expiration time.

The controller 11 of the server 10 then transmits the integrated account code information to the terminal A using the communication I/F 14 (S490a).

Note that if the account integration request information is not received from the terminal A using the communication I/F 14 (S470a: NO), the controller 11 of the server 10 receives the settlement request information from the store code reader device 50 using the communication I/F 14, and executes step S170a in FIG. 1-9.

If the integrated account code information is received from the server 10 using the communication I/F 22, the controller 21 of the terminal A causes the display 24 to update and display the payment code based on the received integrated account code information (A470a).

Note that if the integrated account code information includes the identifier and the expiration time of the integrated account payment token, the controller 21 of the terminal A may also update and display the identifier and the expiration time.

The controller 51 of the store code reader device 50 uses the code reader 58 to read the payment code displayed in the display 24 of the terminal A (P140). In this case, since the payment code displayed in the display 24 is associated with the integrated account payment token, the reading result obtained by the code reader 58 includes the integrated account payment token as a payment token.

The controller 51 of the store code reader device 50 transmits settlement request information including the store ID, the amount to be settled, and the payment token (in this case, the integrated account payment token), for example, without limitation thereto, to the server 10 using the communication I/F 54 (P150).

Upon receiving the settlement request information from the store code reader device 50 using the communication I/F 14, the controller 11 of the server 10 executes integrated account settlement processing (S500a).

In the integrated account settlement processing, the controller 11 of the server 10 retrieves the integrated account ID using the integrated account payment token with which the request has been made. Further, the controller 11 of the server 10 executes, for the integrated account, settlement processing to pay the amount to be settled to the member store defined by the store ID, using the combined total of the electronic money account balance of the user A.A and the shared wallet balance that are designated by the integrated account member IDs, based on the integrated account member IDs (here, the payment application ID of the user A.A and the shared wallet ID of the shared wallet) associated with the integrated account ID.

If the settlement using the integrated account is successful, the controller 11 of the server 10 reduces the shared wallet balance by the amount to be settled. If the shared wallet balance falls below the amount to be settled, the controller 11 reduces the shared wallet balance to “0” and subtracts the shortfall from the electronic money account balance of the user A.A.

Note that if the settlement using the integrated account is successful, the controller 11 of the server 10 may reduce the electronic money account balance of the user A.A by the amount to be settled, and if the electronic money account balance of the user A.A falls below the amount to be settled, the controller 11 may reduce the electronic money account balance of the user A.A to “0” and subtract the shortfall from the shared wallet balance.

Next, the controller 11 of the server 10 transmits settlement result information including the result of the settlement processing and the integrated account balance after the settlement processing, for example, without limitation thereto, to the store code reader device 50 using the communication I/F 14 (S510).

The controller 11 of the server 10 also transmits integrated account settlement result information including the result of the settlement processing, the electronic money account and the shared wallet balance that is included in the integrated account after the settlement processing, and the amounts paid from the electronic money account and the shared wallet, for example, without limitation thereto, to the terminal A using the communication I/F 14 (S520), and ends the processing.

Upon receiving the settlement result information from the server 10 using the communication I/F 54, the controller 51 of the store code reader device 50 causes the display 53 to display the settlement result information (P160), and ends the processing.

Upon receiving the integrated account settlement result information from the server 10 using the communication I/F 22, the controller 21 of the terminal A causes the display 24 to display the integrated account settlement result information (A480), and ends the processing.

Relationship Between Integrated Account Payment Token and Code Information

As mentioned above, the integrated account payment token is a payment token for authorizing payment from the balance of the integrated account associated with the integrated account ID, for example, without limitation thereto. That is, the integrated account payment token is associated with the integrated account ID. Code information obtained by encoding the integrated account payment token is the integrated account code information.

Also, the integrated account ID is associated with the integrated account member IDs that are a payment application ID and a shared wallet ID of a shared wallet that are to be integrated, for example, without limitation thereto.

Accordingly, it can be said that the integrated account code information (a non-limiting example of first code information) includes or is associated with a payment application ID (a non-limiting example of information relating to a second account) and a shared wallet ID (a non-limiting example of information relating to a shared account) that are to be integrated.

Effects of Fifth Embodiment

In the fifth embodiment, the terminal 20 executes processing relating to settlement based on the shared wallet balance. Money can be sent from the user account of the user of the terminal 20 to the shared wallet balance.

This configuration makes it possible to achieve the same effects as those of the third and fourth embodiments, for example, without limitation thereto.

Further, in the fifth embodiment, the terminal 20 causes the display 24 to display the integrated account code information (a non-limiting example of first code information) associated with user account information (a non-limiting example of second account information) of the user of the terminal 20 and the shared account, based on input to this user account information. The terminal 20 executes processing relating to settlement based on the integrated account code information being read.

As an example of the effect achieved by this configuration, the first code information associated with the second account and the shared account can be displayed in the display region of the terminal and used for settlement, based on input to the second account information. In addition, settlement can be easily implemented based on the first code information being read.

In the fifth embodiment, the terminal 20 causes the display 24 to display the shared wallet code information (a non-limiting example of first code information) associated with the shared account, and the user account information (a non-limiting example of second account information) of the user of the terminal 20. The terminal 20 causes the display 24 to display the integrated account code information (a non-limiting example of second code information) associated with the user account information and the shared account, based on input to the user account information regarding the user of the terminal 20.

As an example of the effect achieved by this configuration, the first code information associated with the shared account can be displayed in the display region of the terminal and used for settlement, and the user of the terminal can recognize the second account information. In addition, the second code information associated with the second account and the shared account can be displayed in the display region of the terminal and used for settlement based on input to the second account information.

The fifth embodiment describes a configuration in which the shared wallet code information (a non-limiting example of first code information) and the integrated account code information (a non-limiting of second code information) are transmitted from the server 10 (a non-limiting example of a server that executes processing relating to first settlement) to the terminal 20.

As an example of the effect achieved by this configuration, the first code information and the second code information can be easily acquired from an external device.

Further, the fifth embodiment describes a configuration in which the terminal 20 causes the display 24 to display information regarding the balance of the integrated account that is the combined total of information regarding the shared wallet balance (a non-limiting example of an amount of first electronic money associated with a shared account) and the electronic money account balance (an amount of second electronic money associated with a second account, without limitation thereto) of the user account, and the integrated account code information (a non-limiting example of second code information).

As an example of the effect achieved by this configuration, the user of the terminal can be notified of the combined total amount of the amount of the first electronic money associated with the shared account and the amount of the second electronic money associated with the second account. In addition, the second code information can be displayed in the display region of the terminal and used for settlement.

Fifth Embodiment Variation (1)

In the fifth embodiment, upon receiving the integrated account code information, the controller 21 of the terminal A causes the display 24 to update and display the integrated account code information. However, the payment code need not be updated.

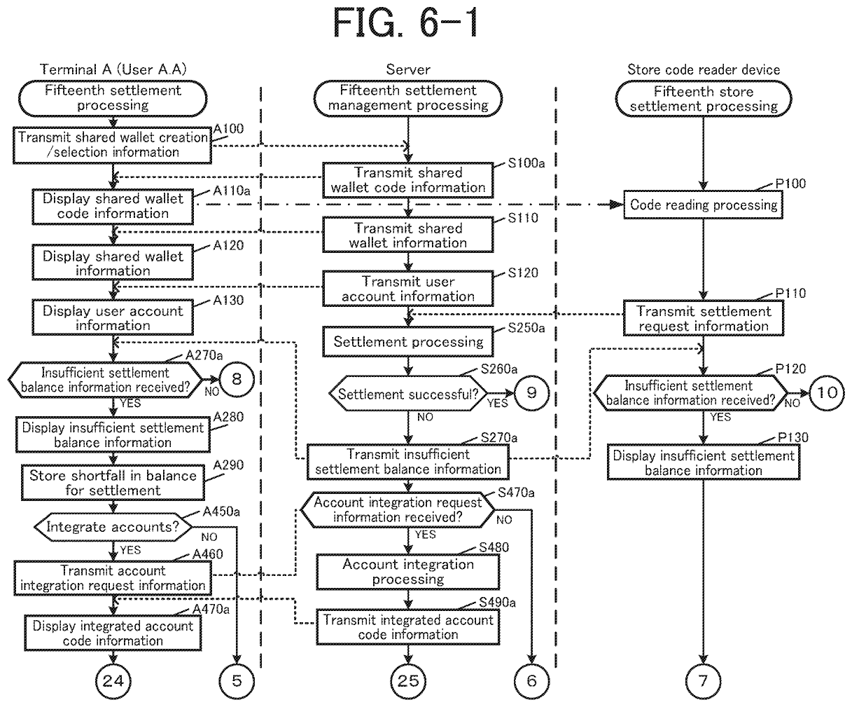

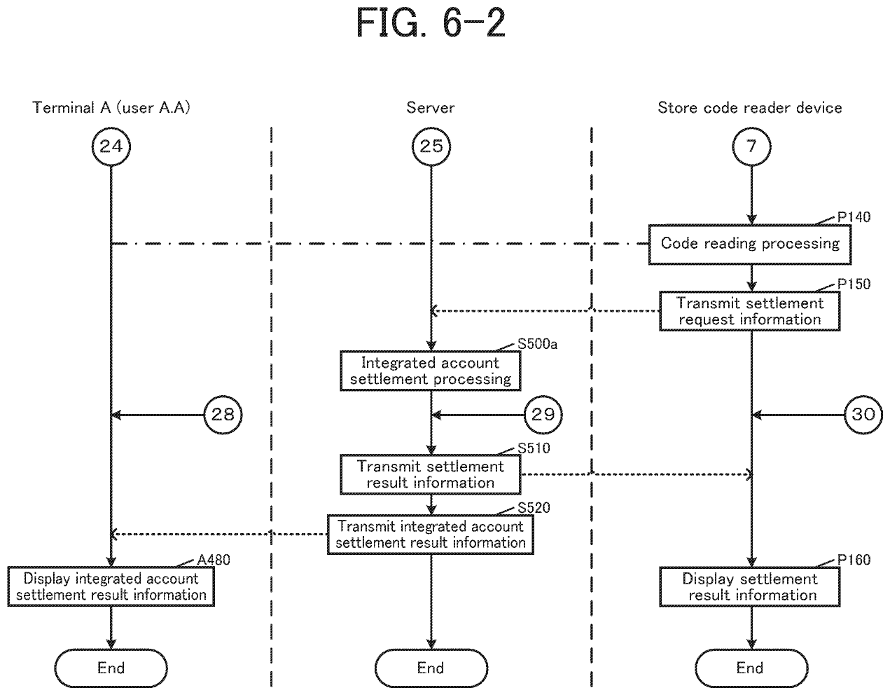

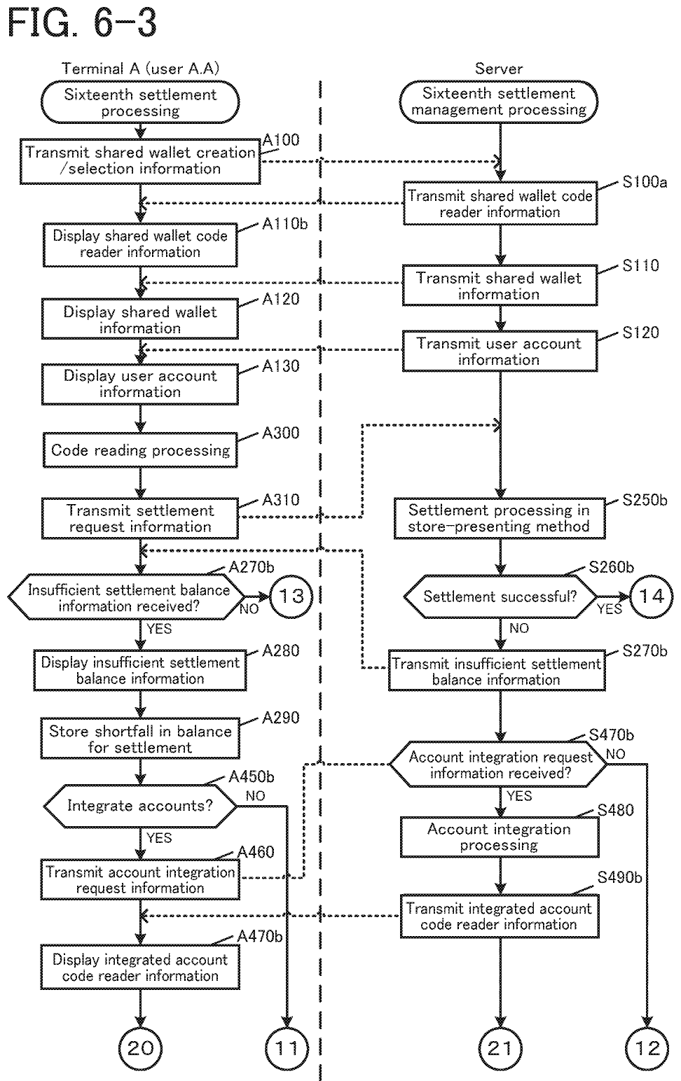

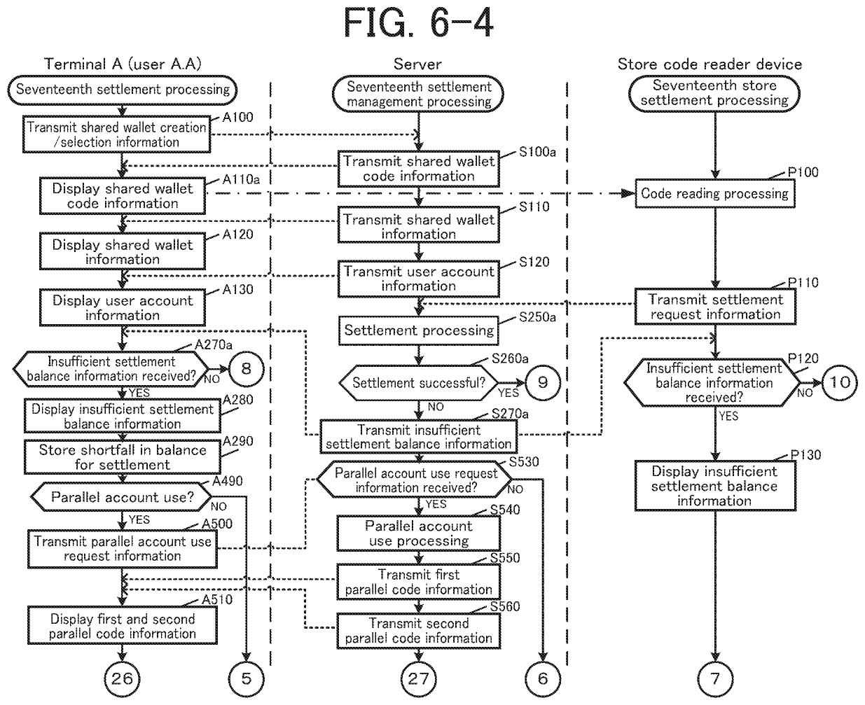

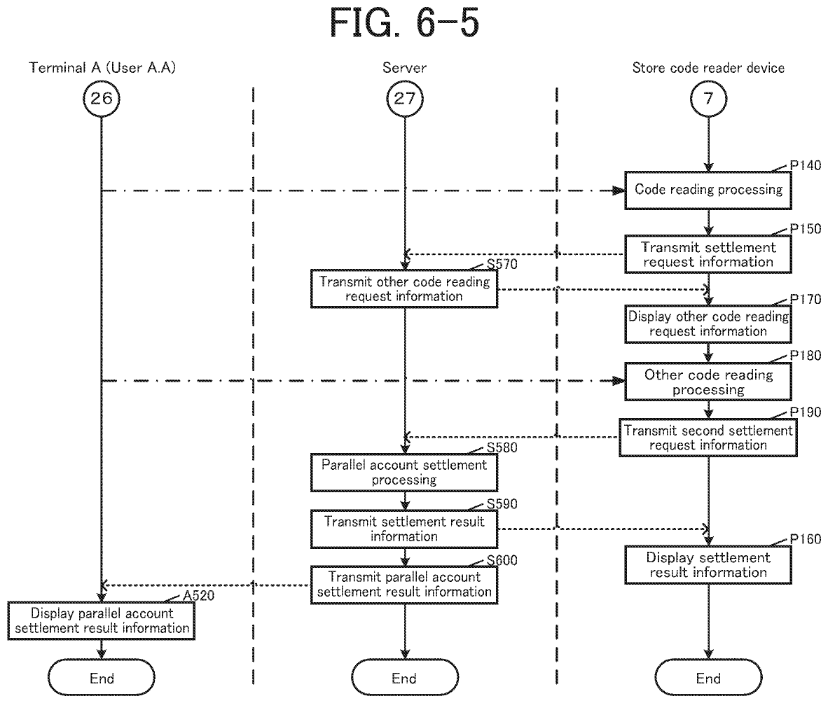

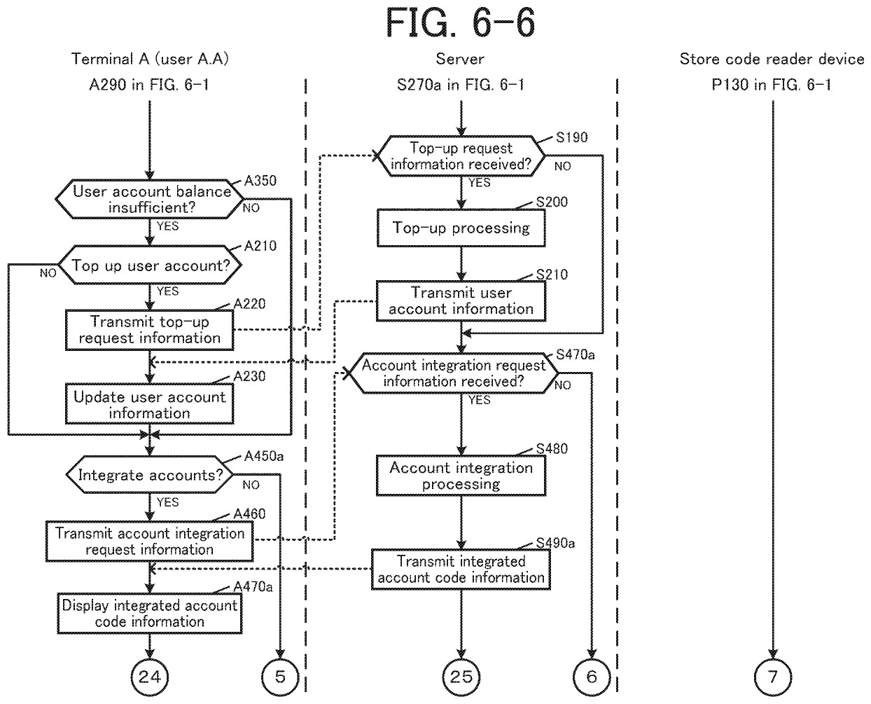

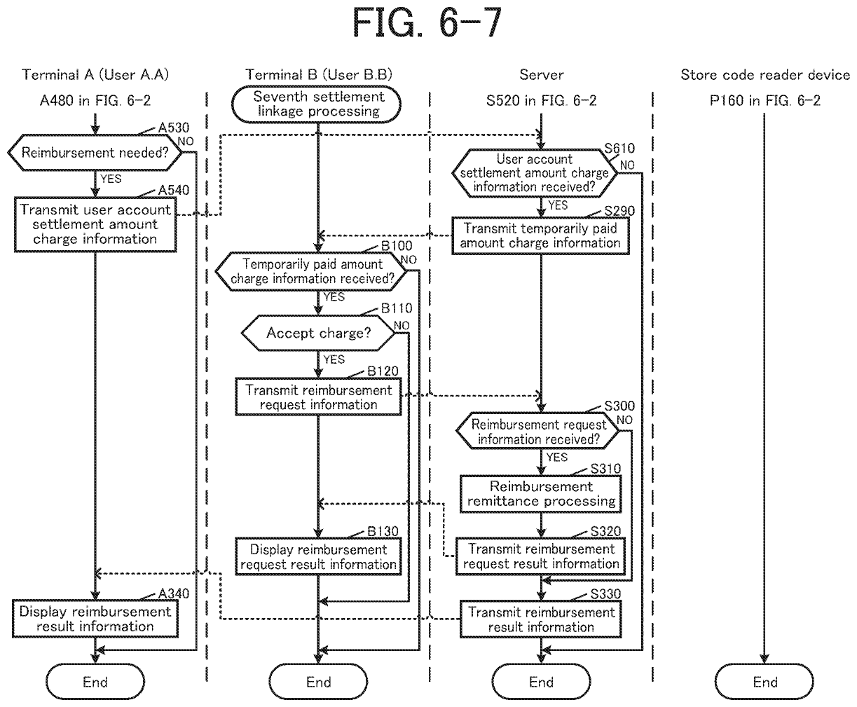

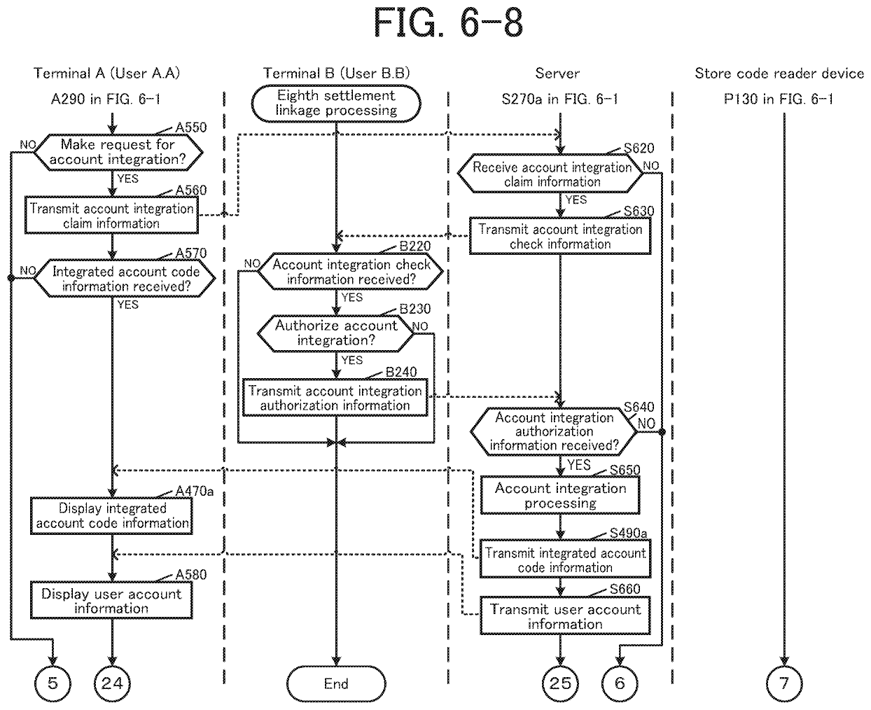

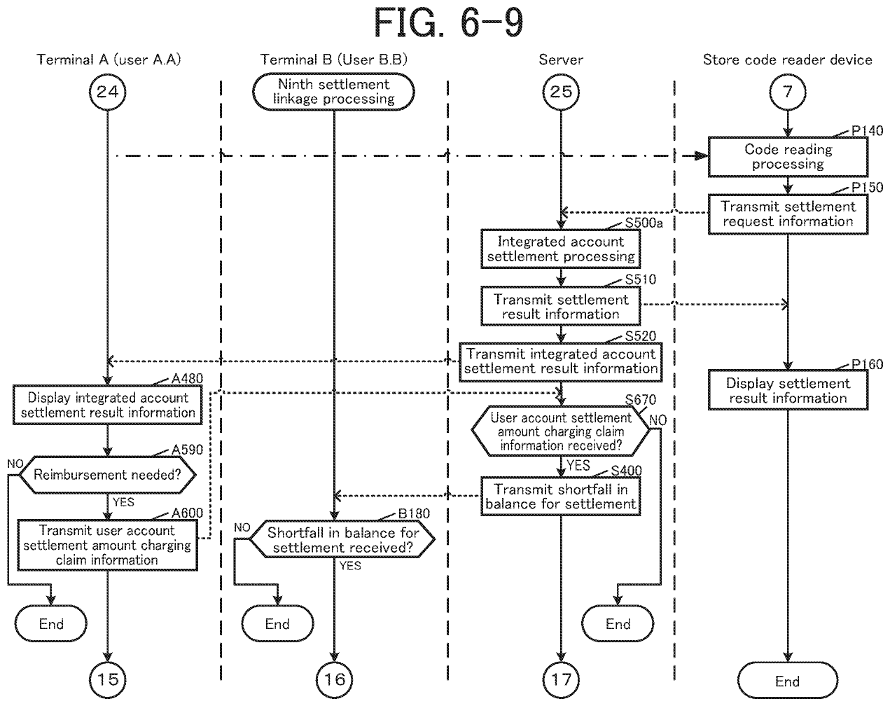

In this case, in S480 in FIG. 5-6, the controller 11 of the server 10 deletes (invalidates) the shared wallet payment token generated in S100a in FIG. 5-6, for example, without limitation thereto. Then, the controller 11 may generate an integrated account payment token having the same identifier as that of the shared wallet payment token generated in S100a in FIG. 5-6.

Fifth Embodiment Variation (2)

The fifth embodiment has described code settlement in the user-presenting mode, but this need not be the case. Specifically, code settlement in the store-presenting mode may alternatively be adopted.

Example Display Screen

FIG. 5-8 is a diagram showing an example of a code reader screen (before integration) that is displayed when a “code reader” icon in the camping fund payment screen in FIG. 3-3 is touched by the user A.A of the terminal 20.

In FIG. 5-8, “camping fund”, which is the currently executed item in the submenu, is displayed as a current location in the hierarchical menu of the “Payment App” below the title bar. Below the “camping fund”, a code reading region CR1 is displayed, “code reader” is displayed as an operation guide for the user, and a camping fund code payment region 2423 is displayed below the “code reader”.

In an upper part of the camping fund code payment region 2423, an image of a wallet, the name of the shared wallet (camping fund), and the shared wallet balance of this camping fund (“1,000 yen” in this example) are displayed, similarly to FIG. 3-4. Below that, the text “integrate with your wallet” is displayed, and a slide button CN7 is arranged next to such text. Below that, the text “your wallet” is displayed, and the balance (“25,000 yen” in this example) is displayed next to such text.

FIG. 5-9 is a diagram showing an example of a payment code information updating screen that is displayed when the slide button CN7 is touched in the code reader screen (before integration) in FIG. 5-8.

In this example, the slide button CN7 has been touched, for example, and is in the “ON” state (with the circle moved to the right end of the elongated circle, and the elongated circle highlighted). Updating information CJK is displayed in a pop-up format, similarly to FIG. 5-4.

FIG. 5-10 is a diagram showing an example of a code reader screen (after integration) that is displayed after the payment code information updating screen in FIG. 5-9 is updated.

In this screen, the updating information CJK that was displayed in a pop-up format in the screen in FIG. 5-9 has been erased as a result of account integration (updating of the code information) being completed. In an upper part of the camping fund code payment region 2423, information in which an image of a wallet and the text “camping fund” are combined with an image of a purse with a clasp and the text “your wallet” by a sign “+” is displayed as information indicating that the shared wallet has been integrated with the user's wallet. In addition, the combined balance (“26,000 yen” in this example) after the wallet integration is displayed in association with the above information.

After the reading of the payment store code is completed in the code reader screen shown in FIG. 5-10, the input of the payment amount shown in FIG. 3-11 is completed, and settlement processing is completed by the server 10, the same code payment completion screen as FIG. 3-7 is displayed.

Processing

FIGS. 5-11 and 5-12 are flowcharts showing an example flow of processing executed by the devices in this variation. These flowcharts show examples of settlement processing executed by the controller 21 of the terminal A (non-limiting examples of which include the terminal 20 of the user A.A) and settlement management processing executed by the controller 11 of the server 10, in order from the left.

After causing the display 24 to display the user account information (A130), the controller 21 of the terminal A causes the display 24 to additionally display a button functioning to select whether or not to execute payment using an integrated account that is the combined total of the electronic money account balance of the user A.A and the shared wallet balance (A450b).

If executing payment using the integrated account is selected based on a user operation to the input/output device 23 of the terminal A (A450b: YES), the controller 21 of the terminal A executes step A460.

If executing payment using the integrated account is not selected (A450b: NO), the controller 21 of the terminal A executes step A190 in FIG. 1-11.

If the account integration request information is received from the terminal A using the communication I/F 14 (S470b: YES), the controller 11 of the server 10 executes account integration processing (S480).

If the account integration request information is not received (S470b: NO), the controller 11 of the server 10 receives the settlement request information from the terminal A, and executes step S170b in FIG. 1-11.

Upon executing step S480, the controller 11 of the server 10 generates integrated account code reader information, which is code reading information including the generated integrated account payment token. The controller 11 of the server 10 then transmits the integrated account code reader information to the terminal A using the communication I/F 14 (S490b).

Upon receiving the integrated account code reader information from the server 10 using the communication I/F 22, the controller 21 of the terminal A causes the display 24 to display a code reader screen for reading a payment store code, based on the received integrated account code reader information, and activates the camera 27 to read the code (A470b). The controller 21 of the terminal A then executes step A190.

Upon receiving the settlement request information from the terminal A using the communication I/F 14, the controller 11 of the server 10 executes integrated account settlement processing in the store-presenting mode (S500b).

The integrated account settlement processing in the store-presenting mode can be executed similarly to the integrated account settlement processing, and therefore, a detailed description thereof is omitted.

The controller 11 of the server 10 then executes step S520, and ends the processing.

Upon receiving the integrated account settlement result information from the server 10 using the communication I/F 22, the controller 21 of the terminal A causes executes step A480 and ends the processing.

In this variation, the terminal 20 causes the display 24 to display a code reader screen (a non-limiting example of first code reader information) for reading a payment store code that is based on the integrated account code reader information, based on input to the user account information (a non-limiting example of second account information) of the user of the terminal 20. The terminal 20 then executes processing relating to settlement with use of the controller 21, based on reading of the payment store code using the terminal 20 with the code reader screen displayed in the display 24.

As an example of the effect achieved by this configuration, the first code reader information can be displayed in the display region of the terminal and used for settlement, based on the input to the second account information. In addition, settlement can be easily implemented based on reading of the code information using the terminal with the first code reader information displayed in the display region.

Further, in this variation, the terminal 20 causes the display 24 to display the code reader screen (a non-limiting example of first code reader information) for reading the payment store code. The terminal 20 then causes the display 24 to display the code reader screen (a non-limiting example of second code reader information) for reading the payment store code that is based on the integrated account code reader information, based on input to the user account information (a non-limiting example of second account information) of the user of the terminal 20. The terminal 20 then executes processing relating to settlement with use of the controller 21, based on reading of the payment store code using the terminal 20 with the code reader screen displayed in the display 24.

As an example of the effect achieved by this configuration, the first code reader information can be displayed in the display region of the terminal and used for settlement, and the user of the terminal can recognize the second account information. In addition, the second code reader information can be displayed in the display region of the terminal and used for settlement based on the input to the second account information.

Further, this variation describes a configuration in which the terminal 20 causes the display 24 to display information regarding the balance of the integrated account that is the combined total of information regarding the shared wallet balance (a non-limiting example of an amount of first electronic money associated with a shared account) and the electronic money account balance (an amount of second electronic money associated with a second account, without limitation thereto) of the user account, and the code reader screen (a non-limiting example of second code reader information) for reading the payment store code that is based on the integrated account code reader information.

As an example of the effect achieved by this configuration, the user of the terminal can be notified of the combined total amount of the amount of the first electronic money associated with the shared account and the amount of the second electronic money associated with the second account. In addition, the second code reader information can be displayed in the display region of the terminal and used for settlement.

Fifth Embodiment Variation (3)

In the fifth embodiment, a plurality of accounts are associated with a single code in the account integration processing. However, this need not be the case. A plurality of payment codes may be displayed on a terminal to carry out settlement using these codes, for example, without limitation thereto.

Note that when settlement is carried out using a plurality of codes, the maximum amount that can be settled is the total of electronic money account balances of the plurality of accounts associated with the plurality of codes.

This payment method will be hereinafter referred to as “parallel account use”.

Example Display Screen

FIG. 5-13 is a diagram showing another example of the code payment screen.

In FIG. 5-13, two payment codes that are one-dimensional payment codes shown as bar codes are displayed one on top of the other, unlike FIG. 5-5.

The upper payment code is first parallel code information for authorizing payment from the electronic money account balance associated with the payment application ID of the user A.A and in which a payment token (a later-described first parallel payment token), which includes a flag for selecting parallel account use, is stored, for example, without limitation thereto.

Meanwhile, the lower payment code is second parallel code information for authorizing payment from the shared wallet balance associated with the shared wallet ID and in which a payment token (a later-described second parallel payment token), which includes a flag for selecting parallel account use, is stored, for example, without limitation thereto.

Note that the positions at which the first and second parallel code information is displayed and the arrangement thereof can be freely set and changed.

The first and second payment code information may alternatively be two-dimensional payment codes shown as QR codes or the like, instead of one-dimensional payment codes as mentioned above.

Processing

FIGS. 5-14 and 5-15 are flowcharts showing an example flow of processing executed by the devices in this variation. These flowcharts show examples of settlement processing executed by the controller 21 of a terminal A (non-limiting examples of which include the terminal 20 of a user A.A), settlement management processing executed by the controller 11 of the server 10, and store settlement processing executed by the controller 51 of the store code reader device 50, which is an element of a store POS system (non-limiting examples of which include the store POS system 40 at a member store S1), in order from the left.

The controller 21 of the terminal A, after executing step A130, causes the display 24 to additionally display a button functioning to select whether or not to execute payment with parallel account use with the electronic money account of the user A.A and the shared wallet (A490).

If executing payment with parallel account use is selected based on a user operation to the input/output device 23 of the terminal A (A490: YES), the controller 21 of the terminal A transmits parallel account use request information to the server 10 using the communication I/F 22 (A500).

If executing payment with parallel account use is not selected (A490: NO), the controller 21 of the terminal A receives the settlement result information from the server 10 using the communication I/F 22, and executes step A180 in FIG. 1-9.

If the parallel account use request information is received from the terminal A using the communication I/F 14 (YES: S530), the controller 11 of the server 10 executes parallel account use processing (S540).

If the parallel account use request information is not received (S530: NO), the controller 11 of the server 10 receives the settlement request information from the store code reader device 50, and executes step S170a in FIG. 1-9.

In the parallel account use processing, the controller 11 of the server 10 first authorizes payment from the electronic money account balance associated with the payment application ID of the user A.A, and generates a payment token including a flag for selecting parallel account use. This payment token will be hereinafter referred to as a “first parallel payment token”.

Further, the controller 11 of the server 10 authorizes payment from the shared wallet balance associated with the shared wallet ID, and generates a payment token including a flag for selecting parallel account use. This payment token will be hereinafter referred to as a “second parallel payment token”.

The first and second parallel payment tokens are each identified by an integer value of a predetermined number of digits (non-limiting examples of which include 12 digits), for example, without limitation thereto. These tokens may have an expiration time.

The controller 11 of the server 10 then generates first parallel code information, which is code information including the first parallel payment token, and second parallel code information, which is code information including the second parallel payment token.

The first and second parallel code information each includes a payment code (image information) obtained by encoding an identifier of a corresponding token into a one-dimensional code (bar code) and/or a two-dimensional code (QR code), for example, without limitation thereto.

Note that if the first and second parallel payment tokens have an expiration time, the code information may also include the expiration time.

After transmitting the first parallel code information to the terminal A using the communication I/F 14 (S550), the controller 11 of the server 10 transmits the second parallel code information to the terminal A using the communication I/F 14 (S560).

Upon receiving the first and second parallel code information using the communication I/F 22, the controller 21 of the terminal A causes the display 24 to display the first and second parallel code information one on top of the other (A510).

The controller 51 of the store code reader device 50 uses the code reader 58 to read one of the payment codes displayed in the display 24 of the terminal A (P140). The controller 51 of the store code reader device 50 then transmits settlement request information including the store ID, the amount to be settled, and the payment token (in this case, the first or second parallel payment token) to the server 10 using the communication I/F 54, for example, without limitation thereto (P150).

Upon receiving the settlement request information from the store code reader device 50 using the communication I/F 14, the controller 11 of the server 10 detects the flag for selecting parallel account use from the received first or second parallel payment token. Then, the controller 11 of the server 10 transmits the other code reading request information to the store code reader device 50 using the communication I/F 14 to make a request for the other payment token generated in the parallel account use processing (S570).

Upon receiving the other code reading request information from the server 10 using the communication I/F 54, the controller 51 of the store code reader device 50 causes the display 53 to display a screen that prompts the reading of the other payment code (P170).

The controller 51 of the store code reader device 50 uses the code reader 58 to read the other payment code displayed in the display 24 of the terminal A (P180). The controller 51 of the store code reader device 50 then transmits second settlement request information including the store ID, the amount to be settled, and the payment token (in this case, one of the first and second parallel payment tokens that was not transmitted in P150) to the server 10 using the communication I/F 54, for example, without limitation thereto (P190).

Upon receiving the second settlement request information from the terminal A using the communication I/F 14, the controller 11 of the server 10 executes parallel account settlement processing (S580).

The parallel account settlement processing can be executed similarly to the integrated account settlement processing by regarding the payment as payment using an integrated account of the electronic money account of the user A.A associated with the first parallel payment token and the shared wallet associated with the second parallel payment token. Therefore, a detailed description thereof is omitted.

The controller 11 of the server 10 then executes steps S590 and S600 and ends the processing. Also, upon receiving parallel account settlement result information from the server 10 using the communication I/F 22, the controller 21 of the terminal A executes step A520 and ends the processing.

Note that steps S590, S600, and A520 can be executed similarly to steps S510, S520, and A480 by regarding the payment as the same payment using an integrated account as in the parallel account settlement processing. Therefore, a redundant description thereof is omitted.

Fifth Embodiment Variation (4)

In the fifth embodiment, at the time of payment using an integrated account, even if the shared wallet balance is insufficient and the shortfall is temporarily paid using the user's electronic money account balance, another user (non-limiting examples of which include the user B.B) of the shared wallet is not charged for the temporarily paid amount. However, the other user may be charged for the temporarily paid amount.

FIG. 5-16 is a flowchart showing an example flow of processing executed by the devices in this variation. These flowcharts show examples of settlement processing executed by the controller 21 of the terminal A (non-limiting examples of which include the terminal 20 of the user A.A), settlement linkage processing executed by the controller 21 of the terminal B (non-limiting examples of which include the terminal 20 of the user B.B), settlement management processing executed by the controller 11 of the server 10, and store settlement processing executed by the controller 51 of the store code reader device 50, which is an element of a store POS system (non-limiting examples of which include the store POS system 40 at a member store S1), in order from the left.

Note that the former half of the processing can be implemented with the same processing as that in FIGS. 5-6 and 5-7, for example, without limitation thereto, and a description thereof is therefore omitted here.

The controller 21 of the terminal A, after executing step A480, causes the display 24 to display a screen for selecting whether or not to make reimbursement for the temporarily paid amount (A530).

Note that in the integrated account settlement result information used in step A480, if the amount paid from the electronic money account of the user A.A is “0”, or the settlement has failed, reimbursement need not be made (A530: NO). Then, the processing may end without causing the display 24 to display the selection screen. If the amount paid from the electronic money account of the user A.A is greater than “0” and the settlement has been successful, reimbursement may be automatically made (A530: YES) without causing the display 24 to display the selection screen.

If making reimbursement is selected based on a user operation to the input/output device 23 of the terminal A (A530: YES), the controller 21 of the terminal A transmits user account settlement amount charge information including the amount paid from the electronic money account of the user A.A included in the integrated account settlement result information to the server 10 using the communication I/F 22 (A540).

Upon receiving the reimbursement result information from the server 10 using the communication I/F 22, the controller 21 of the terminal A executes step A340 and ends the processing.

Note that if not making reimbursement has been selected (A530: NO), the controller 21 of the terminal A ends the processing.

After transmitting the integrated account settlement result information (S520) and receiving the user account settlement amount charge information from the terminal A using the communication I/F 14 (S610: YES), the controller 11 of the server 10 executes steps S290 to S330 while regarding the amount paid from the electronic money account of the user A.A included in the user account settlement amount charge information as the shortfall in the balance for settlement.

If the user account settlement amount charge information is not received (S610: NO), the controller 11 of the server 10 ends the processing.

Upon receiving the temporarily paid amount charge information from the server 10 using the communication I/F 22 (B100: YES), the controller 21 of the terminal B executes steps B110 to B130. If the temporarily paid amount charge information is not received (B100: NO), the controller 21 of the terminal B ends the processing.

Fifth Embodiment Variation (5)

In the fifth embodiment, the balance (an amount capable of being paid using an integrated account) of the integrated account is the combined total amount of the electronic money account balance of the user A.A and the shared wallet balance at the start of the payment. However, this need not be the case.

The electronic money account of the user A.A may be topped up (i.e., money may be sent thereto) from an account of an external financial institution that is registered in advance by the user A.A, before the shared wallet and the electronic money account of the user A.A are integrated, for example, without limitation thereto.

Example Display Screen

FIG. 5-17 is a diagram showing an example of a code payment screen (before integration) that is displayed when the icon shown as “code payment” in the camping fund payment screen in FIG. 3-3 is touched by the user A.A of the terminal 20. FIG. 5-17 is different from FIG. 5-3 in the balance (“1,000 yen” in this example) displayed next to “your wallet” in the camping fund code payment region 2421, and a top-up button CN5 is displayed next to the balance. If the top-up button CN5 is touched, top-up is performed in the top-up screen shown in FIG. 3-14.

FIG. 5-18 is a diagram showing an example of a code payment screen (after top-up) that is displayed when top-up is completed in the top-up screen in FIG. 3-14. In this example, the balance is “25,000 yen” as a result of being topped up.

FIG. 5-19 shows an example of a code payment screen (after integration) that is displayed based on the slide button CN7 being touched in the code payment screen (before integration) of FIG. 5-18 and the accounts being integrated.

In this example, in an upper part of the camping fund code payment region 2421 in FIG. 5-19, an image of a wallet, the name (camping fund) of the shared wallet, a sign “+” indicating addition, an image of a purse with a clasp, and the text “your wallet” are displayed. In addition, the integrated balance (“26,000 yen” in this example) that is based on the integration of the shared account with the user's account is also displayed.

The payment codes displayed in the camping fund code payment region 2421 in FIG. 5-19 are different from the payment codes in FIG. 5-18 as a result of the shared account and the user's account being integrated.

Processing

FIG. 5-20 is a flowchart showing an example flow of processing executed by the devices in this variation. These flowcharts show examples of settlement processing executed by the controller 21 of a terminal A (non-limiting examples of which include the terminal 20 of a user A.A), settlement management processing executed by the controller 11 of the server 10, and store settlement processing executed by the controller 51 of the store code reader device 50, which is an element of a store POS system (non-limiting examples of which include the store POS system 40 at a member store S1), in order from the left.

The controller 21 of the terminal A, after executing step A130, executes steps A210 to A230. Next, the controller 21 of the terminal A executes step A450a.

Accordingly, in this case, the controller 11 of the server 10 executes steps S190 to S210 after S120. Next, the controller 11 of the server 10 executes step A470a.

Note that the electronic money account of the user A.A may be topped up after integrating the shared wallet with the electronic money account of the user A.A. In this case, after executing step A470a, the controller 21 of the terminal A may execute steps A210 to A230, and may execute step A480 upon receiving the integrated account settlement result information from the server 10. Further, after executing step S490a, the controller 11 of the server 10 may execute steps S190 to S210, and may execute processing in S500a upon receiving the settlement request information from the store code reader device 50.

Fifth Embodiment Variation (6)

In the fifth embodiment, whether or not to integrate the shared wallet with the electronic money account of the user (non-limiting examples of which include the user A.A) of the terminal (non-limiting examples of which include the terminal A) that executes settlement processing is selected. However, the electronic money accounts to be integrated are not limited thereto. The electronic money account of another member (non-limiting examples of which include the user B.B) of the shared wallet may alternatively be integrated, for example, without limitation thereto.

Example Display Screen

FIG. 5-21 is a diagram showing an example of a code payment screen (before integration) that is displayed when the icon shown as “code payment” in the camping fund payment screen in FIG. 3-3 is touched by the user A.A of the terminal 20.

In FIG. 5-21, unlike FIG. 5-3, the text “integrate wallets” is displayed in the camping fund code payment region 2421, but no indication relating to integration with the user's wallet is given as in FIG. 5-3.

FIG. 5-22 is a diagram showing an example of a code payment screen (before member integration) that is displayed when the slide button CN7 is operated in the code payment screen (before integration) in FIG. 5-21.

In this example, the slide button CN7 in the “ON” state is shown in the camping fund code payment region 2421 in FIG. 5-18. Below that, a wallet integration guide region WT1 including the text “integrate wallets” and serving as an operation guide for the user is superimposed on the code payment screen.

Below that, further, a wallet integration member selection region WTM1 for selecting a user (member) to be integrated is superimposed on the wallet integration guide region WT1.

In the wallet integration member selection region WTM1, the explanation “which member's wallet do you want to integrate with?” is displayed in an upper part, and user candidates for account integration are displayed below the explanation in association with check mark buttons CN2.

Specifically, as a user candidate, information relating to the user (the user's icon image, “you” indicating the user, and the user's electronic money account balance (“25,000 yen” in this example)) are displayed, for example, without limitation thereto. Below that, as another user candidate, information relating to the user B.B (the icon image of the user B.B, the user name “user B.B”) is displayed.

Upon the check mark button CN2 associated with the user B.B being touched, the user account (electronic money account) of the user B.B is integrated with the shared wallet, for example, without limitation thereto.

FIG. 5-23 is a diagram showing an example of a notification screen that is displayed in the display 24 of the terminal 20 of the user B.B when the check mark button CN2 for selecting the user B.B is touched in the code payment screen (before member integration) in FIG. 5-22.

In FIG. 5-23, the icon image of the user B.B and the user name “B.B” are displayed in the title bar. Below the title bar, the text “notifications” is displayed as a current location in the hierarchical menu of “Payment App”.

An icon image of a “bell”, which indicates a notification, is displayed below the text “notifications”. Next to the icon image, the text “shared wallet: camping fund” is displayed in an upper part, and a notification summary (“wallet integration request has arrived from A.A” in this example) is displayed below. Below that, the text “today”, which indicates the notification date, is displayed.

Below the notification date, the camping fund notification display region 2429 is provided.

In an upper part of the camping fund notification display region 2429, an image of a wallet, which indicates a shared wallet, and the name of the shared wallet (“camping fund” in this example) are displayed, for example, without limitation thereto. Next to “camping fund”, “Apr. 11, 2020 16:18” is displayed as the date and time of notification, and icon images of users (“user A.A” and “user B.B” in this example) who share this shared wallet are displayed below the date and time.

In the camping fund notification display region 2429, “wallet integration request” is displayed as a requested item from the user A.A, and a sentence “wallet integration request has arrived from A.A” is displayed as content of the request below the requested item, for example, without limitation thereto.

Below that, as the details of the wallet integration request, the shared wallet balance (“1,000 yen” in this example) of the camping fund is displayed together with an image of a wallet and the name (“camping fund” in this example) of the shared wallet. Below that, the user's electronic money account balance (“20,000 yen” in this example) is displayed together with an image of a purse with a clasp and the text “your wallet” (the user B.B's wallet in this example). Below that, the text “shared wallet members” is displayed together with icon images of the shared wallet members, and the number (“2” in this example) of shared wallet members is displayed next to these icon images and the text.

In a lower part of the camping fund notification display region 2429, an allow button 242P for allowing wallet integration and a reject button 242Q for rejecting wallet integration are displayed.

FIG. 5-24 is a diagram showing an example of a code information update screen that is displayed in the display 24 of the terminal 20 of the user A.A when the allow button 242P is touched in the notification screen in FIG. 5-23.

In this code information update screen, unlike FIG. 5-22, the icon image of the user B.B, the user name “B.B”, and the electronic money account balance (“20,000 yen” in this example) of the user B.B are newly displayed together with a highlighted check mark button CN2 below the text “integrate wallets” in the camping fund code payment region 2421. Further, updating information CJK, which indicates that code information is being updated, is superimposed on the camping fund code payment region 2421.

FIG. 5-25 is a diagram showing an example of a code payment screen (after member integration) that is displayed in the display 24 of the terminal 20 of the user A.A after the code information update screen in FIG. 5-24.

In this code payment screen, the result of integrating the user account of the user B.B with the shared account is displayed. Specifically, in an upper part of the camping fund code payment region 2421, an image of a wallet, the name (camping fund) of the shared wallet, a sign “+” indicating addition, an image of a purse with a clasp, and “B.B's wallet” are displayed. Also, the amount (“21,000 yen” in this example) that is the sum of the shared wallet balance and the electronic money account balance of the user B.B is displayed as a balance after the account integration.

Further, as a result of the account integration, payment codes displayed in the camping fund code payment region 2421 in FIG. 5-25 are different from the payment code shown in FIG. 5-21.

FIG. 5-26 is a diagram showing an example of a code payment screen (integration request pending) that is displayed in the display 24 of the terminal 20 of the user A.A before either the allow button 242P or the reject button 242Q is operated by the user B.B in the notification screen in FIG. 5-23.

In this example, in the camping fund code payment region 2421, a slide button CN7 associated with the text “integrate wallets” is in an “ON” state.

Below that, the icon image of the user B.B and the user name “B.B” are displayed together with a grayed-out check mark button CN2. A rectangular frame surrounding the text “pending” is displayed next to the icon image and user name of the user B.B. This display allows the user A.A to recognize that a request for account integration has been made to the user B.B and has not yet been allowed by the user B.B (or has not been rejected).

FIG. 5-27 is a diagram showing another example of the code payment screen in FIG. 5-21.

FIG. 5-27 is different from FIG. 5-21 in that the text “top up shared wallet” is newly displayed together with a check mark button CN2 below the text “integrate wallets”. In this example, the user A.A can top up the shared wallet by touching the check mark button CN2.

Processing

FIG. 5-28 is a flowchart showing an example flow of processing executed by the devices in this variation. These flowcharts show examples of settlement processing executed by the controller 21 of the terminal A (non-limiting examples of which include the terminal 20 of the user A.A), settlement linkage processing executed by the controller 21 of the terminal B (non-limiting examples of which include the terminal 20 of the user B.B), settlement management processing executed by the controller 11 of the server 10, and store settlement processing executed by the controller 51 of the store code reader device 50, which is an element of a store POS system (non-limiting examples of which include the store POS system 40 at a member store S1), in order from the left.

The controller 21 of the terminal A, after executing step A130, integrates an electronic money account of another user (non-limiting examples of which include the user B.B) who is a shared wallet member with the shared wallet member, and causes the display 24 to additionally display a button functioning to select whether or not to making a request for enabling payment to the other user (non-limiting example of which include the user B.B), for example, without limitation thereto (A550).

If making a request to integrate the electronic money account of the user B.B with the shared wallet is selected based on a user operation to the input/output device 23 of the terminal A (A550: YES), the controller 21 of the terminal A transmits account integration claim information to the server 10 using the communication I/F 22 (A560).

If making a request to integrate the electronic money account of the user B.B with the shared wallet is not selected (A550: NO), the controller 21 of the terminal A receives the settlement result information from the server 10 using the communication I/F 22, and executes step A180 in FIG. 1-9.

If the account integration claim information is received from the terminal A using the communication I/F 14 (S620: YES), the controller 11 of the server 10 transmits account integration verification information to the terminal B using the communication I/F 14 (S630).

If the account integration claim information is not received (S620: NO), the controller 11 of the server 10 receives the settlement request information from the store code reader device 50 using the communication I/F 14, and executes step S170a in FIG. 1-9.

If the account integration verification information is received from the server 10 using the communication I/F 22 (B220: YES), the controller 21 of the terminal B causes the display 24 to display a screen for selecting whether or not to authorize integration of the electronic money account of the user B.B with the shared wallet, based on the account integration verification information (B230). If the account integration verification information is not received (B220: NO), the controller 21 of the terminal B ends the processing.

If authorizing the account integration is selected based on a user operation to the input/output device 23 of the terminal B (B230: YES), the controller 21 of the terminal B transmits account integration authorization information to the server 10 using the communication I/F 22 (B240), and ends the processing. If not authorizing the account integration is selected (B230: NO), the controller 21 of the terminal B ends the processing.

If the account integration authorization information is received from the terminal B using the communication I/F 14 (S640: YES), the controller 11 of the server 10 executes account integration processing to integrate the electronic money account of the user B.B with the shared wallet (S650), and executes step S490a.

Note that the account integration processing can be performed similarly to step S480 in FIG. 5-6, and the details of the processing are therefore not described.

If the account integration authorization information is not received (S640: NO), the controller 11 of the server 10 receives the settlement request information from the store code reader device 50 using the communication I/F 14, and executes step S170a in FIG. 1-9.

Next, the controller 11 of the server 10 transmits user account information including the electronic money account balance of the user B.B to the terminal A using the communication I/F 14 (S660). Upon receiving the settlement request information from the store code reader device 50 using the communication I/F 14, the controller 11 of the server 10 executes step S500a in FIG. 5-7.

If the integrated account code information is received from the server 10 using the communication I/F 22 (A570), the controller 21 of the terminal A executes step A470a. Next, upon receiving the user account information from the server 10 using the communication I/F 22, the controller 21 of the terminal A causes the display 24 to additionally display the electronic money account balance of the user B.B, for example, without limitation thereto, based on the received user account information (A580). Then, upon receiving the integrated account settlement result information from the server 10 using the communication I/F 22, the controller 21 of the terminal A executes step A480 in FIG. 5-7.

If the integrated account code information is not received (A570: NO), the controller 21 of the terminal A, upon receiving the settlement result information from the server 10 using the communication I/F 22, executes step A180 in FIG. 1-9.

Fifth Embodiment Variation (7)

In the fifth embodiment variation (6), at the time of payment using an integrated account of a shared wallet and an electronic money account of another user (non-limiting examples of which include the user B.B) of the shared wallet, even if the shared wallet balance is insufficient and the shortfall is temporarily paid using the balance of the other user's electronic money account, the user A.A of the terminal A that carried out the payment is not charged for the temporarily paid amount. However, the user A.A may be charged for the temporarily paid amount.

FIG. 5-29 is a flowchart showing an example flow of processing executed by the devices in this variation. These flowcharts show examples of settlement processing executed by the controller 21 of the terminal A (non-limiting examples of which include the terminal 20 of the user A.A), settlement linkage processing executed by the controller 21 of the terminal B (non-limiting examples of which include the terminal 20 of the user B.B), settlement management processing executed by the controller 11 of the server 10, and store settlement processing executed by the controller 51 of the store code reader device 50, which is an element of a store POS system (non-limiting examples of which include the store POS system 40 at a member store S1), in order from the left.

Note that the former half of the processing may be the same as FIG. 5-28, for example, without limitation thereto. Also, the latter half of the processing may be the same as FIG. 4-21, for example, without limitation thereto. Therefore, a description thereof is omitted here.

The controller 21 of the terminal A, after executing step A580 in FIG. 5-28, receives the integrated account settlement result information from the server 10 using the communication I/F 22, and executes step A480.

Next, the controller 21 of the terminal A causes the display 24 to display a screen for selecting whether or not to make reimbursement for the temporarily paid amount (A590).

Note that in the integrated account settlement result information used in step A480, if the amount paid from the electronic money account of the user B.B to which the request for integration has been made is “0”, or the settlement has failed, reimbursement need not be made (A590: NO). Then, the processing may end without causing the display 24 to display the selection screen. If the amount paid from the electronic money account of the user B.B is greater than “0” and the settlement has been successful, reimbursement may be automatically made (A590: YES) without causing the display 24 to display the selection screen.

If making reimbursement is selected based on a user operation to the input/output device 23 of the terminal A (A590: YES), the controller 21 of the terminal A transmits user account settlement amount charge information including the amount paid from the electronic money account of the user B.B included in the integrated account settlement result information to the server 10 using the communication I/F 22 (A600).

The controller 21 of the terminal A then executes step A400 and the subsequent steps in FIG. 4-21.

On the other hand, if not making the reimbursement is selected (A590: NO), the controller 21 of the terminal A ends the processing.

After transmitting the integrated account settlement result information (S520) and receiving the user account settlement amount charge information from the terminal A using the communication I/F 14 (S670: YES), the controller 11 of the server 10 executes step S400 and the subsequent steps while regarding the amount paid from the electronic money account of the user B.B included in the user account settlement amount charge information as the shortfall in the balance for settlement.

If the user account settlement amount charge information is not received (S670: NO), the controller 11 of the server 10 ends the processing.

Upon receiving the shortfall in the balance for settlement from the server 10 using the communication I/F 22 (B180: YES), the controller 21 of the terminal B executes step B190 and the subsequent steps in FIG. 4-21. If the shortfall in the balance for settlement is not received (B180: NO), the controller 21 of the terminal B ends the processing.

Fifth Embodiment Variation (8)

The terminal 20 causes the display 24 to display shared wallet code information or a code reader for reading a payment store code that is based on or shared wallet code reader information. Then, the terminal 20 can cause the display 24 to display a payment code associated with user account information regarding the user, or a code reader screen for reading or a payment store code, based on input to the user account information regarding the user of the terminal 20.

In this case, settlement can be carried out preferentially from the shared wallet balance, for example, without limitation thereto, out of the shared wallet balance and the electronic money account balance of the user account of the user of the terminal 20.

In this variation, the terminal 20 causes the display 24 to display shared wallet code information (a non-limiting example of first code information associated with a shared account), or a code reader screen (a non-limiting example of first code reader information) for reading a payment store code that is based on or shared wallet code reader information. Then, based on input to the user account information (a non-limiting example of second account information) regarding the user of the terminal 20, the terminal 20 causes the display 24 to display a payment code (a non-limiting example of third code information associated with a second account) associated with the user account information, or a code reader information (a non-limiting example of third code reader information) for reading a payment store code that is based on the user account information.

As an example of the effect achieved by this configuration, the first code information associated with a shared account or the first code reader information can be displayed in the display region of the terminal and used for settlement. In addition, the third code information associated with the second account or the third code reader information can be displayed in the display region of the terminal and used for settlement based on input to the second account information.

Further, this variation describes a configuration in which, in settlement, payment is carried out preferentially from a shared wallet balance (a non-limiting example of a balance of a shared account), out of the shared wallet balance and the electronic money account balance of the user account of the user of the terminal 20.

As an example of the effect achieved by this configuration, payment is carried out preferentially from the balance of the shared account, and thus, the second account can be used as a secondary account.

Fifth Embodiment Variation (9)

Various display screens and user interfaces (UIs) described above are merely examples, and there is no limitation thereto.

Example Display Screen

FIG. 5-30 is a diagram showing an example of a code payment screen (before integration) that is displayed when “your wallet” (not shown) is touched in the submenu in FIG. 3-1, and an icon shown as “code payment” in the user's wallet screen is touched by the user A.A of the terminal 20. This code payment screen is an example of a screen for selecting a shared account as an integration destination with the user's account as a base.

In FIG. 5-30, “code payment”, which is the currently executed item in the submenu, is displayed as a current location in the hierarchical menu of the “Payment App” below the title bar. In a code payment region 2451 provided below the “code payment”, the user's electronic money account balance (“25,000 yen” in this example) is displayed together with an image of a purse with a clasp and the text “your wallet”.

Below that, the text “integrate wallets” is displayed, and a slide button CN7 is arranged next to such text. A shared account to be integrated with the own user account can be selected by operating the slide button CN7.

FIG. 5-31 is a diagram showing an example of a code payment screen (before shared wallet integration) that is displayed when the slide button CN7 is touched in the code payment screen (before integration) in FIG. 5-30.

In FIG. 5-31, the slide button CN7 in the code payment region 2451 in FIG. 5-30 is in an “ON” state. Below that, a wallet integration guide region WT2 including the text “integrate wallets” and serving as an operation guide for the user is superimposed on the code payment screen. Below that, further, a shared wallet integration selection region WTM2 for selecting a shared wallet to be integrated is superimposed on the wallet integration guide region WT2.

In the shared wallet integration selection region WTM2, the explanation “select a shared wallet to integrate” is displayed in an upper part, the text “camping fund” indicating a shared wallet for the camping fund is displayed together with a check mark button CN2 below the explanation, and the shared wallet balance (“1,000 yen” in this example) is displayed next to “camping fund”.

Below that, the text “travel to South Korea” indicating a shared wallet for travel to South Korea is displayed together with a check mark button CN2, and the shared wallet balance (“90,000 yen” in this example) is displayed next to the “travel to Korea”

FIG. 5-32 is a diagram showing an example of a code information update screen that is displayed when the check mark button CN2 associated with the shared wallet for travel to South Korea is touched in the code information update screen (before shared wallet integration) in FIG. 5-31.

FIG. 5-32 is different from FIG. 5-31 in that, below the text “integrate wallets” in the code payment region 2451, the text “travel to South Korea” is newly displayed together with a highlighted check mark button CN2, the balance (“90,000 yen” in this example) is newly displayed next to the “travel to South Korea”, and updating information CJK indicating that the code information is being updated is superimposed on the camping fund code payment region 2421.

FIG. 5-33 is a diagram showing an example of a code payment screen (after shared wallet integration) that is displayed after the code information update screen in FIG. 5-32.

In this code payment screen, an image of a purse with a clasp, “your wallet”, a sign “+” indicating addition, an image of a wallet, and the text “travel to South Korea” are displayed in an upper part of the code payment region 2451, and the balance (“115,000 yen” in this example) that is the result of integrating the own user account with the shared account (travel to South Korea) is also displayed. Further, as a result of integrating the accounts, the payment codes displayed in the code payment region 2451 are different from the payment codes in FIG. 5-30.

### Sixth Embodiment

The sixth embodiment is an embodiment in which when the terminal 20 (non-limiting examples of which include the terminal A) executes payment from the shared wallet balance at a member store using the payment application, but the shared wallet balance is insufficient at the time of the payment, the insufficient shared wallet balance is compensated for by executing the payment based on an integrated account of the electronic money account of the user A.A and a shared wallet.

The content described in the sixth embodiment is applicable to any other embodiments and variations.

Corresponding elements that are the same as those already described are assigned the same reference numerals as those used for corresponding elements, and a redundant description thereof is omitted.

Processing

FIGS. 6-1 and 6-2 are flowcharts showing an example flow of processing executed by the devices in the embodiment. These flowcharts show examples of settlement processing executed by the controller 21 of a terminal A (non-limiting examples of which include the terminal 20 of a user A.A), settlement management processing executed by the controller 11 of the server 10, and store settlement processing executed by the controller 51 of the store code reader device 50, which is an element of a store POS system (non-limiting examples of which include the store POS system 40 at a member store S1), in order from the left. These types of processing are examples of processing relating to code settlement in the user-presenting mode.

The controller 51 of the store code reader device 50 executes steps P100 to P160 as store settlement processing.

The controller 11 of the server 10, after executing step S120, receives the settlement request information from the store code reader device 50 using the communication I/F 14, and executes step S250a. After executing step S270a, the controller 11 executes step S470a.

The controller 21 of the terminal A executes step A270a after executing step A130. After executing step A290, the controller 21 executes step A450a.

FIG. 6-2 is a flow illustrated for convenience as it is necessary for the following description. Steps performed by the devices are the same as those in FIG. 5-7 and a description thereof is therefore omitted.

Note that, while executing P130, the store code reader device 50 cannot determine whether or not to advance the processing to the flow in FIG. 6-2 or the flow in FIG. 4-5 after executing P130. Therefore, the processing branches depending on the processing executed by the controller 11 of the server 10. Since the processing executed by the controller 51 of the store code reader device 50 is the same in FIGS. 6-2 and 4-5, the processing is not directly affected by the branching result of the server 10.

Effects of Sixth Embodiment

The sixth embodiment describes a configuration in which the terminal 20 executes, with use of the controller 21, processing relating to settlement based on the shared account (a non-limiting example of a first account) and the user account (a non-limiting example of a second account) of the user of the terminal 20 when the shared wallet balance is insufficient based on the amount to be settled (a non-limiting example of an amount of first settlement) and the shared wallet balance (a balance of the first account, without limitation thereto).

As an example of the effect achieved by this configuration, settlement can be appropriately carried out based on the first and second accounts even when the balance of the first account is insufficient.

Sixth Embodiment Variation (1)

The sixth embodiment has described the code settlement in the user-presenting mode, but this need not be the case. Specifically, the code settlement in the store-presenting mode may alternatively be adopted.

FIG. 6-3 is a flowchart showing an example flow of processing executed by the devices in this variation. These flowcharts show examples of settlement processing executed by the controller 21 of the terminal A (non-limiting examples of which include the terminal 20 of the user A.A) and settlement management processing executed by the controller 11 of the server 10, in order from the left.

The controller 21 of the terminal A, after executing step A130, executes step A300. After executing step A290, the controller 21 executes step A450b.

The controller 11 of the server 10 executes step S120, and executes step S250b upon receiving the settlement request information from the terminal A using the communication I/F 14. After executing step S270b, the controller 11 executes step S470b.

Sixth Embodiment Variation (2)

In the sixth embodiment, a plurality of accounts are associated with a single code through the account integration processing. However, this need not be the case. Payment may be carried out by using a plurality of accounts in parallel, for example, without limitation thereto.

FIGS. 6-4 and 6-5 are flowcharts showing an example flow of processing executed by the devices in this variation. These flowcharts show examples of settlement processing executed by the controller 21 of a terminal A (non-limiting examples of which include the terminal 20 of a user A.A), settlement management processing executed by the controller 11 of the server 10, and store settlement processing executed by the controller 51 of the store code reader device 50, which is an element of a store POS system (non-limiting examples of which include the store POS system 40 at a member store S1), in order from the left.

The controller 51 of the store code reader device 50 executes steps P100 to P160 as store settlement processing.

The controller 11 of the server 10, after executing step S120, receives the settlement request information from the store code reader device 50 using the communication I/F 14, and executes step S250a. After executing step S270a, the controller 11 executes step S530.

The controller 21 of the terminal A, after executing step A130, executes step A270a. After executing step A290, the controller 21 executes step A490.

Steps of the devices in FIG. 6-5 are the same as those in FIG. 5-15, and a description thereof is therefore omitted.

Note that, while executing P130, the store code reader device 50 cannot determine whether or not to advance the processing to the flow in FIG. 6-5 or the flow in FIG. 4-5 after executing P130, and therefore the processing branches depending on the processing executed by the controller 11 of the server 10.

Sixth Embodiment Variation (3)

In the sixth embodiment, the combined total amount of the electronic money account balance of the user A.A and the shared wallet balance at the start of the payment is the balance (an amount capable of being paid using an integrated account) of the integrated account. However, this need not be the case.

If the sum of the electronic money account balance of the user A.A and the shared wallet balance falls below the payment amount, the electronic money account of the user A.A may be topped up (i.e., money may be sent thereto) from an account of an external financial institution that is registered in advance by the user A.A before integrating the shared wallet with the electronic money account of the user A.A, for example, without limitation thereto.

FIG. 6-6 is a flowchart showing an example flow of processing executed by the devices in this variation. These flowcharts show examples of settlement processing executed by the controller 21 of a terminal A (non-limiting examples of which include the terminal 20 of a user A.A), settlement management processing executed by the controller 11 of the server 10, and store settlement processing executed by the controller 51 of the store code reader device 50, which is an element of a store POS system (non-limiting examples of which include the store POS system 40 at a member store S1), in order from the left.

Note that the latter half of the processing may be the same as FIG. 6-2 or 4-5, for example, without limitation thereto, and a description thereof is therefore omitted here.

The controller 21 of the terminal A, after executing step A290, executes steps A350, and executes steps A210 to A230 as required. Thereafter, the controller 21 of the terminal A executes step A450a and the subsequent steps.

Note that the controller 21 of the terminal A may always execute steps A210 to A230 without executing step A350.

The controller 11 of the server 10, after executing step S270a, executes steps S190 to S210, and executes step S470a and the subsequent steps.

The controller 51 of the store code reader device 50, after executing step P130, executes step P140 and the subsequent steps.

Sixth Embodiment Variation (4)

In the sixth embodiment, at the time of payment using an integrated account, even if the shared wallet balance is insufficient and the shortfall is temporarily paid using the user's electronic money account balance, another user (non-limiting examples of which include the user B.B) of the shared wallet is not charged for the temporarily paid amount. However, the other user may be charged for the temporarily paid amount.

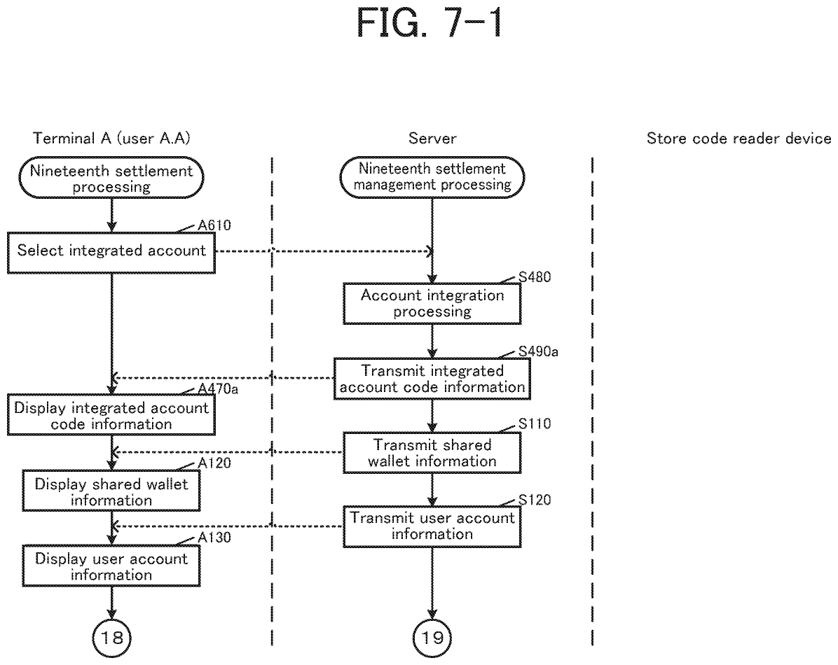

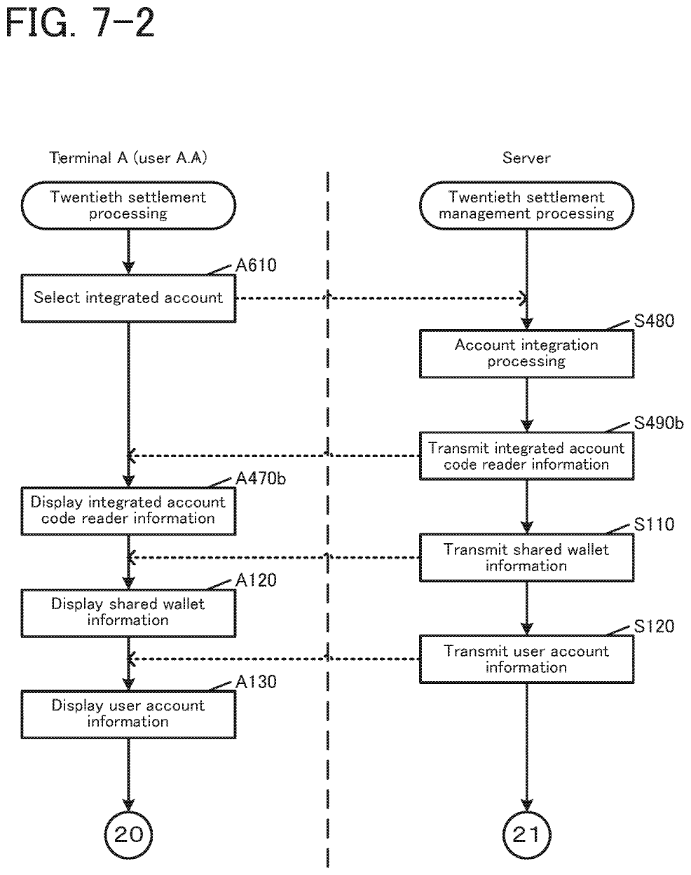

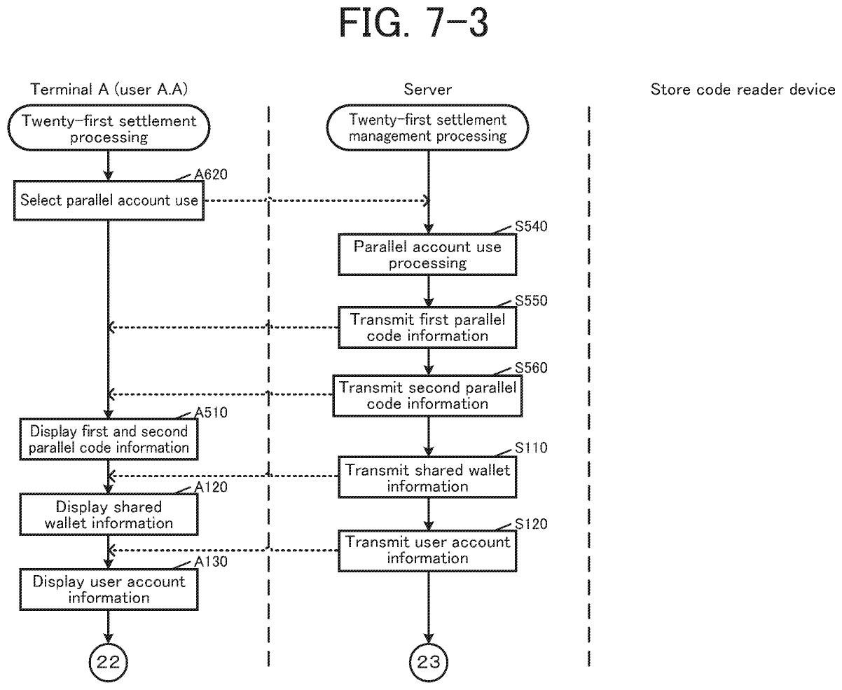

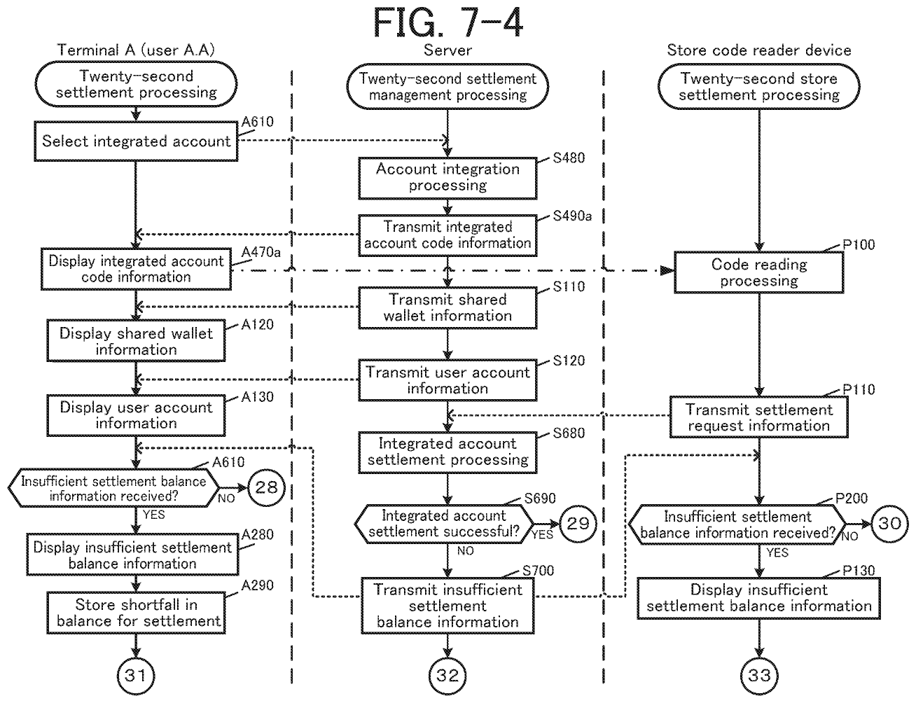

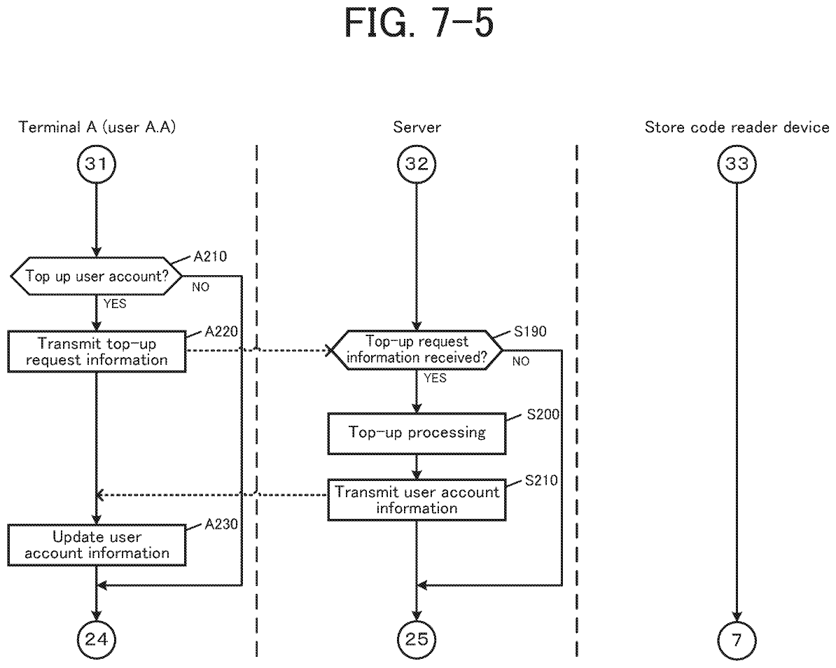

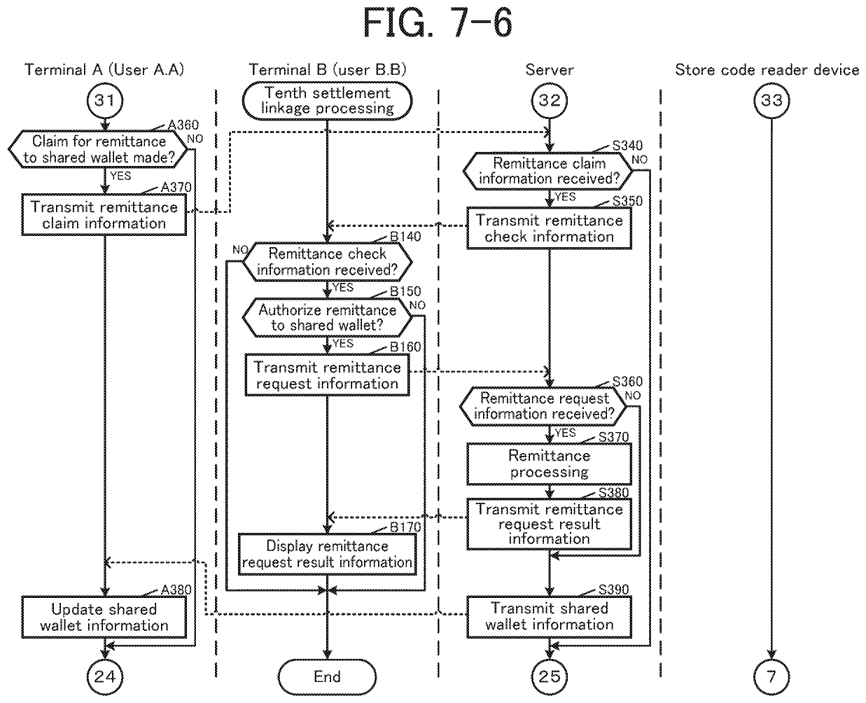

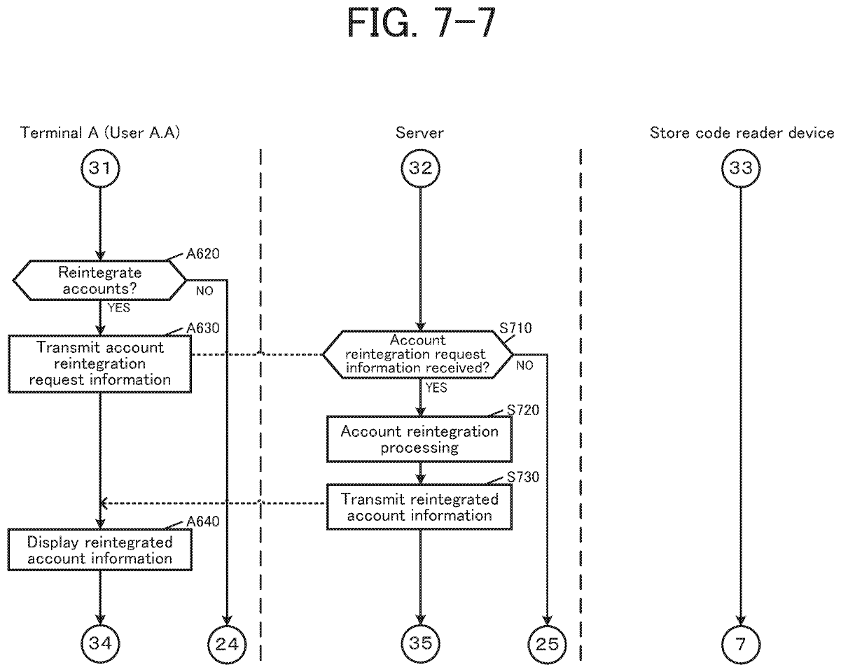

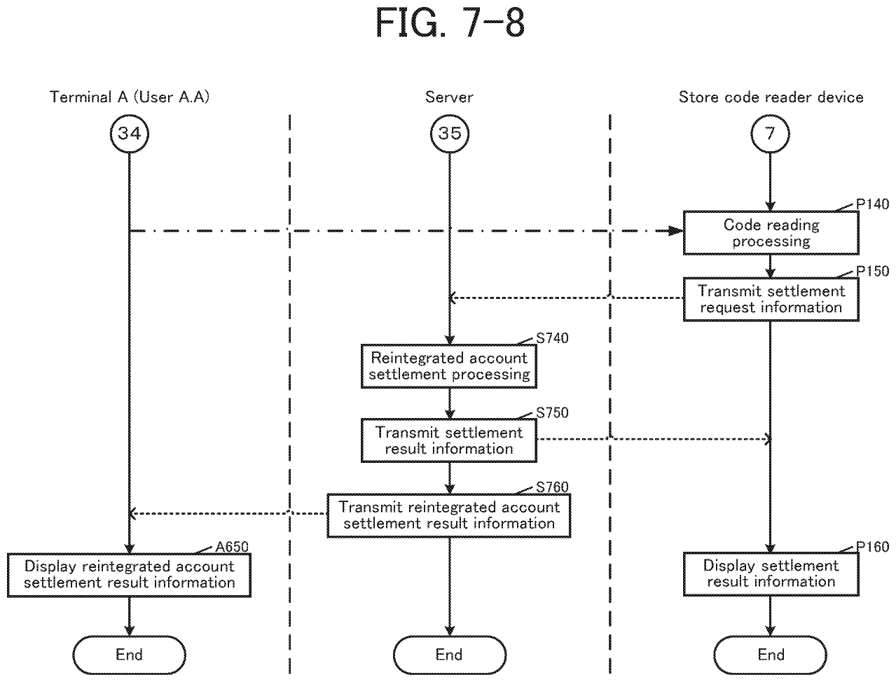

FIG. 6-7 is a flowchart showing an example flow of processing executed by the devices in this variation. These flowcharts show examples of settlement processing executed by the controller 21 of the terminal A (non-limiting examples of which include the terminal 20 of the user A.A), settlement linkage processing executed by the controller 21 of the terminal B (non-limiting examples of which include the terminal 20 of the user B.B), settlement management processing executed by the controller 11 of the server 10, and store settlement processing executed by the controller 51 of the store code reader device 50, which is an element of a store POS system (non-limiting examples of which include the store POS system 40 at a member store S1), in order from the left.

The controller 21 of the terminal A, after executing step A480, executes steps A530 to A340 and ends the processing.

The controller 21 of the terminal B executes steps B100 to B130 and ends the processing.

The controller 11 of the server 10, after executing step S520, executes steps S610 to S330 and ends the processing.

The controller 51 of the store code reader device 50 ends the processing after executing step P160.

Each step can be implemented similarly to FIG. 5-16, and the details thereof are therefore not described.

Note that another user (non-limiting examples of which include the user B.B) of the shared wallet may be charged for the amount temporarily paid by the user A.A by advancing the processing from the latter half of the processing in FIG. 6-6 to the flow in FIG. 6-7.

Sixth Embodiment Variation (5)

In the sixth embodiment, whether or not to integrate the electronic money account of the user (non-limiting examples of which include the user A. A) of the terminal (non-limiting examples of which include the terminal A) that executes settlement processing with the shared wallet is selected if payment is not carried out due to the insufficient shared wallet balance. However, the electronic money account to be integrated is not limited thereto. The electronic money account of another member (non-limiting examples of which include the user B.B) of the shared wallet may alternatively be integrated, for example, without limitation thereto.

FIG. 6-8 is a flowchart showing an example flow of processing executed by the devices in this variation. These flowcharts show examples of settlement processing executed by the controller 21 of the terminal A (non-limiting examples of which include the terminal 20 of the user A.A), settlement linkage processing executed by the controller 21 of the terminal B (non-limiting examples of which include the terminal 20 of the user B.B), settlement management processing executed by the controller 11 of the server 10, and store settlement processing executed by the controller 51 of the store code reader device 50, which is an element of a store POS system (non-limiting examples of which include the store POS system 40 at a member store S1), in order from the left.

Note that the latter half of the processing may be the same as FIG. 6-2, for example, without limitation thereto, and a description thereof is therefore omitted here.

The controller 21 of the terminal A, after executing step A290, executes steps A550 to A580. Upon receiving the integrated account settlement result information from the server 10 using the communication I/F 22, the controller 11 of the terminal A executes step A480 and the subsequent steps.

The controller 21 of the terminal B executes steps B220 to B240 and ends the processing.

The controller 11 of the server 10, after executing step S270a, executes steps S620 to S660. Upon receiving the settlement request information from the store code reader device 50 using the communication I/F 14, the controller 11 of the server 10 executes step S500a and the subsequent steps.

The controller 51 of the store code reader device 50, after executing step P130, executes step P140 and the subsequent steps.

Each step can be implemented similarly to FIG. 5-28, and the details thereof are therefore not described.

Sixth Embodiment Variation (6)

In the sixth embodiment variation (5), even if a shortfall is temporarily paid using the balance of another user's electronic money account, the user A.A of the terminal A that carried out the payment is not charged for the temporarily paid amount. However, the user A.A may be charged for the temporarily paid amount.

FIG. 6-9 is a flowchart showing an example flow of processing executed by the devices in this variation. These flowcharts show examples of settlement processing executed by the controller 21 of the terminal A (non-limiting examples of which include the terminal 20 of the user A.A), settlement linkage processing executed by the controller 21 of the terminal B (non-limiting examples of which include the terminal 20 of the user B.B), settlement management processing executed by the controller 11 of the server 10, and store settlement processing executed by the controller 51 of the store code reader device 50, which is an element of a store POS system (non-limiting examples of which include the store POS system 40 at a member store S1), in order from the left.

Note that the former half of the processing may be the same as FIG. 6-8, for example, without limitation thereto. Also, the latter half may be the same as FIG. 4-21, for example, without limitation thereto. Therefore, description thereof is omitted here.

The controller 21 of the terminal A, after executing step A580, receives the integrated account settlement result information from the server 10 using the communication I/F 22, and executes steps A480 to A600. If the result of A600 is YES, the controller 21 of the terminal A executes step A400 and the subsequent steps.

The controller 21 of the terminal B executes step B180. If the result of B180 is YES, the controller 21 executes step B190 and the subsequent steps.

The controller 11 of the server 10, after executing step S660, receives the settlement request information from the store code reader device 50 using the communication I/F 14, and executes steps S500a to S400. If step S400 is executed, the controller 11 of the server 10 executes step S410 and the subsequent steps.

The controller 51 of the store code reader device 50, after executing step P130, executes processing in P140 to P160.

Each step can be implemented similarly to FIG. 5-29, and the details thereof are therefore not described.

### Seventh Embodiment

The seventh embodiment is an embodiment in which the terminal 20 (non-limiting examples of which include the terminal A) uses the payment application to execute payment at a member store from an electronic money balance of an integrated account that is the combined total of the shared wallet balance and the electronic money account balance of the user (non-limiting examples of which include the user A.A) of the terminal 20. In the present embodiment, processing starts from payment using the integrated account, unlike the fifth embodiment.

The content described in the seventh embodiment is applicable to any other embodiments and variations.

Corresponding elements that are the same as those already described are assigned the same reference numerals as those used for corresponding elements, and a redundant description thereof is omitted.

Processing

FIG. 7-1 is a flowchart showing an example flow of processing executed by the devices in the present embodiment. These flowcharts show examples of settlement processing executed by the controller 21 of a terminal A (non-limiting examples of which include the terminal 20 of a user A.A), settlement management processing executed by the controller 11 of the server 10, and store settlement processing executed by the controller 51 of the store code reader device 50, which is an element of a store POS system (non-limiting examples of which include the store POS system 40 at a member store S1), in order from the left. These types of processing are examples of processing relating to code settlement in the user-presenting mode.

Note that the latter half of the processing may be executed similarly to FIG. 5-7 for example, without limitation thereto, and the details are therefore not described.

First, the controller 21 of the terminal A transmits information for selecting an integrated account obtained by integrating a shared wallet capable of being used from the terminal A with the user's electronic money account, for example, without limitation thereto, to the server 10 using the communication I/F 22 (A610).

The information for selecting an integrated account includes a shared wallet ID and the payment application ID of the user A.A, for example, without limitation thereto. The controller 21 of the terminal A may receive a selectable shared wallet ID from the server 10 using the communication I/F 22 in this step, or may call a selectable shared wallet ID that is stored in advance in the storage 28. Also, the controller 21 of the terminal A may transmit a terminal telephone number with which a payment application ID can be specified by the controller 11 of the server 10, instead of the payment application ID.

Upon receiving the information for selecting an integrated account from the terminal A using the communication I/F 14, the controller 11 of the server 10 executes step S480 based on the information for selecting an integrated account.

Note that if an integrated account has already been created, the controller 21 of the terminal A may transmit, as the information for selecting an integrated account, information for selecting one from integrated account IDs including an integrated account ID of the already created integrated account, to the server 10 using the communication I/F 22. The controller 21 of the terminal A may receive a selectable integrated account ID from the server 10 using the communication I/F 22 in this step, or may call a selectable shared wallet ID stored in advance in the storage 28. In this case, in step S480, the controller 11 of the server 10 need not add a record to the integrated account management data during the account integration processing.

The controller 11 of the server 10 then executes steps S490a to S120, and executes step S500a and the subsequent steps upon receiving the settlement request information from the store code reader device 50 using the communication I/F 14.

Upon receiving the integrated account code information from the server 10 using the communication I/F 22, the controller 21 of the terminal A executes steps A470a to A130, and executes step A480 and the subsequent steps upon receiving the integrated account settlement result information using the communication I/F 14.

Note that in step A610, the controller 21 of the terminal A may transmit information for selecting an integrated account obtained by integrating a shared wallet capable of being used from the terminal A and an electronic money account of a shared wallet member other than the user to the server 10 using the communication I/F 22, for example, without limitation thereto. In this case, the information for selecting an integrated account includes a shared wallet ID and a payment application ID of the user B.B, for example, without limitation thereto.

Effects of Seventh Embodiment

In the seventh embodiment, the terminal 20 causes the display 24 to display the integrated account code information (a non-limiting example of first code information) associated with a first account with which the user of the terminal 20 can carry out settlement and a user account (a non-limiting example of a second account different from the first account) of the user of the terminal 20. The terminal 20 then executes, with use of the controller 21, processing relating to settlement based on the integrated account code information being read.

As an example of the effect achieved by this configuration, it is possible to display the first code information associated with the first account with which the user of the terminal can carry out settlement and the second account different from the first account, in the display region of the terminal, and have the displayed first code information used for settlement. In addition, settlement can be easily implemented based on the first code information being read.

Further, the seventh embodiment describes a configuration in which the first account is a shared account (a non-limiting example of a shared account with which at least the user of the terminal and a first user different from the user of the terminal can carry out settlement).

As an example of the effect achieved by this configuration, it is possible to display the first code information associated with the shared account and the second account different from the shared account, in the display region of the terminal, and have the displayed first code information used for settlement. In addition, settlement can be easily implemented based on the first code information being read.

Further, the seventh embodiment describes a configuration in which the integrated account code information (a non-limiting example of first code information) is one code (a non-limiting example of one piece of code information).

As an example of the effect achieved by this configuration, settlement can be easily implemented using one piece of code information, rather than a plurality of pieces of code information.

The seventh embodiment describes a configuration in which the integrated account code information (a non-limiting example of first code information) includes the payment application ID of the user of the terminal 20, or the payment application ID (a non-limiting example of information relating to a second account) of a user of a different terminal 20, and a shared wallet ID (a non-limiting example of information relating to a shared account).

As an example of the effect achieved by this configuration, in addition to the aforementioned effects, the information relating to the second account and the information relating to the shared account can be included in one piece of code information, which is efficient.

The seventh embodiment describes a configuration in which the terminal 20 causes the display 24 to display information (a non-limiting example of third account information relating to a third account) for selecting an integrated account that includes a payment application ID (a non-limiting example of the third account) of a user (non-limiting examples of which include the user B.B) of a terminal 20 that is different from the user (non-limiting examples of which include the user A.A) of the own terminal 20, and information (a non-limiting example of second account information relating to a second account) for selecting an integrated account that includes a payment application ID (a non-limiting example of the second account) of the user of the own terminal 20.

As an example of the effect achieved by this configuration, the user of the terminal can be notified of the third account information relating to the third account different from the second account, in addition to the second account information.

Further, in the seventh embodiment, the terminal 20 causes the display 24 to display information (a non-limiting example of second account information relating to a second account) for selecting an integrated account that includes a payment application ID (a non-limiting example of a second account) of the user (non-limiting examples of which include the user A.A) of the own terminal 20, and information (a non-limiting example of third account information relating to a third account) for selecting an integrated account that includes a payment application ID (a non-limiting example of the third account) of a user (a non-limiting example of the user B.B) of a different terminal 20. The terminal 20 then causes the display 24 to display the integrated account code information (a non-limiting example of first code information) in which the shared account and the user account of the user of the own terminal 20 are integrated, based on input to the displayed information for selecting the integrated account that includes the payment application ID (a non-limiting example of the second account) of the user (non-limiting examples of which include the user A.A) of the terminal 20.

As an example of the effect achieved by this configuration, the user of the terminal can recognize the third account information relating to the third account different from the second account, together with the second account information relating to the second account. In addition, it is possible to display the first code information or the first code reader information in the display region and have the displayed information used for settlement, based on input to the second account information that is made by the user of the terminal.

The seventh embodiment describes a configuration in which the second account is the account of the user of the terminal 20 (a non-limiting example of an account of a user of a terminal).

As an example of the effect achieved by this configuration, settlement can be implemented using the account of the user of the terminal as the second account.

In the seventh embodiment, the server 10 transmits integrated account code information (a non-limiting example of first code information) associated with a first account with which the user of one terminal 20 can carry out settlement and a user account (a non-limiting example of a second account different from the first account) of the user of this terminal 20, to the terminal 20 using the communication I/F 14. Further, the server 10 receives the settlement request information (a non-limiting example of first code information and goods information) from the store code reader device 50 using the communication I/F 14. The server 10 then executes settlement processing (a non-limiting example of processing relating to first settlement) with use of the controller 11 based on the received settlement request information.

As an example of the effect achieved by this configuration, it is possible to make the user of the terminal acquire the first code information associated with the first account with which the user of the terminal can carry out settlement, and with the second account different from the first account.

Seventh Embodiment Variation (1)

The seventh embodiment has described the code settlement in the user-presenting mode, but this need not be the case. Specifically, the code settlement in the store-presenting mode may alternatively be adopted.

FIG. 7-2 is a flowchart showing an example flow of processing executed by the devices in this variation. These flowcharts show examples of settlement processing executed by the controller 21 of the terminal A (non-limiting examples of which include the terminal 20 of the user A.A) and settlement management processing executed by the controller 11 of the server 10, in order from the left.

Note that the latter half of the processing may be executed similarly to FIG. 5-12 for example, without limitation thereto, and the details are therefore not described.

The controller 21 of the terminal A, after executing steps A610 to A130, executes step A190 and the subsequent steps.

The controller 11 of the server 10, after executing steps S480 to S120, receives the settlement request information from the terminal A using the communication I/F 14, and executes step S500b and the subsequent steps.

In this variation, the terminal 20 causes the display 24 to display a code reader screen (a non-limiting example of first code reader information) for reading a payment store code that is based on integrated account code reader information associated with a first account with which the user of the terminal 20 can carry out settlement and the user account (a non-limiting example of a second account) of the user of the terminal 20. Then, the terminal 20 executes processing relating to settlement with use of the controller 21 based on the payment store code being read by the terminal 20 with the code reader screen that is based on the integrated account code reader information displayed in the display 24 thereof.

As an example of the effect achieved by this configuration, it is possible to display the first code reader information associated with the first account with which the user of the terminal can carry out settlement and the second account different from the first account in the display region of the terminal, and have the displayed first code reader information used for settlement. In addition, settlement can be easily implemented based on the code information being read by the terminal with the first code reader information displayed therein.

Seventh Embodiment Variation (2)

A plurality of accounts are associated with a single code through the account integration processing. However, this need not be the case. Payment may be carried out by using a plurality of accounts in parallel, for example, without limitation thereto.

FIG. 7-3 is a flowchart showing an example flow of processing executed by the devices in this variation. These flowcharts show examples of settlement processing executed by the controller 21 of the terminal A (non-limiting examples of which include the terminal 20 of the user A.A) and settlement management processing executed by the controller 11 of the server 10, in order from the left.

Note that the latter half of the processing may be executed similarly to FIG. 5-15 for example, without limitation thereto, and the details are therefore not described.

First, the controller 21 of the terminal A transmits information for selecting parallel account use of a shared wallet capable of being used from the terminal A and the user's electronic money account, for example, without limitation thereto, to the server 10 using the communication I/F 22 (A620).

The information for selecting parallel account use includes the shared wallet ID and the payment application ID of the user A.A, for example, without limitation thereto.

Upon receiving the information for selecting parallel account use from the terminal A using the communication I/F 14, the controller 11 of the server 10 executes step S540 based on the information for selecting parallel account use. The controller 11 of the server 10 then executes steps S550 to S120, and executes step S570 and the subsequent steps upon receiving settlement request information from the store code reader device 50.

Upon receiving the first and second parallel code information from the server 10 using the communication I/F 22, the controller 21 of the terminal A executes steps A510 to A130, and executes step A520 and the subsequent steps upon receiving the parallel account settlement result information from the server 10 using the communication I/F 22.

Note that, as mentioned above, it can be said that the integrated account code information (a non-limiting example of first code information) includes or is associated with a payment application ID to be integrated (a non-limiting example of information relating to a second account) and a shared wallet ID (a non-limiting example of information relating to a shared account).

This variation describes a configuration in which the integrated account code information (a non-limiting example of first code information) includes second code information and third code information, the second code information is associated with a shared wallet ID (a non-limiting example of a shared account), the third code information is associated with the payment application ID to be integrated (a non-limiting example of a second account), and the second code information is displayed in a region different from the third code information.

As an example of the effect achieved by this configuration, settlement can be easily implemented based on separate pieces of code information that are displayed in different regions.

Seventh Embodiment Variation (3)

In the seventh embodiment, processing ends if payment using the integrated account for which a code is presented first fails. However, this need not be the case.

If payment using the integrated account fails, the user's account may be topped up and increase the balance of the integrated account to compensate for the insufficient balance and carry out payment again, for example, without limitation thereto.

FIGS. 7-4 and 7-5 are flowcharts showing an example flow of processing executed by the devices in this variation. These flowcharts show examples of settlement processing executed by the controller 21 of a terminal A (non-limiting examples of which include the terminal 20 of a user A.A), settlement management processing executed by the controller 11 of the server 10, and store settlement processing executed by the controller 51 of the store code reader device 50, which is an element of a store POS system (non-limiting examples of which include the store POS system 40 at a member store S1), in order from the left.

Note that the latter half of the processing may be executed similarly to FIG. 6-2 for example, without limitation thereto, and the details are therefore not described.

The controller 21 of the terminal A executes steps A610 to A130. The controller 11 of the server 10 then executes steps S480 to S120. The controller 51 of the store code reader device 50 executes processing in P100 to P110.

The controller 11 of the server 10 receives the settlement request information from the store code reader device 50 using the communication I/F 14. In this case, the settlement request information includes an integrated account payment token that is based on the integrated account code information transmitted in step S490a. Therefore, the controller 11 of the server 10 executes the integrated account settlement processing (S680). The integrated account settlement processing can be executed similarly to step S500a in FIG. 5-7, and the details thereof are therefore not described.

If settlement is successful in S680 (S690: YES), the controller 11 of the server 10 advances the processing to step S510 in FIG. 6-2.

If the settlement fails in S680 (S690: NO), the controller 11 of the server 10 transmits insufficient settlement balance information including a message indicating the settlement failure and the shortfall in the balance for settlement in the shared wallet in this case, to the terminal A and the store code reader device 50 using the communication I/F 14 (S700).

Here, the insufficient settlement balance information in this variation is information indicating that the balance of the integrated account is insufficient, and the integrated account is an account obtained by integrating a shared account with the user account of the user A.A. For this reason, the insufficient settlement balance information in this variation is information indicating that the shared wallet balance and the electronic money account balance of the user A.A are insufficient.

Then, the controller 11 of the server 10 also executes steps S190 to S210, and executes step S500a and the subsequent steps upon receiving settlement request information from the store code reader device 50 using the communication I/F 14.

Upon receiving the insufficient settlement balance information from the server 10 using the communication I/F 22 (A610: YES), the controller 21 of the terminal A executes steps A280 to A290. After also executing steps A210 to A230, the controller 21 of the terminal A receives the integrated account settlement result information from the server 10 using the communication I/F 22, and executes step A480.

If the insufficient settlement balance information is not received (A610: NO), the controller 21 of the terminal A receives the integrated account settlement result information from the server 10 using the communication I/F 22, and executes step A480 and the subsequent steps.

If the insufficient settlement balance information is received from the server 10 using the communication I/F 54 (P200: YES), the controller 51 of the store code reader device 50 executes step P130 and the subsequent steps. If the insufficient settlement balance information is not received (P200: NO), the controller 51 of the store code reader device 50 receives the settlement result information from the server 10 using the communication I/F 54 and executes step P160 and the subsequent steps.

In this variation, the terminal 20 causes the display 24 to display the insufficient settlement balance information (a non-limiting example of first information relating to insufficiency of a balance of a shared account and a second account) indicating that the shared wallet balance and the electronic money account balance of the user of the terminal 20 are insufficient, based on the amount to be settled (a non-limiting example of an amount of first settlement), the shared wallet balance (a non-limiting example of the balance of the shared account), and the electronic money account balance of the user of the terminal 20 (a non-limiting example of the balance of the second account). The terminal 20 then executes, with use of the controller 21, processing (a non-limiting example of processing for sending money to the second account) for topping up the electronic money account of the user of the terminal 20 based on input to the insufficient settlement balance information that is made by the user of the terminal 20.

As an example of the effect achieved by this configuration, the user of the terminal can be notified that the balances of the shared account and the second account are insufficient. In addition, money can be sent to the second account based on input for the first information that is made by the user of the terminal.

Seventh Embodiment Variation (4)

In the seventh embodiment and the seventh embodiment variation (3), even if, at the time of payment using an integrated account, the shared wallet balance is insufficient and the shortfall is temporarily paid using the balance of the user's electronic money account, another user (non-limiting examples of which include the user B.B) of the shared wallet is not charged for the temporarily paid amount. However, the other user may be charged for the temporarily paid amount.

In this case, the flow in FIG. 6-7 may be executed instead of the flow in FIG. 6-2 in the latter half of the processing.

Seventh Embodiment Variation (5)

In the seventh embodiment variation (3), if payment using an integrated account fails, the user's account is topped up to increase the balance of the integrated account and thus compensate for the insufficient balance. However, this need not be the case.

The insufficient balance may alternatively be compensated for by requesting another shared wallet member to send money to the shared wallet, for example, without limitation thereto.

FIG. 7-6 is a flowchart showing an example flow of processing executed by the devices in this variation. These flowcharts show examples of settlement processing executed by the controller 21 of the terminal A (non-limiting examples of which include the terminal 20 of the user A.A), settlement linkage processing executed by the controller 21 of the terminal B (non-limiting examples of which include the terminal 20 of the user B.B), settlement management processing executed by the controller 11 of the server 10, and store settlement processing executed by the controller 51 of the store code reader device 50, which is an element of a store POS system (non-limiting examples of which include the store POS system 40 at a member store S1), in order from the left.

Note that the former half of the processing may be the same as FIG. 7-4, for example, without limitation thereto. Also, the latter half of the processing may be the same as FIG. 6-2, for example, without limitation thereto. Therefore, a description thereof is omitted here.

The controller 21 of the terminal A, after executing step A290, executes steps A360 to A380, and executes step A480 and the subsequent steps upon receiving the integrated account settlement result information from the server 10 using the communication I/F 22.

The controller 21 of the terminal B executes steps B140 to B170 and ends the processing.

The controller 11 of the server 10, after executing steps S340 to S390, receives the settlement request information from the store code reader device 50 using the communication I/F 14, and executes step S500a and the subsequent steps.

Note that each step of the processing can be executed similarly to FIG. 4-19, and the details thereof is therefore omitted.

In the latter half of the processing, if the shortfall is temporarily paid using the balance of another user's electronic money account by executing the flow in FIGS. 6-9 and 4-21 instead of the flow in FIG. 6-2, the user A.A of the terminal A that carried out the payment may be charged for the temporarily paid amount.

Further, if a request for remittance to the shared wallet member was made to another shared wallet member but the remittance to the shared wallet was not authorized by this shared wallet member, the terminal 20 that made the remittance request may be configured to not cause the display 24 to display the integrated account code information or to not execute processing relating to subsequent settlement.

Seventh Embodiment Variation (6)

In the seventh embodiment variation (3), if payment using an integrated account fails, the user's account is topped up to increase the balance of the integrated account and thus compensate for the insufficient balance. However, this need not be the case.

An electronic money account of yet another shared wallet member may also be added to the integrated account including the shared wallet member and the user's electronic money account, for example, without limitation thereto.

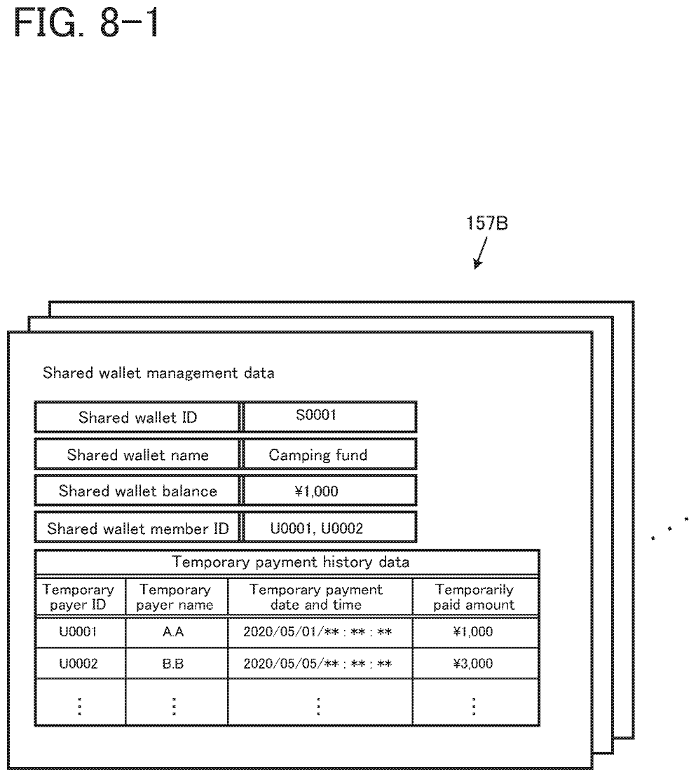

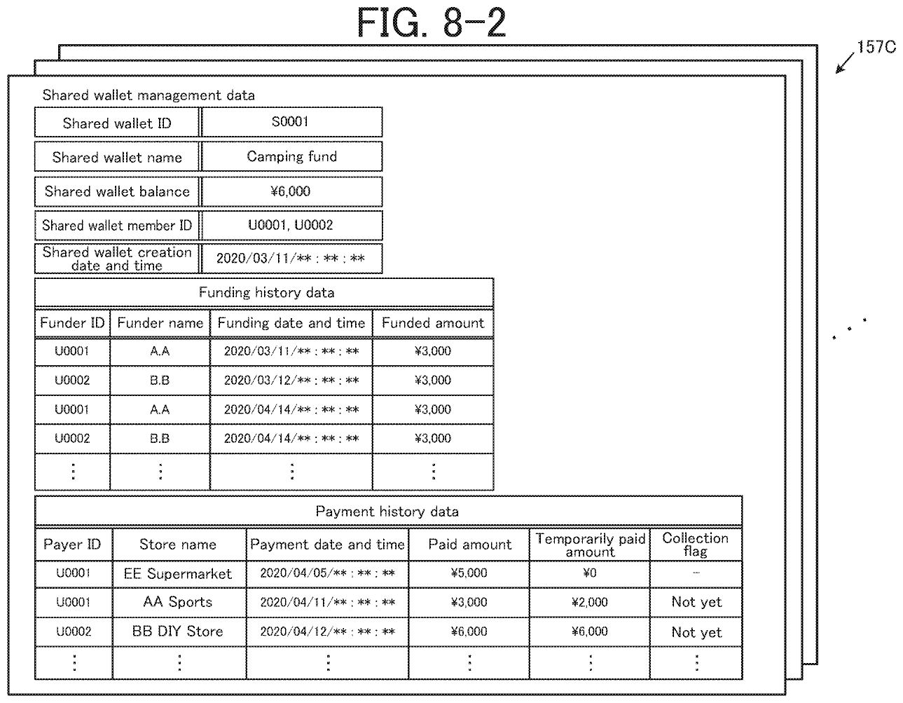

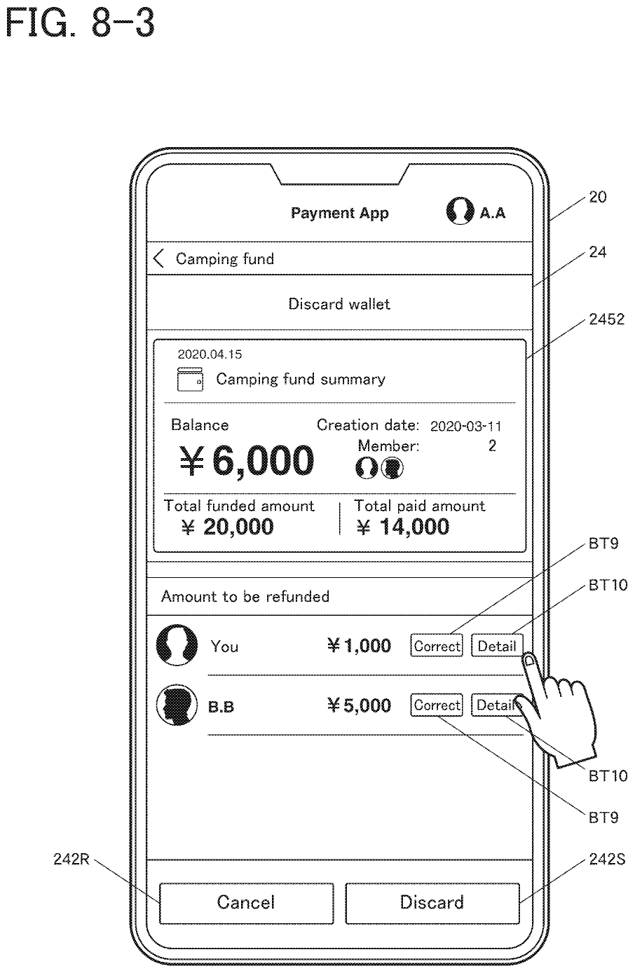

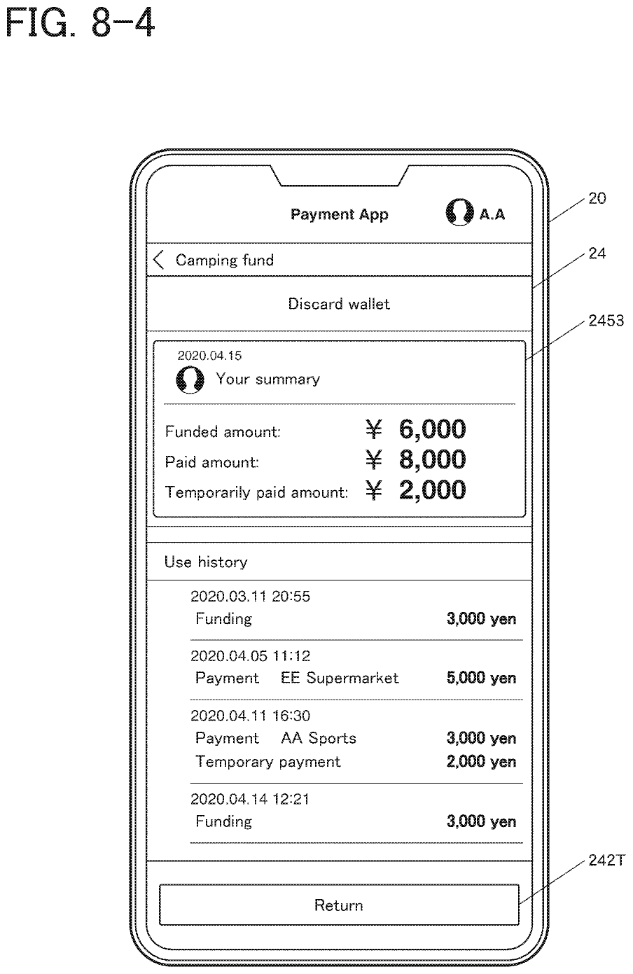

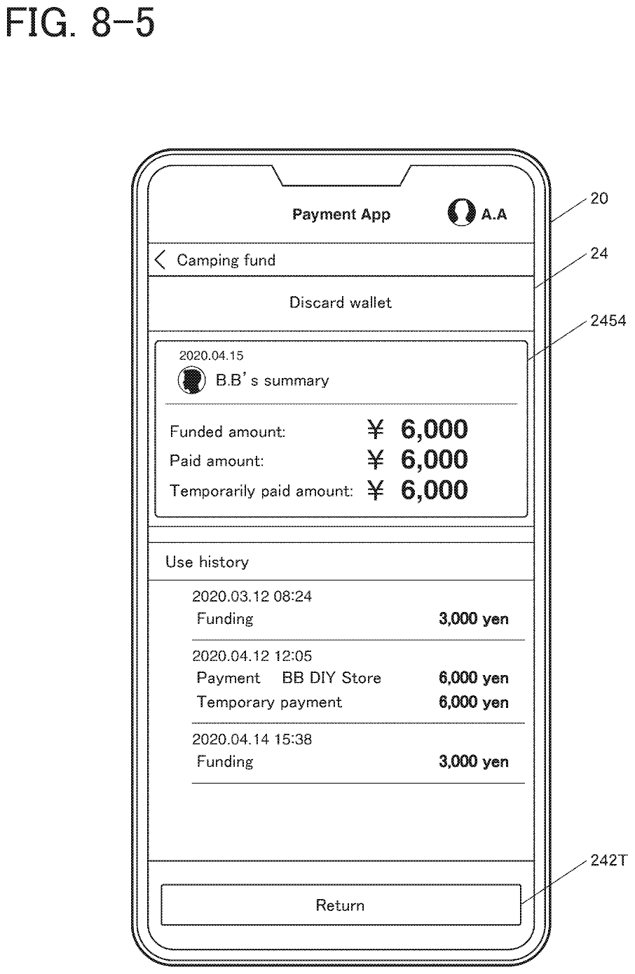

FIGS. 7-7 and 7-8 are flowcharts showing an example flow of processing executed by the devices in this variation. These flowcharts show examples of settlement processing executed by the controller 21 of a terminal A (non-limiting examples of which include the terminal 20 of a user A.A), settlement management processing executed by the controller 11 of the server 10, and store settlement processing executed by the controller 51 of the store code reader device 50, which may be included in of a store POS system (non-limiting examples of which include the store POS system 40 at a member store S1), in order from the left.

Note that the former half of the processing may be the same as FIG. 7-4 for example, without limitation thereto, and a description thereof is therefore omitted here.

The controller 21 of the terminal A, after executing step A290, causes the display 24 to display a screen for selecting whether or not to further integrating another electronic money account (non-limiting examples of which include the electronic money account of the user B.B) to the integrated account (A620). In the following, further addition of an electronic money account to an integrated account will be referred to as “account reintegration”.

If account reintegration is selected based on a user operation to the input/output device 23 of the terminal A (A620: YES), the controller 21 of the terminal A transmits account reintegration request information including the integrated account ID of an integration source and a payment application ID of the user to be added, to the server 10 using the communication I/F 22.

If account reintegration is not selected based on a user operation to the input/output device 23 of the terminal A (A620: NO), the controller 21 of the terminal A receives integrated account settlement result information from the server 10 using the communication I/F 22, and executes step A480 in FIG. 6-2.

If the account reintegration request information is received from the terminal A using the communication I/F 14 (S710: YES), the controller 11 of the server 10 executes account reintegration processing (S720).

If the account reintegration request information is not received (S710: NO), the controller 11 of the server 10 receives the settlement request information from the store code reader device 50 using the communication I/F 14, and executes step S500a and the subsequent steps.

In the account reintegration processing, the controller 11 of the server 10 retrieves a record of integrated account management data having the integrated account ID of the integration source from the integrated account management database 159, and adds the payment application ID of the user B.B to the integrated account member IDs of this record. The balance of the integrated account is an amount obtained by further adding the electronic money balance of the payment application ID added to the integrated account member IDs.

Then, the controller 11 of the server 10 transmits reintegrated account information including the electronic money balance of the reintegrated account, to the terminal A using the communication I/F 14 (S730).

Upon receiving the reintegrated account information from the server 10 using the communication I/F 22, the controller 21 of the terminal A causes the display 24 to update and display the electronic money balance of the reintegrated account (A640). The controller 11 of the store code reader device 50 then executes steps P140 to P160 and ends the processing.

Note that, upon executing the account reintegration processing, the controller 11 of the server 10 may also regenerate an integrated account payment token and integrated account code information including the new integrated account payment token, and transmit the regenerated integrated account payment token and integrated account code information to the terminal A using the communication I/F 14. In this case, upon receiving the integrated account code information from the server 10 using the communication I/F 22, the controller 21 of the terminal A causes the display 24 to update and display the integrated account code information.

Upon receiving the settlement request information from the store code reader device 50 using the communication I/F 14, the controller 11 of the server 10 executes reintegrated account settlement processing (S740).

In the integrated account settlement processing, the controller 11 of the server 10 retrieves the integrated account ID using the integrated account payment token with which the request has been made. Further, the controller 11 of the server 10 executes, for the integrated account, settlement processing to pay the amount to be settled to the member store defined by the store ID, using the combined total of the electronic money account balance of the user A.A, the electronic money account balance of the user B.B, and the shared wallet balance that are specified by the integrated account member IDs, based on the integrated account member IDs (here, the payment application ID of the user A.A, the payment application ID of the user B.B, and the shared wallet ID of the shared wallet) associated with the integrated account ID.

If the settlement using the integrated account is successful, the controller 11 of the server 10 reduces the shared wallet balance by the amount to be settled.

On the other hand, if the shared wallet balance falls below the amount to be settled, the controller 11 of the server 10 preferentially uses the shared wallet balance for the payment to reduce the shared wallet balance to “0”, and thereafter equally divides the shortfall (=the amount to be settled−the shared wallet balance) and subtracts the amount corresponding to the division result from the electronic money account balance of the user A.A and the electronic money account balance of the user B.B, for example, without limitation thereto.

Next, the controller 11 of the server 10 transmits settlement result information including the result of the settlement processing and the balance of the reintegrated account after the settlement processing, for example, without limitation thereto, to the store code reader device 50 using the communication I/F 14 (S750).

The controller 11 of the server 10 also transmits integrated account settlement result information including the result of the settlement processing, the electronic money accounts and the shared wallet balance that are included in the integrated account after the settlement processing, and the amounts paid from the respective electronic money accounts and the shared wallet, for example, without limitation thereto, to the terminal A using the communication I/F 14 (S760), and ends the processing.

Upon receiving the reintegrated account settlement result information from the server 10 using the communication I/F 22, the controller 21 of the terminal A causes the display 24 to display the reintegrated account settlement result information (A650), and ends the processing.

Note that in account reintegration, an electronic money account that can be added to an integrated account is not limited to a user account. Another shared wallet may be added.

In this variation, in settlement, payment is carried out preferentially from the shared wallet balance (a non-limiting example of a balance of a shared account), out of the shared wallet balance, the electronic money account balance of the user account of the user of the own terminal 20, and the electronic money account balance of the user account of the user of a different terminal 20.

As an example of the effect achieved by this configuration, payment is carried out preferentially from the balance of the shared account, and thus, the other accounts can be used as secondary accounts.

Further, this variation describes a configuration in which the terminal 20 executes, with use of the controller 21, processing relating to settlement based on the shared account and the user accounts of the shared wallet members, including the user account (a non-limiting example of a second account) of the user of the own terminal 20 and the user account of another shared wallet member.

As an example of the effect achieved by this configuration, settlement can be implemented based on the shared account and the accounts of the users capable of making settlement using the shared account, the accounts including the second account.

Further, this variation describes a configuration in which the integrated account code information (a non-limiting example of first code information) is associated with the user accounts of the shared wallet members.

As an example of the effect achieved by this configuration, the first code information associated with an account of each user able to carry out settlement using the shared account can be used for settlement.

Further, this variation describes a configuration in which payment that is based on settlement is executed while the shortfall in the shared wallet member is equally divided, and the division result is subtracted from the user accounts of the shared wallet members.

As an example of the effect achieved by this configuration, fair settlement can be realized since the shortfall in the balance of the shared account is equally assigned to the accounts of the users able to carry out settlement using the shared account.

Seventh Embodiment Variation (7)

In the seventh embodiment variation (6), account reintegration processing for integrating a shared wallet with electronic money accounts of two or more users and payment using a reintegrated account are performed after payment is attempted once using the integrated account and fails. However, this need not be the case.

Account reintegration may alternatively be performed after FIG. 6-1, for example, without limitation thereto.

Seventh Embodiment Variation (8)

In the case of applying code settlement in the user-presenting mode, the terminal 20 causes the display 24 to display code information (payment code etc.) (a non-limiting example of third code information associated with a second account) that is associated with the user account of the user of the terminal 20. Further, the terminal 20 causes information relating to a shared wallet (a shared wallet ID etc.) (a non-limiting example of shared account information), for example, without limitation thereto, to be displayed in the same screen. Then, terminal 20 may cause the display 24 to display integrated account code information (a non-limiting example of first code information) that is associated with the shared account and the user account of the user of the terminal 20, for example, without limitation thereto, based on input to the displayed information relating to the shared wallet that is made by the user of the terminal 20.

Similarly, in the case of applying code settlement in the store-presenting mode, the terminal 20 causes the display 24 to display a code reader screen (a non-limiting example of a third code reader screen associated with a second account) for reading a payment store code that is based on code reader information associated with the user account of the user of the terminal 20. Also, the terminal 20 causes information (a shared wallet ID etc.) relating to a shared wallet, for example, without limitation thereto, to be displayed in the same screen. Then, terminal 20 may cause the display 24 to display a code reader screen (a non-limiting example of a first code reader screen) for reading the payment store code that is based on integrated account code reader information associated with the shared account and the user account of the user of the terminal 20, for example, without limitation thereto, based on input to the displayed information relating to the shared wallet that is made by the user of the terminal 20.

As an example of the effect achieved by this configuration, the third code information associated with the second account or the third code reader information can be displayed in the display region of the terminal and used for settlement. In addition, it is possible to display the first code information associated with the first account with which the user of the terminal can carry out settlement, and the second account different from the first account, or first code reader information that is an indication relating to reading of code information, in the display region of the terminal and use the displayed information for settlement, based on input to the shared account information that is made by the user of the terminal.

When code settlement in the user-presenting mode is applied to the above case, the terminal 20 may display shared wallet code information (a non-limiting example of third code information associated with a first account) associated with a shared account, for example, without limitation thereto, instead of the code information (payment code etc.) associated with the user account of the user of the terminal 20.

Further, when code settlement in the store-presenting mode is applied to the above case, the terminal 20 may display a code reader screen (a non-limiting example of third code information associated with a first account) for reading a payment store code that is based on shared wallet code reader information, for example, without limitation thereto, instead of the code reader screen for reading a payment store code that is based on the code reader information associated with the user account of the user of the terminal 20.

As an example of the effect achieved by this configuration, the third code information associated with the first account or the third code reader information can be displayed in the display region of the terminal and used for settlement. In addition, it is possible to display the first code reader information associated with the first account with which the user of the terminal can carry out settlement, and the second account different from the first account, or the first code reader information that is an indication relating to reading of code information, in the display region of the terminal and use the displayed information for settlement, based on input to the shared account information that is made by the user of the terminal.

Seventh Embodiment Variation (9)

In the seventh embodiment, settlement can also be carried out through wireless communication (including short-range wireless communication) instead of code settlement, similarly to the fourth embodiment variation (9).

This configuration can be implemented similarly by applying the processing described in the fourth embodiment variation (9) to account integration described in the seventh embodiment.

### Eighth Embodiment

The eighth embodiment is an embodiment associated with charging and remittance of the temporarily paid amount mentioned above. The charging and remittance of the temporarily paid amount can be applied to any of the second to seventh embodiments.

In the eighth embodiment, the terminal 20 of a shared wallet member uses the payment application to execute payment at a member store from the electronic money balance of the shared wallet. If the electronic money balance of the shared wallet is insufficient at the time of the payment, the insufficient balance of the shared wallet is compensated for by sending money from the user's electronic money account to the shared wallet.

After that, in the eighth embodiment, the amount temporarily paid from the user's electronic money account balance is charged when the shared wallet is discarded.

The content described in the eighth embodiment is applicable to any other embodiments and variations.

Corresponding elements that are the same as those already described are assigned the same reference numerals as those used for corresponding elements, and a redundant description thereof is omitted.

“Discarding a shared wallet” means terminating the shared wallet, or more specifically, deleting the shared wallet since it will not be used thereafter, for example, without limitation thereto.

Shared wallet discarding processing for deleting data on the shared wallet that is stored and managed in the server 10 is executed in response to a discarding request from a terminal 20 of a representative of the shared wallet member or a terminal 20 of another shared wallet member, for example, without limitation thereto.

Payment processing performed each time on the terminal of the shared wallet member can be executed similarly to FIGS. 4-4 to 4-5 in the fourth embodiment, for example, without limitation thereto, and a detailed description thereof is omitted here.

Data Configuration

FIG. 8-1 is a diagram showing an example data configuration of a second shared wallet management database 157B, which is an example of the shared wallet management database 157 stored in the storage 15 of the server 10 in the present embodiment.

Shared wallet management data is stored as management data for each shared wallet ID in the second shared wallet management database 157B.

A shared wallet ID, a shared wallet name, a shared wallet balance, a shared wallet member ID, and temporary payment history data are stored in association with each other as each piece of the shared wallet management data, for example, without limitation thereto.

The shared wallet ID, the shared wallet name, the shared wallet balance, and the shared wallet member ID are the same as those in the first shared wallet management database 157A.

The temporary payment history data is data for recording history of temporary payment executed for a shared wallet when payment is carried out using the shared wallet and the amount to be settled is partially or entirely paid temporarily from a user's electronic money account balance due to an insufficient shared wallet balance, and a temporary payer ID, a temporary payer name, date and time of temporary payment, and the temporarily paid amount are stored in association with each other, for example, without limitation thereto.

The temporary payer ID is an identifier for identifying a person (temporary payer) who executes temporary payment using his electronic money account balance due to the insufficient shared wallet balance, and a payment application ID of the user who carries out temporary payment is stored as the temporary payer ID, for example, without limitation thereto.

The temporary payer name is the name of the temporary payer, and a user name corresponding to the temporary payer ID is stored as the temporary payer name, for example, without limitation thereto.

The date and time of temporary payment is an item recording the date and time when temporary payment is carried out, and the date and time when the controller 11 of the server 10 executes steps S170a in FIG. 4-5 is stored as the date and time of temporary payment, for example, without limitation thereto.

The temporarily paid amount is an amount temporarily paid from the user's electronic money account balance due to the shared wallet balance being insufficient, and the shortfall in the balance for settlement calculated in step S250a in FIG. 4-4 is stored as the temporarily paid amount, for example without limitation thereto.

It is assumed that settlement processing (first settlement processing) is executed in accordance with FIGS. 4-4 and 4-5 on a terminal (non-limiting examples of which include the terminal A of the user A. A) of a shared wallet member. It is also assumed that the settlement processing fails in step S250a in FIG. 4-4, and the shortfall in the balance for settlement is “1,000 yen”, for example, without limitation thereto.

If the settlement processing is successful in step S170a in FIG. 4-5, the controller 11 of the server 10 adds the payment application ID (“U0001”, which is the payment application ID of the user A.A in this example) that is executing the settlement processing, the user name thereof (“A.A” in this example), the date and time (“2020/5/1/**:**:**” in this example) when the settlement processing is executed, and the shortfall (“1,000 yen” in this example) in the balance for settlement (=temporarily paid amount) transmitted in step S270a in FIG. 4-4, in association with the temporary payment history data.

Note that if the shortfall in the balance for settlement is “0”, or the settlement processing fails in step S170a in FIG. 4-5, processing for adding the above items to the temporary payment history data is not executed.

Further, it is assumed that another settlement processing (second settlement processing) is executed in accordance with FIGS. 4-4 to 4-5 on the terminal B. In this case, if the shortfall in the balance for settlement is “3,000 yen”, and the settlement processing is successfully carried out by sending money from the electronic money account of the user B.B to the shared wallet, for example, without limitation thereto, the controller 11 of the server 10 adds the payment application ID (“U0002”, which is the payment application ID of the user B.B in this example) that is executing the settlement processing, the user name thereof (“B.B” in this example), the date and time (“2020/5/5/**:**:**” in this example) when the settlement processing is executed, and the shortfall (“3,000 yen” in this example) in the balance for settlement (=temporarily paid amount), in association with the temporary payment history data.

If discarding the shared wallet is selected on a terminal 20 (non-limiting examples of which include the terminal A of the user A.A) of any of the shared wallet members, the controller 21 of the terminal A transmits shared wallet discarding claim information to the server 10 using the communication I/F 22.

Upon receiving the shared wallet discarding claim information from the terminal A using the communication I/F 14, the controller 11 of the server 10 executes temporarily paid amount charging processing for each temporarily paid amount stored in the temporary payment history data.

In the second shared wallet management database 157B shown as an example in FIG. 8-1, first, the terminal B is charged “500 yen” (=1,000 yen+2 people), which is the amount temporarily paid on “2020/5/1/**:**:**”, based on the temporary payment history data, for example, without limitation thereto. Next, the terminal A is charged “1,500 yen” (=3,000 yen+2 people), which is the amount temporarily paid on “2020/5/5/**:**:**”-.

Charging processing for each item can be executed similarly to FIG. 4-9, for example, without limitation thereto, and the details are therefore not described.

Note that when discarding the shared wallet is selected on the terminal A, for example, without limitation thereto, if not charging another shared wallet member for the amount temporarily paid by the user of the terminal A is selected, the controller 11 of the server 10 may be configured to not execute charging processing while transmitting information including a message indicating that the terminal B will not be charged for the amount temporarily paid on “2020/5/1/**:**:**”, for example.

Upon the temporarily paid amount charging processing being executed for all temporarily paid amounts stored in the temporary payment history data, the controller 11 of the server 10 executes the shared wallet discarding processing.

Note that payment processing executed by the terminal is not limited to the fourth embodiment, and is also applicable to any of the second to seventh embodiments.

If account integration processing is involved, amounts temporarily paid from users' electronic money account balances may be used as the temporarily paid amount.

Effects of Eighth Embodiment

The eighth embodiment describes a configuration in which the temporarily paid amount charge information is transmitted to a second terminal 20 (a terminal 20 to be charged) based on discarding of a shared wallet (a non-limiting example of discarding of a shared account).

As an example of the effect achieved by this configuration, charge information that is based on settlement can be transmitted to the terminal based on the discarding of the shared account.

The eighth embodiment describes a configuration in which the aforementioned temporarily paid amount charge information is temporarily paid amount charge information (a non-limiting example of first charge information) for charging a user of a second terminal 20 for a temporarily paid amount, processing relating to settlement (a non-limiting example of processing relating to second settlement) is executed based on a shared account and the user account (a non-limiting example of a second account) of the user of the second terminal 20 (a terminal 20 that charges the temporarily paid amount), and temporarily paid amount charge information (a non-limiting example of second charge information different from the first charge information) for charging a user of a first terminal 20 for a temporarily paid amount that is based on settlement (a non-limiting example of second settlement) carried out by the user of the second terminal 20 is transmitted to the first terminal 20 (a non-limiting example of a first terminal) based on discarding of the shared wallet.

As an example of the effect achieved by this configuration, the second charge information that is based on the second settlement and different from the first charge information can be transmitted to the first terminal based on the discarding of the shared account.

This variation also describes a configuration in which the terminal 20 transmits information (a non-limiting example of information relating to changing of charge information) including a message indicating that a temporarily paid amount is not charged, to at least one of the terminals 20 of the shared wallet members using the communication I/F 22.

As an example of the effect achieved by this configuration, it is possible to give a notification that charge information is changed, by transmitting information relating to changing of the charge information to at least one of the terminals of the users able to carry out settlement using the shared account.

Eighth Embodiment Variation (1)

In the eighth embodiment, when a shared wallet is discarded, charging of the amounts that have been temporarily paid up to then using the shared wallet is executed, but this need not be the case.

In this variation, the terminal 20 of a shared wallet member uses the payment application to execute payment at a member store from the electronic money account balance of the shared wallet or from an electronic money balance of an integrated account of the shared wallet and the user's electronic money account. When an operation to discard the shared wallet is performed, the shared wallet balance is distributed and sent (returned) to user accounts based on the amount sent from the user accounts to the shared wallet and the amount temporarily paid by the user accounts.

In the following, sending money from a user account to the shared wallet will be referred to as “funding to the shared wallet”, and the amount sent will be referred to “funded amount”.

Payment processing performed each time on the terminal of each shared wallet member can be executed similarly to FIGS. 6-1, 6-2, and 4-5 in the sixth embodiment, for example, without limitation thereto, and the details thereof are therefore not described.

FIG. 8-2 is a diagram showing an example data configuration of a third shared wallet management database 157C, which is an example of the shared wallet management database 157 stored in the storage 15 of the server 10.

Shared wallet management data is stored as management data for each shared wallet ID in the third shared wallet management database 157C.

A shared wallet ID, a shared wallet name, a shared wallet balance, a shared wallet member ID, date and time of shared wallet creation, funding history data, payment history data are stored in association with each other as each piece of the shared wallet management data, for example, without limitation thereto.

The shared wallet ID, the shared wallet name, the shared wallet balance, and the shared wallet member ID are the same as those in the first shared wallet management database 157A.

The date and time when the shared wallet is created are stored as the date and time of shared wallet creation.

The funding history data is history data of funding executed for this shared wallet, and a funder ID, a funder name, date and time of funding, and a funded amount are stored in association with each other as the funding history data, for example, without limitation thereto.

The funder ID is an identifier for identifying a person (funder) who executes funding to this shared wallet, and the payment application ID of the user who carries out funding is stored as the funder ID, for example, without limitation thereto.

The funder name is the name of the funder, and a user name corresponding to the funder ID is stored as the funder name, for example, without limitation thereto.

The date and time of funding are the date and time when funding is executed, and the date and time when the funder executes funding to the shared wallet are stored as the date and time of funding, for example, without limitation thereto.

The funded amount is the amount funded to this shared wallet by this funder on this date and time.

FIG. 8-2 shows that the user A.A funded “3,000 yen” on “2020/3/11/**” and “3,000 yen” on “2020/4/14/**:**:**” to the shared wallet “camping fund”, for example, without limitation thereto. It is also shown that the user B.B funded “3,000 yen” on “2020/3/12/**:**:**” and “3,000 yen” on “2020/4/14/**:**:**”, for example, without limitation thereto.

The payment history data is history of payment that is executed and is successfully carried out using this shared wallet, and a payer ID, a store name, date and time of payment, a payment amount, a temporarily paid amount, and a collection flag are stored in association with each other as the payment history data, for example, without limitation thereto.

The payer ID is an identifier for identifying a person (payer) who executes payment using this shared wallet at a member store, and the payment application ID of the user who carries out payment is stored as the payer ID, for example, without limitation thereto.

The store name is a name for identifying the member store at which payment is carried out, and the name of a store or a service that is registered when the member store registers for use of the payment application is stored as the store name, for example, without limitation thereto.

The date and time of payment are the date and time when the payer executes payment using the payment application at the member store with this store name, and the date and time when settlement processing or integrated account settlement processing is executed and successfully carried out by the controller 11 of the server 10 is stored as the date and time of payment, for example, without limitation thereto.

The payment amount is the amount to be settled to execute payment using the payment application at the member store with this store name, and the amount to be settled that is based on the settlement request information that the controller 11 of the server 10 receives using the communication I/F 14 from the store code reader device 50 is stored as the payment amount, for example, without limitation thereto.

The temporarily paid amount is the amount that is temporarily paid from a user's electronic money account balance due to the shared wallet balance being insufficient when payment is executed from the electronic money account balance of an integrated account of a shared wallet and the user's electronic money account, and the amount paid from the payer's electronic money account that is based on the result of the integrated account settlement processing is stored as the temporarily paid amount, for example, without limitation thereto. Note that the temporarily paid amount is “0” if the integrated account settlement processing is not executed.

The collection flag is flag information for recording whether or not, when the temporarily paid amount is greater than “0”, the temporarily paid amount is charged and reimbursement is completed, for each payment. If the reimbursement remittance processing is executed by the controller 11 of the server 10 and successful, for example, without limitation thereto, “done” is stored as the collection flag, for example, without limitation thereto. If the reimbursement remittance processing is not executed by the controller 11 of the server 10, or the reimbursement remittance processing fails, “not yet” is stored as the collection flag, for example, without limitation thereto. If the temporarily paid amount is “0”, reimbursement need not be executed, and “−” is stored, for example, without limitation thereto.

The temporarily paid amount charging processing performed each time of payment can be executed similarly to FIG. 6-7, for example, without limitation thereto, and the details are therefore not described.

In FIG. 8-2, the payment history data indicates that a payer “U0001” (i.e., the user A.A) has paid “5,000 yen” at a store “EE Supermarket” on “2020/4/5/**:**:**” using the shared wallet “camping fund”, for example, without limitation thereto. It is also indicated that the payer “U0001” (i.e., the user A.A) has paid “3,000 yen” at a store “AA Sports” on “2020/4/11/**:**:**”, temporarily paid “2,000 yen” fromthe electronic money account of the user A.A, and reimbursement for the temporarily paid amount has “not yet” been completed.

Upon receiving the shared wallet discarding claim information from the terminal A, for example, without limitation thereto, using the communication I/F 14, the controller 11 of the server 10 executes shared wallet reimbursement/discarding processing based on the shared wallet management data in the third shared wallet management database 157C.

In the shared wallet reimbursement/discarding processing, first, the total amount funded by each funder is calculated for each funder ID in the funding history data. Next, the total amount temporarily paid by each payer is calculated for each payer ID in the payment history data. Note that when the total temporarily paid amount is calculated, only temporarily paid amounts with the collection flag of “not yet” are added.

In FIG. 8-2, the total amount funded by the user A.A is “6,000 yen” (=3,000 yen+3,000 yen), and the total amount funded by the user B.B is “6,000 yen” (=3,000 yen+3,000 yen), for example, without limitation thereto. Further, the total amount temporarily paid by the user A.A is “2,000 yen”, and the total amount temporarily paid by the user B.B is “6,000 yen”.

Next, the amount obtained by adding the total amount funded by all the shared wallet members and the total temporarily paid amounts is calculated as a total amount funded to the shared wallet “camping fund”. In FIG. 8-2, the total funded amount is “20,000 yen” (=6,000 yen+6,000 yen+2,000 yen+6,000 yen), for example, without limitation thereto.

Thereafter, an average paid amount per shared wallet member that has been paid from the shared wallet up to the point in time when the shared wallet reimbursement/discarding processing is executed is calculated by “(total funded amount−shared wallet balance)÷number of shared wallet members”.

In FIG. 8-2, the average paid amount is “(20,000 yen−6,000 yen)÷2=7,000 yen”, for example, without limitation thereto.

Next, the amount to be refunded for refunding the shared wallet balance based on the proportion of the funded amount is calculated for each payment application ID stored as the shared wallet member ID. The amount to be refunded is calculated by “(total funded amount+total temporarily paid amount)−average paid amount”.

The amount to be refunded is an amount obtained by subtracting the amount obtained by equally dividing the amount paid from the shared wallet, from the sum of the amount that has been directly funded to the shared wallet by each user (total funded amount) and the amount that has been indirectly funded through temporary payment (total temporarily paid amount).

In FIG. 8-2, the amount to be refunded to the user A.A is “6,000 yen+2,000 yen−7,000 yen=1,000 yen”, and the amount to be refunded to the user B.B is “6,000 yen+6,000 yen−7,000 yen=5,000 yen”, for example, without limitation thereto.

Lastly, the controller 11 of the server 10 executes refunding processing to refund the amount to be refunded to the electronic money account of each shared wallet member using the shared wallet balance.

Note that if the amount to be refunded is negative, reimbursement is carried out by sending an amount that is an absolute value of the amount to be refunded, from the electronic money account of this user to the shared wallet.

After the shared wallet reimbursement/discarding processing is executed, and the shared wallet balance becomes “0”, the controller 11 of the server 10 executes shared wallet discarding processing.

Note that payment processing executed by the terminal is not limited to the sixth embodiment, and is also applicable to any of the second to seventh embodiments.

When processing for sending money to the shared wallet is executed, the shortfall in the balance for settlement, which is the amount that at least needs to be sent to the shared wallet to successfully carry out payment using the shared wallet, may be stored as the temporarily paid amount.

Example Display Screen

FIG. 8-3 is a diagram showing an example of a camping fund summary display screen that is displayed when an icon shown as “discard wallet” is touched by the user A.A of the terminal 20 in the camping fund payment screen in FIG. 3-3. The example display screen described below is a screen diagram to which the example in FIG. 8-2 is applied.

In this example, “camping fund”, which is the currently executed item in the submenu, is displayed as a current location in the hierarchical menu of the “Payment App” below the title bar. “Discard wallet” is displayed as an operation guide for the user below the “camping fund”, and a camping fund summary display region 2452 is displayed below the “discard wallet”.

The camping fund summary display region 2452 is displayed, divided into three levels. On an upper level, “Apr. 15, 2020” is displayed as the current date, and an image of a wallet and a summary of the name (camping fund) of the shared wallet are displayed below the date.

On a middle level, “6,000 yen” is displayed as a shared wallet balance of the camping fund, together with the text “balance”. Next to the shared wallet balance, “Mar. 11, 2020” is displayed as creation date, and “2” is displayed as the number of shared wallet members of the camping fund below the creation date. Below that, icon images of the user A.A and the user B.B, who are shared wallet members, are displayed.

On a lower level, “20,000 yen” and “14,000 yen” are displayed as a total funded amount and the total paid amount, respectively. The total paid amount is an amount calculated by “total funded amount−shared wallet balance”, for example, without limitation thereto.

The amount to be refunded to each member is displayed in a list format below the camping fund summary display region 2452.

In a first row of the amount to be refunded, the text “you”, which is a user name, is displayed together with the icon image of the user A.A, and “1,000 yen” is displayed as an amount to be refunded next to “you” in this example. Next to the amount to be refunded, a correction button BT9 for correcting the amount to be refunded to the user, and a detail button BT10 for checking the details of the amount to be refunded to the user are displayed side by side.

In a second row of the amount to be refunded, the text “B.B”, which is a user name, is displayed together with the icon image of the user B.B, and “5,000 yen” is displayed as an amount to be refunded next to “B.B” in this example. Next to the amount to be refunded, a correction button BT9 and a detail button BT10 are displayed side by side, similarly to the row of the user A.A.

In a lower part of the screen, a cancel button 242R for canceling discarding of the shared wallet, and a discard button 242S for discarding the shared wallet are displayed side by side.

FIG. 8-4 is a diagram showing an example of the user's summary display screen that is displayed when the detail button BT10 in the row of the user is touched in the camping fund summary display screen in FIG. 8-3.

In this example, the user's summary display region 2453 is divided into two levels. On an upper level, “Apr. 15, 2020” is displayed as the current date. Below that, the text “you”, which is a user name, is displayed together with the icon image of the user A.A. On a lower level, the text “funded amount” is displayed to indicate a funded amount, and “6,000 yen”, which is the total amount funded by the user A.A, is displayed next to such text.

Below that, the text “paid amount” is displayed to indicate a paid amount, and “8,000 yen”, which is the total paid amount by the user A.A using the shared wallet “camping fund”, is displayed next to such text. Below that, the text “temporarily paid amount” is displayed to indicate a temporarily paid amount, and “2,000 yen”, which is the total amount temporarily paid by the user A.A, is displayed next to such text.

The use history of the user is displayed in time series in a list format below the user's summary display region 2453. In a first row, “Mar. 11, 2020 20:55” is displayed as the date and time of use, the text “funding” is displayed as a used item below that, and “3,000 yen” is also displayed as a funded amount.

In a second row, “Apr. 5, 2020 11:12” is displayed as the date and time of use, the text “payment” is displayed as a used item below that, and “EE Supermarket” is displayed as a payment destination. “5,000 yen” is also displayed as a paid amount next to “EE Supermarket”.

In a third row, “Apr. 11, 2020 16:30” is displayed as the date and time of use, the text “payment” is displayed as a used item below that, and “AA Sports” is also displayed as a payment destination. “3,000 yen” is displayed as a paid amount next to “AA Sports”. Below that, the text “temporary payment” is displayed as a used item, and “2,000 yen” is displayed as a temporarily paid amount.

In a fourth row, “Apr. 14, 2020 12:21” is displayed as the date and time of use, the text “funding” is displayed as a used item below that, and “3,000 yen” is displayed as a funded amount.

A return icon 242T is displayed in a lowermost part of the user's summary display region 2453.

FIG. 8-5 is a diagram showing an example of the user B.B's summary display screen that is displayed when the detail button BT10 in the user B.B's row is touched in the camping fund summary display screen in FIG. 8-3.

This example will describe the user B.B's summary display screen, which has the same display format as the above-described user's (user A.A's) summary display screen.

In the user B.B's summary display screen, the user B.B's summary display region 2454 is divided into two levels. “Apr. 15, 2020” is displayed as the current date on an upper level, and the text “B.B” indicating the user name is displayed together with the icon image of the user B.B below the current date. On a lower level, the text “funded amount” is displayed to indicate and funded amount, and “6,000 yen”, which is the total amount funded by the user B.B, is displayed next to such text. Below that, the text “paid amount” is displayed to indicate a paid amount, and “6,000 yen”, which is the total paid amount by the user B.B using the shared wallet “camping fund”, is displayed next to such text. Below that, the text “temporarily paid amount” is displayed to indicate a temporarily paid amount, and “6,000 yen”, which is the total amount temporarily paid by the user B.B, is displayed next to such text.

The user B.B's use history is displayed in time series in a list format below the user B.B's summary display region 2454. In a first row, “Mar. 12, 2020 8:24” is displayed as the date and time of use, the text “funding” is displayed as a used item below that, and “3,000 yen” is also displayed as a funded amount.

In a second row, “Apr. 12, 2020 12:05” is displayed as the date and time of use, the text “payment” is displayed as a used item below that, and “BB DIY Store” is displayed as a payment destination. “6,000 yen” is also displayed as a paid amount next to “BB DIY Store”. Below that, the text “temporary payment” is displayed as a used item, and “6,000 yen” is displayed as a temporarily paid amount.

In a third row, “Apr. 14, 2020 15:38” is displayed as the date and time of use, the text “funding” is displayed as a used item below that, and “3,000 yen” is also displayed as a funded amount.

A return icon 242T is displayed at a lowermost part of the user B.B's summary display region 2454.

In this variation, processing for remittance to the shared wallet that is based on the temporarily paid amount charge information is executed based on input made by the user of the terminal 20. If the shared wallet contains an amount greater than or equal to the amount paid from the user account (a non-limiting example of a first account) of a first terminal 20 through settlement (a non-limiting example of first settlement) carried out by the user of the first terminal 20, the amount paid from the user account of the user of the first terminal 20 through the settlement carried out by the user of the first terminal 20 is sent from the shared wallet.

As an example of the effect achieved by this configuration, if the shared account contains an amount greater than or equal to the amount paid from the first account through the first settlement, the amount paid from the first account through the first settlement can be sent from the shared account.

Further, this variation describes a configuration in which the terminal 20 transmits information (a non-limiting example of information relating to changing of information relating to a refund) for correcting the amount to be refunded to the user of the own terminal 20 to another terminal 20 via the server 10 using the communication I/F 22.

As an example of the effect achieved by this configuration, it is possible to give a notification that refund information is changed, by transmitting information relating to changing of the refund information to at least one of the terminals of the users able to carry out settlement using the shared account.

Eighth Embodiment Variation (2)

In the eighth embodiment variation (1), the controller 11 of the server 10 executes refunding processing to send the amount to be refunded to the electronic money account of each shared wallet member, using the shared wallet balance. However, this need not be the case.

The following processing may alternatively be executed, for example, without limitation thereto.

When a shared wallet is discarded, the controller 11 of the server 10 executes temporary refunding processing to temporarily refund the amount (hereinafter referred to as an “amount temporarily refunded per person”) obtained by equally dividing the shared wallet balance to each user. The controller 11 then calculates and determines the amount to be sent/received for each user based on the amount temporarily refunded per person and the amount to be refunded (=(total funded amount+total temporarily paid amount)−average paid amount) described in the eighth embodiment variation (1). The final amount is adjusted by causing the terminal 20 to execute remittance processing/money-receiving processing that is based on the calculated and determined amount to be sent/received.

A description will be given using an example amount shown in FIG. 8-2.

Since the shared wallet balance is “6,000 yen” when the shared wallet is discarded, the controller 11 of the server 10 temporarily refunds “6,000 yen 2 people=3,000 yen” as the amount temporarily refunded per person to the users A.A and B.B.

Meanwhile, in the example in FIG. 8-2, the amount to be refunded to the user A.A is “6,000 yen+2,000 yen−7,000 yen=1,000 yen”, and the amount to be refunded to the user B.B is “6,000 yen+6,000 yen−7,000 yen=5,000 yen”. Then, the user A.A will be given 2,000 yen too much, and the user B.B will be given 2,000 yen too little. Therefore, the controller 11 transmits information to give a notification that “2,000 yen” is to be sent from the user account of the user A.A to the user account of the user B.B, to the terminal 20 of the user A.A and the terminal 20 of the user B.B using the communication I/F 14. The controller 11 then subtracts “2,000 yen” from the electronic money account balance of the user A.A, and adds “2,000 yen” to the electronic money account balance of the user B.B. Thereafter, the controller 11 executes the shared wallet discarding processing.

This variation describes a configuration in which, when a shared wallet is discarded, a second terminal 20 receives, using the communication I/F 22, information (a non-limiting example of information relating to sending money from a user of a terminal to a first user of a first terminal) giving a notification that money is to be sent from a user account of a user of the second terminal 20 to the user account of the user of a first terminal 20 (a non-limiting example of the first terminal) or information (a non-limiting example of information relating to sending money from the first user of the first user of the first terminal to the user of the terminal) giving a notification that money is to be sent from the user account of the user of the first terminal 20 to the user account of the user of the second terminal 20, based at least on information regarding an amount (a non-limiting example of a second amount) sent from the first terminal 20 to the shared wallet and information regarding an amount (a non-limiting example of a first amount) sent from the second terminal 20 to the shared wallet.

As an example of the effect achieved by this configuration, remittance to the shared account can be implemented. In addition, when the shared account is discarded, it is possible to receive the information relating to sending money from the user to the first user or the information relating to sending money from the first user to the user and give a notification to the user of the terminal, based at least on the information regarding the second amount sent from the first terminal to the shared account and the information regarding the first amount.

Further, in this variation, the aforementioned information giving a notification that money is to be sent from the user account of the user of the second terminal 20 to the user account of the user of the first terminal 20 or the information giving a notification that money is to be sent from the user account of the user of the first terminal 20 to the user account of the user of the second terminal 20 is determined based on the amount (a non-limiting example of a first amount) sent from the second terminal 20 to the shared wallet, the amount (a non-limiting example of a second amount) sent from the first terminal 20 to the shared wallet, and the shared wallet balance (a non-limiting example of a balance of a shared account).

As an example of the effect achieved by this configuration, the information relating to sending money from the user to the first user or the information relating to sending money from the first user to the user can be appropriately determined based on the first amount, the second amount, and the balance of the shared account.

This variation also describes a configuration in which processing relating to settlement is executed by a first terminal 20 (a non-limiting example of a first terminal of a first user) based on the user account (a non-limiting example of a first account) of the user of the first terminal 20 and a shared account, and a second terminal 20 receives, using the communication I/F 22, the temporarily paid amount charge information (a non-limiting example of charge information relating to a charge for an amount that is based on first settlement) that is based on the settlement carried out by the user of the first terminal 20, based on discarding of the shared wallet.

As an example of the effect achieved by this configuration, the charge information relating to a charge for the amount that is based on the first settlement can be received based on discarding of the shared account.

Further, in this variation, the server 10 receives, using the communication I/F 22, information regarding an amount (a non-limiting example of a first amount) to be sent from a second terminal 20 to a shared account with which at least the user (a non-limiting example of a user of a terminal) of the second terminal 20 and a user (a non-limiting example of a first user) of a first terminal 20 can carry out settlement, and information regarding an amount (a non-limiting example of a second amount) to be sent from the first terminal 20 to the shared account. Then, based on discarding of the shared wallet, the server 10 then executes, with use of the controller 11, remittance processing (a non-limiting example of processing relating to sending money from the account of the user of the terminal to the account of the first user of the first terminal) to send money from the user account of the user of the second terminal 20 to the user account of the first terminal 20, or remittance processing (a non-limiting example of processing relating to sending money from the account of the first user of the first terminal to the account of the user of the terminal) to send money from the user account of the user of the first terminal 20 to the user account of the user of the second terminal 20, based on the aforementioned information regarding the amount to be sent.

As an example of the effect achieved by this configuration, based on discarding the shared account, reimbursement can be appropriately carried out by executing, with use of the controller of the server, the processing relating to sending money from the user's account to the account of the first user or the processing relating to sending money from the account of the first user to the user's account, based at least on the information regarding the first amount and the information regarding the second amount.

### Ninth Embodiment

Next, an embodiment of the aforementioned “(B) linked-account settlement” will be described. The ninth embodiment is an embodiment for implementing linked-account settlement.

The content described in the ninth embodiment is applicable to any other embodiments and variations.

Corresponding elements that are the same as those already described are assigned the same reference numerals as those used for corresponding elements, and a redundant description thereof is omitted.

A description will be given of the present embodiment in which user accounts of users (hereinafter referred to as “group members”) included in a group formed on a messaging application are linked, as an example of account linkage. The server 10 that implements this embodiment has the same configuration as that shown in FIG. 3-20.

The present embodiment will describe the server 10 executing account linkage processing.

Note that, not limited thereto, the account linkage processing may be executed by the terminal 20.

Example Display Screen

In the following, an example display screen will be described while taking an example of a talk-room on the aforementioned messaging application. As mentioned above, a talk using the messaging application is an example of a “chat”, and a talk-room is an example of a “chat-room”.

In the following example, linked-account settlement is carried out by linking user accounts of a plurality of group members included in a group formed on the messaging application.

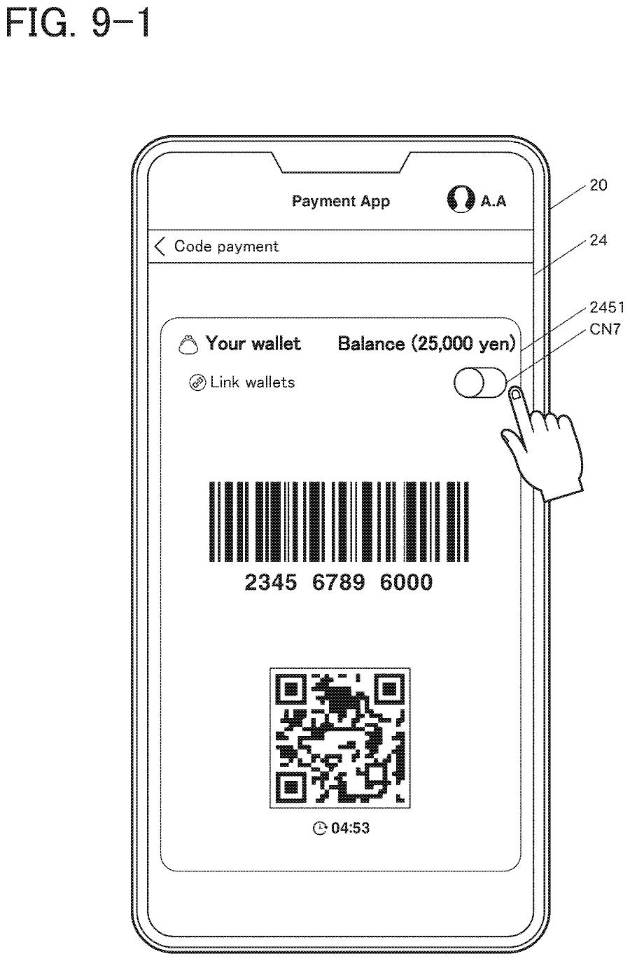

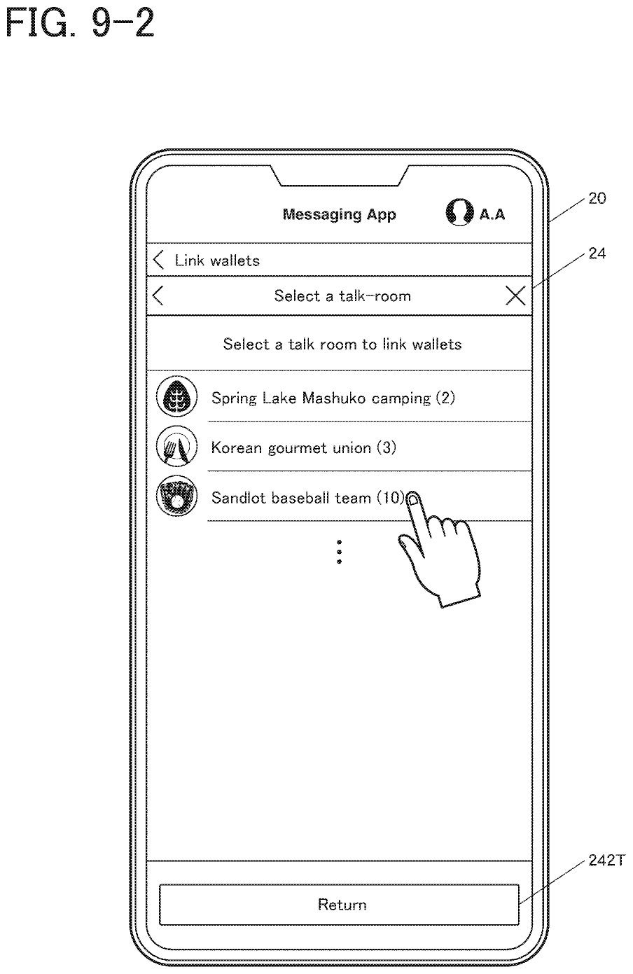

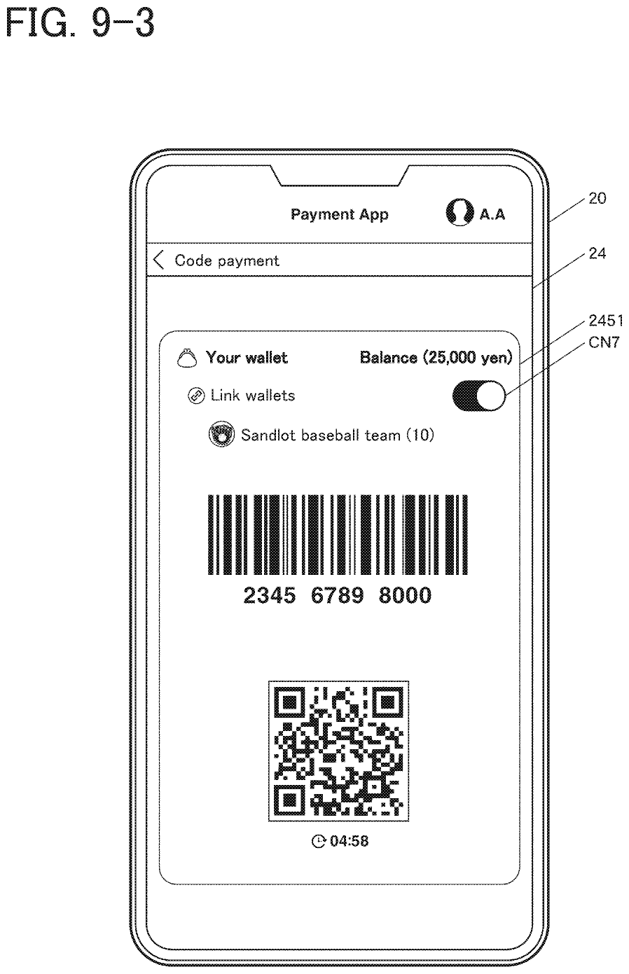

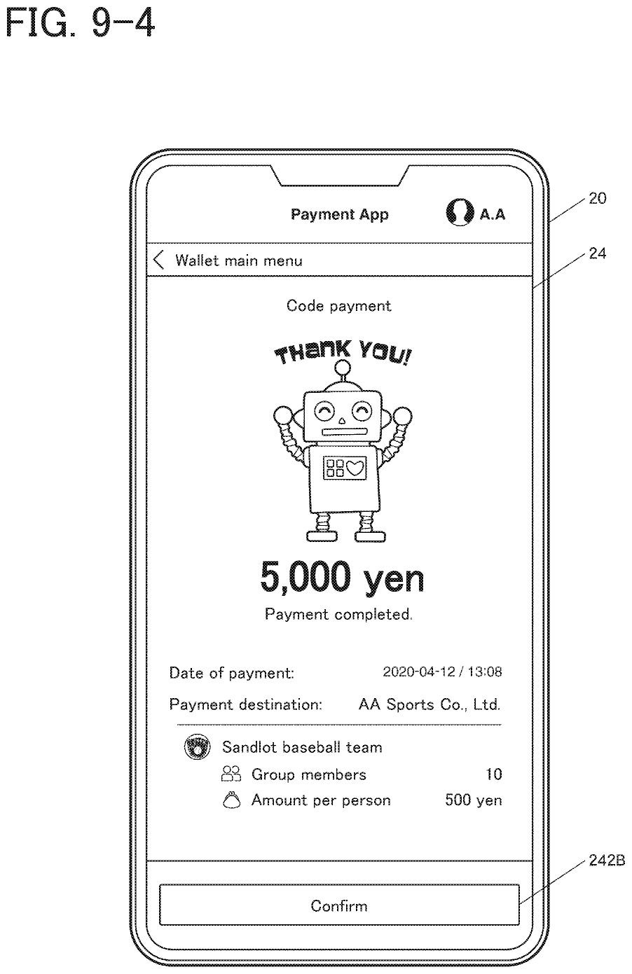

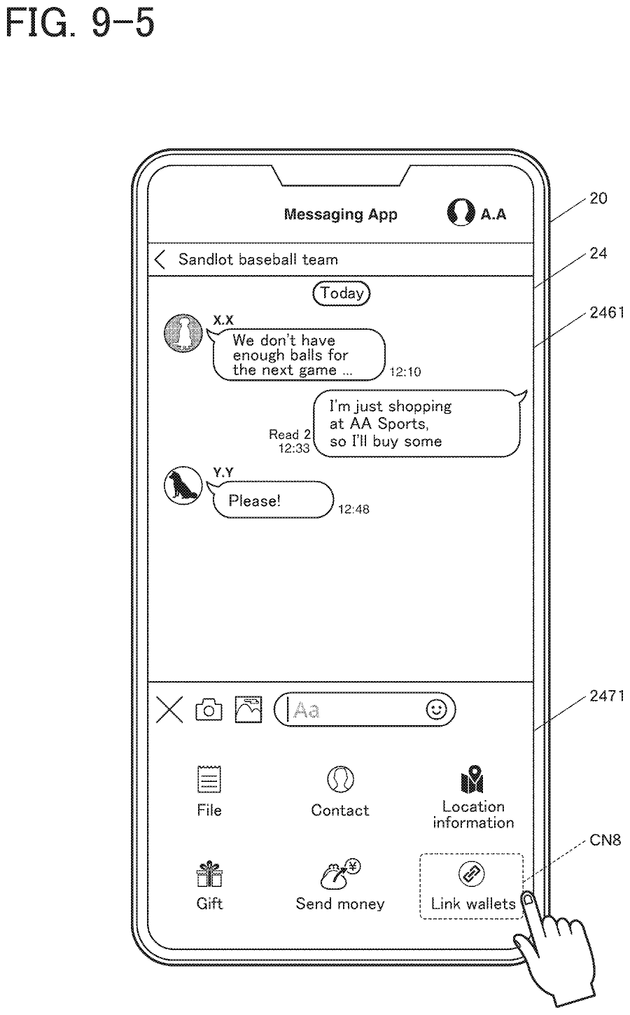

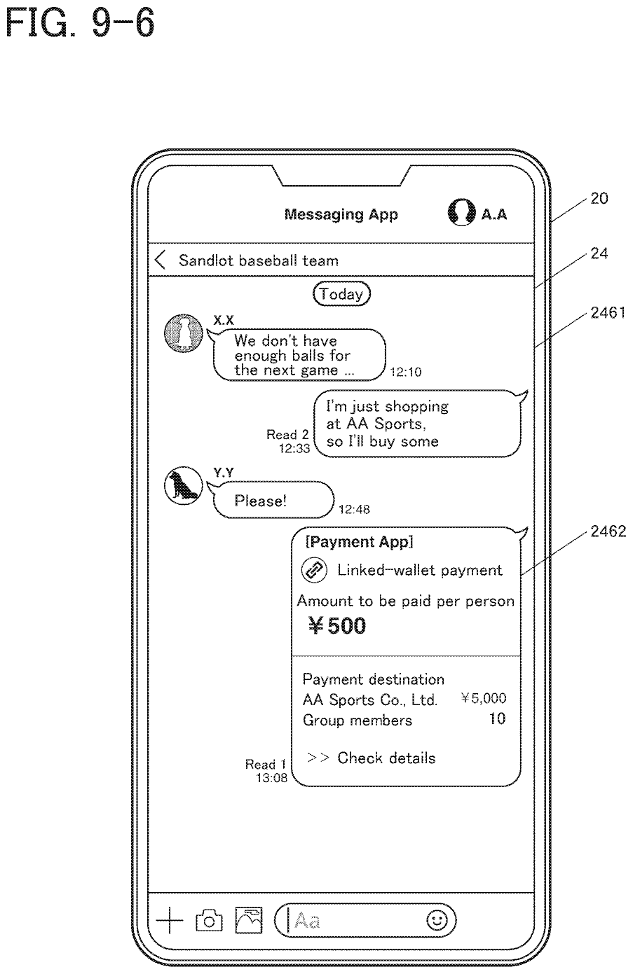

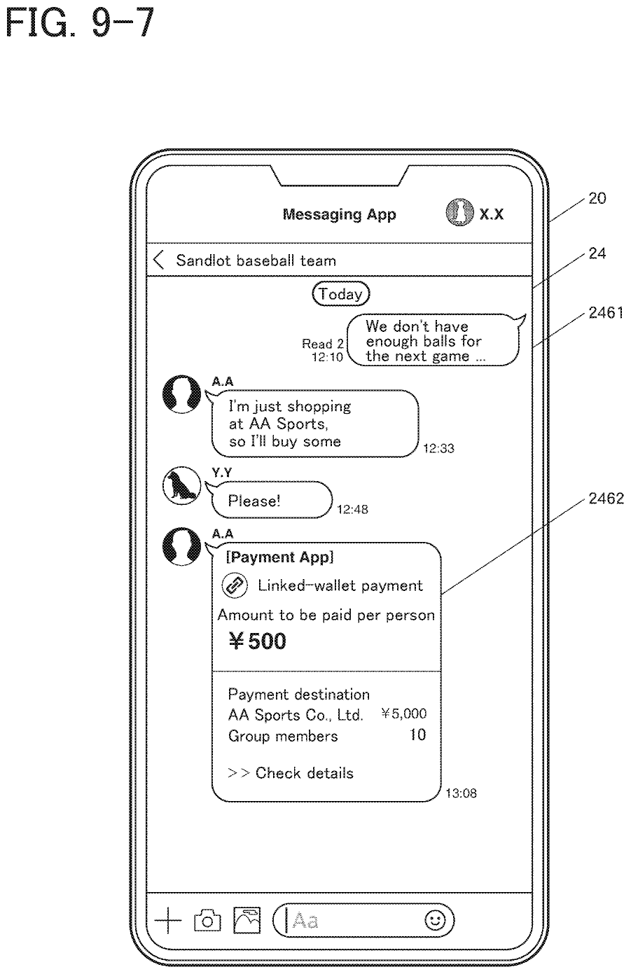

FIG. 9-1 is a diagram showing an example of a code payment screen (before linkage) that is displayed in the display 24 of the terminal 20 of the user A.A when “your wallet” (not shown) is touched in the submenu in FIG. 3-1, and an icon shown as “code payment” is touched by the user A.A of the terminal 20 in the user's wallet screen, similarly to FIG. 5-30.

In an upper part of the code payment region 2451 for paying from the user's wallet, the text “integrate wallets” is displayed in FIG. 5-3 below the text “your wallet” displayed together with an icon image of a purse with a clasp. In contrast, in FIG. 9-1, the text “link wallets” is displayed together with an anchor mark, and a slide button CN7 for switching between “ON” and “OFF” of wallet linkage is displayed next to “Link wallets”. Wallet linkage is substantially synonymous with account linkage.

FIG. 9-2 is a diagram showing an example of a talk-room selection screen that is displayed when the slide button CN7 is touched in FIG. 9-1.

In this screen, “Messaging App”, which is the application name of the messaging application, is displayed in an uppermost title bar, and an icon image of the user A.A and the text “A.A” indicating the user name are displayed next to the application name, for example, without limitation thereto. The current location in a hierarchical menu of the “Messaging App” is displayed below the title bar.

Specifically, “link wallets”, which is the top menu that is currently executed, is displayed, for example, without limitation thereto. Below that, the text “select a talk-room” are displayed, and a “× icon” for closing this screen is displayed next to such text. Below that, the explanation “select a talk-room to link wallets” is displayed as an operation guide for the user, and a plurality of talk-rooms (more specifically, group talk-rooms) are displayed in a list format below the explanation.

This list includes a plurality of row items that are vertically arranged so that the user can select any of these items, and the name of a talk-room is displayed in association with a talk-room icon image of the talk-room in each row item.

In this example, the list includes a row item in which the text “spring Lake Mashuko camping (2)” is displayed in association with an icon image of a tree, a row item in which the text “Korean gourmet union (3)” is displayed in association with an icon image of a knife and a fork on a dish, and a row item in which the text “sandlot baseball team (10)” are displayed in association with an icon image of a glove catching a ball. “The number in ( )” indicates the number of users (group members) included in each group.

FIG. 9-3 is a diagram showing an example of a code payment screen (after linkage) that is displayed when the row item in which the text “sandlot baseball team (10)” is displayed is touched in the talk-room selection screen shown in FIG. 9-2.

FIG. 9-3 is different from FIG. 9-1 in that in the code payment region 2451, the slide button CN7 is in an “ON” state, and the text “sandlot baseball team (10)” is newly displayed together with the icon image of a glove catching a ball below the slide button CN7.

Furthermore, displayed payment codes are different from those in FIG. 9-1 due to the accounts (wallets) being linked.

FIG. 9-4 is a diagram showing an example of a code payment completion screen that is displayed on the terminal 20 when settlement processing is completed by the server 10, similarly to FIG. 3-7.

The code payment completion screen in FIG. 9-4 is different from the code payment completion screen in FIG. 3-7 in a lower part of this screen below a portion indicating that the payment destination is “AA Sports Co., Ltd.” Specifically, information relating to the “sandlot baseball team” group is newly displayed below underlining of the payment destination displayed. More specifically, “10” is displayed as the number of members of the “sandlot baseball team”, and “500 yen” is displayed as an amount per person.

A confirm button 242B for giving a notification that the user has confirmed completion of the code payment is displayed in the lower part of the screen.

FIG. 9-5 is a diagram showing an example of a talk-room screen of the messaging application executed on the terminal 20 that is displayed in the display 24.

In this talk-room screen, “Messaging_App”, which is the application name of the messaging application, is displayed in an uppermost title bar, for example, without limitation thereto. The current location in a hierarchical menu of the “Messaging App” is displayed below the title bar. Specifically, “sandlot baseball team (10)”, which is the top menu that is currently executed, is displayed, for example, without limitation thereto. Below that, a talk-room region 2461 is provided, and further, an icon display region 2471 is provided below the talk-room region 2461.

In this example, the text “today” is displayed as a date at the center of the upper part of the talk-room region 2461. Below that, a user name “X.X” is displayed together with an icon image of a user X.X, and a message “We don't have enough balls for the next game . . . ” is displayed in a balloon on the left side of the screen as a message sent from the user X.X at “12:10”.

Below that, a message “I'm just shopping at AA Sports, so I'll buy some” is displayed in a balloon on the right side of the screen as a message that the user A.A, who is the user of the terminal 20, replied at “12:33”.

Below that, a user name “Y.Y” is displayed together with an icon image of a user YY, and a message “Please!” is displayed in a balloon on the left side of the screen as a message sent from the user Y.Y at “12:48”.

Six icons corresponding to “file”, “contact”, “location information”, “gift”, “send money”, and “link wallets” are displayed in the icon display region 2471, for example, without limitation thereto. In the following description, the icon corresponding to “link wallets” will be referred to as a wallet linkage icon CN8.

FIG. 9-6 is a diagram showing an example of a talk-room screen that is displayed when the wallet linkage icon CN8 is touched in the talk-room screen in FIG. 9-5.

In FIG. 9-6, a linkage notification message 2462 for giving a notification that the accounts have been linked and payment has been carried out from the linked accounts is displayed as a message sent from the user A.A below the message “Please!” sent from the user Y.Y that is displayed in the talk-room region 2461 in FIG. 9-5.

Upon the screen in FIG. 9-4 being displayed in the display 24 of the terminal 20 of the user A.A, for example, without limitation thereto, information relating to the payment is transmitted from the payment management server 10A to the messaging management server 10B via an API, for example, without limitation thereto. Then, the linkage notification message 2462 is generated and automatically sent to the terminals whose accounts are linked, by the controller of the messaging management server 10B, for example, without limitation thereto.

In this linkage notification message 2462, the text [Payment App] is displayed in an upper part, and the text “linked-wallet payment” is displayed together with an anchor mark below [Payment App]. Below that, “500 yen” is displayed to indicate the amount to be paid per person.

In a lower part, “AA Sports Co., Ltd.” is displayed as the payment destination, “5,000 yen” is displayed as the payment amount, and “10” is displayed as the number of group members. Below that, a detail check icon for checking the details is displayed.

FIG. 9-7 is a diagram showing an example of a talk-room screen corresponding to FIG. 9-6 that is displayed in the display 24 of the terminal 20 of the user X.X. The aforementioned linkage notification message 2462 is displayed below the message “Please!” sent from the user YY.

Effects of Ninth Embodiment

In the ninth embodiment, the terminal 20 executes, with use of the controller 21, processing (a non-limiting example of processing for associating a first account with a second account) for linking the user account (a non-limiting example of the first account) of the user of the terminal 20 with the user account (a non-limiting example of the second account) of another group member. The terminal 20 then executes, with use of the controller 21, processing relating to settlement based on the linked user accounts of the user of the terminal 20 and the other group member.

As an example of the effect achieved by this configuration, the first account with which the user of the terminal can carry out settlement can be associated with the second account different from the first account. Further, settlement that is based on the associated first and second accounts can be implemented.

The ninth embodiment also describes a configuration in which a user account (a non-limiting example of a second account) of another account to be linked is selected based on a selection of a group talk-room (a non-limiting example of a chat-room).

As an example of the effect achieved by this configuration, the second account can be selected using a simple method, namely a selection of a chat-room.

Ninth Embodiment Variation (1)

In the ninth embodiment, accounts are linked by selecting a group talk-room, but this need not be the case. Needless to say, user accounts of two users can also be linked.

When user accounts of two users A.A and B.B are linked to carry out settlement, for example, without limitation thereto, the user A.A may directly select the user B.B on the payment application or the messaging application that is executed on the terminal 20 to link the own user account with the user account of the user B.B. In this case, the user accounts of the users A.A and B.B are linked to perform linked-account settlement.

Note that the user B.B may be disadvantaged if the user A.A links their accounts without permission. For this reason, the user A.A may ask the user B.B for permission for account linkage.

Ninth Embodiment Variation (2)

In the ninth embodiment, settlement can also be carried out through wireless communication (including short-range wireless communication) instead of code settlement, similarly to the fourth embodiment variation (9).

In the case of applying the aforementioned contactless communication, the user of the terminal 20 carries out settlement by holding the terminal 20 over the card reader or the card reader/writer at the store, similarly to the above-described embodiment. In this case, if, as a result of reading information using the card reader, the electronic money account balance of the user account of the user of the terminal 20 is insufficient, the controller 11 of the server 10 transmits information (insufficient settlement balance information) indicating the insufficient balance to the terminal 20 using the communication I/F 14, for example, without limitation thereto. Upon receiving the insufficient settlement balance information from the server 10 using the communication I/F 22, the controller 21 of the terminal 20 causes the display 24 to display the insufficient settlement balance information. The controller 21 of the terminal 20 then executes account linkage processing based on input to the displayed insufficient settlement balance information that is made by the user of the terminal 20. Linked-account settlement can be carried out by the user of the terminal 20 holding again the terminal 20 over the card reader at the store.

Note that accounts can also be linked in advance, as mentioned above.

This applies to the case of applying Bluetooth communication.

This variation describes a configuration in which processing relating to settlement is executed through wireless communication with the store code reader device 50 (a non-limiting example of a terminal at a store that sells goods or provides a service to be purchased through settlement) using the communication I/F 22 of the terminal 20.

As an example of the effect achieved by this configuration, settlement can be implemented through wireless communication with the terminal at the store that provides goods or provides a service to be purchased through the first settlement.

This variation also describes a configuration in which the aforementioned wireless communication is short-range communication.

As an example of the effect achieved by this configuration, wireless communication with the terminal at the store that provides goods or provides a service to be purchased through the first settlement can be implemented with short-range communication.

Ninth Embodiment Variation (3)

The linked-account settlement described in the ninth embodiment may be shared account settlement in which a shared account is temporarily created and is used to carry out settlement.

Specifically, if a group talk-room with which linked-account settlement is to be performed is selected in the talk-room selection screen in FIG. 9-2, the server 10 creates a temporary shared wallet (shared wallet balance=0) with shared wallet members being the members of the selected group talk-room, for example, without limitation thereto.

When settlement is to be carried out from the created shared wallet, the settlement will fail since the shared wallet balance is “0”. In this case, settlement can be carried out by applying the method described in any of the above-described second to seventh embodiments, for example, without limitation thereto.

That is, in this case, the content described in the above second to seventh embodiments can be applied similarly.

When the shared wallet is discarded, the content described in the eighth embodiment can be applied similarly.

### Tenth Embodiment

The tenth embodiment is an embodiment relating to combinations (variations) of two accounts (a first account and a second account) in various embodiments described above.

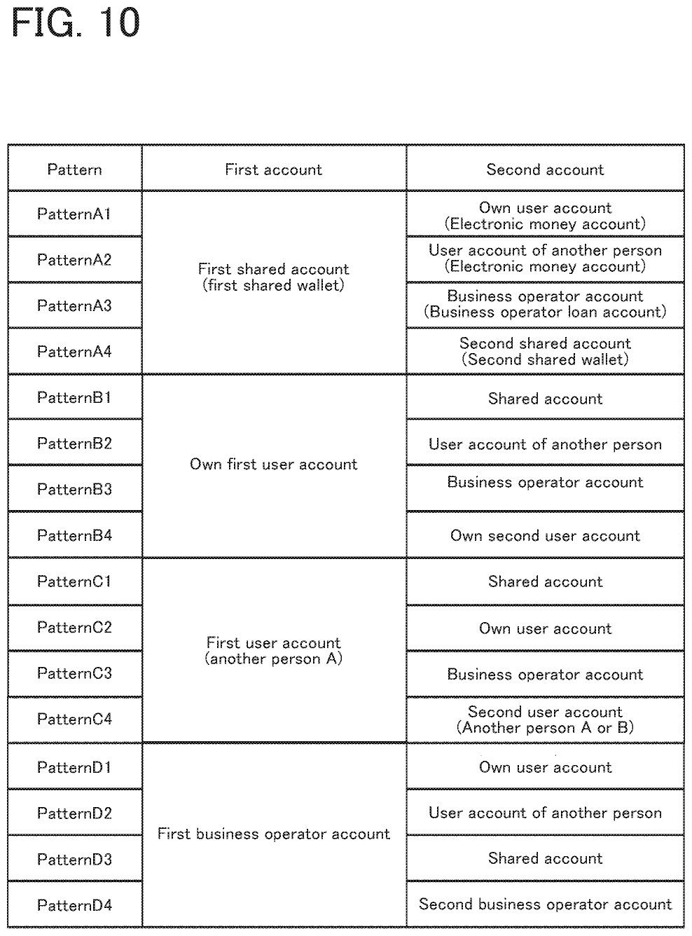

FIG. 10 is a diagram showing an example of a table for illustrating combinations of the first account and the second account.

In this table, patterns, first accounts, and second accounts are associated with each other, for example, without limitation thereto. Each pattern will be described below.

(1) Patterns A

Patterns A are patterns in which the first account is a “first shared account (first shared wallet)”, and include four patterns A1 to A4 with four types of second accounts.

The first shared account is an account (primary account) of a shared wallet that can be used by users of a plurality of terminals 20 including the user of the own terminal 20.

In the pattern A1, the second account is a “user account (electronic money account) of the user”.

In the pattern A2, the second account is a “user account (electronic money account) of another person”.

In the pattern A3, the second account is a “business operator account (business operator loan account)”.

“Business operator” may refer to a licensed business operator in the business of financing or lending money, including a business operator that provides a payment service (payment application), for example, without limitation thereto.

The business operator account is an account of a payment application of this business operator.

The business operator loan account is an account for this business operator to finance or lend money to the user (the user of the terminal 20).

In the pattern A4, the second account is a “second shared account (second shared wallet)”.

The second shared account is a shared account (secondary shared account) different from the first shared account that can be used by users of a plurality of terminals 20 including the user of the own terminal 20.

(2) Patterns B

Patterns B are patterns in which the first account is an “own first user account”, and include four patterns B1 to B4 with four types of second accounts.

The own first user account is an account (primary user account) of the payment application of the user.

In the pattern B1, the second account is a “shared account”.

In the pattern B2, the second account is a “user account of another person”.

In the pattern B3, the second account is a “business operator account”.

In the pattern B4, the second account is an “own second user account”.

The own second user account is an account (secondary user account of the user) of the payment application of the user that is different from the own first user account.

(3) Patterns C

Patterns C are patterns in which the first account is a “first user account (another person A)”, and include four patterns C1 to C4 with four types of second accounts.

The first user account (another person A) is an account of the payment application of the other person A.

In the pattern C1, the second account is a “shared account”.

In the pattern C2, the second account is an “own user account”.

In the pattern C3, the second account is a “business operator account”.

In the pattern C4, the second account is a “second user account (another person A or B)”.

The second user account (another person A or B) is an account (secondary user account of the other person A) of the payment application of the other person A that is different from the first user account of the other person A, or an account (primary user account of the other person B) of the payment application of the other person B.

(4) Patterns D

Patterns D are patterns in which the first account is a “first business operator account”, and include four patterns D1 to D4 with four types of second accounts.

The first business operator account is an account (a primary account of a first business operator account) of the payment application of the first business operator.

In the pattern D1, the second account is the “own user account”.

In the pattern D2, the second account is the “user account of another person”.

In the pattern D3, the second account is the “shared account”.

In the pattern D4, the second account is a “second business operator account”.

The second business operator account is an account (secondary account of the first business operator) of the payment application of the first business operator that is different from the first business operator account, or an account (primary account of a second business operator) of the payment application of a second business operator.

In shared account settlement, any of the patterns A (the patterns A1 to A4), the pattern B1, the pattern C1, and the pattern D3 that include the shared account, out of the above-listed patterns, is applicable. In this case, shared account settlement can be carried out by applying the method of any of the second to eighth embodiments similarly.

In linked-account settlement, any of the patterns B2 to B4, the patterns C2 to C4, and the patterns D1, D2, and D4 that do not include the shared account, out of the above-listed patterns, is applicable. In this case, linked-account settlement can be carried out by applying the method of the ninth embodiment similarly.

If linked-account settlement is regarded as a method in which a plurality of users carry out settlement together, patterns that do not use the shared account can also be applied to the methods of the second to eighth embodiments. That is, of the above-listed patterns, any of the patterns B2 to B4, the patterns C2 to C4, and the patterns D1, D2, and D4 that do not include the shared account is also applicable to the second to eighth embodiments.

Effects of Tenth Embodiment

According to the tenth embodiment, settlement can be implemented by setting various accounts as the first and second accounts. Thus, convenience of the user of the terminal can be improved.

When the second account is a business operator account (a non-limiting example of an account of a business operator), settlement can be implemented based at least on the account of the business operator by causing processing relating to the settlement to be executed by lending a shortfall in the balance from this business operator account, for example, without limitation thereto. In addition, even when the balance is insufficient, settlement can also be appropriately carried out by borrowing a shortfall in the balance from the account of the business operator.

1. A non-transitory computer-readable medium configured to store instructions which, when executed by at least one processor of a terminal that executes processing relating to payment, cause the at least one processor to:
perform processing related to a first settlement based on a first account with which a user of the terminal is able to carry out settlement;
control a display region of the terminal to display first information related to an insufficiency of a balance of the first account, the first information being based on an amount of the first settlement and the balance of the first account; and
based on a first input being received at the display region while the first information is displayed, perform the processing related to the first settlement based on at least a second account different from the first account.

2. The non-transitory computer-readable medium according to claim 1, wherein the first account is a shared account, and
wherein at least the user of the terminal and a first user different from the user of the terminal are able to carry out settlement with the shared account.

3. The non-transitory computer-readable medium according to claim 2, wherein the processing related to the first settlement is performed based on at least the shared account and the second account, based on the first input received at the display region.

4. The non-transitory computer-readable medium according to claim 3, wherein in the first settlement, payment is carried out preferentially from a balance of the shared account from among the shared account and the second account.

5. The non-transitory computer-readable medium according to claim 3, wherein according to the first settlement, money is transferred from the second account to the shared account, and the first settlement is carried out based on a balance of the shared account.

6. The non-transitory computer-readable medium according to claim 5, wherein according to the processing related to the first settlement, the money is transferred from the second account to the shared account based on the first input, and
wherein the first input received from the user of the terminal.

7. The non-transitory computer-readable medium according to claim 1, wherein the instructions further cause the at least one processor to:
control the display region to display first code information associated with the second account, or code reader information which indicates reading of code information, based on the first input being received at the display region while the first information is displayed, the first input being received from the user of the terminal; and
perform the processing related to the first settlement based on the first code information being read, or based on the code information being read by the terminal while the code reader information is displayed in the display region.

8. The non-transitory computer-readable medium according to claim 2, wherein the second account is an account of the user of the terminal.

9. The non-transitory computer-readable medium according to claim 8, wherein the instructions further cause the at least one processor to:
control the display region to display second information related to an insufficiency of a balance of the shared account, based on the amount of the first settlement, the balance of the shared account, and a balance of the second account; and
perform processing related to sending money to the second account, based on a second input being received at the display region while the second information is displayed, the second input received from the user of the terminal.

10. The non-transitory computer-readable medium according claim 2, wherein the second account is an account of the first user.

11. The non-transitory computer-readable medium according to claim 10, wherein the instructions further cause the at least one processor to:
transmit a request for permission to use the second account for settlement to another terminal different from the terminal using a communication interface of the terminal, and
wherein the processing related to the first settlement is performed based on the permission being received from the first user.

12. The non-transitory computer-readable medium according to claim 10, wherein the instructions further cause the at least one processor to:
receive, using a communication interface of the terminal, charge information related to a charge for an amount corresponding to payment using the second account; and
control the display region to display a first indication based on the charge information.

13. The non-transitory computer-readable medium according to claim 2,
wherein the processing related to the first settlement is performed based on the shared account and accounts of users,
wherein the users are able to carry out settlement using the shared account, and
wherein the accounts include the second account.

14. The non-transitory computer-readable medium according to claim 13, wherein payment that is based on the first settlement is executed while a shortfall in the balance of the shared account is equally assigned to the accounts.

15. The non-transitory computer-readable medium according to claim 2,
wherein the second account is an account of a business operator, and
wherein the processing related to the first settlement is performed by lending, from the second account, an amount corresponding to a shortfall in the balance of the first account.

16. The non-transitory computer-readable medium according to claim 2, wherein the processing related to the first settlement is performed based on code information displayed at the display region being read, or based on the terminal reading code information.

17. The non-transitory computer-readable medium according to claim 2,
wherein the first information is received using a communication interface of the terminal from a server that processes the first settlement, based on the balance of the shared account being determined to be insufficient based on the amount of the first settlement and the balance of the shared account.

18. The non-transitory computer-readable medium according to claim 1,
wherein the processing related to the first settlement is performed using wireless communication with a terminal corresponding to a store which sells goods or provides a service to be purchased according to the first settlement, and
wherein the wireless communication is performed using a communication interface of the terminal.

19. The non-transitory computer-readable medium according to claim 18, wherein the wireless communication comprises short-range communication.

20. The non-transitory computer-readable medium according to claim 1, wherein the second account is an account of a first user different from the user of the terminal.

21. The non-transitory computer-readable medium according to claim 20, wherein the second account is selected based on input to the terminal, the input being received from the user of the terminal.

22. The non-transitory computer-readable medium according to claim 20, wherein the second account is selected based on a selection of a chat-room including the user of the terminal and the first user, the selection being received from the user of the terminal.

23. The non-transitory computer-readable medium according to claim 22, wherein the instructions further cause the at least one processor to:
transmit information related to a request for permission to use the second account for settlement, using a communication interface of the terminal, and
wherein the processing related to the first settlement is executed based on the permission being received from the first user.

24. An information processing method of a terminal for performing processing related to settlement, the method comprising:
performing, using a controller of the terminal, processing related to first settlement based on a first account with which a user of the terminal is able to carry out settlement;
displaying, in a display region of the terminal, first information related to an insufficiency of a balance of the first account, based on an amount of the first settlement and the balance of the first account; and
based on a first input being received at the display region while the first information is displayed, performing, using the controller, the processing related to the first settlement based on at least a second account different from the first account.

25. A terminal for performing processing relating to settlement, the terminal comprising:
a controller configured to perform processing relating to a first settlement, based on a first account with which a user of the terminal is able to carry out settlement; and
a display configured to display first information relating to an insufficiency of a balance of the first account, based on an amount of the first settlement and the balance of the first account,
based on an input being received from the user of the terminal at the display while the first information is displayed, the controller is further configured to perform the processing related to the first settlement based on at least a second account different from the first account.

26. A terminal for performing processing relating to settlement, the terminal comprising:
a processor configured to read program code stored in a memory and execute processing based on the program code,
wherein the program code is configured to cause the processor to:
perform processing related to a first settlement based on a first account with which a user of the terminal is able to carry out settlement,
control a display region of the terminal to display first information related to an insufficiency of a balance of the first account, based on an amount of the first settlement and the balance of the first account, and
based on a first input being received at the display region while the first information is displayed, perform the processing related to the first settlement based on at least a second account different from the first account.

27. A non-transitory computer-readable medium configured to store instructions which, when executed by at least one processor of a server that communicates with a terminal for performing processing relating to settlement, cause the at least one processor to:
perform processing related to first settlement based on a first account with which a user of the terminal is able to carry out settlement;
control a communication interface of the server to transmit, to the terminal, first information relating to insufficiency of a balance of the first account based on an amount of the first settlement and the balance of the first account; and
based on a first input being received from the user of the terminal at a display region of the terminal while the first information is displayed on the display region, perform the processing related to the first settlement based at least on a second account different from the first account.
